(19) United States
(12) Patent Application Publication
(10) Pub. No.: US 2013/0116132 A1
(43) Pub. Date: May 9, 2013

(54) ALZHEIMER'S PROBE KIT

(71) Applicants: Praveen SHARMA, Oslo (NO); Torbjorn LINDAHL, Oslo (NO)

(72) Inventors: Praveen SHARMA, Oslo (NO); Torbjorn LINDAHL, Oslo (NO)

(73) Assignee: DIAGENIC ASA, Oslo (NO)

(21) Appl. No.: 13/339,631

(22) Filed: Dec. 29, 2011

(30) Foreign Application Priority Data
Nov. 3, 2011 (GB) 1118985.9

(51) Int. Cl. C40B 40/06; C40B 30/04

(52) U.S. Cl. 506/9; 506/16

(57) ABSTRACT

Oligonucleotide probes for use in assessing gene transcript levels in a sample, which may be used in analytical techniques, particularly diagnostic techniques, are disclosed. Conveniently the probes are provided in kit form. Different sets of probes may be used in techniques to prepare gene expression patterns and identify, diagnose or monitor neurodegenerative diseases or conditions and their progression.

### FIELD OF THE INVENTION

The present invention relates to oligonucleotide probes, for use in assessing gene transcript levels in a sample, which may be used in analytical techniques, particularly diagnostic techniques. Conveniently the probes are provided in kit form. Different sets of probes may be used in techniques to prepare gene expression patterns and identify, diagnose or monitor neurodegenerative diseases or conditions and their progression.

### BACKGROUND OF THE INVENTION

Neurodegenerative disease results in the progressive degeneration and/or death of nerve cells leading to problems with movement (ataxias) or mental functioning (dementias). In particular the method is concerned with identifying, diagnosing or monitoring cognitive impairment and its progression, e.g. to dementias such as Alzheimer's disease or stages thereof.

Dementias account for the majority of neurodegenerative diseases in the population. The prevalence of dementia is rapidly rising as the average age of the population increases. It is estimated that more than 24 million people worldwide have dementia. Alzheimer's disease accounts for the highest number of dementia cases, particularly in the elderly.

Evidence suggests that the pathophysiological process of dementia, e.g. Alzheimer's disease, begins years, if not decades, prior to the diagnosis of clinical dementia. Therapeutic interventions early in the pathophysiological process are more likely to be successful, particularly as treatments of Alzheimer's disease appear to have limited impact once the clinical symptoms appear and neuronal degradation has begun.

Thus, there is a need to identify patients that might progress to ataxia or dementia as soon as possible so that treatment and management strategies may be contemplated at an early stage. Current methods for detecting dementias have poor positive predictive accuracy of up to about 61% (Visser, 2006, Principles & Practice of Geriatric Medicine, 4th Edition, Eds. Pathy et al., Section 94).

In Alzheimer's disease and other dementias, the earliest clinical sign of the presence of a cognitive disorder is mild cognitive impairment (MCI) which is a predementia phase of cognitive dysfunction.

MCI is a general term that defines a mildly impaired set of patients which show reduced cognitive performance. MCI patients may be divided into amnestic MCI and non-amnestic MCI but even this is not predictive of whether the MCI will progress to dementia. Not all forms of MCI will evolve into a dementia such as Alzheimer's disease and some may be stable or exhibit improvement with time.

Thus MCI describes a group of patients grouped by clinical parameters rather than the underlying pathology. Within that group are sub-groups that will convert to Alzheimer's disease, that will convert to other dementias, which are stable or which will revert to normal cognitive function.

The sub-group of MCI patients that convert to dementia may be considered prodromal for that dementia, e.g. to have prodromal Alzheimer's disease (AD). It is generally accepted that the progression rate of patients with MCI to AD is between 10 and 15% per year but to date there is no reliable and easy way of identifying the sub-group that will convert.

Methods for identifying whether a patient will progress from MCI to Alzheimer's disease include assessment of various predictors of progression such as the ApoE ε4 carrier status, presence of atrophy on MRI, 18FDG PET pattern of Alzheimer's disease, presence of CSF markers (such as amyloid β1-42 peptide, total tau and phosphorylated tau) and a positive amyloid imaging scan (see Petersen et al., 2009, Arch. Neurol., 66(12), p1447-1454). However, whilst these predictors may be associated with Alzheimer's disease they are not always specific to Alzheimer's disease and more than one marker is usually necessary to aid diagnosis, particularly coupled with cognitive testing.

As mentioned above, to allow for early therapeutic intervention, early identification of neurodegnerative diseases or conditions is important, e.g. the identification of MCI patients that will progress to dementia. Okamura et al., 2002, Am. J. Psychiatry, 159:3, p474-476 used a combined test of CSF tau levels and regional cerebral blood flow in the posterior cingulate cortex. However, such methods are time consuming, complex and invasive with high cost and low patient compliance making introducing such diagnostic tools in a wide clinical setting challenging. Furthermore, cognitive markers have been found to be better predictors of conversion to dementia (Gomar et al., 2011, Arch. Gen Psychiatry, 68(9); p961-969). A simple test to identify and stage neurodegenerative disorders and diseases, particularly in relation to Alzheimer's disease would be desirable. In particular the use of an accurate blood based test would clearly be a valuable asset in the assessment of patients with possible neurodegenerative diseases or conditions.

In earlier work, the present inventors identified the systemic effect of various diseases and conditions on gene expression in blood cells, see e.g. WO98/49342 and WO04/046382, incorporated herein by reference, the latter of which describes specific probes for the diagnosis of breast cancer and Alzheimer's disease.

Blood tests based on gene expression profiling in the diagnosis of brain disorders have been described. In particular, the present inventors have identified that the expression of 96 genes allows the detection of patients with Alzheimer's disease (Rye et al., 2011, Journal of Alzheimer's Disease, 23, p121-129). However, these methods have not allowed for the determination of the stage or progression of the disease or for the identification of the sub-group within MCI patients that will progress to dementia. The identification of quick and easy methods of sample analysis for, for example, diagnostic applications, remains the goal of many researchers. End users seek methods which are cost effective, produce statistically significant results and which may be implemented routinely without the need for highly skilled individuals.

### SUMMARY OF THE INVENTION

We have now identified sets of probes which are of surprising utility for identifying, staging and monitoring neurodegenerative diseases and conditions, particularly Alzheimer's disease.

In work leading up to this invention, the inventors examined the level of expression of various genes in patients with neurodegenerative diseases at various stages relative to normal patients.

Thus in one aspect, the present invention provides a set of oligonucleotide probes, wherein said set comprises at least 10 oligonucleotides, wherein each of said 10 oligonucleotides, which are each different, are selected from:
(a) an oligonucleotide which is a part of a sequence as set forth in Table 1;
(b) an oligonucleotide derived from a sequence as set forth in Table 1;
(c) an oligonucleotide with a sequence complementary to the sequence of the oligonucleotide of a) or b); or
(d) an oligonucleotide which is functionally equivalent to an oligonucleotide as defined in (a), (b) or (c).

As referred to herein, a sequence as set forth in Table 1 is the sequence to which the assay refers, e.g. ASSAY0001 refers to sequence No. 1 provided herein. An oligonucleotide which is part of said sequence has the size as described hereinafter and satisfies the requirements of the oligonucleotide probes as described herein, e.g. in length and function. Such oligonucleotides include probes such as primers which correspond to a part of the disclosed sequence or the complementary sequence. More than one oligonucleotide may be a part of the sequence, e.g. to generate a pair of primers and/or a labelling probe.

In a preferred aspect the oligonucleotide has the sequence set forth in the context sequence for said full length sequence or a part thereof as described herein, wherein said context sequence is a portion of the full length sequence and is provided in Tables 2 to 9 in relation to the relevant sequence and is referred to herein as the oligonucleotide sequence from said Tables. As referred to herein, an oligonucleotide from a Table (or a Table oligonucleotide or probes) refers to an oligonucleotide which is a part of a sequence (oligonucleotide or full length) as set forth in a Table or its derived, complementary or functionally equivalent oligonucleotides.

Preferably, each of said 10 probes is part of a different sequence as set forth in Table 1, but one or more of said oligonucleotides may be replaced by the corresponding complementary or functionally equivalent oligonucleotide, i.e. replaced with an oligonucleotide that will bind to the same gene transcript. If, for example, only primers are to be used, in all likelihood all oligonucleotides will be parts of the provided sequences.

In a preferred aspect, said set comprises at least 15, 20, 30, 40, 50, 60 or especially preferably all of the probes of Table 1.

In particularly preferred aspects the probes may be from Tables 2 to 9 as described hereinafter.

Conveniently the 10 or more probes Which are selected are probes which are common to one or more of the Tables described herein. Thus, preferably said 10 or more probes are selected from probes which appear in both Tables 2 and 3 (in particular in relation to MCI stable versus converter analysis discussed hereinafter) or in both of Tables 9 and 10 (in particular in relation to determining the progression of Alzheimer's disease). In preferred alternative aspects, in Tables in which only some sequences exhibit a p-value of <0.5, the 10 or more probes may be selected from that group. These probes thus provide core probes to which additional probes may be added from relevant Tables. Each table of probes may also form a core group of probes (e.g. Table 3), to which additional probes may be added, e.g. one or probes from Table 2, in particular those exhibiting a p-value of <0.5.

These probes do not rely on the development of disease to clinically recognizable levels and allow detection of a neurodegenerative disease or disorder at a very early stage, even years before other subjective or objective symptoms appear.

The use of such probes in products and methods of the invention, form further aspects of the invention as described hereinafter.

### BRIEF DESCRIPTION OF THE DRAWINGS

FIG. 1 shows the population profile showing the probability of converted MCI (0 to 1) for each case (tag) demonstrating the discrimination between MCI stable and conversion. The 1st, 2nd, 4th-11th, 13th-24th, 26th-32nd, 35th, 54th and 64th cases were included in the MCI stable cohort and the other cases in the MCI conversion cohort.

FIGS. 2 to 9 the results of Permutation plots for the probes reported in tables 1A, 2, 3, 4, 5, 8, 9 and 10, respectively. AUC is the area under the curve and the X axis represents the number of variables selected from the corresponding Tables.

### DETAILED DESCRIPTION OF THE INVENTION

As referred to herein an “oligonucleotide” is a nucleic acid molecule having at least 6 monomers in the polymeric structure, i.e. nucleotides or modified forms thereof. The nucleic acid molecule may be DNA, RNA or PNA (peptide nucleic acid) or hybrids thereof or modified versions thereof, e.g. chemically modified forms, e.g. LNA (Locked Nucleic acid), by methylation or made up of modified or non-natural bases during synthesis, providing they retain their ability to bind to complementary sequences. Such oligonucleotides are used in accordance with the invention to probe target sequences and are thus referred to herein also as oligonucleotide probes or simply as “probes”.

“Probes” as referred to herein are oligonucleotides which bind to the relevant transcript and which allow the presence or amount of the target molecule to which they bind to be detected. Such probes may be, for example probes which act as a label for the target molecule (referred to hereinafter as labelling probes) or which allow the generation of a signal by another means, e.g. a primer.

As referred to herein a “labelling probe” refers to a probe which binds to the target sequence such that the combined target sequence and labelling probe carries a detectable label or which may otherwise be assessed by virtue of the formation of that association. For example, this may be achieved by using a labelled probe or the probe may act as a capture probe of labelled sequences as described hereinafter.

When used as a primer, the probe binds to the target sequence and optionally together with another relevant primer allows the generation of an amplification product indicative of the presence of the target sequence which may then be assessed and/or quantified. The primer may incorporate a label or the amplification process may otherwise incorporate or reveal a label during amplification to allow detection. Any oligonucleotides which bind to the target sequence and allow the generation of a detectable signal directly or indirectly are encompassed.

“Primers” refer to single or double-stranded oligonucleotides which hybridize to the target sequence and under appropriate conditions (i.e. in the presence of nucleotides and an inducing agent such as a DNA polymerase and at a suitable temperature and pH) act as a point of initiation of synthesis to allow amplification of the target sequence through elongation from the primer sequence e.g. via PCR.

In primer based methods, preferably real time quantitative PCR is used as this allows the efficient detection and quantification of small amounts of RNA in real time. The procedure follows the general RT-PCR principle in which mRNA is first transcribed to cDNA which is then used to amplify short DNA sequences with the help of sequence specific primers. Two common methods for detection of products in real-time PCR are: (1) non-specific fluorescent dyes that intercalate with any double-stranded DNA, for example SYBR green dye and (2) sequence-specific DNA probes consisting of oligonucleotides that are labelled with a fluorescent reporter which permits detection only after hybridization of the probe with its complementary DNA target for example the ABI TaqMan System (which is discussed in more detail in the Examples).

An “oligonucleotide derived from a sequence as set forth in Table 1” (or any other table) includes an oligonucleotide derived from the genes corresponding to the sequences (i.e. the presented oligonucleotides or the listed gene sequences) provided in those tables, i.e. to provide oligonucleotides which bind to transcripts from the same gene as the gene to whose transcripts the oligonucleotide of Table 1 binds, preferably which bind to the same transcript but in the alternative derived oligonucleotides may bind to splicing variants. Tables 2 to 9 provides gene identifiers for the various sequences (i.e. the gene sequence corresponding to the sequence provided). Details of the genes may be obtained from the Panther Classification System for genes, transcripts and proteins (see the website having the URL that ends in: pantherdb.org/genes). Alternatively details may be obtained directly from Applied Biosystems Inc., CA, USA. In this case the oligonucleotide forms a part of the gene sequence of which the sequence provided in any one of Tables 1 to 9 is a part. Thus the derived oligonucleotide may form a part of said gene (or its transcript). Thus, for example, labelling probe or primer sequences may be derived from anywhere on the gene to allow specific binding to that gene or its transcript. Thus in a preferred aspect said derived oligonucleotide is an oligonucleotide that is complementary to and binds to a gene as set forth in any one of Tables 1 to 9 or the complementary sequence of said gene.

Preferably the oligonucleotide probes forming said set (and hence the part of the sequence provided in the Tables) are at least 15 bases in length to allow binding of target molecules. Especially preferably said oligonucleotide probes are at least 10, 20, 30, 40 or 50 bases in length, but less than 200, 150, 100 or 50 bases, e.g. from 20 to 200 bases in length, e.g. from 30 to 150 bases, preferably 50-100 bases in length.

When that probe is a primer, similar considerations apply, but preferably said primers are from 10-30 bases in length, e.g. from 15-28 bases, e.g. from 20-25 bases in length. Usual considerations apply in the development of primers, e.g. preferably the primers have a G+C content of 50-60% and should end at the 3′-end in a G or C or CG or GC to increase efficiency, the 3′-ends should not be complementary to avoid primer dimers, primer self-complementarity should be avoided and runs of 3 or more Cs or Gs at the 3′ ends should be avoided. Primers should be of sufficient length to prime the synthesis of the desired extension product in the presence of the inducing agent.

To identify appropriate primers for performance of the invention, the gene sequences or oligonucleotide sequences provided in Tables 1 to 9 may be used to design primers or probes. Preferably said primers are generated to amplify short DNA sequences (e.g. 75 to 600 bases). Preferably short amplicons are amplified, e.g. preferably 75-150 bases. The probes and primers can be designed within an exon or may span an exon junction. For example, Tables 2 to 9 provides the ABI Taqman Assay ID that can be used to obtain additional information pertaining to Assay IDs from the supplier web page having the URL that ends in: appliedbiosystems.com/absite/us/en/home/applications-technologies/real-time-per/taqman-probe-based-gene-expression-analysis/taqman-gene-expression-assay-selection-guide.html. Once Taqman assays has been identified they can then be obtained from the supplier. Alternatively, the gene names and gene symbols can be used to identify the corresponding gene sequences in public databases, for example The National Center for Biotechnology Information (see the website having the URL that ends in: ncbi.nlm.nih.gov/). Alternatively, the oligonucleotide nucleotide sequences provided may be used to identify corresponding gene and transcript by aligning them to known sequences using Nucleotide Blast (Blastn) program at NCBI. Using the gene or transcript sequence, primers and probes can be designed by using freely or commercially available programs for oligonucleotide and primer design, for example The Primer Express Software by Applied Biosystems.

As referred to herein the term “complementary sequences” refers to sequences with consecutive complementary bases (i.e. T:A, G:C) and which complementary sequences are therefore able to bind to one another through their complementarity.

Reference to “10 oligonucleotides” refers to 10 different oligonucleotides. Whilst a Table 1 oligonucleotide, a Table 1 derived oligonucleotide and their functional equivalent are considered different oligonucleotides, complementary oligonucleotides are not considered different. Preferably however, the at least 10 oligonucleotides are 10 different Table 1 oligonucleotides (or Table 1 derived oligonucleotides or their functional equivalents). Thus said 10 different oligonucleotides are preferably able to bind to 10 different transcripts.

Preferably said oligonucleotides are as set forth in Table 1 or are derived from a sequence set forth in Table 1. Said derived oligonucleotides include oligonucleotides derived from the genes corresponding to the sequences provided in those tables, or the complementary sequences thereof.

In a preferred aspect, said oligonucleotides are as set forth in any one of Tables 2 to 9 or are derived from, complementary to or functionally equivalent to such oligonucleotides. Thus when the text refers to Table 1, this may equally be considered to refer to any of Tables 2 to 9 in preferred embodiments.

In a preferred embodiment, said set contains all of the probes (i.e. oligonucleotides) of any one of Tables 1 to 9 (or their derived, complementary sequences, or functional equivalents) or of the sub-sets described above or below. Thus in one aspect the set may contain all of the probes of any one of Tables 1 to 9 (or their derived, complementary sequences, or functional equivalents), i.e. oligonucleotides from all of the sequences sets forth in any one of Tables 1 to 9, or derived, complementary or functionally equivalent oligonucleotides thereof. In a preferred aspect the sets consist of only the above described probes (or their derived, complementary sequences, or functional equivalents).

In addition to the above described informative probes the set may contain one or more reference probes (also referred to herein as assays) which may be used to normalize or pre-process the gene expression data. For example beta-actin has been used in the methods described herein which has been found to be preferable for TaqMan data on the platforms tested.

A “set” as described herein refers to a collection of unique oligonucleotide probes (i.e. having a distinct sequence) and preferably consists of less than 1000 oligonucleotide probes, especially less than 500, 400, 300, 200 or 100 probes, and preferably more than 10, 20, 30, 40 or 50 probes, e.g. preferably from 10 to 500, e.g. 10 to 100, 200 or 300, especially preferably 20 to 100, e.g. 30 to 100 probes. In some cases less than 10 probes may be used, e.g. from 2 to 9 probes, e.g. 5 to 9 probes. As described hereinafter, in methods of the invention such sets may be used in the presence of other probes and the signal from those other probes may be ignored or not used in classification analyses. In such cases the sets may additionally consist of such secondary, non-informative probes as described in more detail hereinafter.

It will be appreciated that increasing the number of probes will prevent the possibility of poor analysis, e.g. misdiagnosis by comparison to other diseases or stages thereof which could similarly alter the expression of the particular genes in question. Other oligonucleotide probes not described herein may also be present, particularly if they aid the ultimate use of the set of oligonucleotide probes. However, preferably said set consists only of said Table 1 (or other Table) oligonucleotides, Table 1 (or other Table) derived oligonucleotides, complementary sequences or functionally equivalent oligonucleotides, or a sub-set (e.g. of the size and type as described above or below) thereof.

Multiple copies of each unique oligonucleotide probe, e.g. 10 or more copies, may be present in each set, but constitute only a single probe.

A set of oligonucleotide probes, which may preferably be immobilized on a solid support or have means for such immobilization, comprises the at least 10 oligonucleotide probes selected from those described hereinbefore. As mentioned above, these 10 probes must be unique and have different sequences. Having said this however, two separate probes may be used which recognize the same gene but reflect different splicing events. However oligonucleotide probes which are complementary to, and bind to distinct genes are preferred.

When probes of the set are primers, in a preferred aspect pairs of primers are provided. In such cases the reference to the oligonucleotides that should be present (e.g. 10 oligonucleotides) should be scaled up accordingly, i.e. 20 oligonucleotides which correspond to 10 pairs of primers, each pair being specific for a particular target sequence. In a further alternative, the probes of the set may comprise both labelling probes and primers directed to a single target sequence (e.g. for the Taqman assay described in more detail hereinafter). In this case the reference to oligonucleotides that should be present (e.g. 10 oligonucleotides) should be scaled up to 30 oligonucleotides, i.e. 10 pairs of primers and a corresponding relevant labelled probe for a particular target sequence.

Thus in a preferred aspect the set of the invention comprises at least 20 oligonucleotides and said set comprises pairs of primers in which each oligonucleotide in said pair of primers binds to the same transcript or its complementary sequence and preferably each of the pairs of primers bind to a different transcript. In a further preferred aspect the invention provides a set of oligonucleotide probes which comprises at least 30 oligonucleotides and said set comprises pairs of primers and a labelled probe for each pair of primers in which each oligonucleotide in said pair of primers and said labelled probe bind to the same transcript or its complementary sequence and preferably each of the pairs of primers and the labelled probe bind to different transcripts. The labelled probe is “related” to its pair of primers insofar as the primers bind up or downstream of the target sequence to which the labelled probe binds on the same transcript.

As described herein a “functionally equivalent” oligonucleotide to those set forth in Table 1 (or other Tables) or derived therefrom refers to an oligonucleotide which is capable of identifying the same gene as an oligonucleotide of Table 1 or derived therefrom, i.e. it can bind to the same mRNA molecule (or DNA) or a splice variant transcribed from a gene (target nucleic acid molecule) as the Table 1 oligonucleotide or the Table 1 derived oligonucleotide (or its complementary sequence) but does not have precise complementarity to the mRNA or DNA (unlike derived sequences). Preferably said functionally equivalent oligonucleotide is capable of recognizing, i.e. binding to the same splicing product as a Table 1 oligonucleotide or a Table 1 derived oligonucleotide. Preferably said mRNA molecule is the full length mRNA molecule which corresponds to the Table 1 oligonucleotide or the Table 1 derived oligonucleotide.

As referred to herein “capable of binding” or “binding” refers to the ability to hybridize under conditions described hereinafter.

Alternatively expressed, functionally equivalent oligonucleotides (or complementary sequences) have sequence identity or will hybridize, as described hereinafter, to a region of the target molecule to which molecule a Table 1 oligonucleotide or a Table 1 derived oligonucleotide or a complementary oligonucleotide binds. Preferably, functionally equivalent oligonucleotides (or their complementary sequences) hybridize to one of the mRNA sequences which corresponds to a Table 1 oligonucleotide or a Table 1 derived oligonucleotide under the conditions described hereinafter or has sequence identity to a part of one of the mRNA sequences which corresponds to a Table 1 oligonucleotide or a Table 1 derived oligonucleotide. A “part” in this context refers to a stretch of at least 5, e.g. at least 10 or 20 bases, such as from 5 to 100, e.g. 10 to 50 or 15 to 30 bases.

In a particularly preferred aspect, the functionally equivalent oligonucleotide binds to all or a part of the region of a target nucleic acid molecule (mRNA or cDNA) to which the Table 1 oligonucleotide or Table 1 derived oligonucleotide binds. A “target” nucleic acid molecule is the gene transcript or related product e.g. mRNA, or cDNA, or amplified product thereof. Said “region” of said target molecule to which said Table 1 oligonucleotide or Table 1 derived oligonucleotide binds is the stretch over which complementarity exists. At its largest this region is the whole length of the Table 1 oligonucleotide or Table 1 derived oligonucleotide, but may be shorter if the entire Table 1 sequence or Table 1 derived oligonucleotide is not complementary to a region of the target sequence.

As referred to herein any reference to Table 1 may equally be interpreted as applying to any one of Tables 2 to 9.

Preferably said part of said region of said target molecule is a stretch of at least 5, e.g. at least 10 or 20 bases, such as from 5 to 100, e.g. 10 to 50 or 15 to 30 bases. This may for example be achieved by said functionally equivalent oligonucleotide having several identical bases to the bases of the Table 1 oligonucleotide or the Table 1 derived oligonucleotide. These bases may be identical over consecutive stretches, e.g. in a part of the functionally equivalent oligonucleotide, or may be present non-consecutively, but provide sufficient complementarity to allow binding to the target sequence.

Thus in a preferred feature, said functionally equivalent oligonucleotide hybridizes under conditions of high stringency to a Table 1 oligonucleotide or a Table 1 derived oligonucleotide or the complementary sequence thereof. Alternatively expressed, said functionally equivalent oligonucleotide exhibits high sequence identity to all or part of a Table 1 oligonucleotide. Preferably said functionally equivalent oligonucleotide has at least 70% sequence identity, preferably at least 80%, e.g. at least 90, 95, 98 or 99%, to all of a Table 1 (or any of Tables 2 to 9) oligonucleotide or a part thereof (or all or part of a sequence set forth in any of those Tables). As used in this context, a “part” refers to a stretch of at least 5, e.g. at least 10 or 20 bases, such as from 5 to 100, e.g. 10 to 50 or 15 to 30 bases, in said Table 1 oligonucleotide. Especially preferably when sequence identity to only a part of said Table 1 oligonucleotide is present, the sequence identity is high, e.g. at least 80% as described above.

Functionally equivalent oligonucleotides which satisfy the above stated functional requirements include those which are derived from the Table 1 oligonucleotides and also those which have been modified by single or multiple nucleotide base (or equivalent) substitution, addition and/or deletion, but which nonetheless retain functional activity, e.g. bind to the same target molecule as the Table 1 oligonucleotide or the Table 1 oligonucleotide from which they are further derived or modified. Preferably said modification is of from 1 to 50, e.g. from 10 to 30, preferably from 1 to 5 bases. Especially preferably only minor modifications are present, e.g. variations in less than 10 bases, e.g. less than 5 base changes.

Within the meaning of “addition” equivalents are included oligonucleotides containing additional sequences which are complementary to the consecutive stretch of bases on the target molecule to which the Table 1 oligonucleotide or the Table 1 derived oligonucleotide binds. Alternatively the addition may comprise a different, unrelated sequence, which may for example confer a further property, e.g. to provide a means for immobilization such as a linker to bind the oligonucleotide probe to a solid support.

Particularly preferred are naturally occurring equivalents such as biological variants, e.g. allelic, geographical or allotypic variants, e.g. oligonucleotides which correspond to a genetic variant, for example as present in a different species.

Functional equivalents include oligonucleotides with modified bases, e.g. using non-naturally occurring bases. Such derivatives may be prepared during synthesis or by post production modification.

“Hybridizing” sequences which bind under conditions of low stringency are those which bind under non-stringent conditions (for example, 6×SSC/50% formamide at room temperature) and remain bound when washed under conditions of low stringency (2×SSC, room temperature, more preferably 2×SSC, 42° C.). Hybridizing under high stringency refers to the above conditions in which washing is performed at 2×SSC, 65° C. (where SSC=0.15M NaCl, 0.015M sodium citrate, pH 7.2).

“Sequence identity” as referred to herein refers to the value obtained when assessed using ClustalW (Thompson et al., 1994, Nucl. Acids Res., 22, p4673-4680) with the following parameters:

Pairwise alignment parameters—Method: accurate, Matrix: IUB, Gap open penalty: 15.00, Gap extension penalty: 6.66;
Multiple alignment parameters—Matrix: IUB, Gap open penalty: 15.00, % identity for delay: 30, Negative matrix: no, Gap extension penalty: 6.66, DNA transitions weighting: 0.5.

Sequence identity at a particular base is intended to include identical bases which have simply been derivatized.

As described above, conveniently said set of oligonucleotide probes may be immobilized on one or more solid supports. Single or preferably multiple copies of each unique probe are attached to said solid supports, e.g. 10 or more, e.g. at least 100 copies of each unique probe are present. Furthermore, as described hereinafter, the set of probes may be contained in platforms containing secondary probes which are not of interest and in that case such platforms may be used and only the signals associated with the probes of interest analysed. This is particularly applicable in the case of large commercially available arrays carrying an abundance of relevant probes.

Alternatively probes may be synthesized in situ onto arrays such as the Affymetrix platforms by methods known in the art.

One or more unique oligonucleotide probes may be associated with separate solid supports which together form a set of probes immobilized on multiple solid support, e.g. one or more unique probes may be immobilized on multiple beads, membranes, filters, biochips etc. which together form a set of probes, which together form modules of the kit described hereinafter. The solid support of the different modules are conveniently physically associated although the signals associated with each probe (generated as described hereinafter) must be separately determinable. Alternatively, the probes may be immobilized on discrete portions of the same solid support, e.g. each unique oligonucleotide probe, e.g. in multiple copies, may be immobilized to a distinct and discrete portion or region of a single filter or membrane, e.g. to generate an array.

A combination of such techniques may also be used, e.g. several solid supports may be used which each immobilize several unique probes.

The expression “solid support” shall mean any solid material able to bind oligonucleotides by hydrophobic, ionic or covalent bridges.

“Immobilization” as used herein refers to reversible or irreversible association of the probes to said solid support by virtue of such binding. If reversible, the probes remain associated with the solid support for a time sufficient for methods of the invention to be carried out.

Numerous solid supports suitable as immobilizing moieties according to the invention, are well known in the art and widely described in the literature and generally speaking, the solid support may be any of the well-known supports or matrices which are currently widely used or proposed for immobilization, separation etc. in chemical or biochemical procedures. Such materials include, but are not limited to, any synthetic organic polymer such as polystyrene, polyvinylchloride, polyethylene; or nitrocellulose and cellulose acetate; or tosyl activated surfaces; or glass or nylon or any surface carrying a group suited for covalent coupling of nucleic acids. The immobilizing moieties may take the form of particles, sheets, gels, filters, membranes, microfibre strips, tubes or plates, fibres or capillaries, made for example of a polymeric material e.g. agarose, cellulose, alginate, teflon, latex or polystyrene or magnetic beads. Solid supports allowing the presentation of an array, preferably in a single dimension are preferred, e.g. sheets, filters, membranes, plates or biochips.

Attachment of the nucleic acid molecules to the solid support may be performed directly or indirectly. For example if a filter is used, attachment may be performed by UV-induced crosslinking. Alternatively, attachment may be performed indirectly by the use of an attachment moiety carried on the oligonucleotide probes and/or solid support. Thus for example, a pair of affinity binding partners may be used, such as avidin, streptavidin or biotin, DNA or DNA binding protein (e.g. either the lac I repressor protein or the lac operator sequence to which it binds), antibodies (which may be mono- or polyclonal), antibody fragments or the epitopes or haptens of antibodies. In these cases, one partner of the binding pair is attached to (or is inherently part of) the solid support and the other partner is attached to (or is inherently part of) the nucleic acid molecules.

As used herein an “affinity binding pair” refers to two components which recognize and bind to one another specifically (i.e. in preference to binding to other molecules). Such binding pairs when bound together form a complex.

Attachment of appropriate functional groups to the solid support may be performed by methods well known in the art, which include for example, attachment through hydroxyl, carboxyl, aldehyde or amino groups which may be provided by treating the solid support to provide suitable surface coatings. Solid supports presenting appropriate moieties for attachment of the binding partner may be produced by routine methods known in the art.

Attachment of appropriate functional groups to the oligonucleotide probes of the invention may be performed by ligation or introduced during synthesis or amplification, for example using primers carrying an appropriate moiety, such as biotin or a particular sequence for capture.

In the alternative, probes may be used without immobilization, e.g. tube based arrays may be used in which the probes are used in solution, e.g. in real time quantitative PCR.

Conveniently, the set of probes described hereinbefore is provided in kit form.

Thus viewed from a further aspect the present invention provides a kit comprising a set of oligonucleotide probes as described hereinbefore optionally immobilized on one or more solid supports.

Preferably, said probes are immobilized on a single solid support and each unique probe is attached to a different region of said solid support. However, when attached to multiple solid supports, said multiple solid supports form the modules which make up the kit. Especially preferably said solid support is a sheet, filter, membrane, plate or biochip.

Optionally the kit may also contain information relating to the signals generated by normal or diseased samples (as discussed in more detail hereinafter in relation to the use of the kits), standardizing materials, e.g. mRNA or cDNA from normal and/or diseased samples for comparative purposes, or reference probes as described before, labels for incorporation into cDNA, adapters for introducing nucleic acid sequences for amplification purposes, primers for amplification and/or appropriate enzymes, buffers and solutions. Optionally said kit may also contain a package insert describing how the method of the invention should be performed, optionally providing standard graphs, data or software for interpretation of results obtained when performing the invention.

The use of such kits to prepare a standard diagnostic gene transcript pattern as described hereinafter forms a further aspect of the invention.

The set of probes as described herein have various uses. Principally however they are used to assess the gene expression state of a test cell(s) in a sample to provide information relating to the organism from which said cell is derived. Gene expression alterations may be evident within the cell (e.g. mRNA transcripts) or in material released from the cell (e.g. microRNA or polypeptides) and thus the gene expression state of the cell may be tested by analysing either the cells or a sample containing the cells or material released from cells. The probes disclosed herein are useful in diagnosing, identifying or monitoring neurodegenerative diseases and various stages thereof in an organism.

Thus in a further aspect the invention provides the use of a set of oligonucleotide probes or a kit as described hereinbefore to determine the gene expression pattern of a cell or sample where the pattern reflects the level of gene expression of genes to which said oligonucleotide probes bind, comprising at least the steps of:

a) isolating mRNA from said cell or sample, which may optionally be reverse transcribed to cDNA;

b) hybridizing the mRNA or cDNA of step (a) to a set of oligonucleotide probes or a kit as defined herein; and

c) assessing the amount of mRNA or cDNA hybridizing to each of said probes to produce said pattern,

wherein the oligonucleotides in said set of oligonucleotides or kit are primary oligonucleotides and said set or kit may additionally comprise secondary oligonucleotides which are not assessed in step c).

In the method described above secondary oligonucleotides may be present which are effectively ignored during the analysis. This allows large arrays containing the probes of interest to be used but only the information provided by hybridization of the sample to those probes is analysed. This also allows the generation of arrays which may be used for a variety of methods by analysis of the hybridization pattern of only select probes.

As mentioned previously, the oligonucleotide probes may act as direct labels of the target sequence (insofar as the complex between the target sequence and the probe carries a label) or may be used as primers. In the case of the former step c) may be performed by any appropriate means of detecting the hybridized entity, e.g. if the mRNA or cDNA is labelled the retention of label in a kit may be assessed. In the case of primers, those primers may be used to generate an amplification product which may be assessed. In that case in step b) said probes are hybridized to the mRNA or cDNA and used to amplify the mRNA or cDNA or a part thereof (of the size described herein for parts or preferred sizes for amplicons) and in step c) the amount of amplified product is assessed to produce the pattern.

In the case of techniques in which both primers and labelling probes are used, in the above method the primers and labelling probes are hybridized to the mRNA or cDNA in step b) and used to amplify the mRNA or cDNA or a part thereof. This amplification causes displacement of probes binding to relevant target sequences and the generation of a signal. In this case, in step c) the amount of mRNA or cDNA hybridizing to the probes is assessed by determining the presence or amount of the signal which is generated. Thus in a preferred aspect, said probes are labelling probes and pairs of primers and in step b) said labelling probes and primers are hybridized to said mRNA or cDNA and said mRNA or cDNA or a part thereof is amplified using said primers, wherein when said labelling probe binds to the target sequence it is displaced during amplification thereby generating a signal and in step c) the amount of signal generated is assessed to produce said pattern. All modes of detection of the presence or amount of binding of the probes as described herein to the target sequence are covered by the above described method and methods of the invention described hereinafter.

The mRNA and cDNA as referred to in this method, and the methods hereinafter, encompass derivatives or copies of said molecules, e.g. copies of such molecules such as those produced by amplification or the preparation of complementary strands, but which retain the identity of the mRNA sequence, i.e. would hybridize to the direct transcript (or its complementary sequence) by virtue of precise complementarity, or sequence identity, over at least a region of said molecule. It will be appreciated that complementarity will not exist over the entire region where techniques have been used which may truncate the transcript or introduce new sequences, e.g. by primer amplification. For convenience, said mRNA or cDNA is preferably amplified prior to step b). As with the oligonucleotides described herein said molecules may be modified, e.g. by using non-natural bases during synthesis providing complementarity remains. Such molecules may also carry additional moieties such as signalling or immobilizing means.

The various steps involved in the method of preparing such a pattern are described in more detail hereinafter.

As used herein “gene expression” refers to transcription of a particular gene to produce a specific mRNA product (i.e. a particular splicing product). The level of gene expression may be determined by assessing the level of transcribed mRNA molecules or cDNA molecules reverse transcribed from the mRNA molecules or products derived from those molecules, e.g. by amplification.

The “pattern” created by this technique refers to information which, for example, may be represented in tabular or graphical form and conveys information about the signal associated with two or more oligonucleotides. Preferably said pattern is expressed as an array of numbers relating to the expression level associated with each probe.

Preferably, said pattern is established using the following linear model:

y=Xb+f Equation 1

wherein, X is the matrix of gene expression data and y is the response variable, b is the regression coefficient vector and f the estimated residual vector. Although many different methods can be used to establish the relationship provided in equation 1, especially preferably the partial Least Squares Regression (PLSR) method is used for establishing the relationship in equation 1.

The probes are thus used to generate a pattern which reflects the gene expression of a cell at the time of its isolation or a sample which may or may not contain cells but which carries expression products released by the cell. The pattern of expression is characteristic of the circumstances under which that cells finds itself and depends on the influences to which the cell has been exposed. Thus, a characteristic gene transcript pattern standard or fingerprint (standard probe pattern) for cells or samples from an individual with a neurodegenerative disease or condition or a stage thereof may be prepared and used for comparison to transcript patterns of test cells. This has clear applications in diagnosing, monitoring or identifying whether an organism is suffering from a neurodegenerative disease or condition or a stage thereof.

As described in the Examples in more detail, the probes of the invention have various uses in discriminating between various conditions in the spectrum of early to late stage neurodegenerative diseases and conditions. Principally, the probes may be used to identify a particular stage of a disease or condition or to assess the progression (predictive and retrospective) of a disease or condition. This information may be used for various purposes, e.g. for monitoring drug efficacy, to optimize drug dosage, to assess efficacy of a therapeutic treatment (e.g. to identify drugs with therapeutic potential), to identify patients suitable for treatment or clinical trails and drug discovery based on the stage of their disease or disorder (the latter which would reduce cost of patient enrolment), but more particularly to identify the stage of a particular disease or condition and/or its progression to allow its management and treatment. The methods are particularly useful in relation to Alzheimer's disease, e.g. for drug development or discovery particularly for very early stages of the disease. Thus, the present invention is concerned with a method of identifying the stage or progression of a neurological disorder or condition.

As used herein, a “stage” of a neurological disease or condition refers to different stages of the neurological disorder or disease which may or may not exhibit particular physiological or metabolic changes, but do exhibit changes at the genetic level which may be detected as altered gene expression. It will be appreciated that during the course of a neurological disease or disorder (or its treatment) the expression of different transcripts may vary. Thus at different stages, altered expression may not be exhibited for particular transcripts compared to “normal” samples. However, combining information from several transcripts which exhibit altered expression at one or more stages through the course of the disease or condition can be used to provide a characteristic pattern which is indicative of a particular stage of disease or condition. The stages of a neurological disease or disorder may be identified based on cognitive or motor performance tests. For example MMSE (Folstein et al., 1975, J. Psych. Res., 12(3), p189-198) and Global CDR (Morris, 1993, Neurology, 43, p2412-2414).

The maximum score for the MMSE is 30. A score of 30 is classed as normal. Based on NHS UK (see the website having the URL that ends in: nhs.uk/Conditions/Alzheimers-disease/Pages/Diagnosis.aspx

Alzheimer's disease is classified as follows:
Mild: MMSE score of between 21 and 26
Moderate: MMSE score of between 10 and 20 M
Moderately severe: MMSE score of between 10 and 14
Severe: MMSE score of less than 10

Clinical Dementia Rating Scale (CDR) is a global assessment instrument that yields global (Morris, 1993, supra) and Sum of Boxes (SOB) scores (O'Bryant et al. 2008, Arch Neurol., 65(8), p1091-1095). Based on the scores the dementia severity is staged as follows:

Global CDR

| | |
|---|---|
| 0 | Normal |
| 0.5 | Very mild |
| 1 | Mild |
| 2 | Moderate |
| 3 | Severe |

Sum of Boxes Staging Category

| | |
|---|---|
| 0 | Normal |
| 0.5-4 | Questionable cognitive impairment |
| 0.5-2.5 | Questionable impairment |
| 3.0-4.0 | Very mild dementia |
| 4.5-9.0 | Mild dementia |
| 9.5-15.5 | Moderate dementia |
| 16.0-18.0 | Severe dementia |

These two scores (Global CDR and Sum of Boxes scores) were utilized to classify patients with clear progression and patients with no clear progressions for Prospective and Retrospective Intra-person modeling as described in the Example.

Stages of neurological disorders or diseases having MMSE, Global CDR and/or Sum of Boxes scores as described above constitute preferred stages according to the invention.

As used herein, the “progression” of a neurological disease or condition encompasses both predictive and retrospective progression and refers to the development of the condition or disease from one stage to the next e.g. from mild to moderate or moderate to severe. In dementias, this progression may be from pre-clinical to prodromal MCI to early dementia to severe dementia. In Alzheimer's disease for example the disease may progress from very mild, to mild, to moderate to severe. CDRs associated with these stages are in the order of 0.5, 1.0, 2.0 and 3.0 respectively. Progression includes both monitoring over several time points and a single assessment for predictive assessments.

In order to assess the stage or progression of a neurological disease or condition, a standard pattern representative of that stage, or multiple stages to assess progression retrospectively or progression profile to assess progression predictively, must be prepared. The standard pattern is prepared by determining the extent of binding of total mRNA (or cDNA or related product), from cells or released expression products from a sample of one or more organisms with a neurological disease or condition with a specific stage or progression profile, to the probes. This reflects the level of transcripts which are present which correspond to each unique probe. The amount of nucleic acid material which binds to the different probes is assessed and this information together forms the gene transcript pattern standard of said neurological disease or condition with a specific stage and/or progression profile. Each such standard pattern is characteristic of a neurological disease or condition with a specific stage or progression profile.

As referred to herein a “progression profile” refers to a stage of a neurological disease or condition with specific clinical and/or pathological characteristics indicative of the expected progression of that disease or condition, e.g. prodromal dementia or stable MCI. Thus a progression profile is predictive of a particular type of progression.

In a further aspect therefore, the present invention provides a method of preparing a standard gene transcript pattern characteristic of a neurological disease or condition with a specific stage or progression profile in an organism comprising at least the steps of:

a) isolating mRNA from a blood sample (e.g. containing cells) of one or more organisms having said neurological disease or condition with a specific stage or progression profile, which may optionally be reverse transcribed to cDNA;

b) hybridizing the mRNA or cDNA of step (a) to a set of oligonucleotides or a kit as described hereinbefore specific for said neurological disease or condition with a specific stage or progression profile in an organism and sample thereof corresponding to the organism and sample thereof under investigation; and

c) assessing the amount of mRNA or cDNA hybridizing to each of said probes to produce a characteristic pattern reflecting the level of gene expression of genes to which said oligonucleotides bind, in the sample with said neurological disease or condition with a specific stage or progression profile.

As described hereinbefore, the set of probes or kit may contain uninformative secondary probes.

For convenience, said oligonucleotides are preferably immobilized on one or more solid supports.

However, in a preferred aspect, said method is performed using primers which amplify the mRNA or cDNA or a part thereof and the amount of amplified product is assessed to produce the pattern. As described hereinbefore, both labelled probes and primers may be used in preferred aspects of the invention.

The standard pattern for various specific stages or progression profiles of neurological diseases or conditions using particular probes may be accumulated in databases and be made available to laboratories on request.

“Disease” samples and organisms or “neurological disease or condition with a specific stage or progression profile” samples and organisms as referred to herein refer to organisms (or samples from the same) with clinical or pathological evidence of a neurological disease or condition. Such organisms are known to have, or which exhibit, the neurological disease or condition under study.

“A neurological disease or condition” refers to a disease or condition which affects neurons in the brain or spinal cord and encompasses central nervous system diseases or conditions in which neuron defects occur. Examples of neurodegenerative diseases include Parkinson's, Huntington's disease and dementias. Particular dementias of interest are Alzheimer's disease, vascular dementia, dementia with Lewy bodies and frontotemporal dementia. Neurological diseases and conditions as referred to herein also encompass mild cognitive impairment (MCI) which may have various causes. Such causes include dementias and other neurodegenerative diseases discussed above as well as conditions such as depression and bipolar disorders, such as schizophrenia, all of which are covered under neurological diseases and conditions.

Neurodegenerative diseases or conditions result in progressive degeneration and/or death of nerve cells which causes problems with movement (called ataxias), or mental functioning (called dementias). The methods described herein may be used to identify or diagnose whether an individual has a specific stage or progression or progression profile of a neurological disease or condition by developing the appropriate classification models for those conditions.

“Normal” as used herein refers to organisms or samples which are used for comparative purposes. Preferably, these are “normal” in the sense that they do not exhibit any indication of, or are not believed to have, any disease or condition that would affect gene expression, particularly in respect of a neurological condition or disease for which they are to be used as the normal standard. However, it will be appreciated that different stages of a neurological disease or condition may be compared and in such cases, the “normal” sample may correspond to the earlier stage of that neurological condition or disease.

As used herein a “sample” refers to any sample obtained from the organism, e.g. human or non-human animal under investigation which contains cells or material secreted from cells and includes, tissues, body fluid or body waste or in the case of prokaryotic organisms, the organism itself. “Body fluids” include blood, saliva, spinal fluid, semen, lymph. “Body waste” includes urine, expectorated matter (pulmonary patients), faeces etc. “Tissue samples” include tissue obtained by biopsy, by surgical interventions or by other means e.g. placenta. Preferably however, the samples which are examined are from areas of the body not apparently affected by the disease or condition. The cells in such samples are not disease cells, i.e. neurons, have not been in contact with such disease cells and do not originate from the site of the disease or condition. The “site of disease” is considered to be that area of the body which manifests the disease in a way which may be objectively determined, e.g. the CNS. Preferably the sample is from blood or is cerebrospinal fluid. The former is particularly preferred. Cerebrospinal fluid may be used for assessment of polypeptides or microRNA as described hereinafter. Preferably the sample from blood is whole blood or a blood product (i.e. a product derived, separated or isolated from blood), such as plasma or serum. Preferably, peripheral blood is used for diagnosis.

It will however be appreciated that the method of preparing the standard transcription pattern and other methods of the invention are also applicable for use on living parts of eukaryotic organisms such as cell lines and organ cultures and explants.

As used herein, reference to “corresponding” sample etc. refers to samples containing cells or cell products preferably from the same tissue, body fluid or body waste, (e.g. blood or blood products) and preparation method, but also includes samples containing cells or cell products from tissue, body fluid or body waste which are sufficiently similar for the purposes of preparing the standard or test pattern. When used in reference to genes “corresponding” to the probes, this refers to genes which are related by sequence (which may be complementary) to the probes although the probes may reflect different splicing products of expression.

“Assessing” as used herein refers to both quantitative and qualitative assessment which may be determined in absolute or relative terms. Any appropriate techniques for the assessment may be used. For example SOLiD™ SAGE™ systems may be used for quantification of gene expression.

The invention may be put into practice as follows.

To prepare a standard transcript pattern for a specific stage or progression profile of a neurological disease or condition, sample mRNA is extracted from the sample, e.g. cells of tissues, body fluid or body waste (e.g. from blood or blood products) according to known techniques (see for example Sambrook et. al. (1989), Molecular Cloning: A laboratory manual, 2nd Ed., Cold Spring Harbor Laboratory Press, Cold Spring Harbor, N.Y.) from an individual or organism with a specific stage or progression profile of a neurological disease or condition.

Owing to the difficulties in working with RNA, the RNA is preferably reverse transcribed to form first strand cDNA. Cloning of the cDNA or selection from, or using, a cDNA library is not however necessary in this or other methods of the invention. Preferably, the complementary strands of the first strand cDNAs are synthesized, i.e. second strand cDNAs, but this will depend on which relative strands are present in the oligonucleotide probes. The RNA may however alternatively be used directly without reverse transcription and may be labelled if so required.

Preferably the cDNA strands are amplified by known amplification techniques such as the polymerase chain reaction (PCR) by the use of appropriate primers. Alternatively, the cDNA strands may be cloned with a vector, used to transform a bacteria such as E. coli which may then be grown to multiply the nucleic acid molecules. When the sequence of the cDNAs are not known, primers may be directed to regions of the nucleic acid molecules which have been introduced. Thus for example, adapters may be ligated to the cDNA molecules and primers directed to these portions for amplification of the cDNA molecules. Alternatively, in the case of eukaryotic samples, advantage may be taken of the polyA tail and cap of the RNA to prepare appropriate primers.

To produce the standard diagnostic gene transcript pattern or fingerprint for a specific stage or progression profile of a neurological disease or condition, the above described oligonucleotide probes are used to probe mRNA or cDNA of the diseased sample to produce a signal for hybridization to each particular oligonucleotide probe species, i.e. each unique probe. A standard control gene transcript pattern may also be prepared if desired using mRNA or cDNA from a normal sample. Thus, mRNA or cDNA is brought into contact with the oligonucleotide probe under appropriate conditions to allow hybridization. Alternatively, specific primer sequences for highly and moderately expressed genes can be designed and methods such as quantitative RT-PCR can be used to determine the levels of highly and moderately expressed genes, particularly the genes as described herein. Hence, a skilled practitioner may use a variety of techniques which are known in the art for determining the relative level of mRNA in a biological sample.

When multiple samples are probed, this may be performed consecutively using the same probes, e.g. on one or more solid supports, i.e. on probe kit modules, or by simultaneously hybridizing to corresponding probes, e.g. the modules of a corresponding probe kit.

To identify when hybridization occurs and obtain an indication of the number of transcripts/cDNA molecules which become bound to the oligonucleotide probes, it is necessary to identify a signal produced when the transcripts (or related molecules) hybridize (e.g. by detection of double stranded nucleic acid molecules or detection of the number of molecules which become bound, after removing unbound molecules, e.g. by washing, or by detection of a signal generated by an amplified product).

In order to achieve a signal, either or both components which hybridize (i.e. the probe and the transcript) may carry or form a signalling means or a part thereof. This “signalling means” is any moiety capable of direct or indirect detection by the generation or presence of a signal. The signal may be any detectable physical characteristic such as conferred by radiation emission, scattering or absorption properties, magnetic properties, or other physical properties such as charge, size or binding properties of existing molecules (e.g. labels) or molecules which may be generated (e.g. gas emission etc.). Techniques are preferred which allow signal amplification, e.g. which produce multiple signal events from a single active binding site, e.g. by the catalytic action of enzymes to produce multiple detectable products.

Conveniently the signalling means may be a label which itself provides a detectable signal. Conveniently this may be achieved by the use of a radioactive or other label which may be incorporated during cDNA production, the preparation of complementary cDNA strands, during amplification of the target mRNA/cDNA or added directly to target nucleic acid molecules.

Appropriate labels are those which directly or indirectly allow detection or measurement of the presence of the transcripts/cDNA. Such labels include for example radiolabels, chemical labels, for example chromophores or fluorophores (e.g. dyes such as fluorescein and rhodamine), or reagents of high electron density such as ferritin, haemocyanin or colloidal gold. Alternatively, the label may be an enzyme, for example peroxidase or alkaline phosphatase, wherein the presence of the enzyme is visualized by its interaction with a suitable entity, for example a substrate. The label may also form part of a signalling pair wherein the other member of the pair is found on, or in close proximity to, the oligonucleotide probe to which the transcript/cDNA binds, for example, a fluorescent compound and a quench fluorescent substrate may be used. A label may also be provided on a different entity, such as an antibody, which recognizes a peptide moiety attached to the transcripts/cDNA, for example attached to a base used during synthesis or amplification.

A signal may be achieved by the introduction of a label before, during or after the hybridization step. Alternatively, the presence of hybridizing transcripts may be identified by other physical properties, such as their absorbance, and in which case the signalling means is the complex itself.

The amount of signal associated with each oligonucleotide probe is then assessed. The assessment may be quantitative or qualitative and may be based on binding of a single transcript species (or related cDNA or other products) to each probe, or binding of multiple transcript species to multiple copies of each unique probe. It will be appreciated that quantitative results will provide further information for the transcript fingerprint of the specific stage or progression profile of the neurological disease or condition which is compiled. This data may be expressed as absolute values (in the case of macroarrays) or may be determined relative to a particular standard or reference e.g. a normal control sample.

Furthermore it will be appreciated that the standard diagnostic gene pattern transcript may be prepared using one or more disease (specific stage or progression profile of a neurological disease or condition) samples (and normal samples if used) to perform the hybridization step to obtain patterns not biased towards a particular individual's variations in gene expression.

The use of the probes to prepare standard patterns and the standard diagnostic gene transcript patterns thus produced for the purpose of identification or diagnosis or monitoring of a specific stage or progression or progression profile of a neurological disease or condition in a particular organism forms a further aspect of the invention.

Once a standard diagnostic fingerprint or pattern has been determined for a specific stage or progression profile of a neurological disease or condition using the selected oligonucleotide probes, this information can be used to identify the presence or absence of a specific stage or progression profile or the progression of a neurological disease or condition in a different test organism or individual.

To examine the gene expression pattern of a test sample, a test sample of tissue, body fluid or body waste (e.g. a blood sample containing cells), corresponding to the sample used for the preparation of the standard pattern, is obtained from a patient or the organism to be studied. A test gene transcript pattern is then prepared as described hereinbefore as for the standard pattern.

In a further aspect therefore, the present invention provides a method of preparing a test gene transcript pattern comprising at least the steps of:

a) isolating mRNA from a blood sample (e.g. containing cells) of said test organism, which may optionally be reverse transcribed to cDNA;

b) hybridizing the mRNA or cDNA of step (a) to a set of oligonucleotides or a kit as described hereinbefore specific for a specific stage or progression profile of a neurological disease or condition in an organism and sample thereof corresponding to the organism and sample thereof under investigation; and

c) assessing the amount of mRNA or cDNA hybridizing to each of said probes to produce said pattern reflecting the level of gene expression of genes to which said oligonucleotides bind, in said test sample.

As described hereinbefore, the set of probes or kit may contain uninformative secondary probes.

In a preferred aspect, said method is performed using primers which amplify the mRNA or cDNA or a part thereof and the amount of amplified product is assessed to produce the pattern. As described hereinbefore, both labelled probes and primers may be used in preferred aspects of the invention.

This test pattern may then be compared to one or more standard patterns to assess whether the sample contains cells which exhibit gene expression indicative of the individual having a specific stage or progression profile of a neurological disease or condition.

Thus viewed from a further aspect the present invention provides a method of diagnosing or identifying or monitoring a specific stage or progression profile of a neurological disease or condition in an organism, comprising the steps of:

a) isolating mRNA from a blood sample (e.g. containing cells) of said organism, which may optionally be reverse transcribed to cDNA;

b) hybridizing the mRNA or cDNA of step (a) to a set of oligonucleotides or a kit as described hereinbefore specific for a specific stage or progression profile of a neurological disease or condition in an organism and sample thereof corresponding to the organism and sample thereof under investigation;

c) assessing the amount of mRNA or cDNA hybridizing to each of said probes to produce a characteristic pattern reflecting the level of gene expression of genes to which said oligonucleotides bind, in said sample; and

d) comparing said pattern to a standard diagnostic pattern prepared according to the method of the invention using a sample from an organism corresponding to the organism and sample under investigation to determine the degree of correlation indicative of the presence of a specific stage or progression profile of a neurological disease or condition in the organism under investigation.

As described hereinbefore, the set of probes or kit may contain uninformative secondary probes.

The method up to and including step c) is the preparation of a test pattern as described above.

Methods of identifying a specific progression profile that is predictive of the expected progression of a neurological disease or condition has not previously been disclosed in the art. Thus in a further aspect the present invention provides a method of diagnosing or identifying a specific progression profile of a neurological disease or condition in an organism, comprising the steps of:

a) isolating mRNA from a blood sample (e.g. containing cells) of said organism, which may optionally be reverse transcribed to cDNA;

b) hybridizing the mRNA or cDNA of step (a) to a set of oligonucleotides or a kit comprising oligonucleotides specific for a specific progression profile of a neurological disease or condition in an organism and sample thereof corresponding to the organism and sample thereof under investigation;

c) assessing the amount of mRNA or cDNA hybridizing to each of said probes to produce a characteristic pattern reflecting the level of gene expression of genes to which said oligonucleotides bind, in said sample; and

d) comparing said pattern to a standard diagnostic pattern prepared according to the method of the invention using a sample from an organism corresponding to the organism and sample under investigation and a set of oligonucleotides or a kit as defined in step b) to determine the degree of correlation indicative of the presence of a specific progression profile of a neurological disease or condition in the organism under investigation.

In step d) the standard diagnostic pattern is prepared according to methods described herein, but using a set of oligonucleotides or kit as described in step d). The invention also extends to such methods of preparing standard diagnostic patterns.

In a preferred aspect, said method is performed using primers which amplify the mRNA or cDNA or a part thereof and the amount of amplified product is assessed to produce the pattern. As described hereinbefore, both labelled probes and primers may be used in preferred aspects of the invention.

As referred to herein, “diagnosis” or “identification” refers to determination of the presence or existence of the specific stage or progression profile of a neurological disease or condition in an organism. “Monitoring” refers to repeated assessments over a period of time to assess the stage or progression of the disorder or disease over time, particularly when an individual is known to be suffering from a neurological condition or disease, for example to monitor the effects of treatment or the progression of the condition or disease, e.g. to determine the suitability of a treatment or provide a prognosis. In a preferred aspect, the patient may be monitored after or during treatment, to determine the efficacy of the treatment, e.g. by reversion to normal patterns of expression. Alternatively the monitoring may allow the optimization of drug dosage or to identify compounds suitable for treatment. The methods also allow the identification of patients suitable for clinical trails as discussed hereinbefore.

Thus in one aspect the present invention provides a method of monitoring the progression of a neurological disease or condition in an organism, comprising the steps of:

a) isolating mRNA from a blood sample (e.g. containing cells) of said organism, which may optionally be reverse transcribed to cDNA;

b) hybridizing the mRNA or cDNA of step (a) to a set of oligonucleotides or a kit as described hereinbefore specific for a specific stage of a neurological disease or condition in an organism and sample thereof corresponding to the organism and sample thereof under investigation;

c) assessing the amount of mRNA or cDNA hybridizing to each of said probes to produce a characteristic pattern reflecting the level of gene expression of genes to which said oligonucleotides bind, in said sample;

d) comparing said pattern to a standard diagnostic pattern prepared according to to a method of the invention using a sample from an organism corresponding to the organism and sample under investigation to determine the degree of correlation indicative of the specific stage of a neurological disease or condition in the organism under investigation;

e) after a time interval, repeating steps a) to d);

f) comparing the specific stage of the disease or condition identified before and after the time interval to establish the progression of said disease or condition.

Conveniently said time interval is at least 3, 6, 12, 18, 24 or 36 months.

In a further preferred aspect the present invention provides a method of determining the efficacy of a treatment of a neurological disease or condition in an organism, comprising performing steps of a) to d) as described above, before, during, and/or after treatment of said neurological condition or disease in said organism to determine the efficacy of said treatment. The degree of correlation between the pattern generated for the samples taken before, after or during treatment and the standard pattern for a specific stage or progression profile will indicate whether there is any change in the pattern and hence the success of the treatment. Reversion to normal expression patterns (by comparison with normal standard patterns) are indicative of successful treatment. The present invention also provides a method of identifying a compound suitable for the treatment of a neurodegenerative condition or disease or a specific stage or progression profile thereof in an organism comprising the steps of:

a) identifying the stage or progression profile of said organism by a method of the invention,

b) administering said compound to said organism,

c) repeating step a) after step b),

d) comparing the stages or progression profiles identified in steps a) and c) to determine if any therapeutic benefit is observed in said organism relative to a comparable organism not treated by said compound.

The presence of a specific stage or progression profile of a neurodegenerative condition or disease may be determined by determining the degree of correlation between the standard and test samples' patterns. This necessarily takes into account the range of values which are obtained for normal and diseased samples. Although this can be established by obtaining standard deviations for several representative samples binding to the probes to develop the standard, it will be appreciated that single samples may be sufficient to generate the standard pattern to identify the specific stage or progression profile if the test sample exhibits close enough correlation to that standard. Conveniently, the presence, absence, or extent of a specific stage or progression profile in a test sample can be predicted by inserting the data relating to the expression level of informative probes in test sample into the standard diagnostic probe pattern established according to equation 1.

In a preferred aspect, the neurological condition is a dementia, preferably Alzheimer's disease. The stages of Alzheimer's disease may be divided into pre-clinical, prodromal Alzheimer's disease and dementia. As referred to herein, “prodromal” Alzheimer's disease is the pre-dementia stage of Alzheimer's disease which is the early symptomatic, pre-dementia phase in which there is episodic memory loss of the hippocampal type without affecting instrumental activities of daily living and biomarker evidence from CSF or imaging which supports pathological changes associated with Alzheimer's disease relative to age-matched individuals. (Dubois, et al., 2007, European Neurological Disease, p53-54). The methods may also be used to detect MCI. MCI is defined as GDS stage 2 or 3 or having a CDR of 0 to 0.5 (Petersen et al., 1999, Arch. Neurol., 56(3); p303-308; Petersen, 2011, N. Engl. J. Med., 364:23, p2227-22234; Morris, 1993, Neurology, 34, p2412-2413). CDR-SOB may also be used in the assessment (O'Bryant et al., 2008, Arch Neurol., 65(8), p1091-1095). Stable MCI as referred to herein is MCI that does not progress to dementia within 2 years. Converting MCI as referred to herein is MCI that does progress to dementia within 2 years.

In particularly preferred aspects of the invention, the stage of a neurodegenerative disease or disorder is MCI, e.g. stable MCI (which does not progress within 2 years) or converting MCI (which progresses to dementia within 2 years). Alternatively the stage may be prodromal dementia, e.g. prodromal Alzheimer's disease. These stages or their progression may be identified or monitored.

The progression profile is preferably a prodromal dementia or stable MCI. The progression profile may in some instances be the same as a stage of a disorder (where that stage has a known progression) but in other instances may provide information on whether progression to a later stage of the disease or disorder can be expected.

In particularly preferred aspects of the invention, said diagnosing or identification or monitoring of a specific stage or progression profile is carried out by comparing, in accordance with methods described hereinbefore:

(i) test patterns of organisms with MCI (or unscreened test organisms) with standard patterns from organisms with stable MCI, converting MCI, MCI, prodromal Alzheimer's disease, Alzheimer's disease and/or healthy organisms;
(ii) test patterns of organisms with a stage of dementia, e.g. Alzheimer's disease with standard patterns from organisms with various stages of dementia, e.g. Alzheimer's disease (e.g. very mild, mild, moderate or severe);
(iii) test pattern of an organism with Alzheimer's disease with standard patterns from organisms with various stages or progression profiles of Alzheimer's disease.

To provide a predictive progression comparisons are made to standard patterns from progression profiles of Alzheimer's disease. However, for retrospective determinations of Alzheimer's disease progression, two determinations are made, e.g. of the type indicated in (i) to (iii) and the results compared as a function of time.

The above tests allow the identification of the following stages: prodromal AD or stable MCI in a test individual with MCI; prodromal AD or AD in a test individual; MCI (of any form) in a test individual. The following stages may be detected which may be used to follow progression: Prodromal AD or progressed AD; very mild AD or mild AD, very mild or mild dementia, AD with clear progression or AD with no clear progression. The tests also allow the diagnosis of AD.

The following progression profiles may be detected: MCI that will convert to AD; very mild AD that will convert to mild AD; moderate AD that will convert to severe AD.

As described in the Examples, the sub-sets of probes from Table 1 have preferred utilities according to the invention. Thus for example, in a preferred aspect in said diagnostic method said organism has MCI and the pattern that is generated for said organism is compared to standard patterns for stable MCI and converting MCI and said set of probes comprises at least 10 Table 2 oligonucleotides or their derived, complementary or functionally equivalent oligonucleotides. Similarly the Table 2 probes may be used to generate standard patterns for stable and converting MCI. The table below provides other preferred aspects of the invention for use in generating standard patterns and performing diagnostic methods according to the invention.

| Table | Test sample | Standard patterns |
|---|---|---|
| 2, 3, 4 | MCI | MCI stable |
| | | MCI converter |
| 5 | Any | Non-AD |
| | | AD |
| 6 | Any | MCI |
| | | Non-MCI |
| 7 | AD | Prodromal AD |
| | | Progressed AD |
| 8 | Dementia | Very mild dementia |
| | | Mild dementia |
| 9 | AD | Predicted: |
| | | Clear progression |
| | | Non-clear progression |
| 10, 11 | AD | Retrospective: |
| | | Clear progression |
| | | Non-clear progression |

In a further preferred aspect, probes exhibiting higher significance (e.g. <0.5), i.e. the probes shown in tables with an asterisk may be used instead of the full set of probes.

Furthermore, as discussed hereinbefore, the 10 or more probes which are selected are preferably probes which are common to one or more of the Tables described herein, e.g. Tables 2 and 3 or Table 9 and 10. Core probes may be selected based on a p-value of <0.5, to which additional probes may be added from relevant Tables. Each table of probes may also form a core group of probes (e.g. Table 3), to which additional probes may be added, e.g. one or probes from Table 2, in particular those exhibiting a p-value of <0.5.

In a particularly preferred aspect, probes for which sequences are provided in the tables are preferred. Context sequences are provided for all sequences. However the full length sequences for Assay0555 (Table 5) and Assay0397 (Table 2) are missing. Thus probes from these Tables but omitting probes from sequences relating to those Assay Nos. are preferred.

Furthermore, whilst the context sequences differ, some of the full length sequences in the tables are duplicated. Thus the full length sequences for the following pairs (and triplicates) of assays are identical:

### ASSAY0128 ASSAY0797

### ASSAY0381 ASSAY1093

### ASSAY0142 ASSAY0885

### ASSAY0207 ASSAY0802

### ASSAY0745 ASSAY1094

### ASSAY0771 ASSAY0772

### ASSAY0476 ASSAY1095

### ASSAY0002 ASSAY0098

### ASSAY0535 ASSAY1103

### ASSAY0355 ASSAY0651

### ASSAY0445 ASSAY0464

### ASSAY0378 ASSAY0897

### ASSAY0534 ASSAY1082

### ASSAY0215 ASSAY0767

### ASSAY0637 ASSAY1097

### ASSAY0911 ASSAY0928

### ASSAY0625 ASSAY1084

### ASSAY0257 ASSAY0792

### ASSAY0577 ASSAY0969

### ASSAY0209 ASSAY0818

### ASSAY0269 ASSAY0794

### ASSAY0642 ASSAY1104

### ASSAY0668 ASSAY0684

### ASSAY0919 ASSAY1083

### ASSAY0709 ASSAY1101

### ASSAY0267 ASSAY0421

### ASSAY0199 ASSAY0766; and

### ASSAY0196 ASSAY0853 ASSAY1074

In a preferred aspect the 10 or more probes which are selected include only one probe from the two Assay Nos in each of the above pairs of Assay Nos, i.e. each of the probes in the 10 or more probes is from a unique sequence.

Data generated using the above mentioned methods may be analysed using various techniques from the most basic visual representation (e.g. relating to intensity) to more complex data manipulation to identify underlying patterns which reflect the interrelationship of the level of expression of each gene to which the various probes bind, which may be quantified and expressed mathematically. Conveniently, the raw data thus generated may be manipulated by the data processing and statistical methods described hereinafter, particularly normalizing and standardizing the data and fitting the data to a classification model to determine whether said test data reflects the pattern of a specific stage or progression profile of a neurodegenerative condition or disease.

The methods described herein may be used to identify, monitor or diagnose a specific stage or progression profile of a neurodegenerative condition or disease, for which the oligonucleotide probes are informative. “Informative” probes as described herein, are those which reflect genes which have altered expression in the specific stage or progression profile of the neurodegenerative condition or disease. Individual probes described herein may not be sufficiently informative for diagnostic purposes when used alone, but are informative when used as one of several probes to provide a characteristic pattern, e.g. in a set as described hereinbefore.

Thus in a further aspect the present invention provides a set of probes as described hereinbefore for use in diagnosis or identification or monitoring of a specific stage or progression profile of a neurodegenerative disease or condition.

The diagnostic method may be used alone as an alternative to other diagnostic techniques or in addition to such techniques. For example, methods of the invention may be used as an alternative or additive diagnostic measure to diagnosis using for example cognitive testing, CSF biomarkers, APOE genotyping or brain volumetric measures (Gomar et al., 2011, Arch. Gen Psychiatry, 68(9), p961-969) for example in the identification and/or diagnosis of specific stages or progression profiles of a neurodegenerative disease or condition. In a preferred aspect the method of the invention is used in conjunction with PET imaging, e.g. for early stage AD diagnosis.

The methods of the invention may be performed on cells from prokaryotic or eukaryotic organisms which may be any eukaryotic organisms such as human beings, other mammals and animals, birds, insects, fish and plants, and any prokaryotic organism such as a bacteria.

Preferred non-human animals on which the methods of the invention may be conducted include, but are not limited to mammals, particularly primates, domestic animals, livestock and laboratory animals. Thus preferred animals for diagnosis include mice, rats, guinea pigs, cats, dogs, pigs, cows, goats, sheep, horses. Particularly preferably a human is diagnosed, identified or monitored according to the methods above.

As described above, the sample under study may be any convenient sample which may be obtained from an organism. Preferably however, as mentioned above, the sample is obtained from a site distant to the site of disease and the cells in such samples are not disease cells, have not been in contact with such cells and do not originate from the site of the disease. In such cases, although preferably absent, the sample may contain cells which do not fulfil these criteria. However, since the probes of the invention are concerned with transcripts whose expression is altered in cells which do satisfy these criteria, the probes are specifically directed to detecting changes in transcript levels in those cells even if in the presence of other, background cells.

Whilst in a preferred aspect the methods of assessment concern the development of a gene transcript pattern from a test sample and comparison of the same to a standard pattern, the elevation or depression of expression of certain markers may also be examined by examining the products of expression and the level of those products. Thus a standard pattern in relation to the expressed product may be generated.

In such methods the levels of expression of a set of polypeptides encoded by the gene to which an oligonucleotide or a derived oligonucleotide as defined hereinbefore, binds, are analysed.

Various diagnostic methods may be used to assess the amount of polypeptides (or fragments thereof) which are present. The presence or concentration of polypeptides may be examined, for example by the use of a binding partner to said polypeptide (e.g. an antibody), which may be immobilized, to separate said polypeptide from the sample and the amount of polypeptide may then be determined. The Gene IDs disclosed in the tables may be used to determine whether antibodies to the relevant polypeptides are available. Information on the genes may be obtained for example at www.genecards.org

“Fragments” of the polypeptides refers to a domain or region of said polypeptide, e.g. an antigenic fragment, which is recognizable as being derived from said polypeptide to allow binding of a specific binding partner. Preferably such a fragment comprises a significant portion of said polypeptide and corresponds to a product of normal post-synthesis processing.

Thus in a further aspect the present invention provides a method of preparing a standard gene transcript expression pattern characteristic of a neurological disease or condition with a specific stage or progression profile in an organism comprising at least the steps of:

a) releasing target polypeptides from a sample (e.g. blood or CSF) of one or more organisms having said neurological disease or condition with a specific stage or progression profile;

b) contacting said target polypeptides with one or more binding partners, wherein each binding partner is specific to a marker polypeptide (or a fragment thereof) encoded by the gene to which an oligonucleotide (or derived sequence) as defined hereinbefore binds, to allow binding of said binding partners to said target polypeptides, wherein said marker polypeptides are specific for said neurological disease or condition with a specific stage or progression profile in an organism and sample thereof corresponding to the organism and sample thereof under investigation; and

c) assessing the target polypeptide binding to said binding partners to produce a characteristic pattern reflecting the level of gene expression of genes which express said marker polypeptides, in the sample with said neurological disease or condition with a specific stage or progression profile.

Preferably at least 10 binding partners are used (in the above method or methods described below) or more as defined in relation to the number of oligonucleotide probes in the sets defined hereinbefore. The oligonucleotide which binds to the gene refers to an oligonucleotide probe as described hereinbefore. Preferred oligonucleotide probes or sets of probes, which bind to genes which encode marker polypeptides to which binding partners as referred to herein bind, are as described hereinbefore. Thus sets of binding partners may be used which correspond to the sets of oligonucleotide probes described herein.

As used herein “target polypeptides” refer to those polypeptides present in a sample which are to be detected and “marker polypeptides” are polypeptides which are encoded by the genes to which oligonucleotides or derived oligonucleotides as defined hereinbefore bind: The target and marker polypeptides are identical or at least have areas of high similarity, e.g. epitopic regions to allow recognition and binding of the binding partner.

“Release” of the target polypeptides refers to appropriate treatment of a sample to provide the polypeptides in a form accessible for binding of the binding partners, e.g. by lysis of cells where these are present. The samples used in this case need not necessarily comprise cells as the target polypeptides may be released from cells into the surrounding tissue or fluid, and this tissue or fluid may be analysed, e.g. whole blood, serum or plasma. Preferably however the preferred samples as described herein are used, e.g. CSF or blood. “Binding partners” comprise the separate entities which together make an affinity binding pair as described above, wherein one partner of the binding pair is the target or marker polypeptide and the other partner binds specifically to that polypeptide, e.g. an antibody.

Various arrangements may be envisaged for detecting the amount of binding pairs which form. In its simplest form, a sandwich type assay e.g. an immunoassay such as an ELISA, may be used in which an antibody specific to the polypeptide and carrying a label (as described elsewhere herein) may be bound to the binding pair (e.g. the first antibody:polypeptide pair) and the amount of label detected.

Other methods as described herein may be similarly modified for analysis of the protein product of expression rather than the gene transcript and related nucleic acid molecules.

Thus a further aspect of the invention provides a method of preparing a test gene transcript expression pattern comprising at least the steps of:

a) releasing target polypeptides from a sample (e.g. blood or CSF) of said test organism;

b) contacting said target polypeptides with one or more binding partners, wherein each binding partner is specific to a marker polypeptide (or a fragment thereof) encoded by the gene to which an oligonucleotide (or derived sequence) as defined hereinbefore binds, to allow binding of said binding partners to said target polypeptides, wherein said marker polypeptides are specific for a specific stage or progression profile of a neurological disease or condition in an organism and sample thereof corresponding to the organism and sample thereof under investigation; and

c) assessing the target polypeptide binding to said binding partners to produce a characteristic pattern reflecting the level of gene expression of genes which express said marker polypeptides, in said test sample.

A yet further aspect of the invention provides a method of diagnosing or identifying or monitoring a specific stage or progression profile of a neurological disease or condition in an organism comprising the steps of:

a) releasing target polypeptides from a sample (e.g. blood or CSF) of said organism;

b) contacting said target polypeptides with one or more binding partners, wherein each binding partner is specific to a marker polypeptide (or a fragment thereof) encoded by the gene to which an oligonucleotide (or derived sequence) as defined hereinbefore binds, to allow binding of said binding partners to said target polypeptides, wherein said marker polypeptides are specific for a specific stage or progression profile of a neurological disease or condition in an organism and sample thereof corresponding to the organism and sample thereof under investigation; and

c) assessing the target polypeptide binding to said binding partners to produce a characteristic pattern reflecting the level of gene expression of genes which express said marker polypeptides in said sample; and

d) comparing said pattern to a standard diagnostic pattern prepared as described hereinbefore using a sample from an organism corresponding to the organism and sample under investigation to determine the degree of correlation indicative of the presence of a specific stage or progression profile of a neurological disease or condition in the organism under investigation.

MicroRNA profiling may be used to develop a pattern characteristic of a specific stage or progression profile of a neurodegenerative disease or disorder as defined above. miRNA microarrays suitable for this purpose are known in the art. In particular miRNA that regulate the genes corresponding to the probes described herein may be used to generate miRNA patterns associated with a specific stage or progression profile.

The methods of generating standard and test patterns and diagnostic techniques rely on the use of informative oligonucleotide probes to generate the gene expression data. In some cases it will be necessary to select these informative probes for a particular method, e.g. to diagnose a specific stage or progression profile of a neurological condition or disorder, from a selection of available probes, e.g. the Table 1 oligonucleotides, the Table 1 derived oligonucleotides, their complementary sequences and functionally equivalent oligonucleotides. Said derived oligonucleotides include oligonucleotides derived from the genes corresponding to the sequences provided in those tables for which gene identifiers are provided. The following methodology describes a convenient method for identifying such informative probes, or more particularly how to select a suitable sub-set of probes from the probes described herein.

Probes for the analysis of a particular stage or progression profile, may be identified in a number of ways known in the prior art, including by differential expression or by library subtraction (see for example WO98/49342). As described in WO04/046382 and as described hereinafter, in view of the high information content of most transcripts, as a starting point one may also simply analyse a random sub-set of mRNA or cDNA species corresponding to the probes described herein and pick the most informative probes from that sub-set.

The following method describes the use of immobilized oligonucleotide probes (e.g. the probes of the invention) to which mRNA (or related molecules) from different samples are bound to identify which probes are the most informative to identify a specific stage or progression profile, e.g. a disease sample. Alternatively, the sub-sets described hereinbefore may be used for the methods described herein. The method below describes how to identify sub-sets of probes from those which are disclosed herein or how to identify additional informative probes that could be used in conjunction with probes disclosed herein. The method also describes the statistical methods used for diagnosis of samples once the probes have been selected.

The immobilized probes can be derived from various unrelated or related organisms; the only requirement is that the immobilized probes should bind specifically to their homologous counterparts in test organisms. Probes can also be derived or selected from commercially available or public databases and immobilized on solid supports, or as mentioned above they can be randomly picked and isolated from a cDNA library and immobilized on a solid support.

The length of the probes immobilised on the solid support should be long enough to allow for specific binding to the target sequences. The immobilised probes can be in the form of DNA, RNA or their modified products or PNAs (peptide nucleic acids). Preferably, the probes immobilised should bind specifically to their homologous counterparts representing highly and moderately expressed genes in test organisms. Conveniently the probes which are used are the probes described herein.

The gene expression pattern of cells in biological samples can be generated using prior art techniques such as microarray or macroarray as described below or using methods described herein. Several technologies have now been developed for monitoring the expression level of a large number of genes simultaneously in biological samples, such as, high-density oligoarrays (Lockhart et al., 1996, Nat. Biotech., 14, p1675-1680), cDNA microarrays (Schena et al, 1995, Science, 270, p467-470) and cDNA macroarrays (Maier E et al., 1994, Nucl. Acids Res., 22, p3423-3424; Bernard et al., 1996, Nucl. Acids Res., 24, p1435-1442).

In high-density oligoarrays and cDNA microarrays, hundreds and thousands of probe oligonucleotides or cDNAs, are spotted onto glass slides or nylon membranes, or synthesized on biochips. The mRNA isolated from the test and reference samples are labelled by reverse transcription with a red or green fluorescent dye, mixed, and hybridised to the microarray. After washing, the bound fluorescent dyes are detected by a laser, producing two images, one for each dye. The resulting ratio of the red and green spots on the two images provides the information about the changes in expression levels of genes in the test and reference samples. Alternatively, single channel or multiple channel microarray studies can also be performed.

The generated gene expression data needs to be preprocessed since, several factors can affect the quality and quantity of the hybridising signals. For example, variations in the quality and quantity of mRNA isolated from sample to sample, subtle variations in the efficiency of labelling target molecules during each reaction, and variations in the amount of unspecific binding between different microarrays can all contribute to noise in the acquired data set that must be corrected for prior to analysis. For example, measurements with low signal /noise ratio can be removed from the data set prior to analysis.

The data can then be transformed for stabilizing the variance in the data structure and normalized for the differences in probe intensity. Several transformation techniques have been described in the literature and a brief overview can be found in Cui, Kerr and Churchill http://www.jax.org/research/churchill/research/expression/Cui-Transform.pdf. Several methods have been described for normalizing gene expression data (Richmond and Somerville, 2000, Current Opin. Plant Biol., 3, p108-116; Finkelstein et al., 2001, In “Methods of Microarray Data Analysis. Papers from CAMDA, Eds. Lin & Johnsom, Kluwer Academic, p57-68; Yang et al., 2001, In “Optical Technologies and Informatics”, Eds. Bittner, Chen, Dorsel & Dougherty, Proceedings of SPIE, 4266, p141-152; Dudoit et al, 2000, J. Am. Stat. Ass., 97, p77-87; Alter et al 2000, supra; Newton et al., 2001, J. Comp. Biol., 8, p37-52). Generally, a scaling factor or function is first calculated to correct the intensity effect and then used for normalising the intensities. The use of external controls has also been suggested for improved normalization.

One other major challenge encountered in large-scale gene expression analysis is that of standardization of data collected from experiments performed at different times. We have observed that gene expression data for samples acquired in the same experiment can be efficiently compared following background correction and normalization. However, the data from samples acquired in experiments performed at different times requires further standardization prior to analysis. This is because subtle differences in experimental parameters between different experiments, for example, differences in the quality and quantity of mRNA extracted at different times, differences in time used for target molecule labelling, hybridization time or exposure time, can affect the measured values. Also, factors such as the nature of the sequence of transcripts under investigation (their GC content) and their amount in relation to the each other determines how they are affected by subtle variations in the experimental processes. They determine, for example, how efficiently first strand cDNAs, corresponding to a particular transcript, are transcribed and labelled during first strand synthesis, or how efficiently the corresponding labelled target molecules bind to their complementary sequences during hybridization. Batch to batch differences in the manufacturing lots is also a major factor for variation in the generated expression data.

Failure to properly address and rectify for these influences leads to situations where the differences between the experimental series may overshadow the main information of interest contained in the gene expression data set, i.e. the differences within the combined data from the different experimental series. Hence, when required the expression data should be batch-adjusted prior to data analysis.

Monitoring the expression of a large number of genes in several samples leads to the generation of a large amount of data that is too complex to be easily interpreted. Several unsupervised and supervised multivariate data analysis techniques have already been shown to be useful in extracting meaningful biological information from these large data sets. Cluster analysis is by far the most commonly used technique for gene expression analysis, and has been performed to identify genes that are regulated in a similar manner, and or identifying new/unknown tumour classes using gene expression profiles (Eisen et al., 1998, PNAS, 95, p14863-14868, Alizadeh et al. 2000, supra, Perou et al. 2000, Nature, 406, p747-752; Ross et al, 2000, Nature Genetics, 24(3), p227-235; Herwig et al., 1999, Genome Res., 9, p1093-1105; Tamayo et al, 1999, Science, PNAS, 96, p2907-2912).

In the clustering method, genes are grouped into functional categories (clusters) based on their expression profile, satisfying two criteria: homogeneity—the genes in the same cluster are highly similar in expression to each other; and separation—genes in different clusters have low similarity in expression to each other.

Examples of various clustering techniques that have been used for gene expression analysis include hierarchical clustering (Eisen et al., 1998, supra; Alizadeh et al. 2000, supra; Perou et al. 2000, supra; Ross et al, 2000, supra), K-means clustering (Herwig et al., 1999, supra; Tavazoie et al, 1999, Nature Genetics, 22(3), p. 281-285), gene shaving (Hastie et al., 2000, Genome Biology, 1(2), research 0003.1-0003.21), block clustering (Tibshirani et al., 1999, Tech report Univ Stanford.) Plaid model (Lazzeroni, 2002, Stat. Sinica, 12, p61-86), and self-organizing maps (Tamayo et al. 1999, supra). Also, related methods of multivariate statistical analysis, such as those using the singular value decomposition (Alter et al., 2000, PNAS, 97(18), p10101-10106; Ross et al. 2000, supra) or multidimensional scaling can be effective at reducing the dimensions of the objects under study.

However, methods such as cluster analysis and singular value decomposition are purely exploratory and only provide a broad overview of the internal structure present in the data. They are unsupervised approaches in which the available information concerning the nature of the class under investigation is not used in the analysis. Often, the nature of the biological perturbation to which a particular sample has been subjected is known. For example, it is sometimes known whether the sample whose gene expression pattern is being analysed derives from a diseased or healthy individual. In such instances, discriminant analysis can be used for classifying samples into various groups based on their gene expression data.

In such an analysis one builds the classifier by training the data that is capable of discriminating between member and non-members of a given class. The trained classifier can then be used to predict the class of unknown samples. Examples of discrimination methods that have been described in the literature include Support Vector Machines (Brown et al, 2000, PNAS, 97, p262-267), Nearest Neighbour (Dudoit et al., 2000, supra), Classification trees (Dudoit et al., 2000, supra), Voted classification (Dudoit et al., 2000, supra), Weighted Gene voting (Golub et al. 1999, supra), and Bayesian classification (Keller et al. 2000, Tec report Univ of Washington). Also a technique in which PLS (Partial Least Square) regression analysis is first used to reduce the dimensions in the gene expression data set followed by classification using logistic discriminant analysis and quadratic discriminant analysis (LD and ODA) has been described (Nguyen & Rocke, 2002, Bioinformatics, 18, p39-50 and 1216-1226).

A challenge that gene expression data poses to classical discriminatory methods is that the number of genes whose expression are being analysed is very large compared to the number of samples being analysed. However in most cases only a small fraction of these genes are informative in discriminant analysis problems. Moreover, there is a danger that the noise from irrelevant genes can mask or distort the information from the informative genes. Several methods have been suggested in literature to identify and select genes that are informative in microarray studies, for example, t-statistics (Dudoit et al, 2002, J. Am. Stat. Ass., 97, p77-87), analysis of variance (Kerr et al., 2000, PNAS, 98, p8961-8965), Neighbourhood analysis (Golub et al, 1999, supra), Ratio of between groups to within groups sum of squares (Dudoit et al., 2002, supra), Non parametric scoring (Park et al., 2002, Pacific Symposium on Biocomputing, p52-63) and Likelihood selection (Keller et al., 2000, supra).

In the methods described herein the gene expression data that has been normalized and standardized is analysed by using Partial Least Squares Regression (PLSR). Although PLSR is primarily a method used for regression analysis of continuous data, it can also be utilized as a method for model building and discriminant analysis using a dummy response matrix based on a binary coding. The class assignment is based on a simple dichotomous distinction such as healthy (class 1)/prodromal Alzheimer's disease (class 2), or a multiple distinction based on multiple disease diagnosis such as prodromal Alzheimer's disease (class 1)/stable MCI (class 2)/healthy (class 3). The list of diseases for classification can be increased depending upon the samples available corresponding to other cancers or stages thereof.

PLSR applied as a classification method is referred to as PLS-DA (DA standing for Discriminant analysis). PLS-DA is an extension of the PLSR algorithm in which the Y-matrix is a dummy matrix containing n rows (corresponding to the number of samples) and K columns (corresponding to the number of classes). The Y-matrix is constructed by inserting 1 in the kth column and −1 in all the other columns if the corresponding ith object of X belongs to class k. By regressing Y onto X, classification of a new sample is achieved by selecting the group corresponding to the largest component of the fitted, ŷ(x)=(ŷ₁(x), ŷ₂(x), . . . , ŷₖ(x)). Thus, in a −1/1 response matrix, a prediction value below 0 means that the sample belongs to the class designated as −1, while a prediction value above 0 implies that the sample belongs to the class designated as 1.

It is usually recommended to use PLS-DA as a starting point for the classification problem due to its ability to handle collinear data, and the property of PLSR as a dimension reduction technique. Once this purpose has been satisfied, it is possible to use other methods such as Linear discriminant analysis, LDA, that has been shown to be effective in extracting further information, Indahl et al. (1999, Chem. and Intell. Lab. Syst., 49, p19-31). This approach is based on first decomposing the data using PLS-DA, and then using the scores vectors (instead of the original variables) as input to LDA. Further details on LDA can be found in Duda and Hart (Classification and Scene Analysis, 1973, Wiley, USA).

The next step following model building is of model validation. This step is considered to be amongst the most important aspects of multivariate analysis, and tests the “goodness” of the calibration model which has been built. In this work, a cross validation approach has been used for validation. In this approach, one or a few samples are kept out in each segment while the model is built using a full cross-validation on the basis of the remaining data. The samples left out are then used for prediction/classification. Repeating the simple cross-validation process several times holding different samples out for each cross-validation leads to a so-called double cross-validation procedure. This approach has been shown to work well with a limited amount of data, as is the case in the Examples described here. Also, since the cross validation step is repeated several times the dangers of model bias and overfitting are reduced.

Once a calibration model has been built and validated, genes exhibiting an expression pattern that is most relevant for describing the desired information in the model can be selected by techniques described in the prior art for variable selection, as mentioned elsewhere. Variable selection will help in reducing the final model complexity, provide a parsimonious model, and thus lead to a reliable model that can be used for prediction. Moreover, use of fewer genes for the purpose of providing diagnosis will reduce the cost of the diagnostic product. In this way informative probes which would bind to the genes of relevance may be identified.

We have found that after a calibration model has been built, statistical techniques like Jackknife (Effron, 1982, The Jackknife, the Bootstrap and other resampling plans. Society for Industrial and Applied mathematics, Philadelphia, USA), based on resampling methodology, can be efficiently used to select or confirm significant variables (informative probes). The approximate uncertainty variance of the PLS regression coefficients B can be estimated by:

$${S}^{2} B = {\sum }_{m = 1}^{M} {( ( B - {B}_{m} ) g )}^{2}$$

where
S²B=estimated uncertainty variance of B;
B=the regression coefficient at the cross validated rank A using all the N objects;
Bₘ=the regression coefficient at the rank A using all objects except the object(s) left out in cross validation segment m; and
g=scaling coefficient (here: g=1).

In our approach, Jackknife has been implemented together with cross-validation. For each variable the difference between the B-coefficients Bᵢ in a cross-validated sub-model and Bₜₒₜ for the total model is first calculated. The sum of the squares of the differences is then calculated in all sub-models to obtain an expression of the variance of the Bᵢ estimate for a variable. The significance of the estimate of Bᵢ is calculated using the t-test. Thus, the resulting regression coefficients can be presented with uncertainty limits that correspond to 2 Standard Deviations, and from that significant variables are detected.

No further details as to the implementation or use of this step are provided here since this has been implemented in commercially available software, The Unscrambler, CAMO ASA, Norway. Also, details on variable selection using Jackknife can be found in Westad & Martens (2000, J. Near Inf. Spectr., 8, p117-124).

The following approach can be used to select informative probes from a gene expression data set:

a) keep out one unique sample (including its repetitions if present in the data set) per cross validation segment;

b) build a calibration model (cross validated segment) on the remaining samples using PLSR-DA;

c) select the significant genes for the model in step b) using the Jackknife criterion;

d) repeat the above 3 steps until all the unique samples in the data set are kept out once (as described in step a). For example, if 75 unique samples are present in the data set, 75 different calibration models are built resulting in a collection of 75 different sets of significant probes;

e) optionally select the most significant variables using the frequency of occurrence criterion in the generated sets of significant probes in step d). For example, a set of probes appearing in all sets (100%) are more informative than probes appearing in only 50% of the generated sets in step d).

Once the informative probes for a disease have been selected, a final model is made and validated. The two most commonly used ways of validating the model are cross-validation (CV) and test set validation. In cross-validation, the data is divided into k subsets. The model is then trained k times, each time leaving out one of the subsets from training, but using only the omitted subset to compute error criterion, RMSEP (Root Mean Square Error of Prediction). If k equals the sample size, this is called “leave-one-out” cross-validation. The idea of leaving one or a few samples out per validation segment is valid only in cases where the covariance between the various experiments is zero. Thus, one sample at-a-time approach can not be justified in situations containing replicates since keeping only one of the replicates out will introduce a systematic bias to the analysis. The correct approach in this case will be to leave out all replicates of the same samples at a time since that would satisfy assumptions of zero covariance between the CV-segments.

The second approach for model validation is to use a separate test-set for validating the calibration model. This requires running a separate set of experiments to be used as a test set. This is the preferred approach given that real test data are available.

The final model is then used to identify the specific stage or progression profile of a neurological condition or disorder in test samples. For this purpose, expression data of selected informative genes is generated from test samples and then the final model is used to determine whether a sample belongs to a diseased or non-diseased class, i.e. whether the sample is from an individual with a specific stage or progression profile of a neurological condition or disorder.

Preferably a model for classification purposes is generated by using the data relating to the probes identified according to the above described method and/or the probes described hereinbefore. Such oligonucleotides may be of considerable length, e.g. if using cDNA (which is encompassed within the scope of the term “oligonucleotide”). The identification of such cDNA molecules as useful probes allows the development of shorter oligonucleotides which reflect the specificity of the cDNA molecules but are easier to manufacture and manipulate. Preferably the sample is as described previously.

The above described model may then be used to generate and analyse data of test samples and thus may be used for the diagnostic methods of the invention. In such methods the data generated from the test sample provides the gene expression data set and this is normalized and standardized as described above. This is then fitted to the calibration model described above to provide classification.

To identify genes that are expressed in high or moderate amount among the isolated population for use in methods of the invention, the information about the relative level of their transcripts in samples of interest can be generated using several prior art techniques. Both non-sequence based methods, such as differential display or RNA fingerprinting, and sequence-based methods such as microarrays or macroarrays can be used for the purpose. Alternatively, specific primer sequences for highly and moderately expressed genes can be designed and methods such as quantitative RT-PCR can be used to determine the levels of highly and moderately expressed genes. Hence, a skilled practitioner may use a variety of techniques which are known in the art for determining the relative level of mRNA in a biological sample.

Especially preferably the sample for the isolation of mRNA in the above described method is as described previously and is preferably not from the site of disease and the cells in said sample are not disease cells and have not contacted disease cells, for example the use of a peripheral blood sample.

The following examples are given by way of illustration only.

### Example 1

### Identification of Informative Probes and their Use to Assess and Monitor Various Stages and Progression Profiles in Alzheimer's Disease, Dementia and MCI

The present Example illustrates the utility of the probe sets described herein in the discrimination of various stages and progression profiles in Alzheimer's disease, dementia and MCI.

### Materials and Methods

This experiment involved the analysis of gene expression patterns from a partial genome screen of 1152 (384 assays×3 cards) gene probes with the following study cohorts:

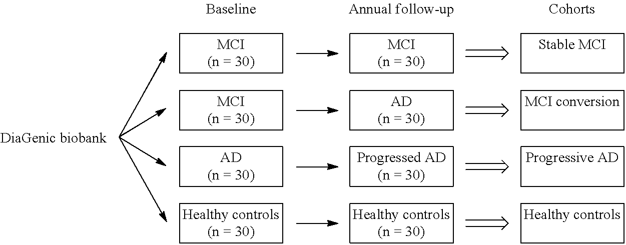

Stable MCI: Subjects with stable MCI (i.e. without conversion to AD or other form of dementia) at baseline and after a minimum time period of 2 years were investigated. The study used the earliest available blood sample. At least 30 subjects were analyzed.

MCI conversion: Subjects were included that have a blood sample at the time of diagnosis with MCI and then received a diagnosis of AD at a follow-up session either 1 or 2 years post-baseline.

Alzheimer's disease: AD patients were monitored by conventional diagnostic testing and dementia graded as mild, moderate or severe AD, as appropriate. Transition through the groups, or based on an on-site clinical assessment, were considered a sign of progression. Suitable subjects were selected from the DiaGenic biobank.

Healthy controls: Healthy volunteers had at least 2 years of cognitive testing to ensure a stable healthy diagnosis.

### Subject Selection Criteria

Subjects were selected according to the criteria stated above.

### Compiled Clinical Data

For each donor in the study, information from the DiaGenic Information Management System (DIMS) was compiled including blood sample data, RNA data and relevant clinical data. In addition clinical progression as well as the scores of clinical dementia rating (global CDR) and CDR sum of boxes (CDR-SOB) have been recorded for the longitudinal AD cohort. Summaries of the cohort demographics are presented in Tables 12 to 14.

TABLE 12
Selected cohort demographic data (% F, age, MMSE and global CDR)

| | | Age | | MMSE | | Global CDR | |
|---|---|---|---|---|---|---|---|
| Cohort | % F | Mean | Min-Max | Mean | Min-Max | Mean | Min-Max |
| MCI conversion | 56 | 71.5 | 52-84 | 28 | 25-30 | 0.0 | 0.0-0.0 |
| Cognitively healthy | 56 | 68.2 | 52-79 | 30 | 29-30 | 0.0 | 0.0-0.0 |
| AD longitudinal baseline | 61 | 70.1 | 53-80 | 24 | 16-29 | 1.0 | 0.0-2.0 |
| AD longitudinal follow-up | 61 | 71.7 | 55-81 | 21 | 10-29 | 1.3 | 1.0-2.0 |
| MCI stable | 56 | 67.4 | 52-81 | 28 | 23-30 | 0.3 | 0.0-1.0 |
| Total | 58 | 70 | 52-84 | 26 | 10-30 | 1.0 | 0.0-2.0 |

TABLE 13
History of chronic illness

History of chronic illness?

| Cohort | No | Yes |
|---|---|---|
| MCI conversion | 3 | 23 |
| Cognitively healthy | 2 | 18 |
| AD longitudinal baseline | 2 | 22 |
| AD longitudinal follow-up | 5 | 26 |
| MCI stable | 8 | 19 |
| Total | 20 | 108 |

TABLE 14
Overview of the use of acetylcholinesterase inhibitor

| | Use of acetylcholinesterase inhibitor? | | | |
|---|---|---|---|---|
| Cohort | No | Yes | Unknown | Total |
| MCI conversion | 31 | 3 | 0 | 34 |
| Cognitively healthy | 32 | 0 | 0 | 32 |
| AD longitudinal baseline | 23 | 8 | 0 | 31 |
| AD longitudinal follow-up | 13 | 18 | 0 | 31 |
| MCI stable | 28 | 3 | 1 | 32 |
| Total | 127 | 32 | 1 | 160 |

### Sample Size

The cohort sample sizes are summarized in Table 15.

TABLE 15
Sample sizes

| Cohort | Sample size |
|---|---|
| MCI stable | 32 |
| MCI conversion | 34 |
| Longitudinal AD | 31 |
| Cognitively healthy | 32 |

### Procedures

### Apparatus and Equipment

| Instrument: | Instrument ID: |
|---|---|
| −70° C. freezer | 400-01/02/03/04 |
| Nanodrop | 120-01 |
| 2100 BioAnalyzer | 110-01 |
| Tetrad | 130-01 |
| ViiA7 Dx west | 100-04 |
| ViiA7 Dx east II | 100-10 |

### Test Materials, Standards and Reagents

| Reagents | Material no./Lot no. |
|---|---|
| PAXgene ™ Blood RNA Kit for | PreAnalytiX cat# 762174 |
| manual extraction | |
| RNA 6000 Nano assay kit | Agilent cat# 5067-1512 |
| RNA 6000 ladder | Agilent cat# 5067-1529 |
| High-capacity cDNA Reverse | Applied Biosystems cat# |
| Transciptase Kit | 4368813, lot no. 1101092 |
| TaqMan ® Universal PCR Master | Applied Biosystems cat# |
| Mix II (2X) with UNG | 4440038, lot no. 1012010 |
| Water mol biograde 5 Prime | Cat# 2500010 |
| RNAse away | Molecular BioProducts cat# |
| | 7002 |
| Antibac | 600521 |
| Reference material RM006 | In-house reference material |
| Reference material RM005 (for | In-house reference material |
| use with BCT-1 cards) | |
| Applied Biosystems TaqMan ® | |
| arrays 384-well format: | Custom ordered cards: |
| MFC card 1 | Batch no. A6709 |
| MFC card 2 | Batch no. A6707 |
| MFC card 3 | Batch no. A6727 |
| Applied Biosystems TaqMan ® arrays | |
| 4 × 96-well format: | Custom ordered cards: |
| BCT-1 | A5709 |

### Blood Samples

The blood samples were collected in PAXgene™ tubes (PreAnalytiX, Hombrechtikon, Switzerland) and left overnight at room temperature before storing at −80° C. until use.

### RNA Extraction and Quality Control

Total RNA was extracted from the blood samples, quality controlled and subsequently stored at ≦−70° C. prior to further processing.

cDNA Synthesis

2210 ng total PAXgene blood RNA was required for one cDNA synthesis for gene expression analysis on the entire set of MFCs (3×384-array cards).

The cDNA syntheses were performed in one day for the primary run and in one day for the rerun samples. The cDNA was prepared with the following specifics for the present study:

The volumes of the components used to prepare the master mix for the cDNA reverse transcription for all samples including reference material is presented in Table 16.

TABLE 16
Volume of components used to prepare cDNA the master mix

| Component | Volume (μl) per reaction |
|---|---|
| 10X Reverse Transcription Buffer | 26 |
| 25X dNTPs | 10.4 |
| 10X random primers | 26 |
| Multiscribe Reverse Transriptase, 50 U/μl | 13 |
| Nuclease-free H₂O | 54.6 |
| Total per reaction | 130 |

For each sample specific cDNA master mix, water was added to 1.5 ml eppendorf tubes. The cDNA master mix was prepared for all samples and distributed as 130 μl aliquots in the tubes already containing water. Finally, RNA was added to master mix aliquots to a total volume of 260 μl. The final concentration of RNA in the cDNA reaction mixture was 8.5 ng/μl.

PCR strips of 8 wells were used for cDNA synthesis. All cDNA syntheses for the primary run and the rerun samples were prepared during the course of one day, respectively, but the cDNA syntheses were prepared in several blocks on the Tetrad thermocycler. After the cDNA synthesis, the cDNA preparations were pooled and stored at −20° C. upon the addition of the PCR master mix in the qPCR step.

qPCR on ViiA7

Amplification of cDNA was the second step in the two-step real-time (RT) qPCR experiment. The MFCs were run on 2 ViiA7 Dx systems from Applied Biosystems. The ViiA7 instruments were qualified according to internal procedures prior to use.

### MFC Cards and TaqMan Assays

The sample-specific PCR mix was loaded into a set of 3 MFC each comprising 384 different TaqMan assays. These assays comprised in-house assay as well as reference and known assays.

The cards were run sequentially during the primary run. For the re-run the samples were run sequentially with randomized order of cards. All 3 cards contained 7 reference assays, including beta-actin.

The TaqMan system detects PCR products using the 5′ nuclease activity of Taq DNA polymerase on fluorogenic DNA probes during each extension cycle. The Taqman probe (normally 25 mer) is labelled with a fluorescent reporter dye at the 5′-end and a fluorescent quencher dye at the 3′-end. When the probe is intact, the quencher dye reduces the emission intensity of the reporter dye. If the target sequence is present the probe anneals to the target and is cleaved by the 5′ nuclease activity of Taq DNA polymerase as the primer extension proceeds. As the cleavage of the probes separates the reporter dye from the quencher dye, the reporter dye fluorescence increases as a function of PCR cycle number. The greater the initial concentration of the target nucleic acid, the sooner a significant increase in fluorescence is observed.

Prepared cDNA was subjected to real-time PCR on the ViiA7 Dx systems with the following specifics for the present study:

Each aliquot (80 μl) of prepared cDNA reaction was used for preparation of the sample specific PCR reaction mixture to be loaded onto one MFC card. The cDNA was diluted 1/10 in the PCR reaction mixture according to Table 17. Each 8 lanes of one card were loaded with 97 μl PCR reaction mixture.

TABLE 17
Volume of components used to prepare
the PCR reaction mixture per MFC card

| Component | Volume (μl) |
|---|---|
| cDNA sample (8.5 ng RNA/μl) | 80 |
| RNAase/DNase-free water | 320 |
| TaqMan Universal PCR Master Mix II (2x) | 400 |
| Total | 800 |

### Reference Material

Reference samples were run throughout the experiment at regular time. These were used to monitor technical aspects such as inter-card and inter-day variability.

### Biological Modeling

### Classification and Merging

The classes and merged classes used for biological modeling are defined in Table 18 and Table 19, respectively.

TABLE 18
Classes

| Cohort | Class | Samples |
|---|---|---|
| Cognitively healthy | HC | 32 |
| MCI stable | S | 32 |
| MCI conversion | C | 34 |
| AD longitudinal (baseline)* | L1 | 31 |
| AD longitudinal (follow-up)* | L2 | 31 |

The 31 samples in L1 and L2 were from the same donor.

TABLE 19
Merged classes

| Name | Classes | Samples |
|---|---|---|
| MCI | C + S | 66 |
| Non-MCI | HC + L1/L2 | 63 |
| Non-AD | HC + S | 63 |
| AD | C + L2 | 61 |

### Statistical Modeling

The data generated from the ABI Viia7 instrument was preprocessed using a single reference assay, beta-actin. Assays from each card (containing 384 assays including different reference assays), 3 cards in total, were individually normalized with the beta-actin measurement within this card. In this analysis any missing values present were filled by the mean value of that particular assay. Excluding references, gene expression data from 1123 assays have been analyzed. The data were scaled during analysis. Partial Least Square Analysis was used for data modeling and variable selection was performed by Jackknifing. Performance results from all data are based on Leave-One-Out Cross-Validation approach (LOOCV) while the performance of models based on significant or informative assays were estimated by double Leave-One-Out Cross-Validation approach (dLOOCV) approach.

For the analysis the 5 outliers mentioned above were removed. The efficacy population thus comprises the following sample cohorts:

TABLE 20
Examined classes

| Cohort | Class | Samples |
|---|---|---|
| Cognitively healthy | HC | 32 |
| MCI stable | S | 31 |
| MCI conversion | C | 30 |
| AD longitudinal (baseline)* | L1 | 31 |
| AD longitudinal (follow-up)* | L2 | 31 |

*The 31 samples in L1 and L2 were from the same donor.

### 1. Blood Based Gene Expression Test to Detect Prodromal AD (or MCI Converters or Preclinical AD) in MCI Population

A PLSR model was built using all 1123 assay data derived from an effective population of 61 samples (31 stable MCI and 30 MCI converters). Performance of the model was determined by leave-one-out cross validation. 225 assays having a p-value of regression coefficient <0.2 were identified as significant or informative (listed in Table 2). The predictive ability of the identified probes was estimated by double leave-one-out cross validation.

In addition, a preselected set of 20 assays identified as informative in independent studies (Table 3) was tested for its ability to detect Prodromal AD in an MCI population. For this purpose a PLSR model was built using these assays and 61 samples (31 stable MCI and 30 MCI converters) and prediction performance determined by LOOCV. The performance results are summarized below.

| | | | | 20 |
|---|---|---|---|---|
| | | | | preselected |
| | | All | Table 2 | Table 3 |
| | | data | probes | probes |
| % of samples correctly | Accuracy | 74% | 77% | 77% |
| predicted | | | | |
| % of MCI converters | Sensitivity | 70% | 73% | 70% |
| correctly predicted | | | | |
| % of Stable MCI | Specificity | 77% | 81% | 84% |
| correctly predicted | | | | |

### Supporting External Data

A contract research organization performed an independent analysis to further support the internal findings based on data for 129 cases (Table 21) with a primary aim to identify a predictive signature to classify S vs. C.

TABLE 21
Classes with QC approved data

| Cohort | Class | Samples |
|---|---|---|
| Cognitively healthy | HC | 32 |
| MCI stable | S | 32 |
| MCI conversion | C | 34 |
| AD longitudinal (baseline) | L1 | 31 |

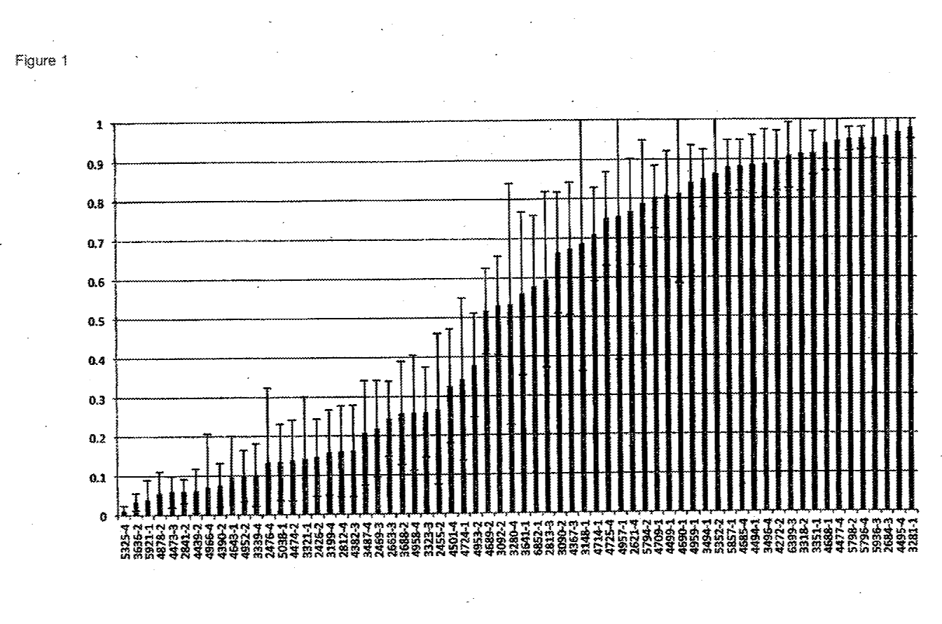

An artificial neural network was trained with an optimal number of assays and validated with monte-carlo cross validation re-sampling. In the cross validation procedure 80% of the samples were used for model training and 20% for model validation. Predictions were summarized and averaged per sample to produce an average predicted score and a standard deviation. The optimal number of assays to use in the network was determined by adding 1 by 1 assay until there was no improvement to accuracy of the classifier. This was all performed within each cross validation loop to prevent information leakage and bias to the performance. With a 10-gene panel (Table 4) the network was able to classify MCI converts from MCI stable with 88% accuracy. The population profile with MCI conversion prediction score for each individual case is shown in FIG. 1.

### 2. Blood Based Gene Expression Test to Detect Prodromal AD and Progressed AD in a Heterogeneous Population

| Cohort | Class | Samples |
|---|---|---|
| Non-AD | | |
| Cognitively healthy | HC | 32 |
| MCI stable | S | 31 |
| AD | | |
| MCI conversion | C | 30 |
| AD longitudinal (follow-up)* | L2 | 31 |
| | | 124 |

A PLSR model was built using all 1123 assay data derived from an effective population of 124 samples (32 cognitively healthy and 31 stable MCI grouped as Non-Alzheimer samples and 30 MCI converters and 31 progressed AD grouped as AD representing both preclinical and clinical Alzheimer samples) and performance determined by leave-one-out cross validation.

302 assays listed in Table 5, having a p-value of regression coefficient <0.05 were identified as significant or informative. Their predictive ability was estimated by double leave-one-out cross validation.

Also, Table 3 probes were tested for their ability to detect Prodromal AD and progressed AD in a heterogeneous population. A PLSR model was built using these assays and prediction performance determined by LOOCV. The different prediction results are summarized below.

| | | All | Table 5 | Table 3 |
|---|---|---|---|---|
| | Performance | data | probes | probes |
| % of samples | Accuracy | 63% | 66% | 73% |
| correctly predicted | | | | |
| % of AD correctly | Sensitivity | 67% | 66% | 67% |
| predicted | | | | |
| % of NonAD correctly | Specificity | 60% | 67% | 79% |
| predicted | | | | |

3. Blood Based Gene Expression Test to Detect Patients with MCI in a Heterogeneous Population

| Cohort | Class | Samples |
|---|---|---|
| MCI | | |
| MCI stable | S | 31 |
| MCI conversion | C | 30 |
| Non-MCI | | |
| Cognitively healthy | HC | 32 |
| AD longitudinal (follow-up)* | L2 | 31 |
| | | 124 |

A PLSR model was built using all 1123 assay data derived from an effective population of 124 samples (and 31 stable MCI grouped and 30 MCI converters grouped as MCI samples and 32 cognitively healthy 31 progressed AD grouped as Non-MCI samples) and performance determined by leave-one-out cross validation.

266 assays listed in Table 6, having a p-value of regression coefficient <0.2 were identified as significant or informative and predictive ability estimated by double LOOCV. The prediction results are shown below:

| | | All | Table 6 |
|---|---|---|---|
| | Performance | data | probes |
| % of samples correctly | Accuracy | 71% | 75% |
| predicted | | | |
| % of NonMCI correctly | Sensitivity | 67% | 77% |
| predicted | | | |
| % of MCI correctly | Specificity | 75% | 73% |
| predicted | | | |

### 4. Blood Based Gene Expression Test to Discriminate Between Different Stages of Alzheimer's Disease

### A. Test to Discriminate Prodromal AD and Progressed AD

| Cohort | Class | Samples |
|---|---|---|
| MCI conversion | Prodromal AD | 30 |
| AD longitudinal follow-up | Progressed AD | 31 |
| | | 61 |

A PLSR model was built using all 1123 assay data derived from 61 samples comprising 30 prodromal and 31 progressed samples. Converters and progressed AD will be 2 extremes for AD, and assays able to discriminate them could be used to discriminate between different stages of Alzheimer's disease. The built in model was validated by LOOCV and prediction performance determined.

Following Jackknifing, 144 assays, listed in Table 7, having a p-value of regression coefficient <0.05 were identified as significant or informative and their predictive ability was determined by double leave-one-out cross validation. The performance results are summarized below:

| | | All | Table 7 |
|---|---|---|---|
| | Performance | data | probes |
| % of samples correctly | Accuracy | 79% | 80% |
| predicted | | | |
| % of Progressed AD | Sensitivity | 80% | 81% |
| % of Prodromal AD | Specificity | 77% | 80% |
| correctly predicted | | | |

### B. Test to Discriminate Very Mild and Mild Dementia

Clinical samples were grouped as very mild or mild based on their Clinical dementia rating. CDR rating can be used to determine functional cognitive decline in patients with dementia.

| Cohort | Class | Samples |
|---|---|---|
| Samples with CDR 0.5 | Very Mild | 78 |
| Samples with CDR 1.0 | Mild | 32 |
| | | 110 |

A validated PLSR model was built in using all 1123 assay and 110 samples (comprising of 73 very mild and 31 mild dementia cases). Jackknifing identified 82 significant and/or informative probes, listed in Table 8. Their predictive ability was determined by double leave-one-out cross validation. The performance results are summarized below:

| | | All | Table 8 |
|---|---|---|---|
| | Performance | data | probes |
| % of samples correctly | Accuracy | 77% | 75% |
| predicted | | | |
| % of correctly | Sensitivity | 77% | 75% |
| predicted Mild AD | | | |
| % of correctly | Specificity | 77% | 74% |
| predicted Very Mild AD | | | |

### 5. Blood Based Gene Expression Test to Predict the Rate of Disease Progression in Alzheimer's Patients.

Gene expression signatures to determine the rate of disease progression in AD patients were developed using two different approaches.

The first investigated the retrospective determination of AD progression using 2 different models. The first model used the difference in gene expression for AD patients at baseline and at a follow-up visit to discriminate between donors with and without clear progression (Intra-person). The second model subsequently used the probes listed in Tables 7 and 11 for modeling of changes in gene expression profile from baseline to follow-up visits for donors with clear progression (Inter-person).

The second approach was a prospective approach aiming at predicting the future rate of disease progression of AD patients using the gene expression data from patients at baseline visit to discriminate between donors with and without clear progression.

Based on global CDR and CDR-Sum of boxes values obtained during the first (baseline) and second follow-up visits the donors were divided into 2 groups. Of the 31 donors, 16 had clear disease progression, 12 had no clear progression. In total 4 donors were removed where one was a technical outlier and for 3 no CDR and CDR-SOB were available The 27 donors were used for further analysis, see below.

| | | Global CDR | | MMSE | |
|---|---|---|---|---|---|
| | | Mean | Mean | Mean | Mean |
| | Do- | baseline | follow-up | baseline | follow-up |
| Cohort | nors | (min-max) | (min-max) | (min-max) | (min-max) |
| Clear | 15 | 0.9 (0.0-1.0) | 1.4 (1.0-2.0) | 25 (16-19) | 21 (12-29) |
| progression | | | | | |
| No clear | 12 | 1.1 (0.0-2.0) | 1.0 (1.0-1.0) | 24 (19-29) | 21 (10-25) |
| progression | | | | | |
| Total | 27 | 1.0 (0.0-2.0) | 1.3 (1.0-2.0) | 24 (16-19) | 21 (10-29) |

### Retrospective Approach

Intra-Person: Change in Gene Expression from Baseline to Follow-Up

The gene expression values for each assay at baseline were subtracted from the values for corresponding assay at follow-up. The data matrix obtained was then modeled by PLSR to discriminate patients with clear and non-clear disease progression. The model identified 78 informative probes with p value of regression coefficients <0.05 listed in Table 10. The performance results are summarized below.

| | | All | Probes listed |
|---|---|---|---|
| | Performance | data | in Table 7 |
| % of correctly | Accuracy | 78% | 67% |
| predicted samples | | | |
| % of correctly | Sensitivity | 87% | 73% |
| predicted samples with | | | |
| clear progression | | | |
| % of correctly | Specificity | 67% | 58% |
| predicted samples with | | | |
| no clear progression | | | |

Inter-Person: Discrimination at Baseline and Follow-Up Stages of the Patients with Clear Disease Progression

For this model, 15 donors with clear progression were modelled by PLSR to discriminate between samples at baseline and follow-up. The performance results including those obtained for identified informative assays (Table 11) and assays listed in Table 7 are presented below.

| | | All | Table 11 | Table 7 |
|---|---|---|---|---|
| | Performance | data | probes | probe set |
| % of correctly | Accuracy | 75% | 94% | 81% |
| predicted samples | | | | |
| % of correctly | Sensitivity | 81% | 94% | 88% |
| predicted samples at | | | | |
| follow-up | | | | |
| % of correctly | Specificity | 69% | 94% | 75% |
| predicted samples at | | | | |
| baseline | | | | |

### Prospective Modeling

To investigate the ability to predict future rate of progression of an AD patient, a model was developed using the gene expression data from baseline samples only. Informative probes were identified and validated by double LOOCV (listed in Table 9). The predictions and performance results are summarized below.

| | | All | Table 9 | Table 7 |
|---|---|---|---|---|
| | Performance | data | probes | probe set |
| % of correctly | Accuracy | 67% | 73% | 67% |
| predicted samples | | | | |
| % of correctly | Sensitivity | 73% | 73% | 67% |
| predicted samples with | | | | |
| clear progression | | | | |
| % of correctly | Specificity | 58% | 73% | 67% |
| predicted samples with | | | | |
| no clear progression | | | | |

The results clearly show that blood based gene expression test has the ability to identify patients where disease will progress more rapidly.

### Minimum Probe Sets Analysis

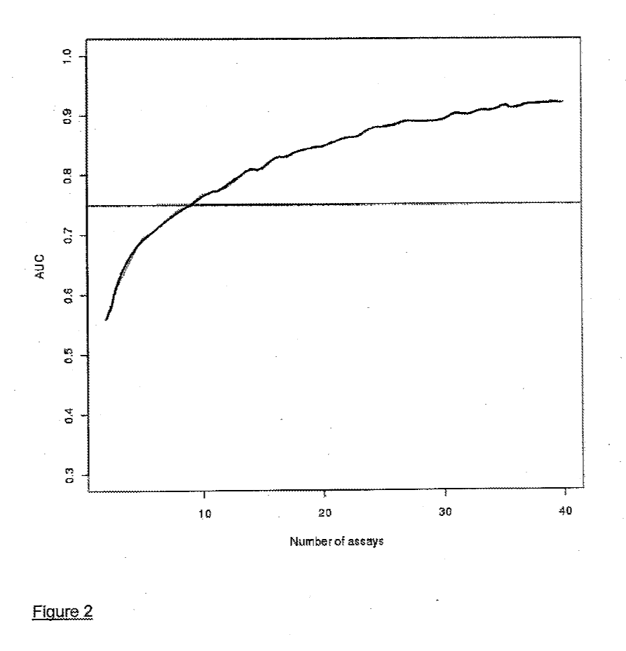

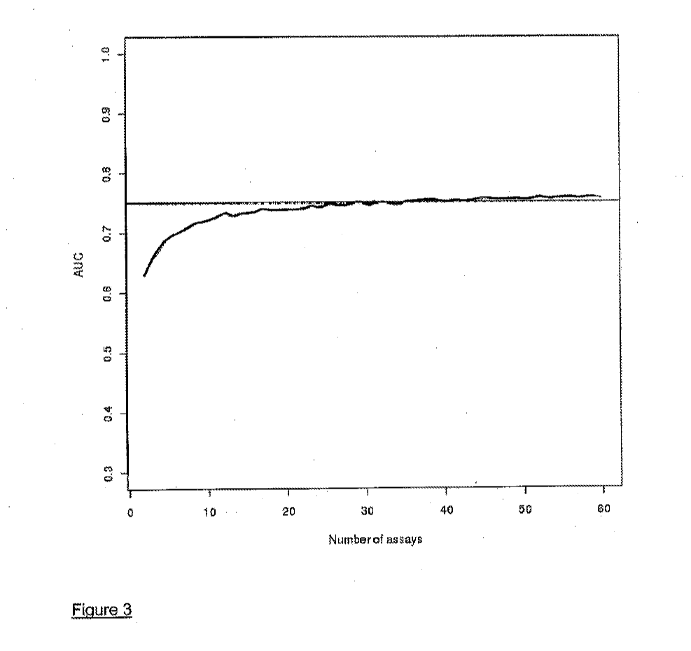

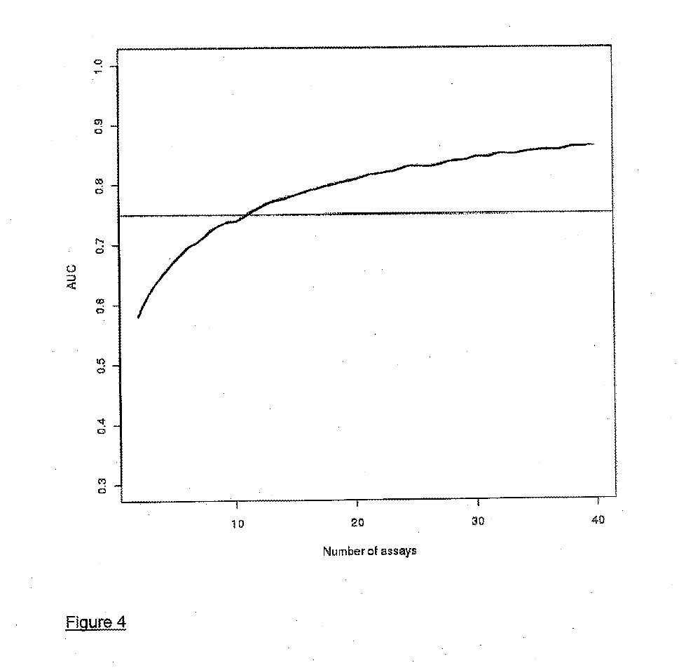

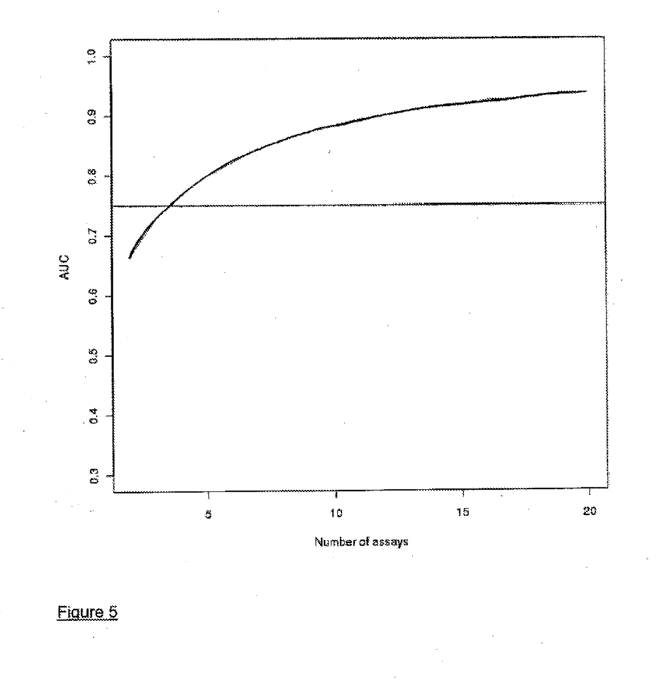

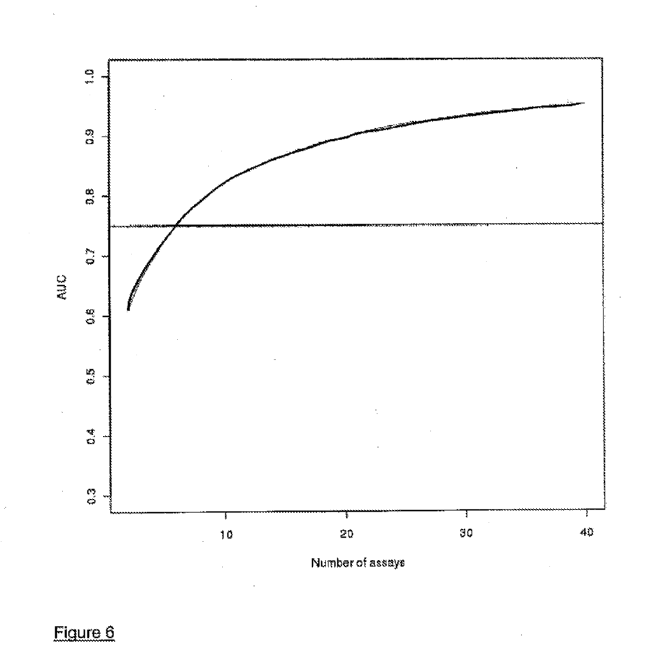

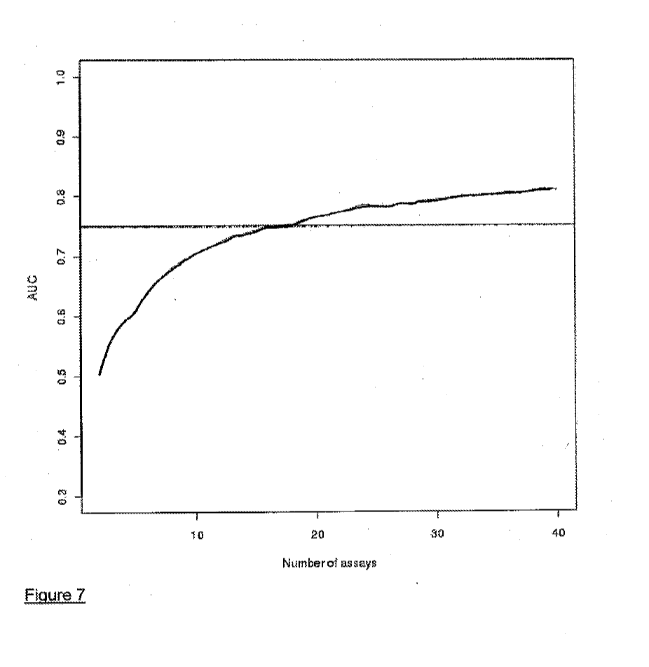

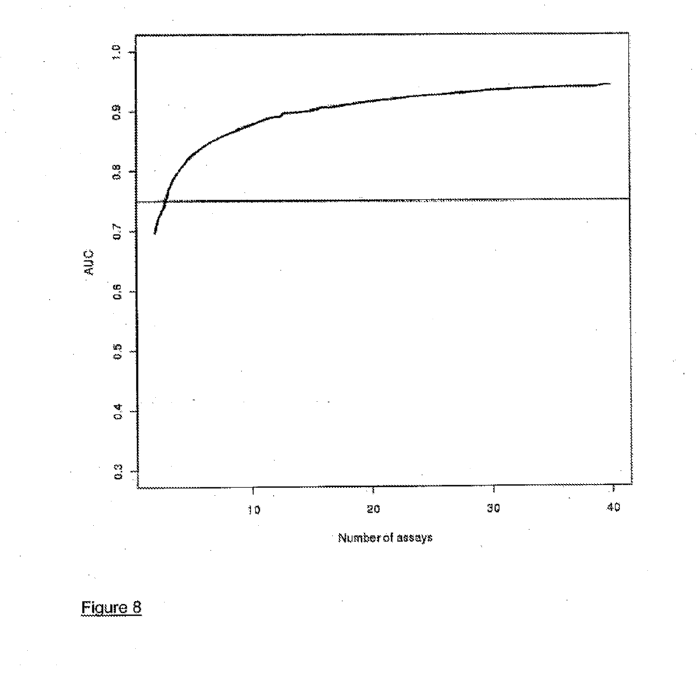

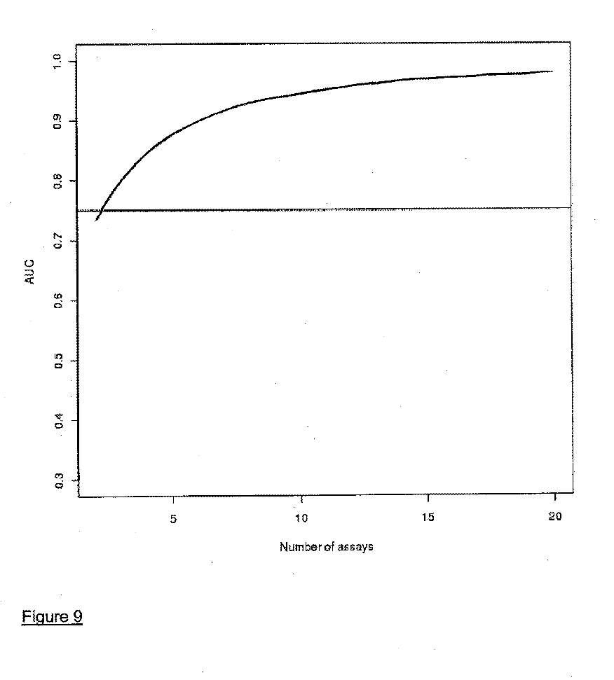

The results above show the generation of data using the sets of probes presented in the various tables. However, selection of 10 or more of those probes also yields useful results. FIGS. 2 to 9 show the results of Permutation plots for the probes reported in the different tables. From the probes listed in the respective tables a set of probes (X axis gives the number of probes) were randomly selected and used to model the relevant classes. The process was iterated several hundred times (to be more specific 5204 iterations in total for Table 2, 11718 iterations in total for Table 6, 10054 iterations for Table 5, 39970 iterations for Table 7, 161636 for Table 10, 29582 iteration for Table 9, 211426 iteration for Table 11, 57802 iteration in total for Table 8). Performance was estimated by calculating Area Under Curve (AUC) which is sensitivity/1-specificity.

### DISCUSSION

The ability to predict whether an MCI patient will remain stable or convert to AD within the next few years is of great value and, hence, the highest expectations were associated with the classification of stable MCI and MCI converters. The use of stable MCI for the classification is highly medical relevant considering the patients presenting with subjective memory complaints may more likely be considered a case of stable MCI than a cognitively healthy subject if they are not converting to AD.

The present example demonstrates that these indeed may be discriminated. Both internal results, as well as supporting external data, using an alternative approach to data processing and model building, demonstrates the classification of stable MCI and MCI converters. Typically an accuracy of 77% was obtained for internal results, with external accuracy data of 88%.

The DiaGenic's ADtect test is a gene expression test for the diagnosis of AD. The prediction is merely a positive or a negative diagnosis, without any staging of a positive AD diagnosis. Both the ability to document a progression in AD diagnosis as well as the ability to stage the AD diagnosis are of clinical relevance.

In the present example, a gene expression signature to determine the progression of AD was developed. Two different approaches were investigated. The first approach investigated the retrospective determination of AD progression using 2 different models. The first model investigated the difference in gene expression for AD patients at baseline and at a follow-up visit to discriminate between donors with and without progression. The second model subsequently used the informative subset for modeling of changes in gene expression profile from baseline to follow-up visit for donors with and without progression, respectively. Using this model subjects with clear progression were correctly predicted in over 94% of cases, demonstrating the potential for the gene signature as an AD progression marker. The second approach was a prospective approach aiming at predicting the future progression of AD patients. For the investigated model an accuracy of 73% was obtained.

Additional modelling for diagnosing and/or staging AD, diagnosing MCI and determining the severity of dementia is also reported.

TABLE 1
Summary of informative probes. Frequency of occurrence in sets. (− = absent, + =
present) The Assay numbers refer to specific sequences for which details are provided after the tables.

| Sequence Number | Table 2 | Table 3 | Table 4 | Table 5 | Table 6 | Table 7 | Table 8 | Table 9 | Table 10 | Table 11 |
|---|---|---|---|---|---|---|---|---|---|---|
| ASSAY0001 | − | − | − | + | − | − | − | + | − | − |
| ASSAY0002 | − | − | − | + | − | − | − | + | + | − |
| ASSAY0003 | − | − | − | + | − | − | − | + | − | − |
| ASSAY0006 | + | − | − | + | − | − | − | + | + | − |
| ASSAY0007 | − | − | − | − | − | − | − | − | + | − |
| ASSAY0010 | − | − | − | + | − | − | − | − | − | − |
| ASSAY0011 | − | − | − | + | + | + | + | − | − | − |
| ASSAY0012 | + | − | − | − | + | + | − | − | − | − |
| ASSAY0013 | − | − | − | + | − | − | − | + | + | − |
| ASSAY0014 | − | − | − | − | + | − | − | − | − | − |
| ASSAY0015 | + | − | − | − | − | − | − | − | + | − |
| ASSAY0017 | + | − | − | + | − | − | − | + | − | − |
| ASSAY0018 | − | − | − | − | − | − | − | + | − | − |
| ASSAY0020 | − | − | − | − | + | − | − | − | − | − |
| ASSAY0022 | − | − | − | − | + | + | + | + | − | − |
| ASSAY0024 | − | − | − | − | − | − | − | + | − | + |
| ASSAY0027 | + | − | − | + | − | − | − | + | − | − |
| ASSAY0031 | − | − | − | − | − | − | − | + | − | − |
| ASSAY0032 | + | − | − | − | + | − | − | − | − | − |
| ASSAY0036 | − | − | − | − | − | − | − | + | − | − |
| ASSAY0037 | + | − | − | − | − | − | − | − | − | + |
| ASSAY0038 | − | − | − | − | − | + | − | − | − | + |
| ASSAY0039 | − | − | − | − | − | − | − | − | − | + |
| ASSAY0040 | + | − | − | + | − | − | − | + | − | − |
| ASSAY0041 | − | − | − | − | − | + | − | + | − | − |
| ASSAY0044 | + | − | − | + | − | − | − | − | − | − |
| ASSAY0045 | − | − | − | + | − | − | − | − | − | − |
| ASSAY0046 | + | − | − | + | − | − | − | − | − | − |
| ASSAY0047 | − | − | − | + | + | − | + | + | − | − |
| ASSAY0048 | − | − | − | + | − | − | − | − | − | − |
| ASSAY0049 | − | − | − | − | − | − | − | + | − | − |
| ASSAY0050 | − | − | − | − | − | − | − | + | − | − |
| ASSAY0051 | − | − | − | − | + | − | + | − | − | − |
| ASSAY0052 | − | − | − | − | − | + | + | − | − | + |
| ASSAY0053 | + | − | − | − | − | − | − | + | + | − |
| ASSAY0054 | − | − | − | − | + | − | − | + | − | − |
| ASSAY0055 | − | − | − | − | − | − | − | + | − | − |
| ASSAY0056 | − | − | − | + | − | − | − | − | − | − |
| ASSAY0057 | − | − | − | − | + | + | + | + | − | − |
| ASSAY0060 | − | − | − | + | − | − | − | − | − | − |
| ASSAY0061 | − | − | − | − | − | − | − | + | − | − |
| ASSAY0062 | − | − | − | + | − | − | + | − | − | − |
| ASSAY0063 | + | − | − | + | − | − | − | − | − | − |
| ASSAY0065 | + | − | − | + | − | − | − | + | − | − |
| ASSAY0066 | − | − | − | − | − | − | − | − | − | + |
| ASSAY0067 | − | − | − | + | − | − | − | − | − | − |
| ASSAY0069 | + | − | − | − | − | − | − | − | − | − |
| ASSAY0070 | − | − | − | − | + | − | − | + | − | + |
| ASSAY0072 | − | − | − | − | + | − | − | − | − | − |
| ASSAY0074 | − | − | − | + | − | − | − | − | − | − |
| ASSAY0077 | − | − | − | − | − | − | − | − | + | + |
| ASSAY0080 | − | − | − | − | − | − | − | + | − | − |
| ASSAY0081 | − | − | − | − | − | − | − | − | + | − |
| ASSAY0082 | − | − | − | − | + | + | + | − | − | − |
| ASSAY0084 | + | − | − | + | − | − | − | − | − | − |
| ASSAY0085 | + | − | − | + | − | − | − | + | − | − |
| ASSAY0086 | − | − | − | + | − | − | − | − | − | − |
| ASSAY0087 | + | − | − | − | − | − | − | − | − | − |
| ASSAY0088 | + | − | − | − | − | − | − | − | − | − |
| ASSAY0089 | − | − | − | + | + | − | − | + | − | − |
| ASSAY0092 | − | − | − | + | − | − | − | − | − | − |
| ASSAY0093 | + | − | − | − | + | + | − | + | − | − |
| ASSAY0096 | − | − | − | − | + | + | − | + | − | − |
| ASSAY0097 | − | − | − | − | − | − | − | + | − | − |
| ASSAY0098 | − | − | − | + | − | − | − | + | + | + |
| ASSAY0099 | − | − | − | − | − | + | − | − | − | + |
| ASSAY0103 | + | − | − | + | − | − | − | − | − | − |
| ASSAY0104 | − | − | − | − | − | − | − | − | − | + |
| ASSAY0107 | − | − | − | + | − | − | − | − | − | − |
| ASSAY0108 | − | − | − | − | − | − | − | + | − | − |
| ASSAY0110 | − | − | − | − | + | − | − | − | − | − |
| ASSAY0112 | + | − | − | + | − | − | − | + | − | − |
| ASSAY0113 | − | − | − | − | + | + | + | − | − | − |
| ASSAY0114 | − | − | − | + | + | + | − | − | − | − |
| ASSAY0115 | − | − | − | − | − | − | − | + | − | − |
| ASSAY0116 | + | − | − | − | − | − | − | − | − | − |
| ASSAY0117 | + | − | − | + | − | − | − | − | − | − |
| ASSAY0118 | − | − | − | − | − | − | − | − | + | − |
| ASSAY0119 | − | − | − | + | − | − | − | + | + | − |
| ASSAY0120 | + | − | − | + | − | − | − | + | − | − |
| ASSAY0122 | + | − | − | − | − | + | − | − | − | − |
| ASSAY0123 | − | − | − | − | + | − | − | − | − | − |
| ASSAY0124 | − | − | − | + | − | − | − | − | − | − |
| ASSAY0126 | + | − | − | + | + | − | − | − | − | + |
| ASSAY0127 | − | − | − | − | − | − | − | + | − | − |
| ASSAY0128 | + | − | − | + | + | + | − | − | − | − |
| ASSAY0129 | − | − | − | + | − | − | − | − | − | − |
| ASSAY0132 | − | − | − | − | + | − | − | + | − | − |
| ASSAY0133 | − | − | − | − | − | − | − | + | + | − |
| ASSAY0135 | − | − | − | − | + | + | − | − | − | − |
| ASSAY0136 | − | − | − | + | − | − | − | + | − | − |
| ASSAY0137 | − | − | − | − | + | − | + | + | − | − |
| ASSAY0138 | + | − | − | − | − | − | − | − | − | − |
| ASSAY0139 | − | − | − | − | + | − | − | − | − | − |
| ASSAY0140 | − | − | − | − | + | + | − | − | − | + |
| ASSAY0141 | + | − | + | + | − | − | − | − | − | − |
| ASSAY0142 | − | − | − | + | − | − | − | − | − | − |
| ASSAY0144 | − | − | − | − | + | − | − | − | − | − |
| ASSAY0145 | − | − | − | − | − | − | − | + | − | − |
| ASSAY0147 | + | − | − | + | − | − | − | − | − | − |
| ASSAY0148 | − | − | − | − | + | + | − | − | − | − |
| ASSAY0149 | − | − | − | + | − | − | − | − | − | − |
| ASSAY0150 | + | − | − | + | − | − | + | + | − | − |
| ASSAY0151 | − | − | − | + | − | − | − | − | − | − |
| ASSAY0152 | − | − | − | + | − | − | − | − | − | − |
| ASSAY0153 | + | − | − | − | − | − | − | − | − | − |
| ASSAY0154 | − | − | − | + | − | − | − | + | − | − |
| ASSAY0155 | − | − | − | + | − | − | − | − | − | − |
| ASSAY0156 | + | − | − | + | − | − | − | + | − | − |
| ASSAY0157 | + | − | − | − | − | − | − | + | − | − |
| ASSAY0158 | + | − | − | + | − | − | − | + | − | − |
| ASSAY0159 | − | − | − | − | − | − | − | − | − | + |
| ASSAY0160 | + | − | − | + | − | − | − | − | − | − |
| ASSAY0161 | − | − | − | − | + | − | − | − | − | − |
| ASSAY0162 | − | − | − | − | − | − | − | + | + | + |
| ASSAY0163 | − | − | − | − | + | − | − | + | − | − |
| ASSAY0164 | − | − | − | + | − | − | − | − | − | + |
| ASSAY0165 | + | − | − | + | − | − | − | − | − | + |
| ASSAY0166 | − | − | − | − | − | − | − | + | − | − |
| ASSAY0168 | − | − | − | + | − | − | − | − | − | − |
| ASSAY0169 | − | − | − | − | − | − | − | + | − | − |
| ASSAY0170 | − | − | − | − | − | − | − | + | − | − |
| ASSAY0171 | − | − | − | + | − | − | − | − | − | − |
| ASSAY0172 | − | − | − | − | − | − | + | − | + | − |
| ASSAY0174 | − | − | − | + | − | − | − | − | − | + |
| ASSAY0176 | − | − | − | + | − | − | − | − | − | + |
| ASSAY0178 | + | − | − | + | + | − | − | − | − | − |
| ASSAY0179 | − | − | − | − | + | − | − | − | − | − |
| ASSAY0180 | − | − | − | + | − | − | − | + | − | − |
| ASSAY0181 | − | − | − | − | + | + | − | − | − | − |
| ASSAY0182 | − | − | − | − | + | − | − | + | − | − |
| ASSAY0183 | + | − | − | + | − | − | − | + | − | − |
| ASSAY0184 | − | − | − | − | + | + | − | − | − | − |
| ASSAY0185 | − | − | − | − | − | − | + | − | − | − |
| ASSAY0186 | − | − | − | − | − | − | − | − | + | − |
| ASSAY0187 | − | − | − | − | − | − | + | − | − | − |
| ASSAY0189 | − | − | − | − | − | + | − | − | − | − |
| ASSAY0190 | − | − | − | − | + | − | − | + | − | − |
| ASSAY0191 | − | + | − | − | − | − | − | + | − | − |
| ASSAY0193 | − | − | − | − | + | − | − | − | − | − |
| ASSAY0194 | − | + | − | + | − | − | − | + | − | − |
| ASSAY0195 | + | − | − | − | − | − | − | − | − | − |
| ASSAY0196 | − | + | − | − | − | − | − | − | − | − |
| ASSAY0197 | − | + | − | + | − | − | − | + | − | − |
| ASSAY0198 | + | − | − | + | − | − | − | − | − | − |
| ASSAY0199 | − | − | − | + | − | − | − | + | − | − |
| ASSAY0200 | − | − | − | + | − | − | − | − | − | − |
| ASSAY0202 | − | + | − | + | + | − | − | − | − | − |
| ASSAY0203 | − | − | − | − | + | − | − | + | − | − |
| ASSAY0204 | − | − | − | + | − | − | − | + | − | − |
| ASSAY0205 | − | − | − | − | − | − | + | − | − | − |
| ASSAY0206 | − | − | − | − | + | − | − | − | − | − |
| ASSAY0207 | + | + | − | − | + | + | − | − | − | − |
| ASSAY0209 | − | − | − | + | + | + | + | − | − | − |
| ASSAY0210 | − | − | − | + | − | + | − | + | − | + |
| ASSAY0211 | + | − | − | − | + | − | − | − | − | − |
| ASSAY0212 | − | − | − | − | + | − | + | − | − | − |
| ASSAY0213 | − | − | − | − | − | − | − | + | − | − |
| ASSAY0214 | − | − | − | − | − | − | − | + | − | − |
| ASSAY0215 | − | + | − | + | − | − | − | + | − | − |
| ASSAY0216 | − | − | − | − | + | + | − | − | − | − |
| ASSAY0217 | − | − | − | − | + | − | − | − | − | − |
| ASSAY0218 | − | − | − | − | − | − | − | + | − | − |
| ASSAY0221 | + | + | − | + | − | − | − | − | − | − |
| ASSAY0222 | + | + | − | + | − | − | − | − | − | − |
| ASSAY0223 | − | − | − | − | + | + | − | + | + | − |
| ASSAY0224 | − | − | − | − | − | − | + | − | − | − |
| ASSAY0225 | − | − | − | − | − | − | − | − | + | + |
| ASSAY0226 | + | + | − | + | − | − | − | − | − | − |
| ASSAY0227 | − | − | − | − | + | − | − | + | − | − |
| ASSAY0228 | − | + | − | − | + | − | − | + | − | − |
| ASSAY0230 | − | − | − | + | + | + | − | − | − | + |
| ASSAY0232 | + | − | − | − | − | − | − | + | − | − |
| ASSAY0234 | + | − | − | − | − | + | − | − | − | − |
| ASSAY0236 | − | + | − | − | + | − | − | − | − | − |
| ASSAY0242 | − | − | − | − | + | + | − | + | + | + |
| ASSAY0243 | − | + | − | − | − | − | − | − | − | − |
| ASSAY0244 | − | − | − | − | + | − | − | − | − | − |
| ASSAY0245 | + | − | − | − | − | − | − | − | + | + |
| ASSAY0246 | + | + | − | + | − | − | − | + | − | − |
| ASSAY0247 | − | − | − | + | − | − | − | − | − | − |
| ASSAY0249 | − | − | − | − | − | − | − | + | − | − |
| ASSAY0250 | − | − | − | − | − | − | − | + | − | − |
| ASSAY0251 | + | + | − | + | − | − | − | + | − | − |
| ASSAY0252 | + | − | − | − | − | − | − | − | − | − |
| ASSAY0253 | − | − | − | − | + | − | − | − | − | − |
| ASSAY0254 | − | − | − | − | − | − | − | + | + | − |
| ASSAY0255 | − | − | − | − | + | − | − | − | − | − |
| ASSAY0256 | − | + | − | − | − | − | − | − | − | + |
| ASSAY0257 | − | − | − | + | + | − | − | − | − | + |
| ASSAY0258 | − | − | − | + | − | − | − | − | − | + |
| ASSAY0259 | + | − | − | − | − | − | − | − | − | − |
| ASSAY0261 | − | − | − | − | + | − | + | − | − | − |
| ASSAY0262 | − | + | − | − | − | − | − | − | − | − |
| ASSAY0263 | − | − | − | − | + | + | − | − | − | + |
| ASSAY0264 | − | − | − | − | + | − | − | − | − | − |
| ASSAY0265 | + | − | − | + | − | − | − | − | − | − |
| ASSAY0266 | − | − | − | − | + | + | − | − | − | − |
| ASSAY0267 | − | − | − | + | + | − | − | + | − | − |
| ASSAY0268 | − | − | − | + | − | − | − | − | − | + |
| ASSAY0269 | − | − | − | + | − | − | − | − | − | + |
| ASSAY0270 | − | − | − | + | − | − | − | + | − | − |
| ASSAY0272 | − | − | − | − | − | − | − | + | − | − |
| ASSAY0273 | + | − | − | − | − | − | − | − | − | − |
| ASSAY0274 | − | − | − | − | − | − | − | − | − | + |
| ASSAY0275 | − | + | − | − | − | − | − | − | − | − |
| ASSAY0277 | − | + | − | − | − | − | − | − | − | − |
| ASSAY0278 | + | + | − | + | + | − | − | − | − | − |
| ASSAY0279 | − | − | − | − | − | − | + | − | − | − |
| ASSAY0280 | − | − | − | + | − | − | − | − | − | − |
| ASSAY0281 | − | − | − | − | − | + | − | + | − | − |
| ASSAY0282 | − | − | − | − | + | + | − | − | − | − |
| ASSAY0284 | − | − | − | + | + | − | − | − | − | − |
| ASSAY0285 | − | − | − | − | + | − | + | + | − | − |
| ASSAY0286 | − | − | − | − | + | − | − | + | − | − |
| ASSAY0289 | + | − | − | + | − | − | + | − | − | − |
| ASSAY0290 | − | − | − | + | + | − | − | − | − | − |
| ASSAY0291 | − | − | − | − | − | + | − | + | − | − |
| ASSAY0292 | − | − | − | + | − | − | − | − | + | + |
| ASSAY0293 | − | − | − | + | − | − | − | − | − | + |
| ASSAY0294 | − | − | − | − | − | − | − | + | − | − |
| ASSAY0296 | − | − | − | − | − | − | − | + | − | − |
| ASSAY0299 | − | − | − | − | + | − | − | − | + | + |
| ASSAY0302 | + | − | − | + | − | − | − | + | − | − |
| ASSAY0304 | − | − | − | − | + | + | + | − | − | − |
| ASSAY0306 | − | − | − | − | + | + | + | − | − | − |
| ASSAY0307 | + | − | − | − | − | − | + | − | − | − |
| ASSAY0309 | − | − | − | − | − | − | − | + | − | − |
| ASSAY0313 | − | − | − | − | + | − | − | + | − | − |
| ASSAY0315 | + | − | − | + | − | − | − | − | − | − |
| ASSAY0316 | + | − | − | − | − | − | − | − | − | − |
| ASSAY0317 | − | − | − | − | + | − | − | − | − | − |
| ASSAY0319 | − | − | − | + | − | − | − | + | − | − |
| ASSAY0320 | − | − | − | + | − | − | − | − | − | − |
| ASSAY0321 | + | − | − | + | − | − | − | − | − | − |
| ASSAY0322 | − | − | − | − | + | − | − | − | − | − |
| ASSAY0324 | − | − | − | − | − | + | − | − | − | − |
| ASSAY0327 | − | − | − | − | − | − | + | − | − | − |
| ASSAY0329 | − | − | − | − | + | − | − | − | − | − |
| ASSAY0331 | − | − | − | + | − | − | − | − | − | − |
| ASSAY0332 | − | − | − | − | + | + | − | + | − | − |
| ASSAY0334 | + | − | − | − | − | − | − | − | + | − |
| ASSAY0335 | + | − | − | + | + | − | − | − | − | − |
| ASSAY0336 | − | − | − | + | − | − | − | − | − | − |
| ASSAY0337 | − | − | − | + | − | − | − | − | + | + |
| ASSAY0338 | + | − | − | − | − | − | − | + | − | − |
| ASSAY0339 | + | − | − | − | − | − | − | + | − | − |
| ASSAY0340 | + | − | − | + | − | − | − | − | − | + |
| ASSAY0341 | − | − | − | + | − | − | − | − | − | − |
| ASSAY0342 | − | − | − | + | − | − | − | − | − | − |
| ASSAY0343 | − | − | − | − | + | − | − | + | − | − |
| ASSAY0344 | − | − | − | + | − | − | − | − | + | + |
| ASSAY0345 | − | − | − | + | − | − | − | − | − | − |
| ASSAY0346 | − | − | − | − | + | + | + | − | − | − |
| ASSAY0347 | + | − | − | − | − | − | − | − | − | − |
| ASSAY0348 | − | − | − | + | + | + | − | − | − | − |
| ASSAY0351 | − | − | − | + | − | − | − | − | − | − |
| ASSAY0352 | − | − | − | − | + | − | − | − | − | + |
| ASSAY0354 | − | − | − | + | − | − | − | − | − | − |
| ASSAY0355 | − | − | − | + | − | − | − | + | − | − |
| ASSAY0356 | − | − | − | + | + | + | − | − | − | − |
| ASSAY0357 | − | − | − | + | − | − | − | − | − | − |
| ASSAY0358 | − | − | − | − | − | − | − | + | − | − |
| ASSAY0359 | − | − | − | − | + | + | − | − | + | + |
| ASSAY0361 | − | − | − | − | − | − | − | + | + | − |
| ASSAY0362 | − | − | − | + | − | − | − | − | − | − |
| ASSAY0364 | − | − | − | − | − | − | − | + | − | − |
| ASSAY0366 | − | − | − | − | + | − | − | − | + | − |
| ASSAY0367 | − | − | − | + | − | − | − | − | − | + |
| ASSAY0368 | + | − | − | − | − | − | − | − | − | − |
| ASSAY0369 | − | − | − | − | − | − | − | + | + | + |
| ASSAY0370 | − | − | − | − | + | + | − | − | − | + |
| ASSAY0371 | − | − | − | − | − | − | − | − | − | + |
| ASSAY0372 | − | − | − | − | + | + | + | − | − | + |
| ASSAY0373 | − | − | − | − | − | + | − | − | − | − |
| ASSAY0374 | + | − | − | + | − | − | − | + | − | − |
| ASSAY0376 | − | − | − | − | − | − | − | + | + | + |
| ASSAY0378 | − | − | − | − | + | − | − | − | − | − |
| ASSAY0379 | + | − | − | − | − | − | − | − | − | − |
| ASSAY0380 | + | − | − | + | − | − | − | + | − | − |
| ASSAY0381 | − | − | − | − | − | − | − | + | + | − |
| ASSAY0382 | + | − | − | − | + | + | − | − | − | − |
| ASSAY0386 | + | − | − | − | − | − | − | − | − | − |
| ASSAY0387 | − | − | − | − | − | − | − | + | − | − |
| ASSAY0388 | − | − | − | − | − | − | − | − | − | + |
| ASSAY0391 | + | − | − | + | − | − | − | − | − | − |
| ASSAY0392 | − | − | − | + | − | + | − | − | − | − |
| ASSAY0393 | − | − | − | + | + | − | − | + | − | − |
| ASSAY0394 | − | − | − | + | − | − | − | + | − | − |
| ASSAY0397 | + | − | − | − | − | − | − | − | − | − |
| ASSAY0399 | − | − | − | − | − | − | + | − | − | − |
| ASSAY0400 | + | − | − | + | − | − | − | + | − | − |
| ASSAY0401 | − | − | − | − | − | − | − | + | + | + |
| ASSAY0402 | − | − | − | + | + | + | − | + | − | − |
| ASSAY0403 | − | − | − | − | − | − | − | − | − | + |
| ASSAY0405 | + | − | − | + | − | + | − | − | − | − |
| ASSAY0407 | − | − | − | + | + | + | − | + | − | + |
| ASSAY0408 | − | − | − | + | + | − | − | − | − | − |
| ASSAY0409 | − | − | − | + | − | − | − | − | − | − |
| ASSAY0410 | − | − | − | − | + | − | − | − | − | − |
| ASSAY0412 | + | − | − | − | − | − | − | − | − | − |
| ASSAY0414 | + | − | − | − | − | − | − | − | − | − |
| ASSAY0415 | − | − | − | − | − | − | − | + | − | − |
| ASSAY0417 | − | − | − | − | − | + | − | − | − | − |
| ASSAY0420 | − | − | − | + | − | − | − | − | − | − |
| ASSAY0421 | + | − | − | + | + | − | − | + | + | + |
| ASSAY0422 | − | − | − | − | − | − | + | − | − | − |
| ASSAY0423 | − | − | − | − | − | − | − | + | + | − |
| ASSAY0424 | + | − | − | − | − | − | − | − | − | − |
| ASSAY0425 | − | − | − | + | + | − | − | + | + | + |
| ASSAY0426 | + | − | − | − | − | − | − | − | − | − |
| ASSAY0427 | − | − | − | + | − | − | − | − | − | − |
| ASSAY0428 | − | − | − | − | − | − | + | − | − | − |
| ASSAY0429 | − | − | − | − | + | − | − | − | + | + |
| ASSAY0431 | + | − | − | + | − | − | − | − | − | − |
| ASSAY0432 | − | − | − | − | + | + | − | + | − | − |
| ASSAY0433 | − | − | − | + | − | − | − | + | − | − |
| ASSAY0434 | − | − | − | − | − | − | − | + | − | + |
| ASSAY0435 | − | − | − | + | − | − | − | − | − | − |
| ASSAY0436 | + | − | − | − | − | − | − | − | − | − |
| ASSAY0437 | − | − | − | + | − | − | − | + | + | − |
| ASSAY0440 | − | − | − | + | + | − | − | − | − | − |
| ASSAY0441 | + | − | − | + | − | − | − | − | − | − |
| ASSAY0442 | − | − | − | + | − | − | − | − | − | − |
| ASSAY0443 | − | − | − | − | + | − | − | − | − | − |
| ASSAY0445 | + | − | − | − | + | − | − | − | − | − |
| ASSAY0446 | + | − | − | − | − | − | − | − | − | − |
| ASSAY0449 | − | − | − | + | − | − | − | − | − | − |
| ASSAY0450 | − | − | − | + | + | + | − | + | − | − |
| ASSAY0451 | − | − | − | − | + | + | − | − | − | + |
| ASSAY0452 | − | − | − | − | − | − | − | − | + | + |
| ASSAY0453 | − | − | − | − | + | + | − | − | − | − |
| ASSAY0455 | − | − | − | − | + | + | − | − | − | − |
| ASSAY0456 | − | − | − | + | + | + | + | − | − | + |
| ASSAY0457 | − | − | − | − | − | − | − | − | − | + |
| ASSAY0458 | − | − | − | − | + | − | + | − | − | − |
| ASSAY0459 | − | − | − | − | + | − | − | − | − | − |
| ASSAY0460 | + | − | + | + | + | − | − | − | − | − |
| ASSAY0461 | + | − | − | − | − | − | − | − | − | − |
| ASSAY0463 | − | − | − | + | − | − | + | + | + | + |
| ASSAY0464 | − | − | − | − | + | + | − | − | − | + |
| ASSAY0465 | − | − | − | − | − | − | − | + | + | − |
| ASSAY0467 | − | − | − | − | + | + | + | − | − | − |
| ASSAY0472 | + | − | − | + | − | − | − | − | − | − |
| ASSAY0473 | − | − | − | − | − | − | − | + | − | − |
| ASSAY0474 | + | − | − | − | + | − | − | − | − | − |
| ASSAY0476 | + | − | − | − | − | + | − | − | − | − |
| ASSAY0477 | − | − | − | − | + | + | − | − | − | − |
| ASSAY0478 | − | − | − | − | + | + | − | + | − | − |
| ASSAY0479 | + | − | − | − | + | − | − | − | − | − |
| ASSAY0480 | − | − | − | + | + | + | − | − | − | − |
| ASSAY0481 | − | − | − | − | + | − | + | − | − | − |
| ASSAY0482 | − | − | − | − | + | + | − | − | − | + |
| ASSAY0483 | + | − | − | − | + | − | − | − | − | − |
| ASSAY0484 | + | − | − | + | + | + | − | + | − | − |
| ASSAY0485 | + | − | − | − | − | − | − | + | − | − |
| ASSAY0486 | − | − | − | − | + | − | − | − | − | + |
| ASSAY0487 | − | − | − | − | − | + | − | − | − | − |
| ASSAY0488 | − | − | − | − | − | + | − | − | − | − |
| ASSAY0489 | − | − | − | + | − | − | + | + | − | − |
| ASSAY0491 | + | − | − | − | − | + | − | − | − | − |
| ASSAY0494 | − | − | − | − | − | − | − | + | − | + |
| ASSAY0495 | − | − | − | − | − | − | − | + | − | − |
| ASSAY0497 | − | − | − | − | − | − | − | + | − | − |
| ASSAY0499 | − | − | − | − | − | − | − | + | − | + |
| ASSAY0500 | + | − | − | − | − | + | − | − | − | − |
| ASSAY0501 | − | − | − | + | − | − | − | − | − | − |
| ASSAY0502 | − | − | − | − | + | − | + | − | − | − |
| ASSAY0504 | − | − | − | − | + | + | − | + | − | − |
| ASSAY0506 | + | − | − | − | − | − | − | − | − | − |
| ASSAY0507 | − | − | − | − | − | − | + | − | − | − |
| ASSAY0509 | − | − | − | − | − | − | − | + | − | − |
| ASSAY0510 | − | − | − | − | − | − | − | + | − | − |
| ASSAY0511 | − | − | − | − | − | − | + | − | − | − |
| ASSAY0512 | − | − | − | − | + | + | − | − | − | + |
| ASSAY0513 | − | − | − | + | − | − | − | + | − | − |
| ASSAY0514 | − | − | − | + | − | − | − | − | − | − |
| ASSAY0516 | − | − | − | − | + | − | − | − | − | − |
| ASSAY0517 | + | − | − | + | − | − | − | + | − | − |
| ASSAY0518 | + | − | − | − | − | − | − | + | − | − |
| ASSAY0521 | − | − | − | − | − | − | − | + | + | + |
| ASSAY0523 | + | − | − | − | + | − | − | − | − | − |
| ASSAY0524 | − | − | − | − | − | − | − | − | + | − |
| ASSAY0526 | + | − | − | + | − | − | − | − | − | − |
| ASSAY0527 | − | − | − | + | − | − | − | − | − | − |
| ASSAY0531 | − | − | − | − | − | + | − | − | − | − |
| ASSAY0532 | + | − | − | − | − | − | + | − | + | − |
| ASSAY0533 | − | − | − | − | − | − | − | − | − | + |
| ASSAY0534 | − | − | − | − | + | − | − | + | + | + |
| ASSAY0535 | + | − | − | + | − | − | − | − | − | + |
| ASSAY0537 | − | − | − | + | − | − | + | − | − | − |
| ASSAY0538 | + | − | − | − | + | − | − | − | − | − |
| ASSAY0539 | + | − | − | − | − | − | − | − | − | − |
| ASSAY0540 | − | − | − | − | + | + | − | − | − | − |
| ASSAY0541 | − | − | − | − | + | + | − | − | − | + |
| ASSAY0542 | − | − | − | − | − | − | + | − | − | − |
| ASSAY0543 | + | − | − | − | + | + | − | − | − | − |
| ASSAY0544 | − | − | − | − | + | − | − | − | − | − |
| ASSAY0545 | − | − | − | − | − | − | − | + | − | − |
| ASSAY0546 | + | − | − | − | + | − | − | − | + | − |
| ASSAY0547 | − | − | − | − | − | + | + | − | − | − |
| ASSAY0548 | − | − | − | + | − | − | − | + | − | − |
| ASSAY0549 | + | − | − | + | − | − | − | + | − | − |
| ASSAY0550 | + | − | − | + | − | − | − | − | − | − |
| ASSAY0551 | − | − | − | − | + | − | − | − | − | − |
| ASSAY0552 | − | − | − | − | + | − | − | − | − | − |
| ASSAY0553 | + | − | − | + | − | − | + | + | − | − |
| ASSAY0555 | − | − | − | + | − | − | − | − | − | − |
| ASSAY0558 | − | − | − | + | − | − | − | − | − | + |
| ASSAY0559 | − | − | − | + | − | − | − | + | − | − |
| ASSAY0560 | − | − | − | − | + | − | − | − | − | − |
| ASSAY0561 | − | − | − | − | − | − | − | + | − | − |
| ASSAY0562 | − | − | − | + | − | − | − | − | − | + |
| ASSAY0563 | − | − | − | − | + | − | − | − | − | − |
| ASSAY0565 | − | − | − | − | + | − | − | − | − | − |
| ASSAY0566 | + | − | − | − | + | − | − | + | − | + |
| ASSAY0567 | − | − | − | − | − | − | − | + | − | − |
| ASSAY0568 | − | − | − | − | + | − | − | + | − | + |
| ASSAY0569 | − | − | − | + | − | − | − | − | − | − |
| ASSAY0570 | − | − | − | − | − | − | + | − | − | − |
| ASSAY0572 | − | − | − | + | + | − | − | + | − | − |
| ASSAY0573 | − | − | − | − | − | − | − | + | − | − |
| ASSAY0574 | − | − | − | − | − | − | − | + | − | − |
| ASSAY0575 | − | − | − | − | − | − | − | + | − | − |
| ASSAY0576 | + | − | − | − | − | + | − | − | − | − |
| ASSAY0577 | − | − | − | + | − | − | − | + | − | − |
| ASSAY0578 | − | − | − | − | − | − | − | + | − | − |
| ASSAY0579 | − | − | − | − | + | + | − | − | − | − |
| ASSAY0580 | + | − | − | − | − | − | − | − | − | − |
| ASSAY0582 | − | − | − | − | − | + | − | − | − | − |
| ASSAY0583 | − | − | − | − | − | − | − | + | − | − |
| ASSAY0584 | + | − | − | + | − | − | + | − | − | − |
| ASSAY0585 | − | − | − | − | + | − | − | − | − | − |
| ASSAY0587 | + | − | − | − | − | − | − | − | − | − |
| ASSAY0588 | + | − | − | + | + | + | − | − | − | − |
| ASSAY0591 | − | − | − | + | − | − | − | + | − | − |
| ASSAY0593 | − | − | − | − | + | − | − | + | + | + |
| ASSAY0596 | − | − | − | − | − | − | − | + | − | − |
| ASSAY0597 | − | − | − | + | + | − | − | − | − | − |
| ASSAY0598 | + | − | − | + | − | − | − | − | − | − |
| ASSAY0599 | − | − | − | + | + | − | − | + | − | − |
| ASSAY0600 | + | − | − | − | − | − | − | − | − | − |
| ASSAY0601 | − | − | − | − | − | − | − | + | − | − |
| ASSAY0603 | − | − | − | − | + | − | − | − | − | + |
| ASSAY0604 | − | − | − | − | − | + | − | − | − | − |
| ASSAY0607 | + | − | − | − | − | − | − | − | − | − |
| ASSAY0608 | − | − | − | + | − | − | − | − | − | − |
| ASSAY0611 | − | − | − | − | + | − | − | − | − | + |
| ASSAY0612 | − | − | − | − | + | − | − | − | − | − |
| ASSAY0613 | − | − | − | − | − | − | − | + | − | − |
| ASSAY0614 | + | − | − | + | − | − | − | + | − | + |
| ASSAY0615 | − | − | − | − | − | − | + | − | − | − |
| ASSAY0616 | − | − | − | − | − | − | − | + | − | − |
| ASSAY0617 | − | − | − | − | + | − | − | − | − | − |
| ASSAY0618 | − | − | − | − | + | − | − | − | − | − |
| ASSAY0619 | − | − | − | − | + | + | + | − | − | − |
| ASSAY0621 | − | − | − | − | − | − | + | − | − | + |
| ASSAY0623 | + | − | − | − | − | − | − | − | − | − |
| ASSAY0624 | − | − | − | + | + | − | − | + | − | − |
| ASSAY0625 | − | − | − | − | + | − | − | + | + | + |
| ASSAY0626 | − | − | − | − | − | − | − | + | − | − |
| ASSAY0627 | − | − | − | − | + | − | − | − | − | − |
| ASSAY0628 | − | − | − | − | + | − | − | − | − | − |
| ASSAY0629 | − | − | − | − | − | − | − | + | − | − |
| ASSAY0632 | − | − | − | − | + | + | − | − | + | + |
| ASSAY0633 | − | − | − | − | − | − | − | + | − | − |
| ASSAY0634 | + | − | − | − | + | − | + | − | − | − |
| ASSAY0637 | − | − | − | + | + | + | − | + | − | − |
| ASSAY0638 | + | − | − | − | + | − | − | + | − | + |
| ASSAY0640 | − | − | − | − | − | − | − | + | − | − |
| ASSAY0641 | − | − | − | − | + | + | + | − | − | − |
| ASSAY0642 | + | − | − | − | − | − | − | − | − | − |
| ASSAY0643 | − | − | − | + | − | − | − | − | − | − |
| ASSAY0644 | − | − | − | − | − | − | − | + | − | − |
| ASSAY0645 | − | − | − | + | + | + | − | + | − | − |
| ASSAY0647 | + | − | − | − | − | − | − | − | − | − |
| ASSAY0648 | + | − | − | − | + | − | − | + | − | + |
| ASSAY0649 | − | − | − | − | − | − | − | + | − | − |
| ASSAY0650 | − | − | − | − | − | − | − | + | − | − |
| ASSAY0651 | + | − | − | + | − | − | − | + | − | − |
| ASSAY0653 | − | − | − | + | + | − | − | − | − | − |
| ASSAY0654 | − | − | − | − | + | − | − | − | − | + |
| ASSAY0655 | + | − | − | + | − | − | − | + | − | − |
| ASSAY0656 | + | − | − | + | + | + | − | + | − | − |
| ASSAY0657 | − | − | − | − | + | − | − | − | − | − |
| ASSAY0659 | − | − | − | − | − | + | − | − | − | − |
| ASSAY0660 | − | − | − | − | + | + | − | + | − | − |
| ASSAY0661 | − | − | − | + | − | − | − | + | + | + |
| ASSAY0662 | + | − | − | − | − | − | − | − | − | − |
| ASSAY0664 | + | − | − | + | − | − | − | − | − | − |
| ASSAY0665 | − | − | − | − | + | + | − | − | − | − |
| ASSAY0666 | − | − | − | − | − | − | − | − | + | − |
| ASSAY0667 | + | − | − | − | − | + | + | − | − | − |
| ASSAY0668 | − | − | − | + | − | − | − | + | − | − |
| ASSAY0669 | + | − | − | − | − | − | − | − | − | − |
| ASSAY0670 | − | − | − | + | − | − | − | − | − | − |
| ASSAY0671 | − | − | − | + | − | − | − | − | − | − |
| ASSAY0672 | − | − | − | − | + | + | − | − | − | − |
| ASSAY0673 | + | − | − | − | − | − | − | − | − | − |
| ASSAY0674 | − | − | − | + | − | − | − | − | + | − |
| ASSAY0675 | + | − | − | − | − | − | − | − | − | − |
| ASSAY0676 | − | − | − | − | + | + | + | − | − | − |
| ASSAY0677 | + | − | − | + | + | + | − | − | − | − |
| ASSAY0678 | − | − | − | − | − | + | + | − | − | − |
| ASSAY0679 | − | − | − | − | − | − | − | − | + | − |
| ASSAY0682 | − | − | − | + | − | − | + | − | − | − |
| ASSAY0683 | − | − | − | + | + | − | + | − | + | − |
| ASSAY0684 | − | − | − | + | + | + | − | + | + | + |
| ASSAY0686 | + | − | − | − | + | + | − | + | + | + |
| ASSAY0687 | − | − | − | − | − | − | − | + | − | − |
| ASSAY0689 | − | − | − | − | − | − | − | − | + | + |
| ASSAY0691 | − | − | − | + | − | − | − | − | − | − |
| ASSAY0692 | − | − | − | + | − | − | − | − | − | − |
| ASSAY0693 | − | − | − | + | − | − | − | − | − | − |
| ASSAY0695 | − | − | − | + | − | − | − | + | − | − |
| ASSAY0696 | − | − | − | − | − | + | − | − | − | − |
| ASSAY0697 | − | − | − | − | + | − | − | − | − | − |
| ASSAY0698 | + | − | − | − | − | − | − | − | − | − |
| ASSAY0699 | − | − | − | + | − | − | − | − | − | − |
| ASSAY0701 | + | − | − | − | − | − | − | − | − | − |
| ASSAY0702 | + | − | − | + | − | − | − | + | − | − |
| ASSAY0703 | − | − | − | − | − | − | − | − | − | + |
| ASSAY0704 | − | − | − | − | − | + | − | − | − | − |
| ASSAY0706 | − | − | − | + | − | − | − | − | − | − |
| ASSAY0709 | − | − | − | + | − | + | − | − | − | + |
| ASSAY0710 | − | − | − | − | + | + | − | − | − | + |
| ASSAY0712 | − | − | − | − | − | + | − | + | − | − |
| ASSAY0713 | − | − | − | + | + | + | − | + | − | − |
| ASSAY0714 | − | − | − | − | + | + | − | − | − | + |
| ASSAY0715 | − | − | − | − | + | + | − | − | − | − |
| ASSAY0716 | + | − | − | − | − | − | − | − | − | − |
| ASSAY0718 | − | − | − | − | − | − | − | − | + | + |
| ASSAY0719 | − | − | − | − | + | − | − | − | + | + |
| ASSAY0720 | − | − | − | + | + | − | − | − | − | + |
| ASSAY0722 | − | − | − | − | − | − | − | + | − | − |
| ASSAY0723 | + | − | − | − | + | − | − | − | − | − |
| ASSAY0724 | − | − | − | − | − | + | − | − | − | − |
| ASSAY0725 | − | − | − | − | − | − | − | + | − | − |
| ASSAY0726 | − | − | − | − | − | + | − | − | + | + |
| ASSAY0727 | − | − | − | − | − | − | − | + | − | − |
| ASSAY0728 | + | − | − | − | + | − | − | − | − | − |
| ASSAY0729 | + | − | − | − | − | − | + | − | − | − |
| ASSAY0733 | − | − | − | − | + | − | − | − | − | − |
| ASSAY0734 | + | − | − | + | − | − | − | + | − | − |
| ASSAY0736 | − | − | − | − | + | + | − | − | − | − |
| ASSAY0739 | − | − | − | − | + | − | − | − | − | − |
| ASSAY0740 | − | − | − | − | − | − | − | − | + | + |
| ASSAY0741 | − | − | − | + | + | + | + | − | + | − |
| ASSAY0743 | − | − | − | − | + | + | + | − | − | − |
| ASSAY0744 | − | − | − | − | − | − | − | + | − | − |
| ASSAY0745 | − | − | − | + | − | − | − | + | − | − |
| ASSAY0746 | − | − | − | − | + | − | − | − | − | − |
| ASSAY0748 | − | − | − | − | + | + | − | + | − | + |
| ASSAY0749 | + | − | − | − | − | + | − | − | − | − |
| ASSAY0750 | − | − | − | + | − | − | − | − | − | − |
| ASSAY0751 | − | − | − | + | − | − | + | − | − | − |
| ASSAY0752 | − | − | − | + | + | − | − | − | − | − |
| ASSAY0753 | − | − | − | − | + | + | + | − | − | + |
| ASSAY0754 | − | − | − | + | + | − | − | + | + | + |
| ASSAY0755 | + | − | − | + | − | − | − | − | − | − |
| ASSAY0756 | − | − | − | − | + | − | − | − | + | − |
| ASSAY0758 | − | − | + | + | − | − | − | − | − | + |
| ASSAY0759 | + | − | + | + | − | − | − | − | − | − |
| ASSAY0760 | − | − | − | − | + | − | − | − | − | − |
| ASSAY0762 | − | − | − | + | − | − | − | − | − | − |
| ASSAY0763 | + | − | − | + | − | − | − | + | − | − |
| ASSAY0766 | − | − | − | + | − | − | − | − | − | − |
| ASSAY0767 | + | − | − | + | − | − | − | − | − | − |
| ASSAY0771 | + | − | − | − | − | − | − | − | − | − |
| ASSAY0772 | + | − | − | − | − | − | − | − | − | − |
| ASSAY0773 | − | − | − | + | − | − | − | − | − | − |
| ASSAY0774 | − | − | − | + | − | − | − | − | − | − |
| ASSAY0778 | − | − | − | + | − | − | − | + | − | − |
| ASSAY0780 | − | − | − | − | + | + | − | − | − | − |
| ASSAY0781 | − | − | − | − | + | − | − | + | − | − |
| ASSAY0782 | + | − | − | + | − | − | − | − | − | + |
| ASSAY0784 | − | − | − | + | − | − | − | + | − | − |
| ASSAY0785 | + | − | − | − | − | − | − | − | − | − |
| ASSAY0786 | − | − | − | − | − | − | − | − | + | − |
| ASSAY0790 | + | − | − | + | − | − | − | − | − | − |
| ASSAY0792 | + | − | − | + | − | − | − | − | − | − |
| ASSAY0793 | − | − | − | + | − | − | − | − | − | − |
| ASSAY0794 | − | − | − | + | − | − | − | − | − | − |
| ASSAY0795 | + | − | − | + | − | − | − | + | + | − |
| ASSAY0797 | + | − | − | − | + | + | + | + | − | − |
| ASSAY0798 | − | − | − | − | + | − | − | − | − | − |
| ASSAY0799 | − | − | − | − | + | − | − | − | + | − |
| ASSAY0801 | − | − | − | + | − | − | − | − | − | − |
| ASSAY0802 | − | − | − | − | + | + | − | − | − | − |
| ASSAY0804 | − | − | − | − | − | − | + | − | − | − |
| ASSAY0805 | + | − | − | − | + | − | − | − | − | − |
| ASSAY0806 | − | − | − | + | − | − | − | + | − | − |
| ASSAY0807 | − | − | − | − | + | + | − | − | − | − |
| ASSAY0809 | − | − | − | + | − | − | − | − | − | − |
| ASSAY0810 | − | − | − | − | + | + | − | − | − | − |
| ASSAY0811 | − | − | − | + | − | − | − | − | − | − |
| ASSAY0814 | + | − | − | − | + | + | + | − | − | − |
| ASSAY0817 | + | − | − | − | − | − | − | − | − | − |
| ASSAY0818 | − | − | − | − | − | + | − | + | − | − |
| ASSAY0819 | + | − | − | − | + | + | − | − | − | − |
| ASSAY0820 | − | − | − | + | − | + | + | + | − | + |
| ASSAY0821 | − | − | − | + | − | − | − | + | − | − |
| ASSAY0822 | − | − | − | + | − | − | − | + | − | − |
| ASSAY0826 | − | − | − | + | + | − | + | − | − | − |
| ASSAY0827 | − | − | − | − | + | + | − | − | − | + |
| ASSAY0831 | − | − | − | − | + | − | − | − | − | − |
| ASSAY0833 | + | − | − | + | − | − | − | − | − | − |
| ASSAY0834 | − | − | − | − | + | + | − | − | − | − |
| ASSAY0835 | − | − | − | + | − | − | − | − | − | + |
| ASSAY0836 | − | − | − | − | + | + | + | − | − | + |
| ASSAY0838 | + | − | − | + | − | − | − | − | − | − |
| ASSAY0841 | + | − | − | − | − | − | − | − | − | − |
| ASSAY0842 | + | − | − | + | − | − | − | + | − | − |
| ASSAY0843 | − | − | − | + | − | − | − | + | − | − |
| ASSAY0844 | − | − | − | − | + | + | + | + | − | − |
| ASSAY0846 | − | − | − | − | + | − | − | − | − | − |
| ASSAY0847 | + | − | − | − | − | − | − | − | − | − |
| ASSAY0850 | − | − | − | + | − | − | − | − | − | − |
| ASSAY0853 | + | − | − | − | − | − | − | − | − | − |
| ASSAY0854 | − | − | − | − | + | + | − | − | − | − |
| ASSAY0856 | − | − | − | − | + | + | + | − | − | + |
| ASSAY0857 | − | − | − | − | + | − | − | − | − | − |
| ASSAY0858 | − | − | − | − | + | + | − | − | − | − |
| ASSAY0859 | − | − | − | + | − | − | − | − | − | − |
| ASSAY0861 | + | − | − | − | + | − | − | − | − | − |
| ASSAY0862 | − | − | − | + | − | − | − | + | − | − |
| ASSAY0863 | − | − | − | + | − | − | − | − | − | − |
| ASSAY0865 | − | − | − | − | + | − | − | − | − | − |
| ASSAY0866 | − | − | − | − | − | − | − | + | − | − |
| ASSAY0867 | − | − | − | + | − | − | − | − | − | − |
| ASSAY0869 | − | − | − | − | − | − | − | − | − | + |
| ASSAY0871 | − | − | − | − | + | + | + | − | − | − |
| ASSAY0874 | − | − | − | − | − | − | − | + | + | − |
| ASSAY0876 | − | − | − | + | + | − | − | + | − | − |
| ASSAY0878 | + | − | + | − | − | − | − | − | − | − |
| ASSAY0879 | − | − | − | + | − | − | − | − | − | − |
| ASSAY0882 | − | − | − | − | + | − | − | + | − | − |
| ASSAY0883 | − | − | − | + | − | − | − | − | − | − |
| ASSAY0885 | − | − | − | − | − | − | − | + | − | − |
| ASSAY0886 | + | − | − | + | + | − | − | + | − | + |
| ASSAY0887 | − | − | − | − | − | − | − | + | − | − |
| ASSAY0888 | − | − | − | − | + | + | + | − | − | − |
| ASSAY0893 | − | − | − | − | + | − | − | − | − | − |
| ASSAY0894 | − | − | − | − | + | − | − | − | − | − |
| ASSAY0895 | − | − | − | − | − | − | − | + | − | − |
| ASSAY0897 | − | − | − | + | − | − | − | − | − | − |
| ASSAY0899 | − | − | − | − | − | − | − | + | − | + |
| ASSAY0900 | + | − | − | − | + | + | − | − | − | + |
| ASSAY0903 | + | − | − | − | − | − | − | − | − | − |
| ASSAY0904 | + | − | − | + | − | − | − | − | − | + |
| ASSAY0906 | − | − | + | − | − | − | − | − | − | − |
| ASSAY0907 | − | − | − | + | − | − | − | − | − | − |
| ASSAY0910 | + | − | − | − | − | − | − | − | − | − |
| ASSAY0911 | − | − | − | + | − | − | − | − | − | − |
| ASSAY0912 | − | − | − | − | − | − | − | + | + | + |
| ASSAY0913 | − | − | − | + | − | − | − | − | − | − |
| ASSAY0914 | − | − | − | + | + | − | + | − | − | − |
| ASSAY0916 | − | − | − | − | + | + | + | − | − | − |
| ASSAY0917 | + | − | − | − | − | − | − | − | − | − |
| ASSAY0919 | − | − | − | + | − | − | − | + | − | + |
| ASSAY0921 | − | − | − | − | − | − | − | + | − | − |
| ASSAY0922 | + | − | − | + | − | − | − | + | − | − |
| ASSAY0923 | − | − | − | − | + | + | − | − | − | + |
| ASSAY0924 | − | − | − | − | + | − | − | − | − | − |
| ASSAY0925 | − | − | − | − | + | − | + | − | − | − |
| ASSAY0927 | − | − | − | − | − | − | − | + | − | − |
| ASSAY0928 | + | − | − | − | − | − | − | − | − | − |
| ASSAY0929 | − | − | − | − | + | − | − | − | − | − |
| ASSAY0931 | − | − | − | + | − | − | − | − | − | − |
| ASSAY0933 | − | − | − | − | + | − | − | − | − | − |
| ASSAY0934 | − | − | − | − | + | − | − | − | − | − |
| ASSAY0935 | − | − | − | + | − | − | − | + | + | − |
| ASSAY0936 | − | − | − | − | + | − | − | − | − | − |
| ASSAY0938 | + | − | − | − | − | − | − | − | − | − |
| ASSAY0939 | − | − | − | + | − | − | − | − | − | − |
| ASSAY0941 | − | − | − | − | + | − | + | + | − | − |
| ASSAY0943 | + | − | − | − | − | − | − | − | − | − |
| ASSAY0944 | − | − | − | + | + | − | − | − | − | − |
| ASSAY0947 | − | − | − | + | − | − | + | + | − | − |
| ASSAY0948 | + | − | − | + | − | − | − | − | − | − |
| ASSAY0950 | + | − | − | + | + | − | − | − | − | − |
| ASSAY0951 | − | − | − | − | + | − | − | − | − | − |
| ASSAY0953 | + | − | − | − | − | − | − | − | − | − |
| ASSAY0957 | − | − | − | + | − | − | − | + | − | − |
| ASSAY0959 | − | − | − | + | − | + | − | − | − | − |
| ASSAY0960 | + | − | − | − | − | − | − | + | + | − |
| ASSAY0962 | − | − | − | + | + | + | − | + | + | + |
| ASSAY0964 | − | − | − | + | − | − | − | − | − | − |
| ASSAY0966 | − | − | − | + | − | + | − | − | − | + |
| ASSAY0968 | − | − | − | + | − | − | − | − | − | − |
| ASSAY0969 | − | − | − | + | − | − | − | + | − | − |
| ASSAY0970 | − | − | − | − | + | − | − | − | − | − |
| ASSAY0971 | + | − | − | + | − | − | − | + | − | − |
| ASSAY0976 | + | − | − | − | − | − | + | − | − | − |
| ASSAY0978 | + | − | − | + | − | − | − | − | − | − |
| ASSAY0980 | − | − | − | − | + | − | − | − | − | − |
| ASSAY0982 | − | − | − | − | + | − | − | − | − | − |
| ASSAY0983 | + | − | − | − | − | − | − | − | − | − |
| ASSAY0985 | + | − | − | − | − | − | − | − | − | − |
| ASSAY0986 | − | − | − | − | − | − | − | + | − | − |
| ASSAY0987 | − | − | − | − | − | − | − | + | − | − |
| ASSAY0988 | − | − | − | − | − | + | − | − | − | − |
| ASSAY0990 | − | − | − | + | − | − | − | − | − | − |
| ASSAY0992 | + | − | − | − | − | − | − | − | + | − |
| ASSAY0994 | − | − | − | + | − | − | − | − | − | − |
| ASSAY0996 | + | − | − | − | + | + | − | − | − | − |
| ASSAY0997 | − | − | − | − | − | − | − | + | − | − |
| ASSAY0998 | + | − | − | − | + | − | − | − | − | − |
| ASSAY1000 | + | − | − | − | + | + | − | − | + | − |
| ASSAY1001 | − | − | − | − | + | − | − | − | − | − |
| ASSAY1002 | − | − | − | − | − | − | − | + | − | − |
| ASSAY1004 | − | − | − | − | + | − | − | + | − | − |
| ASSAY1006 | + | − | − | + | − | − | − | − | − | − |
| ASSAY1007 | − | − | − | − | − | − | − | + | − | − |
| ASSAY1010 | + | − | − | − | + | − | − | − | − | − |
| ASSAY1011 | + | − | − | − | − | − | − | − | − | − |
| ASSAY1012 | + | − | − | − | − | − | − | − | − | − |
| ASSAY1014 | − | − | − | − | − | − | + | − | − | − |
| ASSAY1017 | + | − | + | − | − | − | − | − | − | − |
| ASSAY1018 | + | − | − | − | − | − | − | − | − | − |
| ASSAY1019 | − | − | − | − | − | − | − | + | − | − |
| ASSAY1022 | − | − | − | + | − | − | − | − | − | − |
| ASSAY1023 | − | − | − | + | − | − | + | − | − | − |
| ASSAY1024 | + | − | − | + | − | − | − | − | − | + |
| ASSAY1025 | + | − | + | + | + | − | − | − | − | − |
| ASSAY1026 | + | − | − | + | + | − | + | + | − | − |
| ASSAY1029 | − | − | − | + | − | − | − | − | − | − |
| ASSAY1030 | − | − | − | − | + | − | − | − | − | − |
| ASSAY1033 | + | − | − | − | − | − | − | − | − | − |
| ASSAY1035 | − | − | − | − | − | − | + | − | − | + |
| ASSAY1036 | − | − | − | + | + | − | − | − | − | − |
| ASSAY1037 | + | − | − | − | − | − | − | + | − | − |
| ASSAY1039 | − | − | − | + | − | − | − | + | + | + |
| ASSAY1040 | + | − | − | − | − | − | − | − | − | − |
| ASSAY1041 | + | − | − | − | − | − | − | − | − | − |
| ASSAY1042 | − | − | − | − | + | − | − | + | − | − |
| ASSAY1044 | + | − | − | − | − | − | − | − | − | − |
| ASSAY1045 | − | − | − | + | − | − | − | − | − | − |
| ASSAY1046 | − | − | − | + | − | − | − | − | − | − |
| ASSAY1047 | + | − | − | − | − | − | − | − | + | − |
| ASSAY1048 | − | − | − | − | + | − | − | − | − | − |
| ASSAY1051 | − | − | − | − | − | − | − | + | − | − |
| ASSAY1052 | − | − | − | + | − | − | − | − | − | − |
| ASSAY1053 | − | − | − | + | − | − | − | − | − | − |
| ASSAY1055 | − | − | − | − | − | − | − | − | − | + |
| ASSAY1056 | + | − | − | − | + | − | − | − | − | − |
| ASSAY1057 | − | − | − | + | − | − | − | − | − | − |
| ASSAY1058 | + | − | − | − | − | − | − | + | − | − |
| ASSAY1059 | + | − | − | + | − | − | − | + | − | − |
| ASSAY1061 | − | − | − | + | − | − | − | + | − | − |
| ASSAY1063 | − | − | − | + | − | − | − | − | − | − |
| ASSAY1064 | − | − | − | − | + | − | − | + | − | − |
| ASSAY1065 | − | − | + | − | − | − | − | − | − | − |
| ASSAY1066 | − | − | − | − | − | + | − | − | − | − |
| ASSAY1071 | − | − | − | − | − | + | − | − | − | − |
| ASSAY1074 | − | − | − | + | − | − | − | − | − | − |
| ASSAY1075 | + | − | − | − | − | − | − | − | − | − |
| ASSAY1077 | − | − | − | − | − | − | − | − | + | − |
| ASSAY1078 | − | − | − | + | − | − | − | + | − | − |
| ASSAY1079 | + | − | − | − | − | − | − | − | − | + |
| ASSAY1081 | + | − | − | − | − | − | − | − | + | − |
| ASSAY1082 | − | − | − | + | − | − | − | − | − | − |
| ASSAY1083 | − | − | − | − | + | − | − | − | − | − |
| ASSAY1084 | − | − | − | + | + | − | − | + | − | + |
| ASSAY1086 | + | − | − | − | − | − | − | − | − | − |
| ASSAY1087 | − | − | − | − | − | + | − | − | − | − |
| ASSAY1088 | + | − | − | + | + | − | − | − | − | − |
| ASSAY1090 | − | − | − | + | − | − | − | − | − | − |
| ASSAY1093 | − | − | − | + | − | − | − | + | + | − |
| ASSAY1094 | + | − | − | + | − | − | − | − | − | − |
| ASSAY1095 | + | − | − | − | − | + | − | − | − | − |
| ASSAY1096 | − | − | − | + | + | − | − | − | − | − |
| ASSAY1097 | − | − | − | + | − | − | − | + | − | − |
| ASSAY1099 | + | − | − | − | − | − | − | − | − | + |
| ASSAY1100 | − | − | − | − | + | − | − | − | − | − |
| ASSAY1101 | − | − | + | + | + | − | − | − | − | − |
| ASSAY1102 | + | − | − | + | − | − | − | − | − | − |
| ASSAY1103 | + | − | − | − | − | − | − | + | − | − |
| ASSAY1104 | + | − | − | − | + | − | − | − | − | + |

TABLE 2
Informative probes for Stable MCI versus Converting MCI
Assays with p values <0.05 are marked with an asterisk.

| Sequence No. | | | | |
|---|---|---|---|---|
| (DiaGenic | | Gene | | Context Sequence |
| Assay ID) | TaqMan Assay ID | Symbol | Gene name | (Oligonucleotide sequence) |
| ASSAY0006 | Hs00220373_m1 | SLC12A9 | solute carrier family 12 | CTCCGGCCTCGGTGGCATGAAGCCC |
| | | | (potassium/chloride | |
| | | | transporters), | |
| | | | member 9 | |
| ASSAY0012 | Hs00158122_m1 | ISG20 | interferon stimulated | GCATCCAGAACAGCCTGCTTGGACA |
| | | | exonuclease gene 20 kDa | |
| ASSAY0015* | Hs00174469_m1 | KLRB1 | killer cell lectin-like | TTCCTCGGGATGTCTGTCAGGGTTC |
| | | | receptor subfamily B, | |
| | | | member 1 | |
| ASSAY0017 | Hs00179345_m1 | MAP4K1 | mitogen-activated | CTCTCTCAGGAAAGACCCCCCACCT |
| | | | protein kinase kinase | |
| | | | kinase kinase 1 | |
| ASSAY0027 | Hs00191312_m1 | NMT2 | N-myristoyltransferase | TTCGGATTTATGACAGTGTGAAGAA |
| | | | 2 | |
| ASSAY0032 | Hs00200394_m1 | RASSF1 | Ras association | GAGGTGAACTGGGACGCCTTCAGCA |
| | | | (RaIGDS/AF-6) | |
| | | | domain family member 1 | |
| ASSAY0037 | Hs00218384_m1 | CAND1 | cullin-associated and | GTACAACTAAGGTAAAGGCAAACTC |
| | | | neddylation- | |
| | | | dissociated 1 | |
| ASSAY0040 | Hs00219196_m1 | YIPF1 | Yip1 domain family, | TGGGCTGCTTGGCATACTTTTTTGA |
| | | | member 1 | |
| ASSAY0044 | Hs00219931_m1 | LARS | leucyl-tRNA synthetase | TTTTCAGCAGATGGAATGCGTTTGG |
| ASSAY0046 | Hs00220176_m1 | ENY2 | enhancer of yellow 2 | CGCGGTGATGGTGGTTAGCAAGATG |
| | | | homolog (Drosophila) | |
| ASSAY0053 | Hs00221104_m1 | ABHD6 | abhydrolase domain | CGTGTGTCCTGCTGGCCTGCAGTAC |
| | | | containing 6 | |
| ASSAY0063 | Hs00223860_m1 | ZMAT3 | zinc finger, matrin | AGTACAGAATAATTCAGCAGGTCCT |
| | | | type 3 | |
| ASSAY0065 | Hs00224328_m1 | CRTC3 | CREB regulated | TACCTCCCAGATGGTGTCCTCAGAC |
| | | | transcription | |
| | | | coactivator 3 | |
| ASSAY0069* | Hs00225647_m1 | GNPTAB | N-acetylglucosamine-1- | TCGGAGAGGTGGTTCTGGAATGGAG |
| | | | phosphate transferase, | |
| | | | alpha and beta subunits | |
| ASSAY0084 | Hs00229849_m1 | ADPGK | ADP-dependent | GCATTGTCCATCAGGTCTTTCCCGC |
| | | | glucokinase | |
| ASSAY0085* | Hs00229911_m1 | APH1B | anterior pharynx | TCATCGCCGGAGCTTTCTTCTGGTT |
| | | | defective 1 homolog B | |
| | | | (C. elegans) | |
| ASSAY0087 | Hs00230261_m1 | CD99L2 | CD99 molecule-like 2 | GCATTCAGCAGGGTCTCAACGCAGA |
| ASSAY0088 | Hs00230572_m1 | TM2D2 | TM2 domain containing 2 | GTTGTCTCAAGTTCGGCGGTCAGGC |
| ASSAY0093* | Hs00233856_m1 | LRP1 | low density lipoprotein | CCCCTGAGATTTGTCCACAGAGTAA |
| | | | receptor-related | |
| | | | protein 1 | |
| ASSAY0103 | Hs00154250_m1 | CASP6 | caspase 6, apoptosis- | GTGTTACTCTGTTGCAGAAGGATAT |
| | | | related cysteine | |
| | | | peptidase | |
| ASSAY0112* | Hs00157403_m1 | EPHX2 | epoxide hydrolase 2, | ACGTGACAGTAAAGCCCAGGGTCCG |
| | | | cytoplasmic | |
| ASSAY0116 | Hs00158113_m1 | IRF5 | interferon regulatory | CCGCAGACAGACCCCTCTGCCATGA |
| | | | factor 5 | |
| ASSAY0117* | Hs00158114_m1 | IRF5 | interferon regulatory | ACACCATCTTCAAGGCCTGGGCCAA |
| | | | factor 5 | |
| ASSAY0120 | Hs00159668_m1 | NRD1 | nardilysin (N-arginine | TGTCACAAGCACAGAATCTATGGAT |
| | | | dibasic convertase) | |
| ASSAY0122 | Hs00160118_m1 | PLD1 | phospholipase D1, | CTTAAACGAAAAGCACAACAAGGAG |
| | | | phosphatidylcholine- | |
| | | | specific | |
| ASSAY0126* | Hs00162077_m1 | SOAT1 | sterol O- | CCATCTTGCCAGGTGTGCTGATTCT |
| | | | acyltransferase 1 | |
| ASSAY0128 | Hs00163761_m1 | BTK | Bruton | GTCAGGACTGAGCACACAGGTGAAC |
| | | | agammaglobulinemia | |
| | | | tyrosine kinase | |
| ASSAY0138 | Hs00171585_m1 | CREG1 | cellular repressor of | TGAGCAACCTGCAGGAGAATCCATA |
| | | | E1A-stimulated genes 1 | |
| ASSAY0141 | Hs00173570_m1 | GRN | granulin | GTCGGACGCAGGCAGACCATGTGGA |
| ASSAY0147* | Hs00174179_m1 | ACE | angiotensin I converting | AAGGACTTCCGGATCAAGCAGTGCA |
| | | | enzyme (peptidyl- | |
| | | | dipeptidase A) 1 | |
| ASSAY0150* | Hs00174705_m1 | CD163 | CD163 molecule | ACCTGCTCAGCCCACAGGGAACCCA |
| ASSAY0153 | Hs00175195_m1 | CTSG | cathepsin G | GCTGGGGAAGCAATATAAATGTCAC |
| ASSAY0157 | Hs00175591_m1 | PRNP | prion protein | CACGACCGAGGCAGAGCAGTCATTA |
| ASSAY0158 | Hs00176666_m1 | ITPKB | inositol 1,4,5- | GCAAGATGGGAATCAGGACCTACCT |
| | | | triphosphate 3-kinase B | |
| ASSAY0160* | Hs00176973_m1 | PRKCA | protein kinase C, alpha | GAACCACAAGCAGTATTCTATGCGG |
| ASSAY0165 | Hs00177790_m1 | STK17B | serine/threonine | TGATATTGGAATATGCTGCAGGTGG |
| | | | kinase 17b | |
| ASSAY0178 | Hs00186661_m1 | NCOA1 | nuclear receptor | CACCTCAGCCACCCCTGAATGCTCA |
| | | | coactivator 1 | |
| ASSAY0183 | Hs00188713_m1 | BAG3 | BCL2-associated | GGGCCCCAAGGAGACTCCATCCTCT |
| | | | athanogene 3 | |
| ASSAY0195 | Hs00165445_m1 | PEPD | peptidase D | GAGTTGGAAAGCCTCTTCGAGCACT |
| ASSAY0198 | Hs00174128_m1 | TNF | tumor necrosis factor | TAGCCCATGTTGTAGCAAACCCTCA |
| | | | (TNF superfamily, | |
| | | | member 2) | |
| ASSAY0207 | Hs00196206_m1 | GZMA | granzyme A (granzyme 1, | CCTGCTAATTCCTGAAGATGTCTGT |
| | | | cytotoxic T-lymphocyte- | |
| | | | associated serine | |
| | | | esterase 3) | |
| ASSAY0211 | Hs00203341_m1 | CNOT4 | CCR4-NOT transcription | GATAATTCCCAGCAGATATCTAACA |
| | | | complex, subunit 4 | |
| ASSAY0221 | Hs00215267_m1 | TMEM127 | transmembrane protein | CCCGGACCTGCTGAAAGATTTCTGC |
| | | | 127 | |
| ASSAY0222* | Hs00215631_m1 | MARCH1 | membrane-associated | AGGACATCTGCAGAATCTGTCACTG |
| | | | ring finger (C3HC4) 1 | |
| ASSAY0226 | Hs00220138_m1 | LXN | latexin | ACAAGCCAGCATGGAGGATATTCCA |
| ASSAY0232 | Hs00255879_m1 | GFOD1 | glucose-fructose | AAACCCTAGGCATCGGCAAGAACGT |
| | | | oxidoreductase domain | |
| | | | containing 1 | |
| ASSAY0234 | Hs00266026_m1 | IGFBP7 | insulin-like growth | GCACCTGCGAGCAAGGTCCTTCCAT |
| | | | factor binding protein 7 | |
| ASSAY0245 | Hs00326671_m1 | TTC14 | tetraticopeptide | AGAGAGAGGAGGACAGTTAGAAGAA |
| | | | repeat domain 14 | |
| ASSAY0246* | Hs00330168_m1 | DNHD1 | dynein heavy chain | GGGCGCTGGAGTCAAGTGACTCTAA |
| | | | domain 1 | |
| ASSAY0251* | Hs00367259_m1 | GOLGA8B; | golgin A8 family member | AGAAGCCGGATGGGTTCTCGAGCCG |
| | | GOLGA8A | B; golgin A8 family, | |
| | | | member A | |
| ASSAY0252 | Hs00369741_m1 | SELM | selenoprotein M | CGCGCCCGGGTAGAGACCTGCGGGG |
| ASSAY0259 | Hs00415782_m1 | TMEM179B | transmembrane | CTCGGACCCAGGGCTCCTTCAGTGG |
| | | | protein 179B | |
| ASSAY0265 | Hs00606772_g1 | SH3BGRL3 | SH3 domain binding | CACCGGCTCCCGCGAAATCAAGTCC |
| | | | glutamic acid-rich | |
| | | | protein like 3 | |
| ASSAY0273 | Hs00910358_s1 | MDM4 | Mdm4 p53 binding | TGCATTCTTGCCTAGTTTTCCTTAT |
| | | | protein homolog (mouse) | |
| ASSAY0278 | Hs01092416_s1 | N/A | N/A | GTGTGAAGATCCAGCCTGATGCCCA |
| ASSAY0289 | Hs00194817_m1 | ARPC1B | actin releated protein | CGCGGGAGGAGCCAAGCCGCCATGG |
| | | | 2/3 complex, subunit | |
| | | | 1B, 41 kDa | |
| ASSAY0302 | Hs00198676_m1 | TCERG1 | transcription | TACTCCATGGTGTGTCGTTTGGACT |
| | | | elongation regulator 1 | |
| ASSAY0307 | Hs00199894_m1 | CD160 | CD160 molecule | GGCCCTTCAAGCTTTGTAAGCCTTG |
| ASSAY0315* | Hs00201734_m1 | CCNDBP1 | cyclin D-type | TGCCGTCTCCACAGGAAACCCAGAA |
| | | | binding-protein 1 | |
| ASSAY0316* | Hs00201825_m1 | FBXO7 | F-box protein 7 | ATCTGCGTGATTTTCGAGACAATAC |
| ASSAY0321 | Hs00202956_m1 | PRPF6 | PRP6 pre-mRNA | CGTGGCCAAGCTGTTTTGGAGTCAG |
| | | | processing factor 6 | |
| | | | homolog (S. cerevisiae) | |
| ASSAY0334 | Hs00206922_m1 | CP110 | CP110 protein | TCTCCACTGCTTAACATTGAGAAAA |
| ASSAY0335 | Hs00207926_m1 | SEC24D | SEC24 family, member D | CAGCAAGCCAGCTTATTCTACCAGA |
| | | | (S. cerevisiae) | |
| ASSAY0338 | Hs00209768_m1 | C17orf81 | chromosome 17 open | GATATCAACAATCGGCTGGTTTACC |
| | | | reading frame 81 | |
| ASSAY0339 | Hs00209887_m1 | ABHD14A | abhydrolase domain | GCCCTTGACCTTCCAGGTTTTGGGA |
| | | | containing 14A | |
| ASSAY0340 | Hs00210194_m1 | SIPA1L1 | signal-induced | ACTAGAGAGGCGGCTGTCTCCTGGT |
| | | | proliferation- | |
| | | | associated 1 like 1 | |
| ASSAY0347 | Hs00211458_m1 | C2orf28 | chromosome 2 open | GGCACCATCTTGGGGCTGGATCTCC |
| | | | reading frame 28 | |
| ASSAY0368* | Hs00216278_m1 | CEP192 | centrosomal protein | GCGCCAGAGAGTAAACTACAAATTC |
| | | | 192 kDa | |
| ASSAY0374 | Hs00218284_m1 | TBC1D2 | TBC1 domain family, | CTTCTGACGAAGTGCGCCTACCTCC |
| | | | member 2 | |
| ASSAY0370 | Hs00607710_m1 | ZCCHC9 | zinc finger, CCHC | GGCAAAGAAAAATGCAATGGTGTGT |
| | | | domain containing 9 | |
| ASSAY0380 | Hs00609603_m1 | ACVR2B | activin A receptor, | ATTGCCCACAGGGACTTTAAAAGTA |
| | | | type IIB | |
| ASSAY0382 | Hs00706913_g1 | PCNP | PEST proteolytic | AATGTAGGCAAACTATCAATTTTTT |
| | | | signal containing | |
| | | | nuclear protein | |
| ASSAY0386 | Hs00255388_m1 | LUC7L2 | LUC7-like 2 | GTAGCAGCAAAGGCAGAACGTGTTC |
| | | | (S. cerevisiae) | |
| ASSAY0391* | Hs00272972_m1 | MYST2 | MYST histone | CCAGGCACCAGGCACCAACGGAGAG |
| | | | acetyltransferase 2 | |
| ASSAY0397 | Hs00369386_s1 | N/A | N/A | ACCTCCCTCCCATGGAAGTGCTGTC |
| ASSAY0400 | Hs00379387_m1 | RAD54L2 | RAD54-like 2 | GGCTGCCTCAGGTTCCCAGGGACCT |
| | | | (S. cerevisiae) | |
| ASSAY0405* | Hs00415453_g1 | TRA@ | T cell receptor alpha | TGGATTCAGTTGGCATGGGTGAGCA |
| | | | locus | |
| ASSAY0412 | Hs00607978_s1 | CXCR4 | chemokine (C-X-C motif) | TCCTGTCCTGCTATTGCATTATCAT |
| | | | receptor 4 | |
| ASSAY0414 | Hs00608252_m1 | ZNF207 | zinc finger protein 207 | AGCACAGCACAAGCTCAGGCAGCTG |
| ASSAY0421* | Hs00609836_m1 | AARS | alanyl-tRNA synthetase | CAAAATTTGGGGCTGGATGACACCA |
| ASSAY0424 | Hs00610438_m1 | IDE | insulin-degrading | AGACCAGAAAATGTCCGGGTTGCCA |
| | | | enzyme | |
| ASSAY0426 | Hs00610505_m1 | FSTL3 | follistatin-like 3 | CCGCTGCCGCAAGTCCTGTGAGCAC |
| | | | (secreted glycoprotein) | |
| ASSAY0431* | Hs00612292_m1 | TRA@ | T cell receptor alpha | CTGTGTTTCTGACCTTTGGAACTAT |
| | | | locus | |
| ASSAY0436 | Hs00702907_s1 | RBM17 | RNA binding motif | CAAGTGGGTTTGCAAGGAGACCAGA |
| | | | protein 17 | |
| ASSAY0441 | Hs00708570_s1 | PSENEN | presenilin enhancer | TGGGGCCCTGCTTATTCTCCCAGGA |
| | | | 2 homolog (C. elegans) | |
| ASSAY0445 | Hs00740463_m1 | CSNK1A1 | casein kinase 1, | GGCAAGGGCTAAAGGCTGCAACAAA |
| | | | alpha 1 | |
| ASSAY0446 | Hs00740591_m1 | FAHD2A | fumarylacetoacetate | CGCCGCGGCCAGGCTCTGATGCTGG |
| | | | hydrolase domain | |
| | | | containing 2A | |
| ASSAY0460 | Hs00759012_s1 | MTRF1L | mitochondrial | CGGACTAAGGATGCGGTCCCGGGTT |
| | | | translational release | |
| | | | factor 1-like | |
| ASSAY0461 | Hs00762253_s1 | PIGH | phosphatidylinositol | AAAAAACAAGCCCTTCAGTACTGGT |
| | | | glycan anchor | |
| | | | biosynthesis, class H | |
| ASSAY0472 | Hs00234637_m1 | NKTR | natural killer-tumor | AATCGGCGGTCCAGGAGTTGTAGAT |
| | | | recognition sequence | |
| ASSAY0474 | Hs00235003_m1 | PTGDR | prostaglandin D2 | GCCCGTAATTTATCGCGCTTACTAT |
| | | | receptor (DP) | |
| ASSAY0476 | Hs00236976_m1 | ITGB1 | integrin, beta 1 | TGTGGCGCGTGCAGGTGCAATGAAG |
| | | | (fibronectin receptor, | |
| | | | beta polypeptide, | |
| | | | antigen CD29 includes | |
| | | | MDF2, MSK12) | |
| ASSAY0479 | Hs00240906_m1 | SNCA | synuclein, alpha (non | GTGGCAACAGTGGCTGAGAAGACCA |
| | | | A4 component of amyloid | |
| | | | precursor) | |
| ASSAY0483 | Hs00243655_s1 | CDK5R1 | cyclin-dependent kinase | CCGGAAGGCCACGCTGTTTGAGGAT |
| | | | 5, (regulatory subunit | |
| | | | 1 (p35) | |
| ASSAY0484 | Hs00244704_m1 | CDC25B | cell division cycle 25 | GGCGGAGCAGACGTTTGAACAGGCC |
| | | | homolog B (S. pombe) | |
| ASSAY0485 | Hs00247369_m1 | USP21 | ubiquitin specific | TCTGATGACAAGATGGCTCATCACA |
| | | | peptidase 21 | |
| ASSAY0491 | Hs00250236_s1 | KIF21B | kinesin family | CCCAACATCCATGAGACACCCCGAG |
| | | | member 21B | |
| ASSAY0500* | Hs00256558_m1 | WHSC1L1 | Wolf-Hirschhorn | TTACAGAAAGGTGCCAGCGAGATTT |
| | | | syndrome candidate | |
| | | | 1-like 1 | |
| ASSAY0506 | Hs00257942_m1 | TSEN2 | tRNA splicing | AAGGGCCTAGAATACCTCCTCTGAA |
| | | | endonuclease 2 homolog | |
| | | | (S. cerevisiae) | |
| ASSAY0517 | Hs00261978_m1 | PYROXD2 | pyridine nucleotide- | TGGTGGCTGCAGCGTACCTGCAGAG |
| | | | disulplide oxido- | |
| | | | deructase domain 2 | |
| ASSAY0518 | HS00262488_m1 | FIZ1 | FLT3-interacting zinc | TGCACCACCAGGTCGTCCACACTGG |
| | | | finger 1 | |
| ASSAY0523 | Hs00264679_m1 | CST3 | cystatin C | CGCCCGCAAGCAGATCGTAGCTGGG |
| ASSAY0526 | Hs00266011_m1 | DNAJA1 | DnaJ (Hsp40) homolog, | CTCAGCCCGCACCGGCAGTAGAAGA |
| | | | subfamily A, member 1 | |
| ASSAY0532 | Hs00267168_s1 | MC1R | melanocortin 1 | GCAGGACGCTCAAGGAGGTGCTGAC |
| | | | receptor (alpha | |
| | | | melanocyte stimulating | |
| | | | hormone receptor) | |
| ASSAY0535* | Hs00268342_m1 | SORL1 | sortilin-related | CAACAAGCGGTACATCTTTGCAGAC |
| | | | receptor, L(DLR class) | |
| | | | A repeats-containing | |
| ASSAY0538 | Hs00269779_m1 | GGT5 | gamma-glutamyltrans- | TCAGCCAGGAGGTGCAGAGGGGACT |
| | | | ferase 5 | |
| ASSAY0539 | Hs00269993_m1 | DLX2 | distal-less homeobox 2 | AACGAGCCTGAGAAGGAGGACCTTG |
| ASSAY0543 | Hs00272235_m1 | EIF3M | eukaryotic translation | AGAAGAGTGATGCTGCTTCAAAAGT |
| | | | initiation factor 3, | |
| | | | subunit M | |
| ASSAY0546 | Hs00272828_m1 | ZFP36L2 | zinc finger protein | GTCGACTTCTTGTGCAAGACAGAGA |
| | | | 36, C3H type-like 2 | |
| ASSAY0549 | Hs00273329_s1 | NAT6 | N-acetyltransferase 6 | CCGCACCTCCCGCCTGCACTCCCTG |
| | | | (GCN5-related) | |
| ASSAY0550* | Hs00273392_s1 | LDOC1 | leucine zipper, down- | AACCCCAGCTATTGGCCAGGCCCCT |
| | | | regulated in cancer 1 | |
| ASSAY0553 | Hs00275656_m1 | GSK3B | glycogen synthase | AGAAATAATCAAGGTCCTGGGAACT |
| | | | kinase 3 beta | |
| ASSAY0566 | Hs00293370_m1 | SPPL3 | signal peptide | TATTTAAAGGGCGACCTCCGGCGGA |
| | | | peptidase 3 | |
| ASSAY0576 | Hs00326979_m1 | SYNE1 | spectrin repeat | CAAGCTCGAGGCTCTATTATCAGTC |
| | | | containing, nuclear | |
| | | | envelope 1 | |
| ASSAY0580 | Hs00332198_s1 | FNIP2 | folliculin interacting | ACTTTCCCTCATTCACCACCTTCCA |
| | | | protein 2 | |
| ASSAY0584* | Hs00356601_m1 | CCR2 | chemokine (C-C motif) | GCCACAAGCTGAACAGAGAAAGTGG |
| | | | receptor 2 | |
| ASSAY0587 | Hs00360266_g1 | NFYC | nuclear transcription | GATGGACAGCAGCTCTACCAGATCC |
| | | | factor Y, gamma | |
| ASSAY0588 | Hs00360923_g1 | CRELD2 | cysteine-rich with | TCCAAGTACGAGTCCAGCGAGATTC |
| | | | EGF-like domains 2 | |
| ASSAY0598* | Hs00364877_m1 | NCRNA00219 | non-protein coding | AAAGGTGACCTGAAGGATGTCCTTG |
| | | | RNA 219 | |
| ASSAY0600 | Hs00365842_m1 | CX3CR1 | chemokine (C-X3-C | GGCAGTCCACGCCAGGCCTTCACCA |
| | | | motif) receptor 1 | |
| ASSAY0607 | Hs00370295_m1 | AGAP4; | ArfGAP with GTPase | CGGGAGATGCCTGAAGCTTTGGAGT |
| | | AGAP7; | domain, ankyrin repeat | |
| | | AGAP6; | and PH domain 4; ArfGAP | |
| | | AGAP8 | with GTPase domain, | |
| | | | ankyrin repeat and PH | |
| | | | domain 7; ArfGAP with | |
| | | | GTPase domain, ankyrin | |
| | | | repeat and PH domain 6; | |
| | | | ArfGAP with GTPase | |
| | | | domain, ankyrin repeat | |
| | | | and PH domain 8 | |
| ASSAY0614 | Hs00373045_m1 | GAB2 | GRB2-associated | GAGAGCACAGACTCCCTGAGAAATG |
| | | | binding protein 2 | |
| ASSAY0623 | Hs00376384_m1 | CCDC52 | coiled-coil domain | GCTACACAGGCAAGACTTCAGCAGT |
| | | | containing 52 | |
| ASSAY0634* | Hs00379889_m1 | PQLC3 | PQ loop repeat | GACCTGGCCATGAATCTATGTACTT |
| | | | containing 3 | |
| ASSAY0638 | Hs00384448_m1 | PARS2 | prolyl-tRNA | GGCTGGGATTGCGGTGCCTGTGCTT |
| | | | synthetase 2, | |
| | | | mitochondrial (putative) | |
| ASSAY0642 | Hs00385559_m1 | NT5DC1 | 5-nucleotidase | TTTCCGGACACTCGAGAATGATGAG |
| | | | domain containing 1 | |
| ASSAY0647 | Hs00388932_m1 | MGST3 | microsomal glutathione | TTACCACCCGCGTATAGCTTCTGGC |
| | | | S-transferase 3 | |
| ASSAY0648* | Hs00389570_m1 | SEC16A | SEC16 homolog A | AACCTAAGAAGGGTGAATCCTGGTT |
| | | | (S. cerevisiae) | |
| ASSAY0651* | Hs00391737_m1 | SMG6 | Smg-6 homolog, | ACGCAAGACAGTAAAATATGCCTTG |
| | | | nonsense mediated | |
| | | | mRNA decay factor | |
| | | | (C. elegans) | |
| ASSAY0655 | Hs00394683_m1 | LST1 | leukodyte specific | AGGCCACAAGCTCTGGATGAGGAAC |
| | | | transcript 1 | |
| ASSAY0656* | Hs00395045_m1 | STMN3 | stathmin-like 3 | CCAGTACGGGGACATGGAGGTGAAG |
| ASSAY0662 | Hs00405478_m1 | PDE8B | phosphodiesterase 8B | GAAGCAGTGTGCAGGTCGATCCGGG |
| ASSAY0664 | Hs00405872_m1 | CYTSA | cytospin A | GTGCAGCGCGTGTTCTTGGGGAAGA |
| ASSAY0667 | Hs00409956_g1 | GPS2 | G protein pathway | CTCCGACTCATCCTCTCTGCGCCCC |
| | | | supressor 2 | |
| ASSAY0669 | Hs00411442_m1 | C14orf43 | chromosome 14 open | TGCAGAAGCTGATCCAGACCAAGAC |
| | | | reading frame 43 | |
| ASSAY0673 | Hs00413676_g1 | TRAV20 | T cell receptor alpha | TTCAGCTTGGCTGGTTGAGTGGAGA |
| | | | variable 20 | |
| ASSAY0675 | Hs00414663_m1 | CALCOCO2 | calcium binding and | GCATCTTTAGAGTGGGGTGGAAGAC |
| | | | coiled-coil domain 2 | |
| ASSAY0677 | Hs00414889_m1 | ANKRD36B | ankyrin repeat domain | GAAGGAAAGGACTGCCCTACATTTG |
| | | | 36B | |
| ASSAY0696* | Hs00418955_m1 | SMCHD1 | structural maintenance | AAGGATTTTAAATGGACAGGAACAG |
| | | | of chromosomes | |
| | | | flexible hinge domain | |
| | | | containing 1 | |
| ASSAY0698 | Hs00428757_m1 | DDX17 | DEAD (Asp-Glu-Ala-Asp) | TGACCGTGGAGGATTTGGAGCAAGA |
| | | | box polypeptide 17 | |
| ASSAY0701 | Hs00429827_m1 | RBMX2 | RNA binding motif | ATGGGATCAAGATCAAAGGAAGAAC |
| | | | protein, X-linked 2 | |
| ASSAY0702 | Hs00429977_m1 | SHISA5 | shisa homolog 5 | CCGGGTGCACGTGGTGAGGTGTGTA |
| | | | (Xenopus laevis) | |
| ASSAY0716 | Hs00539429_s1 | CHCHD8 | coiled-coil-helix- | GATCTGGAGTTGAGAGCCATGGGTT |
| | | | coiled-coil-helix | |
| | | | domain containing 8 | |
| ASSAY0723 | Hs00542109_m1 | FBXL16 | F-box and leucine- | ACGGACGCAGGCCTCGAGGTTATGC |
| | | | rich repeat protein 16 | |
| ASSAY0728 | Hs00544515_s1 | C14orf139 | chromosome 14 open | CCAGGGGACGGGAGCAGGTACCCAC |
| | | | reading frame 139 | |
| ASSAY0729 | Hs00559804_m1 | CAPN1 | calpain 1, (mu/l) | AAACTACCCAGCCACCTTCTGGGTG |
| | | | large subunit | |
| ASSAY0734 | Hs00602957_m1 | HN1 | hematological and | CCAAGTCAGCAGGTGCCAAGTCTAG |
| | | | neurological expressed 1 | |
| ASSAY0749 | Hs00833126_g1 | MAPK6 | mitogen-activated | CTGAGCCTTGTTGGCAATACTCAGA |
| | | | protein kinase 6 | |
| ASSAY0755 | Hs00891617_s1 | N/A | N/A | ACAGTTGTTTATGGTAGGAGGACTA |
| ASSAY0759* | Hs00900829_g1 | IL23A | interleukin 23, alpha | CCTCAGCCAACTCCTGCAGCCTGAG |
| | | | subunit p19 | |
| ASSAY0763 | Hs00907493_m1 | TRA2B | transformer 2 beta | ATCAGATTTATAGAAGGCGGTCACC |
| | | | homolog (Drosophila) | |
| ASSAY0767 | Hs00921653_m1 | RBM19 | RNA binding motif | CCGCTCACTTTCACGAGCCCCCGAA |
| | | | protein 19 | |
| ASSAY0771 | Hs00930963_m1 | PLAC8 | placenta-specific 8 | TACTAATTTCCACTGCTTTTAAGGC |
| ASSAY0772 | Hs00930964_g1 | PLAC8 | placenta-specific 8 | CCCGATATGGCATCCCTGGATCTAT |
| ASSAY0782 | Hs00945401_m1 | ANXA1 | annexin A1 | TGCCAAGCCATCCTGGATGAAACCA |
| ASSAY0785* | Hs00949547_g1 | CTBP2 | C-terminal binding | TGCCGGCGAGCTCGGAATTGCCGTG |
| | | | protein 2 | |
| ASSAY0790 | Hs00963390_g1 | CCT8 | chaperonin containing | GTGGTTTTTAAGCATGAAAAGGAAG |
| | | | TCP1, subunit 8 (theta) | |
| ASSAY0792 | Hs00967069_m1 | DNAJC13 | DnaJ (Hsp40) homolog, | AGCAGGATACCTCACAGGACCTGGA |
| | | | subfamily C, member 13 | |
| ASSAY0795 | Hs00971411_m1 | ANXA3 | annexin A3 | TTACTGTTGGCCATAGTTAATTGTG |
| ASSAY0797 | Hs00975865_m1 | BTK | Bruton | TTATCCCTTCCAGGTTGTATATGAT |
| | | | agammaglobulinemia | |
| | | | tyrosine kinase | |
| ASSAY0805 | Hs00996794_m1 | EPB42 | erythrocyte membrane | GAGAGGAGCTACAGATTCCGTTCAG |
| | | | protein band 4.2 | |
| ASSAY0814 | Hs01013056_g1 | GLUL | glutamate-ammonia | TCTGAAGTACATCGAGGAGGCCATT |
| | | | ligase (glutamine | |
| | | | synthetase) | |
| ASSAY0817 | Hs01017895_m1 | CSNK1D | casein kinase 1, delta | GGCTACCCTTCCGAATTTGCCACAT |
| ASSAY0819 | Hs01030693_m1 | ARHGAP17 | Rho GTPase activating | CCAAGATAGTAACAGACTCCAATTC |
| | | | protein 17 | |
| ASSAY0833 | Hs01051024_g1 | SETDB1 | SET domain, bifurcated 1 | TCCCAACCCTTCTTGAACTGGGTCT |
| ASSAY0838 | Hs01056146_m1 | DDX21 | DEAD (Asp-Glu-Ala-Asp) | AACAGAAATACAGGAGAAATGGCAT |
| | | | box polypeptide 21 | |
| ASSAY0841 | Hs01061967_g1 | LSM2 | LSM2 homolog, U6 small | CTCACATGTTATCAGTGAAGAACTG |
| | | | nuclear RNA associated | |
| | | | (S. cerevisiae) | |
| ASSAY0842 | Hs01062739_m1 | TMX4 | thioredoxin-related | TCTGAGCGTTCTGAGCAGAATCGGA |
| | | | transmembrane protein 4 | |
| ASSAY0847 | Hs01067777_m1 | TF | transferrin | TGTCCCACAGAACACTGGGGGAAAA |
| ASSAY0853 | Hs01081697_m1 | IL2RB | interleukin 2 | AGGAGACGTCCAGAAGTGGCTCTCT |
| | | | receptor, beta | |
| ASSAY0861 | Hs01093019_m1 | GSPT1 | G1 to S phase | CAGAGAAACTTGGTACTTGTCTTGG |
| | | | transition 1 | |
| ASSAY0878 | Hs01380343_m1 | DEGS2 | degenerative sperm- | CTACAACCTGCCGCTGGTGCGGAAG |
| | | | atocyte homolog 2, lipid | |
| | | | desaturase (Drosophila) | |
| ASSAY0886 | Hs01564142_m1 | GLIPR1 | GLI pathogenesis- | CTATACATGACTTGGGACCCAGCAC |
| | | | related 1 | |
| ASSAY0900 | Hs01636043_s1 | SRP9 | signal recognition | TGCTGTTGTGACCAATAAATATAAA |
| | | | particle 9 kDa | |
| ASSAY0903 | Hs01691047_sH | N/A | N/A | CCTCTAACAAAACTAAGCTGTCTGG |
| ASSAY0904 | Hs01885851_s1 | LTB4R2 | leukotriene B4 | CTACGGCCTTGGCCTTCTTCAGTTC |
| | | | receptor 2 | |
| ASSAY0910 | Hs01924685_g1 | COX6A1 | cytochrome c oxidase | AGAGAATCTGGACCACTACCCGGGC |
| | | | subunit Via poly- | |
| | | | peptide 1 | |
| ASSAY0917 | Hs02339924_g1 | RPL7L1 | ribosomal protein L7- | TGGCAAAGAAGGAGCAGAAGAAAGG |
| | | | like 1 | |
| ASSAY0922 | Hs02597217_g1 | GNG10; | guanine nucleotide | GAGAGGATCAAGGTCTCTCAGGCAG |
| | | LOC653503 | binding protein (G | |
| | | | protein), gamma 10; | |
| | | | GNG10 pseudogene | |
| ASSAY0928 | Hs03043885_g1 | RPL13A; | ribosomal protein L13a; | CCCTACGACAAGAAAAAGCGGATGG |
| | | RPL13AP5 | ribosomal protein L13a | |
| | | | pseudogene 5 | |
| ASSAY0938 | Hs01092525_m1 | LDLR | low density lipoprotein | ACGTGCTTGTCTGTCACCTGCAAAT |
| | | | receptor | |
| ASSAY0943 | Hs99999035_m1 | IL10 | interleukin 10 | GAAGACTTTCTTTCAAATGAAGGAT |
| ASSAY0948 | Hs00203146_m1 | C11orf2 | chromosome 11 open | ATCTCAGCCACAGACACCATCCGGA |
| | | | reading frame 2 | |
| ASSAY0950 | Hs01123468_m1 | DIDO1 | death inducer- | ATGCGGTGCTCAGGCAGGTATTAAA |
| | | | obliterator 1 | |
| ASSAY0953 | Hs00323153_m1 | NBEAL2 | neurobeachin-like 2 | CGCAGAGGTTGTCAGTGATGGTGTA |
| ASSAY0960 | Hs00984297_m1 | C1orf175 | chromosome 1 open | AATGAAGTGAAAGCTGCTCTGGATA |
| | | | reading frame 175 | |
| ASSAY0971 | Hs00391048_m1 | MEGF9 | multiple EGF-like- | GTGCAACAGTTCTGGGAAATGCCAG |
| | | | domains 9 | |
| ASSAY0976 | Hs00376366_m1 | CCDC12 | coiled-coil domain | CAAACCGGTTGCAGTGGAGGAGAAG |
| | | | containing 12 | |
| ASSAY0978* | Hs00830212_s1 | CALM2 | calmodulin 2 | GTTTAGCCACTTAAAATCTGCTTAT |
| | | | (phosphorylase kinase, | |
| | | | delta) | |
| ASSAY0983 | Hs00198609_m1 | MTMR11 | myotubularin related | GCCACCAGGCTCCGGTGTTTCTCCT |
| | | | protein 11 | |
| ASSAY0985 | Hs00296956_m1 | ANKRD44 | ankyrin repeat domain 44 | TGGAATTGCTTTTGGAAAGAACAAA |
| ASSAY0992 | Hs00293951_m1 | LOC375925 | hypothetical protein | CCCCGCTCAGTTCAATATTTCAAGT |
| | | | LOC375295 | |
| ASSAY0996 | Hs00369838_s1 | GPR82 | G protein-coupled | ATGGGAATATCAATCTGCTCAATGC |
| | | | receptor 82 | |
| ASSAY0998 | Hs00162661_m1 | TMBIM6 | transmembrane BAX | CACTCATTTCATTCAGGCTGGCCTG |
| | | | inhibitor motif | |
| | | | containing 6 | |
| ASSAY1000 | Hs00403541_m1 | FAM129C | family with sequence | CTGCCCTGAATCCTTGGGAGACCAT |
| | | | similarity 129, member C | |
| ASSAY1006* | Hs00228595_m1 | GON4L | gon-4-like (C. elegans) | GATGTGGGGAATGAAGATGAAGCAG |
| ASSAY1010 | Hs00394748_m1 | AGRN | agrin | GAGTTCTGTGTGGAAGATAAACCCG |
| ASSAY1011 | Hs00185803_m1 | MFAP5 | microfibrillar | GATGACTTGGCCTCCCTCAGTGAAA |
| | | | associated protein 5 | |
| ASSAY1012 | Hs00173310_m1 | KCNIP3 | Kv channel interacting | GGGCCATCCACTTTGAGGACTTTGT |
| | | | protein 3, calsenilin | |
| ASSAY1017 | Hs00894734_m1 | PTPRC | protein tyrosine | GCTTTTAATACCACAGGTGTTTCAT |
| | | | phosphatase, receptor | |
| | | | type, C | |
| ASSAY1018 | Hs00608272_m1 | TSC22D3 | TSC22 domain family, | GAACAGGCCATGGATCTGGTGAAGA |
| | | | member 3 | |
| ASSAY1024 | Hs00198650_m1 | CSDE1 | cold shock domain, | TAAAAGTAGGAGATGATGTTGAATT |
| | | | containing E1, RNA- | |
| | | | binding | |
| ASSAY1025 | Hs00182082_m1 | MYD88 | myeloid differentiation | CCCAGCATTGAGGAGGATTGCCAAA |
| | | | primary response gene | |
| | | | (88) | |
| ASSAY1026 | Hs00162271_m1 | SPTBN1 | spectrin, beta, non- | GCTCTGGGCACACAGGTGAGGCAGC |
| | | | erythrocytic 1 | |
| ASSAY1033 | Hs00212914_m1 | CDK12 | cyclin-dependent | CCACTCCCCAGTAGGAAATCCATGA |
| | | | kinase 12 | |
| ASSAY1037 | Hs00300550_m1 | LAMA1 | laminin, alpha 1 | GGCAGAGAGGCCTGTTTCCTGCCAT |
| ASSAY1040* | Hs01107881_m1 | ABCA10 | ATP-binding cassette, | CTCTTTTGTGTTTGTTACTAGTACT |
| | | | sub-family A (ABC1), | |
| | | | member 10 | |
| ASSAY1041 | Hs00430595_m1 | STAG3L4 | stromal antigen 3-like 4 | AAACACAAAGAGCTGCATTAATACT |
| ASSAY1044 | Hs00734523_m1 | ARF1 | ADP-ribosylation | GCAGCCTCTGAGGTGTCCCTGGCCA |
| | | | factor 1 | |
| ASSAY1047 | Hs00398895_m1 | SLMO1 | slowmo homolog 1 | CAATGCAAAGAAGGGGTGGGCTGCT |
| | | | (Drosophila) | |
| ASSAY1056 | Hs00698399_m1 | LRRC50 | leucine rich repeat | TGCCCGATTTGCGTGTACTGAATTT |
| | | | containing 50 | |
| ASSAY1058 | Hs00369593_m1 | RBM33 | RNA binding motif | GAAAATTTCAGTTCTCAGGGTGTTA |
| | | | protein 33 | |
| ASSAY1059* | Hs00195059_m1 | SORBS3 | sorbin and SH3 domain | ATGGCTGGTTTGTGGGTGTCTCCCG |
| | | | containing 3 | |
| ASSAY0175 | Hs00202596_m1 | FBXO9 | F-box protein 9 | CTACATCTGTGCCAGAGACCCTGAA |
| ASSAY1079 | Hs00162564_m1 | TARS | threonyl-tRNA synthetase | CGAGGAGAAGCCGATTGGTGCTGGT |
| ASSAY1081 | Hs00365632_m1 | DGUOK | deoxyguanosine kinase | AGGCTTCTCCCCAGGTTTGTTTGAA |
| ASSAY1086* | Hs00164445_m1 | EPB42 | erythrocyte membrane | GGATGGATGCCCTGGGTATCAAGAG |
| | | | protein band 4.2 | |
| ASSAY1088 | Hs00374213_m1 | GLUL | glutamate-ammonia | TTTCTGTGGCTGGGAACACCTTCCA |
| | | | ligase (glutamine | |
| | | | synthetase) | |
| ASSAY0194 | Hs00289449_m1 | SFI1 | Sfi1 homolog, spindle | GCAGAATGAGATGGCTGAGCGATTC |
| | | | assembly associated | |
| | | | (yeast) | |
| ASSAY1095 | Hs00559595_m1 | ITGB1 | integrin, beta 1 | TTGCTCAAACAGATGAAAATAGATG |
| | | | (fibronectin receptor, | |
| | | | beta polypeptide, | |
| | | | antigen CD29 includes | |
| | | | MDF2, MSK12) | |
| ASSAY1099 | Hs00428461_m1 | CTDSP2 | CTD (carboxy-terminal | CTCACCAAGCAAGGCCTGGTCTCCA |
| | | | domain, RNA polymerase | |
| | | | II, polypeptide A) | |
| | | | small phosphatase 2 | |
| ASSAY1102 | Hs00415445_m1 | RNF216L; | ring finger protein | GAGTGGCGACTCTTTTGAAACAGAT |
| | | RNF216 | 216-like; ring finger | |
| | | | protein 216 | |
| ASSAY1103 | Hs00300475_s1 | SORL1 | sortilin-related | CAGAAGACACACAGCTGCCTGTTCT |
| | | | receptor, L(DLR class) | |
| | | | A repeats-containing | |
| ASSAY1104 | Hs00261330_s1 | NT5DC1 | 5-nucleotidase domain | CATATCGATGCATGCAATGGAAAGA |
| | | | containing 1 | |

TABLE 3
Informative sub-set of probes for Stable MCI versus Converting MCI

| Sequence No. | | | | |
|---|---|---|---|---|
| (DiaGenic | | Gene | | Context Sequence |
| Assay ID) | Assay ID | Symbol | Gene name | (Oligonucleotide sequence) |
| ASSAY0191 | Hs00157817_m1 | GRB2 | growth factor receptor- | GGGGGGACATCCTCAAGGTTTTGAA |
| | | | bound protein 2 | |
| ASSAY0194 | Hs00164370_m1 | CYBA | cytochrome b-245, | GGCCTGATCCTCATCACCGGGGGCA |
| | | | alpha polypeptide | |
| ASSAY0196 | Hs00168402_m1 | IL2RB | interleukin 2 receptor, | GGGCCATGGCTGAAGAAGGTCCTGA |
| | | | beta | |
| ASSAY0197 | Hs00170953_m1 | S100A6 | S100 calcium binding | CCCTACCGCTCCAAGCCCAGCCCTC |
| | | | protein A6 | |
| ASSAY0202 | Hs00182698_m1 | SKAP2 | src kinase associated | CCTCTGATGGAGCCCAGTTTCCTCC |
| | | | phosphoprotein 2 | |
| ASSAY0207 | Hs00196206_m1 | GZMA | granzyme A (granzyme 1, | CCTGCTAATTCCTGAAGATGTCTGT |
| | | | cytotoxic T-lymphocyte- | |
| | | | associated serine | |
| | | | esterase 3) | |
| ASSAY0215 | Hs00208212_m1 | RBM19 | RNA binding motif | ACGAGCCACTAAGCCAGCCGTGACA |
| | | | protein 19 | |
| ASSAY0221 | Hs00215267_m1 | TMEM127 | transmembrane | CCCGGACCTGCTGAAAGATTTCTGC |
| | | | protein 127 | |
| ASSAY0222 | Hs00215631_m1 | MARCH1 | membrane-associated | AGGACATCTGCAGAATCTGTCACTG |
| | | | ring finger (C3HC4) 1 | |
| ASSAY0226 | Hs00220138_m1 | LXN | latexin | ACAAGCCAGCATGGAGGATATTCCA |
| ASSAY0226 | Hs00227667_m1 | DENND2D | DENN/MADD domain | TGGAAGAGGTCCTGCTGGTCAATCT |
| | | | containing 2D | |
| ASSAY0236 | Hs00266763_m1 | GSPT1 | G1 to S phase | CCGTGCGGCACCTGTGGAATCCTCT |
| | | | transition 1 | |
| ASSAY0243 | Hs00292065_m1 | SYTL3 | synaptotagmin-like 3 | GTCACCACCAGGAAGGTCAGTGCAC |
| ASSAY0246 | Hs00330168_m1 | DNHD1 | dynein heavy chain | GGGCGCTGGAGTCAAGTGACTCTAA |
| | | | domain 1 | |
| ASSAY0251 | Hs00367259_m1 | GOLGA8B; | glogin A8 family, | AGAAGCCGGATGGGTTCTCGAGCCG |
| | | GOLGA8A | member B; golden A8 | |
| | | | family, member A | |
| ASSAY0256 | Hs00385050_m1 | RNF166 | ring finger protein 166 | GCGGCCACACGTTCTGCGGGGAGTG |
| ASSAY0262 | Hs00430193_m1 | MAP1S | microtubule-associated | GGAGCTCGAAAGAGGCATCCGGTCT |
| | | | protein 1S | |
| ASSAY0275 | Hs01005146_g1 | LOC651250 | hypothetical LOC651250 | AGCAAGTTCAGAGTTGGATGGTCTA |
| ASSAY0277 | Hs01028786_s1 | ANKRD58 | ankyrin repeat | TCAGCCTCTGACAACCTCCTCCTGA |
| | | | domain 58 | |
| ASSAY0278 | Hs01092416_s1 | N/A | N/A | GTGTGAAGATCCAGCCTGATGCCCA |

TABLE 4
10 genes used for external analysis (stable MCI vs converter MCI)

| Sequence No. | | Gene | | Context Sequence |
|---|---|---|---|---|
| (DiaGenic Assay ID) | Assay ID | Symbol | Gene name | (Oligonucleotide sequence) |
| ASSAY0141 | Hs00173570_m1 | GRN | granulin | GTCGGACGCAGGCAGACCATGTGGA |
| ASSAY0460 | Hs00759012_s1 | MTRF1L | mitochondrial | CGGACTAAGGATGCGGTCCCGGGTT |
| | | | translational release | |
| | | | factor 1-like | |
| ASSAY1025 | Hs00182082_m1 | MYD88 | myeloid differentiation | CCCAGCATTGAGGAGGATTGCCAAA |
| | | | primary response gene | |
| | | | (88) | |
| ASSAY1017 | Hs00894734_m1 | PTPRC | protein kinase | GCTTTTAATACCACAGGTGTTTCAT |
| | | | phosphatase, receptor | |
| | | | type, C | |
| ASSAY0759 | Hs00900829_g1 | IL23A | interleukin 23, alpha | CCTCAGCCAACTCCTGCAGCCTGAG |
| | | | subunit p19 | |
| ASSAY1101 | Hs00536591_g1 | MTG1 | mitochondrial GTPase | CCGAAAAGAGAACCTGGAGTACTGT |
| | | | 1 homolog | |
| | | | (S. cerevisiae) | |
| ASSAY0878 | Hs01380343_m1 | DEGS2 | degenerative | CTACAACCTGCCGCTGGTGCGGAAG |
| | | | spermatocyte homolog | |
| | | | 2, lipid desaturase | |
| | | | (Drosophila) | |
| ASSAY1065 | Hs00205221_m1 | NEK6 | NIMA (never in mitosis | CCTGACCCACAGAGGCATCCCAACA |
| | | | gene a)-related kinase | |
| | | | 6 | |
| ASSAY0906 | Hs01904238_g1 | N/A | N/A | GGACCACCAGCCCCAGTGACAGAAC |
| ASSAY0758 | Hs00898410_g1 | RPL32P3 | ribosomal protein L32 | GCTGGCAGGCACCATGTCGTCCTGT |
| | | | pseudogene 3 | |

TABLE 5
Informative probes for Non-AS versus AS (All probes have p-value <0.5)

| Sequence No. | | Gene | | Context Sequence |
|---|---|---|---|---|
| (DiaGenic probe ID) | Assay ID | Symbol | Gene name | (Oligonucleotide Sequence) |
| ASSAY0001 | Hs00152932_m1 | TLR2 | toll-like receptor 2 | TCAACTGGTAGTTGTGGGTTGAAGC |
| ASSAY0002 | Hs00153510_m1 | MME | membrane metallo- | TGAAGAAAAGGCCTTAGCAATTAAA |
| | | | endopeptidase | |
| ASSAY0003 | Hs00190079_m1 | PFKFB3 | 6-phosphofructo-2- | TGCCCAGATCCTGTGGGCCAAAGCT |
| | | | kinase/fructose-2,6- | |
| | | | biphosphatase 3 | |
| ASSAY0006 | Hs00220373_m1 | SLC12A9 | solute carrier family | CTCCGGCCTCGGTGGCATGAAGCCC |
| | | | 12 (potassium/chloride | |
| | | | transporters), member 9 | |
| ASSAY0010 | Hs00230322_m1 | CRISPLD2 | cysteine-rich secretory | CAGTCTGAAAGCCTGGGGACTCCTC |
| | | | protein LCCL domain | |
| | | | containing 2 | |
| ASSAY0011 | Hs99999905_m1 | GAPDH | glyceraldehyde-3- | GGGCGCCTGGTCACCAGGGCTGCTT |
| | | | phosphatase | |
| | | | dehydrogenase | |
| ASSAY0013 | Hs00163311_m1 | UBE2B | ubiquitin-conjugating | CACCTTTTGAAGATGGTACTTTTAA |
| | | | enzyme E2B (RAD6 | |
| | | | homolog) | |
| ASSAY0017 | Hs00179345_m1 | MAP4K1 | mitogen-activated | CTCTCTCAGGAAAGACCCCCCACCT |
| | | | protein kinase kinase | |
| | | | kinase kinase 1 | |
| ASSAY0027 | HS00191312_m1 | NMT2 | N-myristoyltransferase | TTCGGATTTATGACAGTGTGAAGAA |
| | | | 2 | |
| ASSAY0040 | Hs00219196_m1 | YIPF1 | Yip1 domain family, | TGGGCTGCTTGGCATACTTTTTTGA |
| | | | member 1 | |
| ASSAY0044 | Hs00219931_m1 | LARS | leucyl-tRNA synthetase | TTTTCAGCAGATGGAATGCGTTTGG |
| ASSAY0045 | Hs00220172_m1 | C3orf37 | chromosome 3 open | TTTGAGAAGGATGCAGACTCATCTG |
| | | | reading frame 37 | |
| ASSAY0046 | Hs00220176_m1 | ENY2 | enhancer of yellow 2 | CGCGGTGATGGTGGTTAGCAAGATG |
| | | | homolog (Drosophila) | |
| ASSAY0047 | Hs00220301_m1 | PPAN; | peter pan homolog | ATCAACGTGCACAAGGTGAACCTGA |
| | | PPAN- | (Drosophila); PPAN- | |
| | | P2RY11 | P2RY11 readthrough | |
| ASSAY0048 | Hs00220428_m1 | C1orf63 | chromosome 1 open | ATGGTGCAAAGCCTGAACTGTCGGA |
| | | | reading frame 63 | |
| ASSAY0056 | Hs00221562_m1 | MTMR3 | myotubularin related | TGTGCAGACCAGGGGAGCATCTAAC |
| | | | protein 3 | |
| ASSAY0060 | Hs00223275_m1 | SAMSN1 | SAM domain, SH3 | GATGATTCAACTGAGGCACATGAAG |
| | | | domain and nuclear | |
| | | | localization signals 1 | |
| ASSAY0062 | Hs00223727_m1 | PAPD5 | PAP associated | TTTACAACCAGGTAACGATGTTGGA |
| | | | domain containing 5 | |
| ASSAY0063 | Hs00223860_m1 | ZMAT3 | zinc finger, matrin | AGTACAGAATAATTCAGCAGGTCCT |
| | | | type 3 | |
| ASSAY0065 | Hs00224328_m1 | CRTC3 | CREB regulated | TACCTCCCAGATGGTGTCCTCAGAC |
| | | | transcription | |
| | | | coactivator 3 | |
| ASSAY0067 | Hs00224851_m1 | JMJD4 | jumonji domain | GTGCACAACCTGGATGACACCATCT |
| | | | containing 4 | |
| ASSAY0074 | Hs00226190_m1 | TNFAIP8L2 | tumor necrosis factor, | CCCAGCACAGCAGTGACTGACCACA |
| | | | alpha-induced protein | |
| | | | 8-like 2 | |
| ASSAY0084 | Hs00229849_m1 | ADPGK | ADP-dependent | GCATTGTCCATCAGGTCTTTCCCGC |
| | | | glucokinase | |
| ASSAY0085 | Hs00229911_m1 | APH1B | anterior pharynx | TCATCGCCGGAGCTTTCTTCTGGTT |
| | | | defective 1 homolog B | |
| | | | (C. elegans) | |
| ASSAY0086 | Hs99276716_m1 | SCNM1 | sodium channel | TGCCGCCGGAAGTACAGACCAGAAG |
| | | | modifier 1 | |
| ASSAY0089 | Hs00231324_m1 | SMARCA4 | SWI/SNF related matrix | GAATCCTCACCAGGACCTGCAAGCG |
| | | | associated, actin | |
| | | | dependent regulator of | |
| | | | chromatin subfamily a, | |
| | | | member 4 | |
| ASSAY0092 | Hs00232444_m1 | TCFL5 | transcription factor- | AAAGAGATAGAAGGCGCAGAATCCG |
| | | | like 5 (basic helix- | |
| | | | loop-helix) | |
| ASSAY0098 | Hs00153519_m1 | MME | membrane metallo- | TCCAGGCAATTTCAGGATTATTGGG |
| | | | endopeptidase | |
| ASSAY0103 | Hs00154250_m1 | CASP6 | caspase 6, apoptosis- | GTGTTACTCTGTTGCAGAAGGATAT |
| | | | related cysteine | |
| | | | peptidase | |
| ASSAY0107 | Hs00155735_m1 | AOAH | acyloxyacyl hydrolase | CAAGAAATGGTGCATCTTCCCGAAA |
| | | | (neutrophil) | |
| ASSAY0112 | Hs00157403_m1 | EPHX2 | epoxide hydrolase 2, | ACGTGACAGTAAAGCCCAGGGTCCG |
| | | | cytoplasmic | |
| ASSAY0114 | Hs00157950_m1 | HLA-DOB | major histocompat- | ACAGACTCTCCAGAAGATTTTGTGA |
| | | | ibility complex, class | |
| | | | II, DO beta | |
| ASSAY0017 | Hs00158114_m1 | IRF5 | interferon regulatory | ACACCATCTTCAAGGCCTGGGCCAA |
| | | | factor 5 | |
| ASSAY0119 | Hs00159537_m1 | NBN | nibrin | CCCGGCAGGAGGAGAACCATACAGA |
| ASSAY0120 | Hs00159668_m1 | NRD1 | nardilysin (N-arginine | TGTCACAAGCACAGAATCTATGGAT |
| | | | dibasic convertase) | |
| ASSAY0124 | Hs00160349_m1 | PPP1CB | protein phosphatase 1, | CGAGCTCATCAGGTGGTGGAAGATG |
| | | | catalytic subunit, beta | |
| | | | isozyme | |
| ASSAY0126 | Hs00162077_m1 | SOAT1 | sterol O- | CCATCTTGCCAGGTGTGCTGATTCT |
| | | | acyltransferase 1 | |
| ASSAY0128 | Hs00163761_m1 | BTK | Bruton | GTCAGGACTGAGCACACAGGTGAAC |
| | | | agammaglobulinemia | |
| | | | tyrosine kinase | |
| ASSAY0129 | Hs00164521_m1 | F5 | coagulation factor V | CGAGGAATACAGAGGGCAGCAGACA |
| | | | (proaccelerin, labile | |
| | | | factor) | |
| ASSAY0136 | Hs00170600_m1 | DNAJA3 | DnaJ (Hsp40) | TCAACGTGACGATCCCCCCTGGGAC |
| | | | homolog, subfamily A, | |
| | | | member 3 | |
| ASSAY0141 | Hs00173570_m1 | GRN | granulin | GTCGGACGCAGGCAGACCATGTGGA |
| ASSAY0142 | Hs00174097_m1 | IL1B | interleukin 1, beta | GGATATGGAGCAACAAGTGGTGTTC |
| ASSAY0147 | Hs00174179_m1 | ACE | angiotensin I | AAGGACTTCCGGATCAAGCAGTGCA |
| | | | converting enzyme | |
| | | | (peptidyl-dipeptidase | |
| | | | A) 1 | |
| ASSAY0149 | Hs00174659_m1 | SIGLEC5 | sialic acid binding | GTACCATCACCTCGGGTTCCAGGAA |
| | | | Ig-like lectin 5 | |
| ASSAY0150 | Hs00174705_m1 | CD163 | CD163 molecule | ACCTGCTCAGCCCACAGGGAACCCA |
| ASSAY0151 | Hs00175186_m1 | BPI | bactericidal/perme- | AAGCTGGATAGGCTGCTCCTGGAAC |
| | | | ability-increasing | |
| | | | protein | |
| ASSAY0152 | Hs00175188_m1 | CTSC | cathepsin C | CGGTTATGGGACCACAAGAAAAAAA |
| ASSAY0154 | Hs00175407_m1 | CTSS | cathepsin S | TGTGAAAAACAGCTGGGGCCACAAC |
| ASSAY0155 | Hs00175475_m1 | PGLYRP1 | peptidoglycan | GCGACGTGGGCTACAACTTCCTGAT |
| | | | recognition protein 1 | |
| ASSAY0156 | Hs00175573_m1 | AQP9 | aquaporin 9 | CATCTTGATTGTCCTTGGATGTGGC |
| ASSAY0158 | Hs00176666_m1 | ITPKB | inositol 1,4,5- | GCAAGATGGGAATCAGGACCTACCT |
| | | | triphosphate 3-kinase B | |
| ASSAY0160 | Hs00176973_m1 | PRKCA | protein kinase C, alpha | GAACCACAAGCAGTATTCTATGCGG |
| ASSAY0164 | Hs00177638_m1 | ADAM9 | ADAM metallopeptidase | TGCCACTGGGAATGCTTTGTGTGGA |
| | | | domain 9 (meltrin | |
| | | | gamma) | |
| ASSAY0165 | Hs00177790_m1 | STK17B | serine/threonine | TGATATTGGAATATGCTGCAGGTGG |
| | | | kinase 17b | |
| ASSAY168 | Hs00179987_m1 | FHIT | fragile histidine | CACCTTTTCCATGCAGGATGGCCCC |
| | | | triad gene | |
| ASSAY0171 | Hs00181419_m1 | IGF2R | insulin-like growth | CTTCTGCAGACACTCAAACAGCTAC |
| | | | factor 2 receptor | |
| ASSAY0174 | Hs00183425_m1 | SMAD2 | SMAD family member 2 | TGGACACAGGCTCTCCAGCAGAACT |
| ASSAY0176 | Hs00184625_m1 | ATP6V1C1 | ATPase, H+ trans- | ACCTTCCTGGAATCTCTCTTGATTT |
| | | | porting, lysosomal | |
| | | | 42 kDa, V1 subunit C1 | |
| ASSAY0178 | Hs00186661_m1 | NCOA1 | nuclear receptor | CACCTCAGCCACCCCTGAATGCTCA |
| | | | coactivator 1 | |
| ASSAY0180 | Hs00187845_m1 | BCL2A1 | BCL2-releated protein | AAAACGGAGGCTGGGAAAATGGCTT |
| | | | A1 | |
| ASSAY0183 | Hs00188713_m1 | BAG3 | BCL2-associated | GGGCCCCAAGGAGACTCCATCCTCT |
| | | | athanogene 3 | |
| ASSAY0194 | Hs00164370_m1 | CYBA | cytochrome b-245, | GGCCTGATCCTCATCACCGGGGGCA |
| | | | alpha polypeptide | |
| ASSAY0197 | Hs00170953_m1 | S100A6 | S100 calcium binding | CCCTACCGCTCCAAGCCCAGCCCTC |
| | | | protein A6 | |
| ASSAY0198 | Hs00174128_m1 | TNF | tumor necrosis factor | TAGCCCATGTTGTAGCAAACCCTCA |
| | | | (TNF superfamily, | |
| | | | member 2) | |
| ASSAY1099 | Hs00175295_m1 | TCF12 | transcription factor 12 | GCGCTTGATCCCTTGCAAGCAAAAA |
| ASSAY0200 | Hs00180691_m1 | TACC1 | transforming, acidic | GTCCACTGTGCTTGGGCTGCTGGAG |
| | | | coiled-coil containing | |
| | | | protein 1 | |
| ASSAY0202 | Hs00182692_m1 | SKAP2 | src kinase associated | CCTCTGATGGAGCCCAGTTTCCTCC |
| | | | phosphoprotein 2 | |
| ASSAY0204 | Hs00184390_m1 | TCOF1 | Treacher Collins- | GCATCTCCAGCACAGGTGAAAACCT |
| | | | Franceschetti | |
| | | | syndrome 1 | |
| ASSAY0209 | Hs00200082_m1 | UBL3 | ubiquitin-like 3 | CAATTGGCCAATGGACTGGGAAGAA |
| ASSAY0210 | Hs00203291_m1 | CCDC106 | coiled-coil domain | CTCGGATGGAGGCAGAGGACCACTG |
| | | | containing 106 | |
| ASSAY0215 | Hs00208212_m1 | RBM19 | RNA binding motif | ACGAGCCACTAAGCCAGCCGTGACA |
| | | | protein 19 | |
| ASSAY0221 | Hs00215267_m1 | TMEM127 | transmembrane | CCCGGACCTGCTGAAAGATTTCTGC |
| | | | protein 127 | |
| ASSAY0222 | Hs00215631_m1 | MARCH1 | membrane-associated | AGGACATCTGCAGAATCTGTCACTG |
| | | | ring finger (C3HC4) 1 | |
| ASSAY0226 | Hs00220138_m1 | LXN | latexin | ACAAGCCAGCATGGAGGATATTCCA |
| ASSAY0230 | Hs00228829_m1 | TNKS2 | tankyrase, TRF1- | TGAAACAGCATTGCATTGTGCTGCT |
| | | | interacting ankyrin- | |
| | | | related ADP-ribose | |
| | | | polymerase 2 | |
| ASSAY0246 | Hs00330168_m1 | DNHD1 | dynein heavy chain | GGGCGCTGGAGTCAAGTGACTCTAA |
| | | | domain 1 | |
| ASSAY0247 | Hs00347791_s1 | RPSA; | ribosomal protein SA; | GGTCTGCAGCTCCCACTGCTCAGGC |
| | | RPSAP19; | ribosomal protein SA | |
| | | RPSAP58; | pseudogene 19; ribo- | |
| | | RPSAP9 | somal protein SA | |
| | | | pseudogene 58; | |
| | | | ribosomal protein | |
| | | | SA pseudogene 9 | |
| ASSAY0251 | Hs00367259_m1 | GOLGA8B; | golgin A8 family, | AGAAGCCGGATGGGTTCTCGAGCCG |
| | | GOLGA8A | member B; golgin A8 | |
| | | | family, member A | |
| ASSAY0257 | Hs00397335_m1 | DNAJC13 | DnaJ (Hsp40) | GGTCCAAAGGTTCGAATTACGTTAA |
| | | | homolog, subfamily C, | |
| | | | member 13 | |
| ASSAY0258 | Hs00406040_m1 | LYSMD3 | LysM, putative | TTGTACGGTAGCAGATATCAAGAGA |
| | | | peptidoglycan-binding, | |
| | | | domain containing 3 | |
| ASSAY0265 | Hs00606772_g1 | SH3BGRL3 | SH3 domain binding | CACCGGCTCCCGCGAAATCAAGTCC |
| | | | glutamic acid-rich | |
| | | | protein like 3 | |
| ASSAY0267 | Hs00609831_g1 | AARS | alanyl-tRNA | CGGCGCCTCAGCCAAGGCCCTGAAT |
| | | | synthetase | |
| ASSAY0268 | Hs00705337_s1 | RBM39 | RNA binding motif | AACAGCAGCATATGTACCTCTTCCA |
| | | | protein 39 | |
| ASSAY0269 | Hs00743451_s1 | SUB1 | SUB1 homolog | AACTTAATCTCTTCATGTTCAGTTT |
| | | | (S. cerevisiae) | |
| ASSAY0270 | Hs00754750_s1 | PTP4A2 | protein tyrosine | CCTTTTCCCCCGATCCAAGTTGTAG |
| | | | phosphatase type IVA, | |
| | | | member 2 | |
| ASSAY0278 | Hs01092416_s1 | N/A | N/A | GTGTGAAGATCCAGCCTGATGCCCA |
| ASSAY0280 | Hs01681736_s1 | EP400NL | EP400 N-terminal like | GATATGAATGAATGCTGTGTGGAGC |
| ASSAY0284 | Hs00194045_m1 | ABCA1 | ATP-binding cassette, | ACCCAATCCCAGACACGCCCTGCCA |
| | | | sub-family A (ABC1), | |
| | | | member 1 | |
| ASSAY0289 | Hs00194815_m1 | ARPC1B | actin releated protein | CGCGGGAGGAGCCAAGCCGCCATGG |
| | | | 2/3 complex, subunit | |
| | | | 1B, 41 kDa | |
| ASSAY0290 | Hs00195343_m1 | SMNDC1 | survival motor neuron | GTGAAGATGGACAGTGTTATGAAGC |
| | | | domain containing 1 | |
| ASSAY0292 | Hs00195718_m1 | TAX1BP1 | Tax1 (human T-cell | AAACAACTCTTGCAGGATGAGAAAG |
| | | | leukemia virus type I) | |
| | | | binding protein 1 | |
| ASSAY0293 | Hs00196061_m1 | CEPT1 | choline/ethanolamine | ACAGAGCAGGCACCTCTGTGGGCAT |
| | | | phosphotransferase 1 | |
| ASSAY0302 | Hs00198676_m1 | TCERG1 | transcription | TACTCCATGGTGTGTCGTTTGGACT |
| | | | elongation regulator 1 | |
| ASSAY0315 | Hs00201734_m1 | CCNDBP1 | cyclin D-type binding- | TGCCGTCTCCACAGGAAACCCAGAA |
| | | | protein 1 | |
| ASSAY0319 | Hs00202185_m1 | FTSJ1 | FtsJ homolog 1 | CTTAACCCATTACGCTGGCAAACTG |
| | | | (E. coli) | |
| ASSAY0320 | Hs00202526_m1 | NARF | nuclear prelamin A | AAAAGTCTTGGGGTGCACTATGTAT |
| | | | recognition factor | |
| ASSAY0321 | Hs00202956_m1 | PRPF6 | PRP6 pre-mRNA | CGTGGCCAAGCTGTTTTGGAGTCAG |
| | | | processing factor 6 | |
| | | | homolog (S. cerevisiae) | |
| ASSAY0331 | Hs00204803_m1 | PIK3R5 | phosphoinositide-3- | AGAAGACCCGAGAGGTCCAGGAGAA |
| | | | kinase, regulatory | |
| | | | subunit 5 | |
| ASSAY0335 | Hs00207926_m1 | SEC24D | SEC24 family, member | CAGCAAGCCAGCTTATTCTACCAGA |
| | | | D (S. cerevisiae) | |
| ASSAY0336 | Hs00208333_m1 | IQSEC1 | IQ motif and Sec7 | ACCTCCGAGGTGTGGACGATGGTGA |
| | | | domain 1 | |
| ASSAY0337 | Hs00208459_m1 | N4BP2L2 | NEDD4 binding protein | ATTGTCTCGAATTCTGCTTGGTCAG |
| | | | 2-like 2 | |
| ASSAY0340 | Hs00210194_m1 | SIPA1L1 | signal-induced | ACTAGAGAGGCGGCTGTCTCCTGGT |
| | | | proliferation- | |
| | | | associated 1 like 1 | |
| ASSAY0341 | Hs00210368_m1 | SH3YL1 | SH3 domain containing, | ATCATGAGAGAGTTGGCAATTTGAA |
| | | | Ysc84-like 1 | |
| | | | (S. cerevisiae) | |
| ASSAY0342 | Hs00210626_m1 | VILL | villin-like | GGAAGGTGGAGGTGTGGTGCATCCA |
| ASSAY0344 | Hs00211234_m1 | FAM164A | family with sequence | ACATAGCCAGGCCAGATGGGGACTG |
| | | | similarity 164, | |
| | | | member A | |
| ASSAY0345 | Hs00211349_m1 | TMED5 | transmembrane emp24 | ATCAGATGGAGTTCACACTGTAGAG |
| | | | protein transport | |
| | | | domain containing 5 | |
| ASSAY0348 | Hs00212451_m1 | CAB39 | calcium binding | GCTCATTGACTTTGAGGGCAAAAAA |
| | | | protein 39 | |
| ASSAY0351 | Hs00212862_m1 | ZC3HC1 | zinc finger, C3HC-type | CCATCCCCAGACCGATTTGGGATGT |
| | | | containing 1 | |
| ASSAY0354 | Hs00213209_m1 | ZDHHC3 | zinc finger, DHHC-type | TCGTCCTGTTTACAATGTACATAGC |
| | | | containing 3 | |
| ASSAY0355 | Hs00214019_m1 | SMG6 | Smg-6 homolog, | CCCCTCATCGTGATCAATGAGCTGG |
| | | | nonsense mediated | |
| | | | mRNA decay factor | |
| | | | (C. elegans) | |
| ASSAY0356 | Hs00214159_m1 | FAM46A | family with sequence | ACTCACGCTCAAGGAAGCTTATGTG |
| | | | similarity 46, member A | |
| ASSAY0357 | Hs00214281_m1 | AFTPH | aftiphilin | TATGCAGCAGGATTGGGTATGTTAG |
| ASSAY0362 | Hs00215155_m1 | MARCH5 | membrane-associated | CCAAAATTGGGTCCAGTGGTTTACG |
| | | | ring finger (C3HC4) 5 | |
| ASSAY0367 | Hs00215976_m1 | ARGLU1 | arginine and glutamate | AGCCAAACTGGCCGAAGAACAGTTG |
| | | | rich 1 | |
| ASSAY0374 | Hs00218284_m1 | TBC1D2 | TBC1 domain family, | CTTCTGACGAAGTGCGCCTACCTCC |
| | | | member 2 | |
| ASSAY0380 | Hs00609603_m1 | ACVR2B | activin A receptor, | ATTGCCCACAGGGACTTTAAAAGTA |
| | | | type IIB | |
| ASSAY0391 | Hs00272972_m1 | MYST2 | MYST histone | CCAGGCACCAGGCACCAACGGAGAG |
| | | | acetyltransferase 2 | |
| ASSAY0392 | Hs00287264_m1 | ACSS1 | acyl-CoA synthetase | TGGGGTCAGTGGGAGAGCCCATCAA |
| | | | short-chain family | |
| | | | member 1 | |
| ASSAY0393 | Hs00295454_s1 | N/A | N/A | AGCTAAGAGGTTTCCAGTGCAATAC |
| ASSAY0394 | Hs00325999_m1 | TET2 | tet oncogene family | GGCAGCACATTGGTATGCACTCTCA |
| | | | member 2 | |
| ASSAY0400 | Hs00379387_m1 | RAD54L2 | RAD54-like 2 | GGCTGCCTCAGGTTCCCAGGGACCT |
| | | | (S. cerevisiae) | |
| ASSAY0402 | Hs00390635_m1 | TNK | TRAF2 and NCK | ACCCATCAGAGCAAGCAACCCTGAT |
| | | | interacting kinase | |
| ASSAY0405 | Hs00415453_g1 | TRA@ | T cell receptor alpha | TGGATTCAGTTGGCATGGGTGAGCA |
| | | | locus | |
| ASSAY0407 | Hs00540709_s1 | TMEM203 | transmembrane | CGGGAGCTGGTGCAGTGGCTAGGCT |
| | | | protein 203 | |
| ASSAY0408 | Hs00559348_m1 | CR1 | complement component | TGTTCCTGCTGCCTGCCCACATCCA |
| | | | (3b/4b) receptor 1 | |
| | | | (Knops blood group) | |
| ASSAY0409 | Hs00606257_m1 | ATP6V1G1 | ATPase, H+ | CCCGCAAAAGAAAGAACCGGAGGCT |
| | | | transporting, lysosomal | |
| | | | 13 kDa, V1 subunit G1 | |
| ASSAY0420 | Hs00609515_m1 | CD247 | CD247 molecule | GCCTTTACCAGGGTCTCAGTACAGC |
| ASSAY0421 | Hs00609836_m1 | AARS | alanyl-tRNA synthetase | CAAAATTTGGGGCTGGATGACACCA |
| ASSAY0425 | Hs00610478_m1 | PWP2 | PWP2 periodic | GGCTGGCCAAGTACTTCTTCAATAA |
| | | | tryptophan protein | |
| | | | homolog (yeast) | |
| ASSAY0427 | Hs00610590_m1 | NEDD9 | neural precursor cell | GGAACATCATCAGCTGAGCCAGTTC |
| | | | expressed develop- | |
| | | | mentally down- | |
| | | | regulated 9 | |
| ASSAY0431 | Hs00612292_m1 | TRA@ | T cell receptor alpha | CTGTGTTTCTGACCTTTGGAACTAT |
| | | | locus | |
| ASSAY0433 | Hs00697331_m1 | YTHDF1 | YTH domain family, | TGGTGCGCAAGGAACGGCAGAGTCG |
| | | | member 1 | |
| ASSAY0435 | Hs00702769_s1 | MARCKSL1 | MARCKS-like 1 | GTCCCCCCCAAGGAGACCCCCAAGA |
| ASSAY0437 | Hs00705412_s1 | NFIL3 | nuclear factor, | ACTCTCCACAAAGCTCGCTGTCCGA |
| | | | interleukin 3 regulated | |
| ASSAY0440 | Hs00706419_s1 | SELT | selenoprotein T | ACATGATTGAGAACCAGTGTATGTC |
| ASSAY0441 | Hs00708570_s1 | PSENEN | presenilin enhancer 2 | TGGGGCCCTGCTTATTCTCCCAGGA |
| | | | homolog (C. elegans) | |
| ASSAY0442 | Hs00733884_m1 | U2AF1 | U2 small nuclear RNA | CTGACGGCTCACACTACCATTGCCC |
| | | | auxiliary factor 1 | |
| ASSAY0449 | Hs00741181_g1 | LAGE3 | L antigen family, | AGGATCCTGGTCGTCCGCTGGAAAG |
| | | | member 3 | |
| ASSAY0450 | Hs00743508_s1 | C18orf32 | chromosome 18 open | AGGTAGAATTTTGGGAGGTAATAAT |
| | | | reading frame 32 | |
| ASSAY0456 | Hs00750443_s1 | ARL8B | ADP-ribosylation | GTGTGACTCTGTGGGGACTGCATAG |
| | | | factor-like 8B | |
| ASSAY0460 | Hs00759012_s1 | MTRF1L | mitochondrial | CGGACTAAGGATGCGGTCCCGGGTT |
| | | | translational release | |
| | | | factor 1-like | |
| ASSAY0463 | Hs00762481_s1 | RPL36 | ribosomal protein L36 | CCTTCTCCCCGTCGCTGTCCGCAGC |
| ASSAY0472 | Hs00234637_m1 | NKTR | natural killer-tumor | AATCGGCGGTCCAGGAGTTGTAGAT |
| | | | recognition sequence | |
| ASSAY0480 | Hs00242160_m1 | HHEX | hematopoietically | ACCCCCTGGGCAAACCTCTACTCTG |
| | | | expressed homeobox | |
| ASSAY0484 | Hs00244740_m1 | CDC25B | cell division cycle 25 | GGCGGAGCAGACGTTTGAACAGGCC |
| | | | homolog B (S. pombe) | |
| ASSAY0489 | Hs00248408_m1 | Sep-06 | septin 6 | AGAAAGAGCTGCACGAGAAGTTTGA |
| ASSAY0501 | Hs00256990_m1 | CENPO | centromere protein O | CGGCGAGCCAGCGTGAAAGCATGTA |
| ASSAY0513 | Hs00260900_m1 | C5orf32 | chromosome 5 open | CAGGAGCCTCCTAAAACCACAGTGT |
| | | | reading frame 32 | |
| ASSAY0514 | Hs00261275_m1 | PGBD1 | piggyBac transposable | AGTCAGGTCCCAGACATTGGTGAAG |
| | | | element derived 1 | |
| ASSAY0517 | Hs00261978_m1 | PYROXD2 | pyridine nucleotide- | TGGTGGCTGCAGCGTACCTGCAGAG |
| | | | disulphide | |
| | | | oxireductase domain 2 | |
| ASSAY0526 | Hs00266011_m1 | DNAJA1 | DnaJ (Hsp40) | CTCAGCCCGCACCGGCAGTAGAAGA |
| | | | homolog, subfamily A, | |
| | | | member 1 | |
| ASSAY0527 | Hs00266036_m1 | EIF3E | eukaryotic translation | TTATCAGCCACAATATCTTAATGCA |
| | | | initiation factor 3, | |
| | | | subunit E | |
| ASSAY0535 | Hs00268342_m1 | SORL1 | sortilin-related | CAACAAGCGGTACATCTTTGCAGAC |
| | | | receptor, L(DLR class) | |
| | | | A repeats-containing | |
| ASSAY0537 | Hs00269247_s1 | GPR65 | G protein-coupled | TTCTCTCCTGCCTTGTGCAAAGGGA |
| | | | receptor 65 | |
| ASSAY0548 | Hs00273238_m1 | BACE2 | beta-site APP-cleaving | ACACTTGCCAAGCCATCAAGTTCTC |
| | | | enzyme 2 | |
| ASSAY0549 | Hs00273329_s1 | NAT6 | N-acetyltransferase 6 | CCGCACCTCCCGCCTGCACTCCCTG |
| | | | (GCN5-releated) | |
| ASSAY0550 | Hs00273392_s1 | LDOC1 | leucine zipper, down- | AACCCCAGCTATTGGCCAGGCCCCT |
| | | | regulated in cancer 1 | |
| ASSAY0553 | Hs00275656_m1 | GSK3B | glycogen synthase | AGAAATAATCAAGGTCCTGGGAACT |
| | | | kinase 3 beta | |
| ASSAY0555 | Hs00276784_m1 | N/A | N/A | N/A |
| ASSAY0558 | Hs00287906_s1 | H3F3B | H3 histone, family 3B | GCTGTATTTGCAGTGTGGGCTAAGA |
| | | | (H3.3B) | |
| ASSAY0559 | Hs00291515_m1 | IKBIP | IKBKB interacting | TAATTTCAGAAAAGCTTGAGTCTAC |
| | | | protein | |
| ASSAY0562 | Hs00292593_m1 | COMMD7 | COMM domain | GGGCGCGCAGCAGTTCTCAGCCCTG |
| | | | containing 7 | |
| ASSAY0569 | Hs00299171_m1 | CCDC127 | coiled-coil domain | TTGGCTGCTTTTCGTTGGATTTGGT |
| | | | containing 127 | |
| ASSAY0572 | Hs00300396_m1 | PELP1 | proline, glutamate and | TCTCTCAAAGGCAAGCTGGCCTCAT |
| | | | leucine rich protein 1 | |
| ASSAY0577 | Hs00328354_m1 | HUWE1 | HECT, UBA and WWE | GAAAAAGATCAGATGGGGAACAGGA |
| | | | domain containing 1 | |
| ASSAY0584 | Hs00356601_m1 | CCR2 | chemokine (C-C motif) | GCCACAAGCTGAACAGAGAAAGTGG |
| | | | receptor 2 | |
| ASSAY0588 | Hs00360923_g1 | CRELD2 | cysteine-rich with | TCCAAGTACGAGTCCAGCGAGATTC |
| | | | EGF-like domains 2 | |
| ASSAY0591 | Hs00361490_m1 | CNR2 | cannabinoid receptor 2 | ACAACACAACCCAAAGCCTTCTAGA |
| | | | (macrophage) | |
| ASSAY0597 | Hs00364835_m1 | LRG1 | leucine-rich alpha-2- | ACCAAAAAGCCCAGGGGGCATTCAA |
| | | | glycoprotein 1 | |
| ASSAY0598 | Hs00364877_m1 | NCRNA002 | non-protein coding | AAAGGTGACCTGAAGGATGTCCTTG |
| | | 19 | RNA 219 | |
| ASSAY0599 | Hs00365678_g1 | RAB24 | RAB24, member RAS | GTATTTGGGACACAGCAGGCTCTGA |
| | | | oncogene family | |
| ASSAY0608 | Hs00370691_m1 | FAM113B | family with sequence | TACTTTAATGACCATCCGCAGAGCC |
| | | | similarity 113, | |
| | | | member B | |
| ASSAY0614 | Hs00373045_m1 | GAB2 | GRB2-associated | GAGAGCACAGACTCCCTGAGAAATG |
| | | | binding protein 2 | |
| ASSAY0624 | Hs00377427_m1 | APBB1 | amyloid beta (A4) | TCCCCAGAGGACACAGATTCCTTCT |
| | | | precursor protein- | |
| | | | binding, family B, | |
| | | | member 1 (Fe65) | |
| ASSAY0637 | Hs00383718_m1 | C5AR1 | complement component | AGACCAGAACATGAACTCCTTCAAT |
| | | | 5a receptor 1 | |
| ASSAY0543 | Hs00386037_m1 | BOD1L | biorientation of | CAGAGGCTCAGAGATCAAAGACACA |
| | | | chromosomes in cell | |
| | | | division 1-like | |
| ASSAY0645 | Hs00387426_m1 | MAP2K4 | mitogen-activated | CAAATAATGGCAGTTAAAAGAATTC |
| | | | protein kinase kinase 4 | |
| ASSAY0651 | Hs00391737_m1 | SMG6 | Smg-6 homolog, nonsense | ACGCAAGACAGTAAAATATGCCTTG |
| | | | mediated mRNA decay | |
| | | | factor (C. elegans) | |
| ASSAY0653 | Hs00393297_m1 | ZNF512B | zinc finger protein | TGGTAAGAAAAGGGCTGCGGACAGC |
| | | | 512B | |
| ASSAY0655 | Hs00394683_m1 | LST1 | leukocyte specific | AGGCCACAAGCTCTGGATGAGGAAC |
| | | | transcript 1 | |
| ASSAY0656 | Hs00395045_m1 | STMN3 | stathmin-like 3 | CCAGTACGGGGACATGGAGGTGAAG |
| ASSAY0661 | Hs00405469_m1 | JMJD1C | jumonji domain | TCAAAAGCAGGAATTCTCAAGAAAT |
| | | | containing 1C | |
| ASSAY0664 | Hs00405872_m1 | CYTSA | cytospin A | GTGCAGCGCGTGTTCTTGGGGAAGA |
| ASSAY0668 | Hs00411197_m1 | LRRK2 | leucine-rich repeat | GACAAGAACAAGCCAACTGTTTTCT |
| | | | kinase 2 | |
| ASSAY0670 | Hs00411807_m1 | PHRF1 | PHD and ring finger | GTGCAGAAGATCTGCCACAGCAAGA |
| | | | domains 1 | |
| ASSAY0671 | Hs00412084_m1 | RFTN1 | raftlin, lipid raft | CCGACAGATCTCAGAAAACTGATCT |
| | | | linker 1 | |
| ASSAY0674 | Hs00414236_m1 | GLTSCR2 | glioma tumor | CGCACGAGCGGTGGCTTGTTGTCAG |
| | | | suppressor candidate | |
| | | | region gene 2 | |
| ASSAY0677 | Hs00414889_m1 | ANKRD36B | ankyrin repeat domian | GAAGGAAAGGACTGCCCTACATTTG |
| | | | 36B | |
| ASSAY0682 | Hs00416940_m1 | INSC | inscuteable homolog | TGGCCTGCCTGGCTGCTCTGCGTAG |
| | | | (Drosophila) | |
| ASSAY0683 | Hs00417251_m1 | SNHG6 | small nucleolar RNA | TAGCTGGGCTCTGCGAGGTGCAAGA |
| | | | host gene 6 (non- | |
| | | | protein coding) | |
| ASSAY0684 | Hs00417273_m1 | LRRK2 | leucine-rich repeat | TTTGGCCCTCCTCACTGAGACTATT |
| | | | kinase 2 | |
| ASSAY0691 | Hs00420179_m1 | FAM159A | family with sequence | ACAGACAGCAGGCCCTGAGGAGGTT |
| | | | similarity 159, | |
| | | | member A | |
| ASSAY0692 | Hs00426231_m1 | LYZ | lysozyme (renal | TATCCTGCAGTGCTTTGCTGCAAGA |
| | | | amyloidosis) | |
| ASSAY0693 | Hs00427259_m1 | PPP2CA | protein phosphatase 2, | GAAGTTCCCCATGAGGGTCCAATGT |
| | | | catalytic subunit, | |
| | | | alpha isozyme | |
| ASSAY0695 | Hs00427795_g1 | TNFRSF10 | tumor necrosis factor | CGGAAGTGTAGCAGGTGCCCTAGTG |
| | | C | receptor superfamily, | |
| | | | member 10c, decoy | |
| | | | without an intra- | |
| | | | cellular domain | |
| ASSAY0699 | Hs00429452_m1 | VPREB3 | pre-B lymphocyte 3 | CCTTCCTGTCAGTTTCCCAGACAGT |
| ASSAY0702 | Hs00429977_m1 | SHISA5 | shisa homolog 5 | CCGGGTGCACGTGGTGAGGTGTGTA |
| | | | (Xenopus laevis) | |
| ASSAY0706 | Hs00431040_g1 | SIRPG | signal-regulatory | CAGAAGACCTGACTCTCCTTCCTTC |
| | | | protein gamma | |
| ASSAY0709 | Hs00536594_m1 | MTG1 | mitochondrial GTPase | CAGCGCTTTGGGTACGTGCAGCACT |
| | | | 1 homolog | |
| | | | (S. cerevisiae) | |
| ASSAY0713 | Hs00538077_m1 | C5orf41 | chromosome 5 open | ACACCCACAGACAGCATCGCACAGA |
| | | | reading frame 41 | |
| ASSAY0720 | Hs00540812_m1 | CCDC101 | coiled-coil domain | AGAGGCTGAGTGCAACATCCTTCGG |
| | | | containing 101 | |
| ASSAY0734 | Hs00602957_m1 | HN1 | hematological and | CCAAGTCAGCAGGTGCCAAGTCTAG |
| | | | neurological | |
| | | | expressed 1 | |
| ASSAY0741 | Hs00606874_g1 | TNFRSF13 | tumor necrosis factor | CGGAGACAAGGACGCCCCAGAGCCC |
| | | C | receptor superfamily, | |
| | | | member 13C | |
| ASSAY0745 | Hs00826823_m1 | SFI1 | Sfi1 homolog, spindle | GCAGAACCTCTGGTCCTGTCGGCGG |
| | | | assembly associated | |
| | | | (yeast) | |
| ASSAY0750 | Hs00846452_s1 | RNF208 | ring finger protein 208 | CCACGTGCGGAACCCACTGTCCGCC |
| ASSAY0751 | Hs00852410_g1 | PRKRIR | protein-kinase, | TACTCTGCAGTGCAGTGTCAGATTT |
| | | | interferon-inducible | |
| | | | double stranded RNA | |
| | | | dependent inhibitor, | |
| | | | repressor of (P58 | |
| | | | repressor) | |
| ASSAY0752 | Hs00854645_g1 | BRI3 | brain protein I3 | CCTTCCTGGGCATCTTCCTGGCCAT |
| ASSAY0754 | Hs00867656_g1 | DLEU2 | deleted in lymphocytic | AAAAATTTATTTTACACATGTCAAG |
| | | | leukemia 2 (non- | |
| | | | protein coding) | |
| ASSAY0755 | Hs00891617_s1 | N/A | N/A | ACAGTTGTTTATGGTAGGAGGACTA |
| ASSAY0758 | Hs00898410_g1 | RPL32P3 | ribosomal protein L32 | GCTGGCAGGCACCATGTCGTCCTGT |
| | | | pseudogene 3 | |
| ASSAY0759 | Hs00900829_g1 | IL23A | interleukin 23, alpha | CCTCAGCCAACTCCTGCAGCCTGAG |
| | | | subunit p19 | |
| ASSAY0762 | Hs00902624_m1 | MED6 | mediator complex | AGAAAAGCCTGTTCCAGTGGATCAA |
| | | | subunit 6 | |
| ASSAY0763 | Hs00907493_m1 | TRA2B | transformer 2 beta | ATCAGATTTATAGAAGGCGGTCACC |
| | | | homolog (Drosophila) | |
| ASSAY0766 | Hs00918972_m1 | TCF12 | transcription factor 12 | AACATCAGCCAGTTCCAGAGTTATC |
| ASSAY0767 | Hs00921653_m1 | RBM19 | RNA binding motif | CCGCTCACTTTCACGAGCCCCCGAA |
| | | | protein 19 | |
| ASSAY0773 | Hs00932180_g1 | RPS5 | ribosomal protein S5 | TGACATTTCCCTGCAGGATTACATT |
| ASSAY0774 | Hs00935093_m1 | SYNJ2BP | synaptojanin 2 binding | AGCACAGGTTACAGGTGCAGAATGG |
| | | | protein | |
| ASSAY0778 | Hs00939205_m1 | RNF24 | ring finger protein 24 | GCCTTCCACAGAAAGTGCCTTATTA |
| ASSAY0782 | Hs00945401_m1 | ANXA1 | annexin A1 | TGCCAAGCCATCCTGGATGAAACCA |
| ASSAY0784 | Hs00949382_m1 | ST6GAL1 | ST6 beta- | CCAAAGTGGTACCAGAATCCGGATT |
| | | | galactosamide alpha- | |
| | | | 2,6-sialytransferase 1 | |
| ASSAY0790 | Hs00963390_g1 | CCT8 | chaperonin containing | GTGGTTTTTAAGCATGAAAAGGAAG |
| | | | TCP1, subunit 8 (theta) | |
| ASSAY0792 | Hs00967069_m1 | DNAJC13 | DnaJ (Hsp40) homolog, | AGCAGGATACCTCACAGGACCTGGA |
| | | | subfamily C, member 13 | |
| ASSAY0793 | Hs00967250_m1 | BRP44 | brain protein 44 | AGCTTTTTCGTATTTGGAGATATAA |
| ASSAY0794 | Hs00970533_g1 | SUB1 | SUB1 homolog | GTTGACAAAAAGTTAAAGAGGAAAA |
| | | | (S. cerevisiae) | |
| ASSAY0795 | Hs00971411_m1 | ANXA3 | annexin A3 | TTACTGTTGGCCATAGTTAATTGTG |
| ASSAY0801 | Hs00985988_g1 | CROCC | ciliary rootlet coiled- | CCGCCAGAGGGTGTCCACACTGAAG |
| | | | coil, rootletin | |
| ASSAY0806 | Hs00997789_m1 | PSEN1 | presenilin 1 | TTCATTTACTTGGGGGAAGTGTTTA |
| ASSAY0809 | Hs01003603_m1 | CISH | cytokine inducible | TGCGTTCAGGGACCTCGTCCTTTGC |
| | | | SH2-containing protein | |
| ASSAY0811 | Hs01008103_m1 | DAK | dihydroxyacetone | AGCCGTGCGGCCAGAGCAATCCAGG |
| | | | kinase 2 homolog | |
| | | | (S. cerevisiae) | |
| ASSAY0820 | Hs01031740_m1 | ARPC2 | actin related protein | TGAAAACAATCACGGGGAAGACGTT |
| | | | 2/3 complex, subunit 2, | |
| | | | 34 kDa | |
| ASSAY0821 | Hs01032565_m1 | ST6GALNA | ST6 (alpha-N-acetyl- | CCTGTGACCAGGTCAGTGCCTATGG |
| | | C2 | neuraminyl-2,3-beta- | |
| | | | galactosyl-1,3)-N- | |
| | | | acetylgalactosaminide | |
| | | | alpha-2,6- | |
| | | | sialyltransferase 2 | |
| ASSAY0822 | Hs01032700_m1 | LBR | lamin B receptor | TTATTGTTCTGAAACTTTGTGGTTA |
| ASSAY0826 | Hs01036536_m1 | BCR | breakpoint cluster | ATTGCTGTGGTCACCAAGAGAGAGA |
| | | | region | |
| ASSAY0833 | Hs01051024_g1 | SETDB1 | SET domain, | TCCCAACCCTTCTTGAACTGGGTCT |
| | | | bifurcated 1 | |
| ASSAY0835 | Hs01053640_m1 | TXK | TXK tyrosine kinase | GCTGGCATGAGAAACCTGAAGGCCG |
| ASSAY0838 | Hs01056146_m1 | DDX21 | DEAD (Asp-Glu-Ala-Asp) | AACAGAAATACAGGAGAAATGGCAT |
| | | | box polypeptide 21 | |
| ASSAY0842 | Hs01062739_m1 | TMX4 | thioredoxin-related | TCTGAGCGTTCTGAGCAGAATCGGA |
| | | | transmembrane protein 4 | |
| ASSAY0843 | Hs01064052_g1 | SEPX1 | selenoprotein X, 1 | TTGTCCCTAAAGGCAAAGAAACTTC |
| ASSAY0853 | Hs01075667_m1 | IL6R | interleukin 6 receptor | GCACGCCTTGGACAGAATCCAGGAG |
| ASSAY0859 | Hs01090047_m1 | PRKCD | protein kinase C, delta | AGGACATCCTGGAGAAGCTCTTTGA |
| ASSAY0862 | Hs01095303_m1 | RALB | v-ral simian leukemia | AACGTGGACAAGGTGTTCTTTGACC |
| | | | viral oncogene homolog | |
| | | | B (ras related; GTP | |
| | | | binding protein) | |
| ASSAY0863 | Hs01102345_m1 | RPL37A | ribosomal protein L37a | GCGGTGCCTGGACGTACAATACCAC |
| ASSAY0867 | Hs01110945_m1 | ADA | adenosine deaminase | GTTTAAAAGGCTGAACATCAATGCG |
| ASSAY0876 | Hs01372307_m1 | ZDHHC18 | zinc finger, DHHC-type | ACCTCCCAGCCTAATTGACCGGAGG |
| | | | containing 18 | |
| ASSAY0879 | Hs01395179_m1 | LOC10013 | hypothetical protein | CTCAGATTTTGAGCAAACAAAGCTC |
| | | 1564 | LOC100131564 | |
| ASSAY0883 | Hs01553131_m1 | FNBP4 | formin binding | TGGTTAGTGGCATGGCAGAGAGAAA |
| | | | protein 4 | |
| ASSAY0886 | Hs01564142_m1 | GLIPR1 | GLI pathogenesis- | CTATACATGACTTGGGACCCAGCAC |
| | | | related 1 | |
| ASSAY0897 | Hs01595350_m1 | DTX3 | deltex homolog 3 | CCGGTGTCCAGGGGGCTGAACACCC |
| | | | (Drosophila) | |
| ASSAY0904 | Hs01885851_s1 | LTB4R2 | leukotriene B4 | CTACGGCCTTGGCCTTCTTCAGTTC |
| | | | receptor 2 | |
| ASSAY0907 | Hs01908739_s1 | SLC25A45 | solute carrier family | CAAAGGAGGTGGTGTCTGTCAGTCA |
| | | | 25, member 45 | |
| ASSAY0911 | Hs01926559_g1 | RPL13A | ribosomal protein L13a | CTGGGAAGATGCACAACCAAGGGGT |
| ASSAY0913 | Hs01945436_u1 | RPS13 | ribosomal protein S13 | GTCCTCCCTCCCAATTGGAAATATG |
| ASSAY0914 | Hs02339116_s1 | OR52K1 | olfactory receptor, | GGCAGTTCTCCAGCTTGCCTCTCAG |
| | | | family 52, subfamily K, | |
| | | | member 1 | |
| ASSAY0919 | Hs02510591_s1 | DPYD | dihydropyrimidine | GATGGGTGTACAAACTCATCCTCTT |
| | | | dehydrogenase | |
| ASSAY0922 | Hs02597217_g1 | GNG10; | guanine nucleotide | GAGAGGATCAAGGTCTCTCAGGCAG |
| | | LOC65350 | binding protein (G | |
| | | 3 | protein), gamma 10; | |
| | | | GNG10 pseudogene | |
| ASSAY0931 | Hs99999003_m1 | MYC | v-myc | GGAGACACCGCCCACCACCAGCAGC |
| | | | myelocytomatosis viral | |
| | | | ongogene homolog | |
| | | | (avian) | |
| ASSAY0935 | Hs00991010_m1 | IL1R1 | interleukin 1 receptor, | TATTACAGTGTGGAAAATCCTGCAA |
| | | | type I | |
| ASSAY0939 | Hs00999731_g1 | PICALM | phosphatidylinositol | AAATGGAACCACTAAGAATGATGTA |
| | | | binding clathrin | |
| | | | assembly protein | |
| ASSAY0944 | Hs01587378_mH | TOMM40 | translocase of outer | CCCACAGAGGCGTTCCCTGTACTGG |
| | | | mitochondrial membrane | |
| | | | 40 homolog (yeast) | |
| ASSAY0947 | Hs00254569_s1 | HRH2 | histamine receptor H2 | GGTCACCCCAGTTCGGGTCGCCATC |
| ASSAY0948 | Hs00203146_m1 | C11orf2 | chromosome 11 open | ATCTCAGCCACAGACACCATCCGGA |
| | | | reading frame 2 | |
| ASSAY0950 | Hs01123468_m1 | DIDO1 | death inducer- | ATGCGGTGCTCAGGCAGGTATTAAA |
| | | | obliterator 1 | |
| ASSAY0957 | Hs00536435_m1 | NLRP12 | NLR family, pyrin | ACTACGGACTTTGTGGCTGAAGATC |
| | | | domain containing 12 | |
| ASSAY0959 | Hs00185574_m1 | EZR | ezrin | AAAATGCCGAAACCAATCAATGTCC |
| ASSAY0962 | Hs00211306_m1 | DHRS7 | dehydrogenase/reductase | CTTTAAGAGTGGTGTGGATGCAGAC |
| | | | (SDR family) member 7 | |
| ASSAY0964 | Hs00375656_m1 | MRPL38 | mitochondrial | ATTTCGGGGAGAAGACAGATCCCAA |
| | | | ribosomal protein L38 | |
| ASSAY0966 | Hs00323799_m1 | RNF160 | ring finger protein 160 | TGAAAAGGCATGTCCTAGTTCAGAT |
| ASSAY0968 | Hs00209150_m1 | EPN2 | epsin 2 | AAAACAGCCGAATCTGTGACCTCTC |
| ASSAY0969 | Hs00948075_m1 | HUWE1 | HECT, UBA and WWE | TCAATTGGCCAAGGTATTTCCCAGC |
| | | | domain containing 1 | |
| ASSAY0971 | Hs00391048_m1 | MEGF9 | multiple EGF-like | GTGCAACAGTTCTGGGAAATGCCAG |
| | | | domains 9 | |
| ASSAY0978 | Hs00830212_s1 | CALM2 | calmodulin 2 | GTTTAGCCACTTAAAATCTGCTTAT |
| | | | (phosphorylase kinase, | |
| | | | delta) | |
| ASSAY0990 | Hs00225286_m1 | ZNF655; | zinc finger protein | CCCCTCCCCTCGTGATGGTCATTGT |
| | | NUDCD3 | 655; NudC domain | |
| | | | containing 3 | |
| ASSAY0994 | Hs00219784_m1 | EIF4ENIF1 | eukaryotic translation | TCAGAAACAGGCAACAGCGAGTGAC |
| | | | initiation factor 4E | |
| | | | nuclear import factor 1 | |
| ASSAY1006 | Hs00228595_m1 | GON4L | gon-4-like (C. elegans) | GATGTGGGGAATGAAGATGAAGCAG |
| ASSAY1022 | Hs00183764_m1 | PRDM4 | PR domain containing 4 | TCCCTGCCCCAGGCCTCCCAGTGGC |
| ASSAY1023 | Hs01573555_m1 | ITPR3 | inositol 1,4,5- | GCTTCATCTGTGGTCTGGAGAGGGA |
| | | | triphosphate receptor, | |
| | | | type 3 | |
| ASSAY1024 | Hs00918650_m1 | CSDE1 | cold shock domain | TAAAAGTAGGAGATGATGTTGAATT |
| | | | containing E1, RNA- | |
| | | | binding | |
| ASSAY1025 | Hs00182082_m1 | MYD88 | myeloid differentiation | CCCAGCATTGAGGAGGATTGCCAAA |
| | | | primary response gene | |
| | | | (88) | |
| ASSAY1026 | Hs00162271_m1 | SPTBN1 | spectrin, beta, non- | GCTCTGGGCACACAGGTGAGGCAGC |
| | | | erythrocytic 1 | |
| ASSAY1029 | Hs00203675_m1 | C16orf5 | chromosome 16 open | TGCCTCCGGGTTTCTACCCTCCTCC |
| | | | reading frame 5 | |
| ASSAY1036 | Hs00218198_m1 | DCP1A | DCP1 decapping | CCATCCCGGTTGCAGGCGCCCCACT |
| | | | enzyme homolog A | |
| | | | (S. cerevisiae) | |
| ASSAY1039 | Hs00425763_m1 | TAF6 | TAF6 RNA polymerase | GAGCCTCCTGCTGAAACACTGTGCT |
| | | | II, TATA box binding | |
| | | | protein (TBP)- | |
| | | | associated factor, | |
| | | | 80 kDa | |
| ASSAY1045 | Hs00399261_m1 | RPRD2 | regulation of nuclear | GGCTCCGGAGATCTGCATATCCCCA |
| | | | pre-mRNA domain | |
| | | | containing 2 | |
| ASSAY1046 | Hs00388156_m1 | CHID1 | chitinase domain | GTTGTCGGGGCCAGGTACATCCAGA |
| | | | containing 1 | |
| ASSAY1052 | Hs00391528_m1 | ANKRD17 | ankyrin repeat | ACTAGAAGCTGCAGGAATAGGAAAA |
| | | | domain 17 | |
| ASSAY1053 | Hs00984230_m1 | B2M | beta-2-microglobulin | AAGCAGCATCATGGAGGTTTGAAGA |
| ASSAY1057 | Hs00200632_m1 | SYNRG | snergin, gamma | CCCAAGAAACCAGGCCCTTCCTTGG |
| ASSAY1059 | Hs00195059_m1 | SORBS3 | sorbin and SH3 | ATGGCTGGTTTGTGGGTGTCTCCCG |
| | | | domain containing 3 | |
| ASSAY0161 | Hs00330542_m1 | TPCN1 | two pore segment | TACCTCCAGGAAGGCGAGAACAACG |
| | | | channel 1 | |
| ASSAY1063 | Hs00418559_m1 | POGZ | pogo transposable | CAACAATGCTGGCAATCCTTTGGTC |
| | | | element with ZNF domain | |
| ASSAY1074 | Hs00386697_m1 | IL2RB | interleukin 2 receptor, | GAACACCGGGCCATGGCTGAAGAAG |
| | | | beta | |
| ASSAY1078 | Hs00229975_m1 | HUWE1 | HECT, UBA and WWE | TGAGAATGACAGGAGCCATCCGCAA |
| | | | domain containing 1 | |
| ASSAY1082 | Hs02559508_s1 | SMARCC1 | SWI/SNF releated, | GGGAGGGAGTTTGGCAAGAATGGAG |
| | | | matrix associated, | |
| | | | actin dependent | |
| | | | regulator or chromatin, | |
| | | | subfamily c, member 1 | |
| ASSAY1084 | Hs00390223_m1 | UBR4 | ubiquitin protein | ACATGACCACAGGTACAGAATCAGA |
| | | | ligase E3 component n- | |
| | | | recognin 4 | |
| ASSAY1088 | Hs00374213_m1 | GLUL | glutamate-ammonia | TTTCTGTGGCTGGGAACACCTTCCA |
| | | | ligase (glutamine | |
| | | | synthetase) | |
| ASSAY1090 | Hs00202989_m1 | STK39 | serine threonine | GAGGTTATCGGCAGTGGAGCTACTG |
| | | | kinase 39 (STE20/SPS1 | |
| | | | homolog, yeast) | |
| ASSAY1093 | Hs00226352_m1 | ZCCHC6 | zinc finger, CCHC | AAAGGCTCTTCAGGTAGCCTTTCCA |
| | | | domain containing 6 | |
| ASSAY1094 | Hs00289449_m1 | SFI1 | Sfi1 homolog, spindle | GCAGAATGAGATGGCTGAGCGATTC |
| | | | assembly associated | |
| | | | (yeast) | |
| ASSAY1096 | Hs00323180_m1 | ZNF862 | zinc finger protein 862 | TGGCATCCTTGGGACCTGCTGCTGC |
| ASSAY1097 | Hs00704884_s1 | C5AR1 | complement component | TATTTATTTTATGGCAAGTTGGAAA |
| | | | 5a receptor 1 | |
| ASSAY1101 | Hs00536591_g1 | MTG1 | mitochondrial GTPase 1 | CCGAAAAGAGAACCTGGAGTACTGT |
| | | | homolog (S. cerevisiae) | |
| ASSAY1102 | Hs00415445_m1 | RNF216L; | ring finger protein | GAGTGGCGACTCTTTTGAAACAGAT |
| | | RNF216 | 216-like; ring finger | |
| | | | protein 216 | |

TABLE 6
Informative probes for MCI versus non-MCI

| Sequence No. | TaqMan | Gene | | Context Sequence |
|---|---|---|---|---|
| (DiaGenic probe ID) | Assay ID | Symbol | Gene name | (Oligonucleotide Sequence) |
| ASSAY0011 | Hs99999905_m1 | GAPDH | glyceraldehyde-3- | GGGCGCCTGGTCACCAGGGCTGCTT |
| | | | phosphate | |
| | | | dehydrogenase | |
| ASSAY0012 | Hs00158122_m1 | ISG20 | interferon stimulated | GCATCCAGAACAGCCTGCTTGGACA |
| | | | exonuclease gene 20 kDa | |
| ASSAY0014 | Hs00171131_m1 | SCYE1 | small inducible | GATGCTTTCCCAGGAGAGCCTGACA |
| | | | cytokine subfamily E, | |
| | | | member 1 (endothelial | |
| | | | monocyte-activating) | |
| ASSAY0020 | Hs00190266_m1 | STX4 | syntaxin 4 | AGTGGAGATGCAGGGGGAGATGATC |
| ASSAY0022 | Hs00190463_m1 | C21orf33 | chromosome 21 open | GGGAAGCCCATCGGCTTGTGCTGCA |
| | | | reading frame 33 | |
| ASSAY0032* | Hs00200394_m1 | RASSF1 | Ras association | GAGGTGAACTGGGACGCCTTCAGCA |
| | | | (RalGDS/AF-6) domain | |
| | | | family member 1 | |
| ASSAY0047* | Hs00220301_m1 | PPAN; | peter pan homolog | ATCAACGTGCACAAGGTGAACCTGA |
| | | PPAN- | (Drosophila); PPAN- | |
| | | P2RY11 | P2RY11 readthrough | |
| ASSAY0051 | Hs00220527_m1 | C1orf128 | chromosome 1 open | CCCTCTGAGATGAGACTGTACAAGA |
| | | | reading frame 128 | |
| ASSAY0054 | Hs00221227_m1 | PLEKHA4 | pleckstrin homology | TCTCCCCAGGACAGAGTGTCTGCTC |
| | | | domain containing, | |
| | | | family A | |
| | | | (phosphoinositide | |
| | | | binding specific) | |
| | | | member 4 | |
| ASSAY0057 | Hs00221859_m1 | SQRDL | sulfide quinone | GTTGAGCCCAGTGAGAGACATTTCT |
| | | | reductase-like (yeast) | |
| ASSAY0070* | Hs00225747_m1 | NOTCH2 | Notch homolog 2 | GTGCCTTTACTGGCCGGCACTGTGA |
| | | | (Drosophila) | |
| ASSAY0072 | Hs00225928_m1 | C2orf47 | chromosome 2 open | AGGGAGCGAAGCAGGCTTTTGCTCA |
| | | | reading frame 47 | |
| ASSAY0082* | Hs00228787_m1 | COASY | Coenzyme A synthase | AAAGATCTGTTGAAGAGCAAGTTGC |
| ASSAY0089 | Hs00231324_m1 | SMARCA4 | SWI/SNF releated, | GAATCCTCACCAGGACCTGCAAGCG |
| | | | matrix associated, | |
| | | | actin dependent | |
| | | | regulator of chromatin, | |
| | | | subfamily a, member 4 | |
| ASSAY0093* | Hs00233856_m1 | LRP1 | low density lipoprotein | CCCCTGAGATTTGTCCACAGAGTAA |
| | | | receptor-related | |
| | | | protein 1 | |
| ASSAY0096* | Hs00234224_m1 | ADAM17 | ADAM metallopeptidase | GGTGTCCAGTGCAGTGACAGGAACA |
| | | | domain 17 | |
| ASSAY0110* | Hs00157194_m1 | CTSB | cathepsin B | AAGCCACCCCAGAGAGTTATGTTTA |
| ASSAY0113* | Hs00157831_m1 | GTF2E2 | general transcription | GCCCTTCTCACTCAGCATTATGGAT |
| | | | factor IIE, polypeptide | |
| | | | 2, beta 34 kDa | |
| ASSAY0114* | Hs00157950_m1 | HLA-DOB | major histocompat- | ACAGACTCTCCAGAAGATTTTGTGA |
| | | | ibility complex, | |
| | | | class II, DO beta | |
| ASSAY0123 | Hs00160216_m1 | EXOSC10 | exosome component 10 | GTTGCTTCAGTGCATGAGCAGAGTA |
| ASSAY0126 | Hs00162077_m1 | SOAT1 | sterol O- | CCATCTTGCCAGGTGTGCTGATTCT |
| | | | acyltransferase 1 | |
| ASSAY0128 | Hs00163761_m1 | BTK | Bruton | GTCAGGACTGAGCACACAGGTGAAC |
| | | | agammaglobulinemia | |
| | | | tyrosine kinase | |
| ASSAY0132 | Hs00166580_m1 | UBE3A | ubiquitin protein | CTAGCCGAATGAAGCGAGCAGCTGC |
| | | | ligase E3A | |
| ASSAY0135 | Hs00170192_m1 | PNN | pinin, desmosome | GGCAGTCAGTAGGCTGGGCGGGGAG |
| | | | associated protein | |
| ASSAY0137* | Hs99999908_m1 | GUSB | glucuronidase, beta | TGAACAGTCACCGACGAGAGTGCTG |
| ASSAY0139 | Hs00173091_m1 | HMG20B | high-mobility group 20B | GAAAAGCAGCGGTACCTGGATGAGG |
| ASSAY0140 | Hs00173196_m1 | ZNF146 | zinc finger protein 146 | AGGATCTGCGCGGAAGAAGCCTGAG |
| ASSAY0144 | Hs00174143_m1 | IFNG | interferon, gamma | AAGAAATATTTTAATGCAGGTCATT |
| ASSAY0148* | Hs00174575_m1 | CCL5 | chemokine (C-C motif) | CAACCCAGCAGTCGTCTTTGTCACC |
| | | | ligand 5 | |
| ASSAY0161 | Hs00176998_m1 | PRKCB | protein kinase C, beta | GGCAGAAATTTGAGAGGGCCAAGAT |
| ASSAY0163 | Hs00177066_m1 | MAPK1 | mitogen-activated | CGGCATGGTGTGCTCTGCTTATGAT |
| | | | protein kinase 1 | |
| ASSAY0178 | Hs00186661_m1 | NCOA1 | nuclear receptor | CACCTCAGCCACCCCTGAATGCTCA |
| | | | coactivator 1 | |
| ASSAY0179 | Hs00187510_m1 | RAB7L1 | RAB7, member RAS | CGGTGGGAGTGGATTTTGCTCTGAA |
| | | | oncogene family-like 1 | |
| ASSAY0181 | Hs00188259_m1 | WARS | tryptophanyl-tRNA | AACCAAGGTCAATAAGCATGCGTTT |
| | | | synthetase | |
| ASSAY0182* | Hs00188433_m1 | FIBP | fibroblast growth | TGACCGGTTGGCCAGGGACTATGCA |
| | | | factor (acidic) intra- | |
| | | | cellular binding | |
| | | | protein | |
| ASSAY0184* | Hs00189461_m1 | BPTF | bromodomain PHD | AGCAGCACTCCAGGTAGGCGAAAAC |
| | | | finger transcription | |
| | | | factor | |
| ASSAY0190* | Hs00154457_m1 | CIRBP | cold inducible RNA | GCCCGACTCAGTGGCCGCCATGGCA |
| | | | binding protein | |
| ASSAY0193 | Hs00162605_m1 | TCEB3 | transcription | TAGACATTCTTGCGGAGACTGGGGT |
| | | | elongation factor B | |
| | | | (SIII), polypeptide 3 | |
| | | | (110kDa, elongin A) | |
| ASSAY0202 | Hs00182698_m1 | SKAP2 | src kinase associated | CCTCTGATGGAGCCCAGTTTCCTCC |
| | | | phosphoprotein 2 | |
| ASSAY0203 | Hs00183479_m1 | PDE4A | phosphodiesterase 4A, | CCTGGCCCAAGAACTGGAGAACCTG |
| | | | cAMP-specific | |
| | | | (phosphodiesterase E2 | |
| | | | dunce homolog, | |
| | | | Drosophila) | |
| ASSAY0206 | Hs00195897_m1 | UBE4B | ubiquitination factor | AAATACCCCCTCATGGCACTAGGTG |
| | | | E4B (UFD2 homolog, | |
| | | | yeast) | |
| ASSAY0207* | Hs00196206_m1 | GZMA | granzyme A (granzyme | CCTGCTAATTCCTGAAGATGTCTGT |
| | | | 1, cytotoxic T- | |
| | | | lymphocyte-associated | |
| | | | serine esterase 3) | |
| ASSAY0209 | Hs00200082_m1 | UBL3 | ubiquitin-like 3 | CAATTGGCCAATGGACTGGGAAGAA |
| ASSAY0211 | Hs00203341_m1 | CNOT4 | CCR4-NOT | GATAATTCCCAGCAGATATCTAACA |
| | | | transcription complex, | |
| | | | subunit 4 | |
| ASSAY0212 | Hs00204260_m1 | C11orf21 | chromosome 11 open | GAGGAGGAGCGCTGTGCCCAGGTGG |
| | | | reading frame 21 | |
| ASSAY0216 | Hs00209573_m1 | KIF13B | kinesin family member | TGCCAACAGGAAGCGAGGCTCTCTT |
| | | | 13B | |
| ASSAY0217 | Hs00211141_m1 | SIDT2 | SID1 transmembrane | GACCCGCAACAGGACAGAGGGCGTG |
| | | | family, member 2 | |
| ASSAY0223* | Hs00215938_m1 | RNF31 | ring finger protein 31 | TGCCCCACAACCGGATGCAGGCCCT |
| ASSAY0227 | Hs00222984_m1 | HPS4 | Hermansky-Pudlak | CATAGAGGAAGTGTACCACAGCAGC |
| | | | syndrome 4 | |
| ASSAY0228* | Hs00227687_m1 | DENND2D | DENN/MADD domain | TGGAAGAGGTCCTGCTGGTCAATCT |
| | | | containing 2D | |
| ASSAY0230* | Hs00228829_m1 | TNKS2 | tankyrase, TRF1- | TGAAACAGCATTGCATTGTGCTGCT |
| | | | interacting ankyrin- | |
| | | | related ADP-ribose | |
| | | | polymerase 2 | |
| ASSAY0236 | Hs00266763_m1 | GSPT1 | G1 to S phase | CCGTGCGGCACCTGTGGAATCCTCT |
| | | | transition 1 | |
| ASSAY0242 | Hs00276830_m1 | RUNDC2A | RUN domain | CAGTGAAACAGTGCCAGATCCGCTT |
| | | | containing 2A | |
| ASSAY0244* | Hs00295675_m1 | NGDN | neuroguidin, EIF4E | CTACAGAAAAGGGTCTCAGCTTCTT |
| | | | binding protein | |
| ASSAY0253 | Hs00374428_m1 | DNAJC25- | DNAJC25-GNG10 | TACGAGACACTCAAGGTCTCTCAGG |
| | | GNG10 | readthrough | |
| ASSAY0255 | Hs00382970_m1 | PFDN5 | prefoldin subunit 5 | ATGAAACAGGCCGTCATGGAAATGA |
| ASSAY0257 | Hs00397335_m1 | DNAJC13 | DnaJ (Hsp40) homolog, | GGTCCAAAGGTTCGAATTACGTTAA |
| | | | subfamily C, member 13 | |
| ASSAY0261* | Hs00429212_m1 | C16orf35 | chromosome 16 open | GCTGTGCAGGAGACCCAGCTCATCC |
| | | | reading frame 35 | |
| ASSAY0263* | Hs00606262_g1 | HDAC1 | histone deacetylase 1 | AGGAGAAGAAAGAAGTCACCGAAGA |
| ASSAY0264 | Hs00606522_m1 | TARDBP | TAR DNA binding | GAGAAGTTCTTATGGTGCAGGTCAA |
| | | | protein | |
| ASSAY0266 | Hs00607689_m1 | FAM103A1 | family with sequence | AGGCAATCGGTTGCAAGACAACAGA |
| | | | similarity 103, | |
| | | | member A1 | |
| ASSAY0267 | Hs00609831_g1 | AARS | alanyl-tRNA synthetase | CGGCGCCTCAGCCAAGGCCCTGAAT |
| ASSAY0278 | Hs01092416_s1 | N/A | N/A | GTGTGAAGATCCAGCCTGATGCCCA |
| ASSAY0282* | Hs00192572_m1 | SEL1L | sel-1 suppressor of | CGGGAAACAAACATTCGAGATATGT |
| | | | lin-12-like | |
| | | | (C. elegans) | |
| ASSAY0284 | Hs00194045_m1 | ABCA1 | ATP-binding cassette, | ACCCAATCCCAGACACGCCCTGCCA |
| | | | sub-family A (ABC1), | |
| | | | member 1 | |
| ASSAY0285 | Hs00194072_m1 | APBA2 | amyloid beta (A4) | AACATTCCAGAGACAAAGAAGGTGG |
| | | | precursor protein- | |
| | | | binding, family A, | |
| | | | member 2 | |
| ASSAY0286 | Hs00194400_m1 | LPP | LIM domain containing | GAGGACTTCCACAAGAAATTTGCCC |
| | | | preferred translocation | |
| | | | partner in lipoma | |
| ASSAY0290 | Hs00195343_m1 | SMNDC1 | survival motor neuron | GTGAAGATGGACAGTGTTATGAAGC |
| | | | domain containing 1 | |
| ASSAY0299 | Hs00197744_m1 | POLR3C | polymerase (RNA) III | CAGATAACAAGGAGCCCATTCCAGA |
| | | | (DNA directed) | |
| | | | polypeptide C (62 kD) | |
| ASSAY0304 | Hs00199030_m1 | EHD1 | EH-domain containing 1 | GGCTGGCCAAGGTTCACGCCTACAT |
| ASSAY0306 | Hs00199344_m1 | ZFHX3 | zinc finger homeobox 3 | AGGGCGGAGCATCGTCCAGCCAAGC |
| ASSAY0313 | Hs00201247_m1 | NCBP2 | nuclear cap binding | GACCAGCACTTCCGGGGTGACAATG |
| | | | protein subunit 2, | |
| | | | 20 kDa | |
| ASSAY0317 | Hs00201970_m1 | MGEA5 | meningioma expressed | GTGGAGGAAGCTGAGCAACTTATGA |
| | | | antigen 5 | |
| | | | (hyaluronidase) | |
| ASSAY0322* | Hs00203191_m1 | POLL | polymerase (DNA | GATTGAGCAGACAGTCCAGAAAGCA |
| | | | directed), lambda | |
| ASSAY0329 | Hs00204383_m1 | COMMD9 | COMM domain | AGAGCCTGCTCAAGGCCTCCTCGAA |
| | | | containing 9 | |
| ASSAY0332* | Hs00205182_m1 | SND1 | staphylococcal | CAGCGAGAGGTGGAGGTGGAGGTGG |
| | | | nuclease and tudor | |
| | | | domain containing 1 | |
| ASSAY0335 | Hs00207926_m1 | SEC24D | SEC24 family, member | CAGCAAGCCAGCTTATTCTACCAGA |
| | | | D (S. cerevisiae) | |
| ASSAY0343 | Hs00211070_m1 | ERGIC3 | ERGIC and golgi 3 | CAGCAAGCCAGCTTATTCTACCAGA |
| ASSAY0346* | Hs00211420_m1 | FIS1 | fission 1 (mitochon- | CTGCTCGAGGAGCTGCTGCCCAAAG |
| | | | drial outer membrane) | |
| | | | homolog (S. cerevisiae) | |
| ASSAY0348* | Hs00212451_m1 | CAB39 | calcium binding | GCTCATTGACTTTGAGGGCAAAAAA |
| | | | protein 39 | |
| ASSAY0352 | Hs00213029_m1 | SIRT7 | sirtuin (silent mating | AATCAGCACGGCAGCGTCTATCCCA |
| | | | type information | |
| | | | regulation 2 homolog) | |
| | | | 7 (S. cerevisiae) | |
| ASSAY0356* | HS00214159_m1 | FAM46A | family with sequence | ACTCACGCTCAAGGAAGCTTATGTG |
| | | | similarity 46, member A | |
| ASSAY0359* | Hs00214745_m1 | DPP8 | dipeptidyl-peptidase 8 | CTGCCTGCTCCAAGTGATTTCAAGT |
| ASSAY0366 | Hs00215835_m1 | C19orf60 | chromosome 19 open | CAGCAGCTGAAAATGAAGGTAATTA |
| | | | reading frame 60 | |
| ASSAY0370* | Hs00217272_m1 | NUP133 | nucleoporin 133 kDa | AACTTTTAAAAGATGGCATTCAGCT |
| ASSAY0372* | Hs00218079_m1 | FBXL8 | F-box and leucine-rich | CACAAAAATCAGTTGCGAATGTGAG |
| | | | repeat protein 8 | |
| ASSAY0378 | Hs00400987_m1 | DTX3 | deltex homolog 3 | CTGACGAGAGCTGCATTTGGAAGTG |
| | | | (Drosophila) | |
| ASSAY0382 | Hs00706913_g1 | PCNP | PEST proteolytic | AATGTAGGCAAACTATCAATTTTTT |
| | | | signal containing | |
| | | | nuclear protein | |
| ASSAY0393 | Hs00295454_s1 | N/A | N/A | AGCTAAGAGGTTTCCAGTGCAATAC |
| ASSAY0402 | Hs00390635_m1 | TNIK | TRAF2 and NCK | ACCCATCAGAGCAAGCAACCCTGAT |
| | | | interacting kinase | |
| ASSAY0407* | Hs00540709_s1 | TMEM203 | transmembrane | CGGGAGCTGGTGCAGTGGCTAGGCT |
| | | | protein 203 | |
| ASSAY0408* | Hs00559348_m1 | CR1 | complement component | TGTTCCTGCTGCCTGCCCACATCCA |
| | | | (3b/4b) receptor 1 | |
| | | | (Knops blood group) | |
| ASSAY0410 | Hs00607709_m1 | FAM96A | family with sequence | CACTCAACAGAAGAAGACATCAATA |
| | | | similarity 96, member A | |
| ASSAY0421* | Hs00609836_m1 | AARS | alanyl-tRNA synthetase | CAAAATTTGGGGCTGGATGACACCA |
| ASSAY0425 | Hs00610478_m1 | PWP2 | PWP2 periodic | GGCTGGCCAAGTACTTCTTCAATAA |
| | | | tryptophan protein | |
| | | | homolog (yeast) | |
| ASSAY0429* | Hs00611133_m1 | MRPL10 | mitochondrial ribo- | CGCTGCTAGGTGGCTGCATTGATGA |
| | | | somal protein L10 | |
| ASSAY0432 | Hs00696974_m1 | BUD31 | BUD31 homolog | GAAAGCCATCAGCAGAGAACTCTAT |
| | | | (S. cerevisiae) | |
| ASSAY0440 | Hs00706419_s1 | SELT | selenoprotein T | ACATGATTGAGAACCAGTGTATGTC |
| ASSAY0443* | Hs00739474_g1 | EIF5A; | eukaryotic translation | GAAGAGATCCTGATCACGGTGCTGT |
| | | EIF5AL1 | initiation factor 5A; | |
| | | | eukaryotic translation | |
| | | | initiation factor | |
| | | | 5A-like 1 | |
| ASSAY0445 | Hs00740463_m1 | CSNK1A1 | casein kinase 1, | GGCAAGGGCTAAAGGCTGCAACAAA |
| | | | alpha 1 | |
| ASSAY0450* | Hs00743508_s1 | C18orf32 | chromosome 18 open | AGGTAGAATTTTGGGAGGTAATAAT |
| | | | reading frame 32 | |
| ASSAY0451 | Hs00745818_s1 | ZNF595 | zinc finger protein 595 | CAAAGCTTTTAATCGGCCCTCAACC |
| ASSAY0453* | Hs00748530_s1 | UBE2L3 | ubiquitin-conjugating | CTAAGATGCTGCGATCCCGTTCTGC |
| | | | enzyme E2L 3 | |
| ASSAY0455* | Hs00748915_s1 | PFN1 | profilin 1 | TTTTTGGGCCATTACCCCATACCCC |
| ASSAY0456* | Hs00750443_s1 | ARL8B | ADP-ribosylation | GTGTGACTCTGTGGGGACTGCATAG |
| | | | factor-like 8B | |
| ASSAY0458 | Hs00751057_s1 | GOT2 | glutamic-oxaloacetic | GCTGATGCCGTACCCTCACCCTTTT |
| | | | transminase 2, mito- | |
| | | | chondrial (aspartate | |
| | | | aminotransferase 2) | |
| AASAY0459 | Hs00754648_s1 | SFRS13A | splicing factor, | TGATGCCAGCTGGGAAATTGAGTTT |
| | | | arginine/serine-rich | |
| | | | 13A | |
| ASSAY0460 | Hs00759012_s1 | MTRF1L | mitochondrial | CGGACTAAGGATGCGGTCCCGGGTT |
| | | | translational release | |
| | | | factor 1-like | |
| ASSAY0464* | Hs00793391_m1 | CSNK1A1 | casein kinase 1, | AGTTTTATGTAAGGGGTTTCCTGCA |
| | | | alpha 1 | |
| ASSAY0467 | Hs00798979_s1 | CCT6A | chaperonin containing | TTTGGGATGTCAGCAGTGGCCTGAA |
| | | | TCP1, subunit 6A | |
| | | | (zeta 1) | |
| ASSAY0474* | Hs00235003_m1 | PTGDR | prostaglandin D2 | GCCCGTAATTTATCGCGCTTACTAT |
| | | | receptor (DP) | |
| ASSAY0477* | Hs00237035_m1 | TRAF3 | TNF receptor- | TCGCGCTGCAGAAACACGAAGACAC |
| | | | associated factor 3 | |
| ASSAY0478 | Hs00237047_m1 | YWHAZ | tyrosine 3-monooxy- | GATAAAAAGAACATCCAGTCATGGA |
| | | | genase/tryptophan 5- | |
| | | | monooxygenase | |
| | | | activation protein, | |
| | | | zeta polypeptide | |
| ASSAY0479* | Hs00240906_m1 | SNCA | synuclein, alpha (non | GTGGCAACAGTGGCTGAGAAGACCA |
| | | | A4 component of | |
| | | | amyloid precursor) | |
| ASSAY0480* | Hs00242160_m1 | HHEX | hematopoietically | ACCCCCTGGGCAAACCTCTACTCTG |
| | | | expressed homeobox | |
| ASSAY0481 | Hs00242737_m1 | LTB | lymphotoxin beta (TNF | ATCAGGGAGGACTGGTAACGGAGAC |
| | | | superfamily, member 3) | |
| ASSAY0482 | Hs00242770_m1 | MBD1 | methyl-CpG binding | ATTACCAGAGCCCCACAGGAGACAG |
| | | | domain protein 1 | |
| ASSAY0483 | Hs00243655_s1 | CDK5R1 | cyclin-dependent | CCGGAAGGCCACGCTGTTTGAGGAT |
| | | | kinase 5, regulatory | |
| | | | subunit 1 (p35) | |
| ASSAY0484* | Hs00244740_m1 | CDC25B | cell division cycle 25 | GGCGGAGCAGACGTTTGAACAGGCC |
| | | | homolog B (S. pombe) | |
| ASSAY0486 | Hs00247895_s1 | LSM14B | LSM14B, SCD6 homolog | GAGCCTGGGATGAGCCCCGGCAGCG |
| | | | B (S. cerevisiae) | |
| ASSAY0502 | Hs00257171_s1 | GALNT10 | UDP-N-acetyl-alpha-D- | AGATTCTGCACAAGTCAGCAGTGCA |
| | | | galactosamine: poly- | |
| | | | peptide N-acetyl- | |
| | | | galactosaminyltrans- | |
| | | | ferase 10 (GalNAc-T10) | |
| ASSAY0504 | Hs00257861_m1 | COQ10B | coenzyme Q10 homolog | CGCCCGTGCGGAATGGCAGATATTT |
| | | | B (S. cerevisiae) | |
| ASSAY0512* | Hs00260786_m1 | ARFGAP2 | ADP-ribosylation factor | GTATCCCGAAGCTCTGTCTCCCACT |
| | | | GTPase activating | |
| | | | protein 2 | |
| ASSAY0516 | Hs00261620_m1 | HINT2 | histidine triad | GCGCGGGGGGCAGGTCCGAGGAGCT |
| | | | nucleotide binding | |
| | | | protein 2 | |
| ASSAY0523* | Hs00264679_m1 | CST3 | cystatin C | CGCCCGCAAGCAGATCGTAGCTGGG |
| ASSAY0534* | Hs00268265_m1 | SMARCC1 | SWI/SNF related, | CCAAACTCCCTGCAAAGTGTTTCAT |
| | | | matrix associated, | |
| | | | actin dependent | |
| | | | regulator of chromatin, | |
| | | | subfamily c, member 1 | |
| ASSAY0538 | Hs00269779_m1 | GGT5 | gamma- | TCAGCCAGGAGGTGCAGAGGGGACT |
| | | | glutamyltransferase 5 | |
| ASSAY0540* | Hs00270536_m1 | SNRNP40 | small nuclear | TGAGCCCATCATTATCTCAGCATCG |
| | | | ribonucleoprotein | |
| | | | 40 kDa (U5) | |
| ASSAY0541* | Hs00270620_s1 | IER2 | immediate early | CCCCGCCAAAGTCAGCCGCAAACGA |
| | | | response 2 | |
| ASSAY0543 | Hs00272235_m1 | EIF3M | eukaryotic translation | AGAAGAGTGATGCTGCTTCAAAAGT |
| | | | initiation factor 3, | |
| | | | subunit M | |
| ASSAY0544 | Hs00272381_s1 | CDC43EP3 | CDC42 effector protein | ACTCCTCCAGCCTGTCCGAACAGTA |
| | | | (Rho GTPase binding) 3 | |
| ASSAY0546* | Hs00272828_m1 | ZFP36L2 | zinc finger protein 36, | GTCGACTTCTTGTGCAAGACAGAGA |
| | | | C3H type-like 2 | |
| ASSAY0551 | Hs00275054_m1 | HSD17B12 | hydroxysteroid (17- | GTGGAAAGATCCAAAGGGGCTATTC |
| | | | beta) dehydrogenase 12 | |
| ASSAY0552 | Hs00275374_s1 | BET1L | blocked early in | TCTCCATCCATGCTCACCATAGCCC |
| | | | transport 1 homolog | |
| | | | (S. cerevisiae)-like | |
| ASSAY0560* | Hs00291823_m1 | ZMAT2 | zinc finger, matrin | AAAAGAAAGATGGAAAACCAGTGCA |
| | | | type 2 | |
| ASSAY0563 | Hs00292725_m1 | IFT20 | intraflagellar trans- | GGGGCCGGCAGCCATGGCCAAGGAC |
| | | | port 20 homolog | |
| | | | (Chlamydomonas) | |
| ASSAY0565* | Hs00293336_m1 | TMEM129 | transmembrane | TTTGACATCTGGAGCTGGAGGCCTG |
| | | | protein 129 | |
| ASSAY0566 | Hs00293370_m1 | SPPL3 | signal peptide | TATTTAAAGGGCGACCTCCGGCGGA |
| | | | peptidase 3 | |
| ASSAY0568 | Hs00298999_m1 | SLC38A10 | solute carrier family | TTCGCCTGCCAGTCCCAGGTGCTGC |
| | | | 38, member 10 | |
| ASSAY0572 | Hs0300396_m1 | PELP1 | proline, glutamate and | TCTCTCAAAGGCAAGCTGGCCTCAT |
| | | | leucine rich protein 1 | |
| ASSAY0579* | Hs00330066_m1 | CCNY | cyclin Y | CCGTCGTCACCCTGGTGTACCTTGA |
| ASSAY0585 | Hs00358616_m1 | STK16 | serine/threonine | GTGAGCGGACTGATGTCTGGTCCCT |
| | | | kinase 16 | |
| ASSAY0588* | Hs00360923_g1 | CRELD2 | cysteine-rich with | TCCAAGTACGAGTCCAGCGAGATTC |
| | | | EGF-like domains 2 | |
| ASSAY0593 | Hs00362511_g1 | SUGT1 | SGT1, supressor of | CTGCAACATCCCAGAGGTTTTTCCA |
| | | | G2 allele of SKP1 | |
| | | | (S. cerevisiae) | |
| ASSAY0597 | Hs00364835_m1 | LRG1 | leucine-rich alpha-2- | ACCAAAAAGCCCAGGGGGCATTCAA |
| | | | glycoprotein 1 | |
| ASSAY0599 | Hs00365678_g1 | RAB24 | RAB24, member RAS | GTATTTGGGACACAGCAGGCTCTGA |
| | | | oncogene family | |
| ASSAY0603* | Hs00368207_m1 | PREX1 | phosphatidylinositol- | CTTCTTGCAGTCGGCATTCCTGCAT |
| | | | 3,4,5-triphosphate- | |
| | | | dependent Rac | |
| | | | exchange factor 1 | |
| ASSAY0611 | Hs00371424_s1 | HIST1H4D | histone cluster 1, H4d | TTCGGCGGCTGAGCTTACCTCTACA |
| ASSAY0612* | Hs00372401_g1 | COMMD4 | COMM domain | GGGACAGGGGATTGATTATGAGAAG |
| | | | containing 4 | |
| ASSAY0617 | Hs00375440_m1 | TMEM168 | transmembrane | CCCACCAACTTCTGCAGTCCTGATG |
| | | | protein 168 | |
| ASSAY0618 | Hs00375485_m1 | PGS1 | phosphatidylglycero- | TTTTCGAGCTCATGAAGGGGCAGAT |
| | | | phosphate synthase 1 | |
| ASSAY0619 | Hs00375556_m1 | PIP4K2C | phosphatidylinositol- | CCTTTTCCACAGGGAAAATCTGCCC |
| | | | 5-phosphate 4-kinase, | |
| | | | type II, gamma | |
| ASSAY0624 | Hs00377427_m1 | APBB1 | amyloid beta (A4) | TCCCCAGAGGACACAGATTCCTTCT |
| | | | precursor protein- | |
| | | | binding, family B, | |
| | | | member 1 (Fe65) | |
| ASSAY0625* | Hs00378208_m1 | UBR4 | ubiquitin protein | CACTTGCTTGGCAAGACACAACACT |
| | | | ligase E3 component | |
| | | | n-recognin 4 | |
| ASSAY0627* | Hs00378635_m1 | EXOSC8 | exosome component 8 | GCTGGGTTCAAAACCGTGGAACCTC |
| ASSAY0628* | Hs00378772_m1 | KIAA0368 | KIAA0368 | GGAGACCCAACGTTGTTATCGTCAG |
| ASSAY0632 | Hs00379295_m1 | C1orf144 | chromosome 1 open | AACCCATCCTCGACAGGCCAACCAG |
| | | | reading frame 144 | |
| ASSAY0634 | Hs00379889_m1 | PQLC3 | PQ loop repeat | GACCTGGCCATGAATCTATGTACTT |
| | | | containing 3 | |
| ASSAY0637 | Hs00383718_m1 | C5AR1 | complement component | AGACCAGAACATGAACTCCTTCAAT |
| | | | 5a receptor 1 | |
| ASSAY0638 | Hs00384448_m1 | PARS2 | prolyl-tRNA synthetase | GGCTGGGATTGCGGTGCCTGTGCTT |
| | | | 2, mitochondrial | |
| | | | (putative) | |
| ASSAY0641* | Hs00385203_g1 | FBXW5 | F-box and WD repeat | CCTGTCGCCCGACAACAGGTACCTG |
| | | | domain containing 5 | |
| ASSAY0645* | Hs00387426_m1 | MAP2K4 | mitogen-activated | CAAATAATGGCAGTTAAAAGAATTC |
| | | | protein kinase kinase 4 | |
| ASSAY0648* | Hs00389570_m1 | SEC16A | SEC16 homolog A | AACCTAAGAAGGGTGAATCCTGGTT |
| | | | (S. cerevisiae) | |
| ASSAY0653 | Hs00393297_m1 | ZNF512B | zinc finger protein | TGGTAAGAAAAGGGCTGCGGACAGC |
| | | | 512B | |
| ASSAY0654 | Hs00393592_m1 | FZR1 | fizzy/cell division | ACGATGCCACGCGTCACAGAGATGC |
| | | | cycle 20 related 1 | |
| | | | (Drosophila) | |
| ASSAY0656 | Hs00395045_m1 | STMN3 | stathmin-like 3 | CCAGTACGGGGACATGGAGGTGAAG |
| ASSAY0657* | Hs00397738_m1 | PPP1R3E | protein phosphatase 1, | GGGGAGTGATGACAGAAGGGATGGA |
| | | | regulatory (inhibitor) | |
| | | | subunit 3E | |
| ASSAY0660 | Hs00402617_m1 | MPZL3 | myelin protein zero- | GTGCCTGGATTCAGACTATGAAGAG |
| | | | like 3 | |
| ASSAY0665 | Hs00406064_m1 | DNAJC2 | DnaJ (Hsp40) homolog, | TCAAAGCAGCTCATAAAGCAATGGT |
| | | | subfamily C, member 2 | |
| ASSAY0672* | Hs00412706_m1 | MIA3 | melanoma inhibitory | AGTGAATTTGGATCAGTGGACGGGC |
| | | | activity family, | |
| | | | member 3 | |
| ASSAY0676 | Hs00414732_g1 | LSMD1 | LSM domain containing 1 | AGCCGTCGGATTCCTTCTCTGCCGG |
| ASSAY0677 | Hs00414889_m1 | ANKRD36B | ankyrin repeat domain | GAAGGAAAGGACTGCCCTACATTTG |
| | | | 36B | |
| ASSAY0683 | Hs00417251_m1 | SNHG6 | small nucleolar RNA | TAGCTGGGCTCTGCGAGGTGCAAGA |
| | | | host gene 6 (non- | |
| | | | protein coding) | |
| ASSAY0684 | Hs00417273_m1 | LRRK2 | leucine-rich repeat | TTTGGCCCTCCTCACTGAGACTATT |
| | | | kinase 2 | |
| ASSAY0686 | Hs00418955_m1 | SMCHD1 | structural maintenance | AAGGATTTTAAATGGACAGGAACAG |
| | | | of chromosomes | |
| | | | flexible hinge domain | |
| | | | containing 1 | |
| ASSAY0697 | Hs00428488_g1 | PRDX2 | peroxiredoxin 2 | CCTTTGCCCACGCAGCTTTCAGTCA |
| ASSAY0710* | Hs00536891_m1 | ITSN2 | intersectin 2 | GCTATGAATGGAGGGCCAAACATGT |
| ASSAY0713 | Hs00538077_m1 | C5orf41 | chromosome 5 open | ACACCCACAGACAGCATCGCACAGA |
| | | | reading frame 41 | |
| ASSAY0714* | Hs00538879_s1 | LUC7L3 | LUC7-like 3 | GTTACACTCAATGCAATTCTCAAGT |
| | | | (S. cerevisiae) | |
| ASSAY0715* | Hs00539341_m1 | C10orf137 | chromosome 10 open | AGACTAGTGAGCAAATCTGTGTCTG |
| | | | reading frame 137 | |
| ASSAY0719 | Hs00540753_m1 | DYNLL2 | dynein, light chain, | GCCTCCGTGAAGTGTCACACCATGT |
| | | | LC8-type 2 | |
| ASSAY0720* | Hs00540812_m1 | CCDC101 | coiled-coil domain | AGAGGCTGAGTGCAACATCCTTCGG |
| | | | containing 101 | |
| ASSSAY0723 | Hs00542109_m1 | FBXL16 | F-box and leucine-rich | ACGGACGCAGGCCTCGAGGTTATGC |
| | | | repeat protein 16 | |
| ASSAY0728 | Hs00544515_s1 | C14orf139 | chromosome 14 open | CCAGGGGACGGGAGCAGGTACCCAC |
| | | | reading frame 139 | |
| ASSAY0733 | Hs00602949_g1 | NIP7 | nuclear import 7 | TGTACTATGTGAGTGAGAAGATTAT |
| | | | homolog (S. cerevisiae) | |
| ASSAY0736 | Hs00603727_g1 | EIF1 | eukaryotic translation | TTAAGAAAAAGTTTGCCTGCAATGG |
| | | | initiation factor 1 | |
| ASSAY0739 | Hs00606808_m1 | MRPS6 | mitochondrial | ACAACAGAGGCGGGTATTTCTTGGT |
| | | | ribosomal protein S6 | |
| ASSAY0741 | Hs00606874_g1 | TNFRSF13 | tumor necrosis factor | CGGAGACAAGGACGCCCCAGAGCCC |
| | | C | receptor superfamily, | |
| | | | member 13C | |
| ASSAY0743 | Hs00818252_g1 | KPNA2 | karyopherin alpha 2 | TCATCTTTAGCATGTGGCTACTTAC |
| | | | (RAG cohort 1, | |
| | | | importin alpha 1) | |
| ASSAY0746 | Hs00828573_m1 | TMCC1 | transmembrane and | CCGGGACATCCAGGAGGCCCTGGAG |
| | | | coiled-coil domain | |
| | | | family 1 | |
| ASSAY0748* | Hs00830558_g1 | FOXN3 | forkhead box N3 | TCTAGGGACTTGGTGTTGCTTGGAA |
| ASSAY0752 | Hs00854645_g1 | BRI3 | brain protein I3 | CCTTCCTGGGCATCTTCCTGGCCAT |
| ASSAY0753 | Hs00855332_g1 | LDHA | lactate dehydrogenase A | TCTGACGCACCACTGCCAATGCTGT |
| ASSAY0754 | Hs00867656_s1 | DLEU2 | deleted in lymphocytic | AAAAATTTATTTTACACATGTCAAG |
| | | | leukemia 2 (non- | |
| | | | protein coding) | |
| ASSAY0756 | Hs00894392_m1 | TBX21 | T-box 21 | ACAATGTGACCCAGATGATTGTGCT |
| ASSAY0760 | Hs00902008_m1 | CTCF | CCCTC-binding factor | AGAACCAGCCAACAGCTATCATTCA |
| | | | (zinc finger protein) | |
| ASSAY0780 | Hs00942554_m1 | RPL6 | ribosomal protein L6 | TCTTGCAAGATGGCGGGTGAAAAAG |
| ASSAY0781 | Hs00943178_g1 | PGK1 | phosphoglycerate | AGCCCACAGCTCCATGGTAGGAGTC |
| | | | kinase 1 | |
| ASSAY0797* | Hs00975865_m1 | BTK | Bruton | TTATCCCTTCCAGGTTGTATATGAT |
| | | | agammaglobulinemia | |
| | | | tyrosine kinase | |
| ASSAY0798 | Hs00976004_m1 | EDEM1 | ER degradation | CAACTCCAGCTCCAACTGCAATCGT |
| | | | enhancer, mannosidase | |
| | | | alpha-like 1 | |
| ASSAY0799* | Hs00982887_g1 | BCL2L12 | BCL2-like 12 | CCGCCCAGCCCAGAATTACAGGGTC |
| | | | (proline rich) | |
| ASSAY0802* | Hs00989184_m1 | GZMA | granzyme A (granzyme 1, | ACTCGTGCAATGGAGATTCTGGAAG |
| | | | cytotoxic T-lymphocyte- | |
| | | | associated serine | |
| | | | esterase 3) | |
| ASSAY0805 | Hs00996794_m1 | EPB42 | erythrocyte membrane | GAGAGGAGCTACAGATTCCGTTCAG |
| | | | protein band 4.2 | |
| ASSAY0807* | Hs00998133_m1 | TGFB1 | transforming growth | ACAGCAAGGTCCTGGCCCTGTACAA |
| | | | factor, beta 1 | |
| ASSAY0810 | Hs01007839_m1 | TNPO1 | transportin 1 | GAAGCTGCCTGCAGTGCCTTTGCTA |
| ASSAY0814* | Hs01013056_g1 | GLUL | glutamate-ammonia | TCTGAAGTACATCGAGGAGGCCATT |
| | | | ligase (glutamine | |
| | | | synthetase) | |
| ASSAY0819 | Hs01030693_m1 | ARHGAP17 | Rho GTPase activating | CCAAGATAGTAACAGACTCCAATTC |
| | | | protein 17 | |
| ASSAY0826 | Hs01036536_m1 | BCR | breakpoint cluster | ATTGCTGTGGTCACCAAGAGAGAGA |
| | | | region | |
| ASSAY0827 | Hs01037385_s1 | HMGB1 | high-mobility group | AAAGCAAAGGGAGGATAAAACAGTA |
| | | | box 1 | |
| ASSAY0831 | Hs01043735_m1 | ECE1 | endothelin converting | GCGGCCTATCGGGCTTACCAGAACT |
| | | | enzyme 1 | |
| ASSAY0834* | Hs01053201_s1 | ZBTB38 | zinc finger and BTB | GTAATAAGCTGTGTGACGGTCTTTA |
| | | | domain containing 38 | |
| ASSAY0836 | Hs01053867_s1 | NCRNA002 | non-protein coding | AGCGCCAGTGCTGGCATGGGCTTTC |
| | | 03 | RNA 203 | |
| ASSAY0844* | Hs01064792_m1 | TRANK1 | tetratricopeptide | TAAAGAAGGAAGGTATTGTTCAGGA |
| | | | and ankyrin repeat | |
| | | | containing 1 | |
| ASSAY0846* | Hs01065498_m1 | PIM1 | pim-1 oncogene | CAGAGGGTCTCTTCAGAATGTCAGC |
| ASSAY0854 | Hs01082775_m1 | TFAM | transcription factor A, | GGTGATTCACCGCAGGAAAAGCTGA |
| | | | mitochondrial | |
| ASSAY0856 | Hs01085351_m1 | STK39 | serine threonine | TAAGTTGGCTTCTGGCTGTGATGGG |
| | | | kinase 39 (STE20/SPS1 | |
| | | | homolog, yeast) | |
| ASSAY0857* | Hs01085739_g1 | ACHE | acetylcholinesterase | CTGCAGGTGCTGGTGGGTGTGGTGA |
| | | | (Yt blood group) | |
| ASSAY0858 | Hs01087966_m1 | MEG3 | maternally expressed | GGATCCCTCACCCGGGTCTCTCCTC |
| | | | 3 (non-protein coding) | |
| ASSAY0861* | Hs01093019_m1 | GSPT1 | G1 to S phase | CAGAGAAACTTGGTACTTGTCTTGG |
| | | | transition 1 | |
| ASSAY0865* | Hs01107136_m1 | RPIA | ribose 5-phosphate | GTGATCGCTGATTTCAGGAAAGATT |
| | | | isomerase A | |
| ASSAY0871* | Hs01114250_m1 | TGFBR3 | transforming growth | TCTATTCTCACACAGGGGAGACAGC |
| | | | factor, beta receptor | |
| | | | III | |
| ASSAY0876* | Hs01372307_m1 | ZDHHC18 | zinc finger, DHHC-type | ACCTCCCAGCCTAATTGACCGGAGG |
| | | | containing 18 | |
| ASSAY0882* | Hs01550808_m1 | MX2 | myxovirus (influenza | GAATGCCTACTTCTTGGAAACCAGC |
| | | | virus) resistance 2 | |
| | | | (mouse) | |
| ASSAY0886 | Hs01564142_m1 | GLIPR1 | GLI pathogenesis- | CTATACATGACTTGGGACCCAGCAC |
| | | | related 1 | |
| ASSAY0888* | Hs01577197_m1 | PSEN2 | presenilin 2 | CCTCATTGGCTTGTGTCTGACCCTC |
| | | | (Alzheimer disease 4) | |
| ASSAY0893* | Hs01591359_s1 | N/A | N/A | AGTGCCCTTTAGATGATTCCCCCTC |
| ASSAY0894 | Hs01592406_m1 | UBE2F | ubiquitin-conjugating | AACATTAAAGGATGTCGTTTGGGGA |
| | | | enzyme E2F (putative) | |
| ASSAY0900* | Hs01636043_s1 | SRP9 | signal recognition | TGCTGTTGTGACCAATAAATATAAA |
| | | | particle 9 kDa | |
| ASSAY0914 | Hs02339116_s1 | OR52K1 | olfactory receptor, | GGCAGTTCTCCAGCTTGCCTCTCAG |
| | | | family 52, subfamily K, | |
| | | | member 1 | |
| ASSAY0916 | Hs02339727_m1 | ZNF708 | zinc finger protein 708 | CAAACCCCCAGCTATGTGTTCTCAT |
| ASSAY0923 | Hs02621508_s1 | TNFAIP8 | tumor necrosis factor, | AAATACAGATGTCTCCAGACCTGAG |
| | | | alpha-induced protein 8 | |
| ASSAY0924 | Hs02638995_g1 | PRELID1; | PRELI domain containing | CGCCCGGCTGATGGTGGTGGAGGAA |
| | | LOC728666; | 1; similar to Px19- | |
| | | LOC388955 | like protein (25 kDa | |
| | | | protein of relevant | |
| | | | evolutionary and | |
| | | | lymphoid interest) | |
| | | | (PRELI); PX19 protein | |
| | | | pseudogene | |
| ASSAY0925 | Hs02863396_m1 | GNA12 | guanine nucleotide | AGCGAGTTTCAGCTGGGGGAGTCGG |
| | | | binding protein (G | |
| | | | protein) alpha 12 | |
| ASSAY0929 | Hs03044361_m1 | CYBA | cytochrome b-245, | ATCTCCTGCTCTCGGTGCCCGCCGG |
| | | | alpha polypeptide | |
| ASSAY0933 | Hs99999148_m1 | CCL4 | chemokine (C-C motif) | TCCAGCGCTCTCAGCACCAATGGGC |
| | | | ligand 4 | |
| ASSAY0934 | Hs00929873_m1 | CSF2 | colony stimulating | CAGAAATGTTTGACCTCCAGGAGCC |
| | | | factor 2 (granulocyte- | |
| | | | marcophage) | |
| ASSAY0936 | Hs00245438_m1 | MVP | major vault protein | GGCCTACAACTGGCACTTTGAGGTG |
| ASSAY0941 | Hs00328784_s1 | MTMR3 | myotubularin releated | CCCTCGGGAAGGTTGGTATTGAGGG |
| | | | protein 3 | |
| ASSAY0944* | Hs01587378_mH | TOMM40 | translocase of outer | CCCACAGAGGCGTTCCCTGTACTGG |
| | | | mitochondrial membrane | |
| | | | 40 homolog (yeast) | |
| ASSAY0950 | Hs01123468_m1 | DIDO1 | death inducer- | ATGCGGTGCTCAGGCAGGTATTAAA |
| | | | obliterator 1 | |
| ASSAY0951 | Hs00293472_m1 | C19orf36 | chromosome 19 open | ATCGAAAGCCGCATCGACTGTCAGC |
| | | | reading frame 36 | |
| ASSAY0962* | Hs00211306_m1 | DHRS7 | dehydrogenase/reductase | CTTTAAGAGTGGTGTGGATGCAGAC |
| | | | (SDR family) member 7 | |
| ASSAY0970 | Hs00210321_m1 | ZBTB20 | zinc finger and BTB | TGAAACTACTGAAGAAACCCAAGAC |
| | | | domain containing 20 | |
| ASSAY0980 | Hs00400648_m1 | DENND4A | DENN/MADD domain | AGAACTATGCAATGGAGGTTCTCAT |
| | | | containing 4A | |
| ASSAY0982 | Hs00171488_m1 | SLIT1 | slit homolog 1 | ACCGAGCGCCTGGAACTCAATGGCA |
| | | | (Drosophila) | |
| ASSAY0996 | Hs00369838_s1 | GPR82 | G protein-coupled | ATGGGAATATCAATCTGCTCAATGC |
| | | | receptor 82 | |
| ASSAY0998 | Hs00162661_m1 | TMBIM6 | transmembrane BAX | CACTCATTTCATTCAGGCTGGCCTG |
| | | | inhibitor motif | |
| | | | containing 6 | |
| ASSAY1000 | Hs00403541_m1 | FAM129C | family with sequence | CTGCCCTGAATCCTTGGGAGACCAT |
| | | | similarity 129, | |
| | | | member C | |
| ASSAY1001 | Hs00155586_m1 | MPPED1 | metallophosphoesterase | AGTGGCTGGGCAGCCTGCCCTACGA |
| | | | domain containing 1 | |
| ASSAY1004 | Hs00182998_m1 | LRP8 | low density lipoprotein | GGACGACTGCCCCAAGAAGACCTGT |
| | | | receptor-related | |
| | | | protein 8, apolio- | |
| | | | protein 8 receptor | |
| ASSAY1010* | Hs00394748_m1 | AGRN | agrin | GAGTTCTGTGTGGAAGATAAACCCG |
| ASSAY1025 | Hs00182082_m1 | MYD88 | myeloid differentiation | CCCAGCATTGAGGAGGATTGCCAAA |
| | | | primary response gene | |
| | | | (88) | |
| ASSAY1026 | Hs00162271_m1 | SPTBN1 | spectin, beta, non- | GCTCTGGGCACACAGGTGAGGCAGC |
| | | | erythrocytic 1 | |
| ASSAY1030 | Hs00355914_m1 | ALDH2 | aldehyde dehydrogenase | AAATGTCTCCGGTATTATGCCGGCT |
| | | | 2 family | |
| | | | (mitochondrial) | |
| ASSAY0136 | Hs00218198_m1 | DCP1A | DCP1 decapping enzyme | CCATCCCGGTTGCAGGCGCCCCACT |
| | | | A (S. cerevisiae) | |
| ASSAY1042* | Hs00202482_m1 | ACOT9 | acyl-CoA thioesterase 9 | CTGAAAATAAAGGGCCGGCATTTGT |
| ASSAY0148 | Hs00174752_m1 | EPHB4 | EPH receptor B4 | GACCCAACTGGATGAGAGCGAGGGC |
| ASSAY1056 | Hs00698399_m1 | LRRC50 | leucine rich repeat | TGCCCGATTTGCGTGTACTGAATTT |
| | | | containing 50 | |
| ASSAY1064* | Hs00559914_m1 | YKT6 | YKT6 v-SNARE homolog | TATAAAACTGCCCGGAAACAAAACT |
| | | | (S. cerevisiae) | |
| ASSAY1083 | Hs00559278_m1 | DPYD | dihydropyrimidine | TCATGGACAAGAAACTGCCAAGTTT |
| | | | dehydrogenase | |
| ASSAY1084* | Hs00390223_m1 | UBR4 | ubiquitin protein | ACATGACCACAGGTACAGAATCAGA |
| | | | ligase E3 component | |
| | | | n-recognin 4 | |
| ASSAY1088* | Hs00374213_m1 | GLUL | glutamate-ammonia | TTTCTGTGGCTGGGAACACCTTCCA |
| | | | ligase (glutamine | |
| | | | synthetase) | |
| ASSAY1096* | Hs00323180_m1 | ZNF862 | zinc finger protein 862 | TGGCATCCTTGGGACCTGCTGCTGC |
| ASSAY1100* | Hs00186918_m1 | SNX3 | sorting nexin 3 | AAAGAGAGAGCAAGGTCGTAGTTCC |
| ASSAY1101* | Hs00536591_g1 | MTG1 | mitochondrial GTPase | CCGAAAAGAGAACCTGGAGTACTGT |
| | | | 1 homolog | |
| | | | (S. cerevisiae) | |
| ASSAY1104 | Hs00261330_s1 | NT5DC1 | 5-nucleotidase domain | CATATCGATGCATGCAATGGAAAGA |
| | | | containing 1 | |

Assays with p values <0.05 are marked with an asterisk.

TABLE 7
Informative probes for Prodromal AD versus Progressed AD
(All probes have p-value <0.5)

| Sequence No. | | Gene | | Context Sequence |
|---|---|---|---|---|
| (DiaGenic Assay ID) | Assay ID | Symbol | Gene name | (Oligonucleotide sequence) |
| ASSAY0011 | Hs99999905_m1 | GAPDH | glyceraldehyde-3- | GGGCGCCTGGTCACCAGGGCTGCTT |
| | | | phosphate | |
| | | | dehydrogenase | |
| ASSAY0012 | Hs00158122_m1 | ISG20 | interferon stimulated | GCATCCAGAACAGCCTGCTTGGACA |
| | | | exonuclease gene | |
| | | | 20 kDa | |
| ASSAY0022 | Hs00190463_m1 | C21orf33 | chromosome 21 open | GGGAAGCCCATCGGCTTGTGCTGCA |
| | | | reading frame 33 | |
| ASSAY0038 | Hs00218782_m1 | RNF114 | ring finger protein | TGCCCTGCGGACACGTCTTTTGCTC |
| | | | 114 | |
| ASSAY0041 | Hs00219523_m1 | C1orf183 | chromosome 1 open | TCAAACAGGAGCTGATGTCCATGAA |
| | | | reading frame 183 | |
| ASSAY0052 | Hs00220814_m1 | SLC44A2 | solute carrier family | AAACGAGAACAAACCCTATCTGTTT |
| | | | 44, member 2 | |
| ASSAY0057 | Hs00221859_m1 | SQRDL | sulfide quinone | GTTGAGCCCAGTGAGAGACATTTCT |
| | | | reductase-like (yeast) | |
| ASSAY0082 | Hs00228787_m1 | COASY | Coenzyme A synthase | AAAGATCTGTTGAAGAGCAAGTTGC |
| ASSAY0093 | Hs00233856_m1 | LRP1 | low density lipo- | CCCCTGAGATTTGTCCACAGAGTAA |
| | | | protein receptor- | |
| | | | related protein 1 | |
| ASSAY0096 | Hs00234224_m1 | ADAM17 | ADAM metallopeptidase | GGTGTCCAGTGCAGTGACAGGAACA |
| | | | domain 17 | |
| ASSAY0099 | Hs00153853_m1 | ADAM10 | ADAM metallopeptidase | AAACAGTGCAGTCCAAGTCAAGGTC |
| | | | domain 10 | |
| ASSAY0113 | Hs00157831_m1 | GTF2E2 | general transcription | GCCCTTCTCACTCAGCATTATGGAT |
| | | | factor IIE, poly- | |
| | | | peptide 2, beta 34 kDa | |
| ASSAY0114 | Hs00157950_m1 | HLA-DOB | major histocompat- | ACAGACTCTCCAGAAGATTTTGTGA |
| | | | ibility complex, | |
| | | | class II, DO beta | |
| ASSAY0122 | Hs00160118_m1 | PLD1 | phospholipase D1, | CTTAAACGAAAAGCACAACAAGGAG |
| | | | phosphatidylcholine- | |
| | | | specific | |
| ASSAY0128 | Hs00163761_m1 | BTK | Bruton | GTCAGGACTGAGCACACAGGTGAAC |
| | | | agammaglobulinemia | |
| | | | tyrosine kinase | |
| ASSAY0135 | Hs00170192_m1 | PNN | pinin, desmosome | GGCAGTCAGTAGGCTGGGCGGGGAG |
| | | | associated protein | |
| ASSAY0140 | Hs00173196_m1 | ZNF146 | zinc finger protein | AGGATCTGCGCGGAAGAAGCCTGAG |
| | | | 146 | |
| ASSAY0148 | Hs00174575_m1 | CCL5 | chemokine (C-C motif) | CAACCCAGCAGTCGTCTTTGTCACC |
| | | | ligand 5 | |
| ASSAY0181 | Hs00188259_m1 | WARS | tryptophanyl-tRNA | AACCAAGGTCAATAAGCATGCGTTT |
| | | | synthetase | |
| ASSAY0184 | Hs00189461_m1 | BPTF | bromodomain PHD | AGCAGCACTCCAGGTAGGCGAAAAC |
| | | | finger transcription | |
| | | | factor | |
| ASSAY0189 | Hs00190028_m1 | NDUFS3 | NADH dehydrogenase | CGACACGCGCCCCACTGTCAGACCA |
| | | | (ubiquinone) Fe-S | |
| | | | protein 3, 30 kDa | |
| | | | (NADH-coenzyme Q | |
| | | | reductase) | |
| ASSAY0207 | Hs00196206_m1 | GZMA | granzyme A | CCTGCTAATTCCTGAAGATGTCTGT |
| | | | (granzyme 1, cyto- | |
| | | | toxic T-lymphocyte- | |
| | | | associated serine | |
| | | | esterase 3) | |
| ASSAY0209 | Hs00200082_m1 | UBL3 | ubiquitin-like 3 | CAATTGGCCAATGGACTGGGAAGAA |
| ASSAY0210 | Hs00203291_m1 | CCDC106 | coiled-coil domain | CTCGGATGGAGGCAGAGGACCACTG |
| | | | containing 106 | |
| ASSAY0216 | Hs00209573_m1 | KIF13B | kinesin family member | TGCCAACAGGAAGCGAGGCTCTCTT |
| | | | 13B | |
| ASSAY0223 | Hs00215938_m1 | RNF31 | ring finger protein 31 | TGCCCCACAACCGGATGCAGGCCCT |
| ASSAY0230 | Hs00228829_m1 | TNKS2 | tankyrase, TRF1- | TGAAACAGCATTGCATTGTGCTGCT |
| | | | interacting ankyrin- | |
| | | | related ADP-ribose | |
| | | | polymerase 2 | |
| ASSAY0234 | Hs00266026_m1 | IGFBP7 | insulin-like growth | GCACCTGCGAGCAAGGTCCTTCCAT |
| | | | factor binding | |
| | | | protein 7 | |
| ASSAY0242 | Hs00276830_m1 | RUNDC2A | RUN domain containing | CAGTGAAACAGTGCCAGATCCGCTT |
| | | | 2A | |
| ASSAY0263 | Hs00606262_g1 | HDAC1 | histone deacetylase 1 | AGGAGAAGAAAGAAGTCACCGAAGA |
| ASSAY0266 | Hs00607689_m1 | FAM103A1 | family with sequence | AGGCAATCGGTTGCAAGACAACAGA |
| | | | similarity 103, | |
| | | | member A1 | |
| ASSAY0281 | Hs00191727_m1 | WTAP | Wilms tumor 1 | CTTCTGCCTGGAGAGGATTCAAGAT |
| | | | associated protein | |
| ASSAY0282 | Hs00192572_m1 | SEL1L | sel-1 suppressor of | CGGGAAACAAACATTCGAGATATGT |
| | | | lin-12-like | |
| | | | (C. elegans) | |
| ASSAY0291 | Hs00195560_m1 | MTHFR | 5,10-methylenetetra- | GTGGCAGGTTACCCCAAAGGCCACC |
| | | | hydrofolate reductase | |
| | | | (NAPDH) | |
| ASSAY0304 | Hs00199030_m1 | EHD1 | EH-domain containing 1 | GGCTGGCCAAGGTTCACGCCTACAT |
| ASSAY0306 | Hs00199344_m1 | ZFHX3 | zinc finger homeobox 3 | AGGGCGGAGCATCGTCCAGCCAAGC |
| ASSAY0324 | Hs00203316_m1 | HOOK2 | hook homolog 2 | AGCGGCGGCAGGTGCAGGAACTGCA |
| | | | (Drosophila) | |
| ASSAY0332 | Hs00205182_m1 | SND1 | staphylococcal | CAGCGAGAGGTGGAGGTGGAGGTGG |
| | | | nuclease and tudor | |
| | | | domain containing 1 | |
| ASSAY0346 | Hs00211420_m1 | FIS1 | fission 1 (mito- | CTGCTCGAGGAGCTGCTGCCCAAAG |
| | | | chondrial outer | |
| | | | membrane) homolog | |
| | | | (S. cerevisiae) | |
| ASSAY0348 | Hs00212451_m1 | CAB39 | calcium binding | GCTCATTGACTTTGAGGGCAAAAAA |
| | | | protein 39 | |
| ASSAY0356 | Hs00214159_m1 | FAM46A | family with sequence | ACTCACGCTCAAGGAAGCTTATGTG |
| | | | similarity 46, | |
| | | | member A | |
| ASSAY0359 | Hs00214745_m1 | DPP8 | dipeptidyl-peptidase 8 | CTGCCTGCTCCAAGTGATTTCAAGT |
| ASSAY0370 | Hs00217272_m1 | NUP133 | nucleoporin 133 kDa | AACTTTTAAAAGATGGCATTCAGCT |
| ASSAY0372 | Hs00218079_m1 | FBXL8 | F-box and leucine- | CACAAAAATCAGTTGCGAATGTGAG |
| | | | rich repeat protein 8 | |
| ASSAY0373 | Hs00218203_m1 | ADAP2 | ArfGAP with dual PH | ACGACTGCCTGGTCTTAAAGGAACA |
| | | | domains 2 | |
| ASSAY0382 | Hs00706913_g1 | PCNP | PEST proteolytic | AATGTAGGCAAACTATCAATTTTTT |
| | | | signal containing | |
| | | | nuclear protein | |
| ASSAY0392 | Hs00287264_m1 | ACSS1 | acyl-CoA synthetase | TGGGGTCAGTGGGAGAGCCCATCAA |
| | | | short-chain family | |
| | | | member 1 | |
| ASSAY0402 | Hs00390635_m1 | TNIK | TRAF2 and NCK | ACCCATCAGAGCAAGCAACCCTGAT |
| | | | interacting kinase | |
| ASSAY0405 | Hs00415453_g1 | TRA@ | T cell receptor | TGGATTCAGTTGGCATGGGTGAGCA |
| | | | alpha locus | |
| ASSAY0407 | Hs00540709_s1 | TMEM203 | transmembrane | CGGGAGCTGGTGCAGTGGCTAGGCT |
| | | | protein 203 | |
| ASSAY0417 | Hs00608534_m1 | SCCPDH | saccharopine dehydro- | CCTAAGGCGGGCGGGGTCTTCACAC |
| | | | genase (putative) | |
| ASSAY0432 | Hs00696974_m1 | BUD31 | BUD31 homolog | GAAAGCCATCAGCAGAGAACTCTAT |
| | | | (S. cerevisiae) | |
| ASSAY0450 | Hs00743508_s1 | C18orf32 | chromosome 18 open | AGGTAGAATTTTGGGAGGTAATAAT |
| | | | reading frame 32 | |
| ASSAY0451 | Hs00745818_s1 | ZNF595 | zinc finger protein | CAAAGCTTTTAATCGGCCCTCAACC |
| | | | 595 | |
| ASSAY0453 | Hs00748530_s1 | UBE2L3 | ubiquitin-conjugating | CTAAGATGCTGCGATCCCGTTCTGC |
| | | | enzyme E2L 3 | |
| ASSAY0455 | Hs00748915_s1 | PFN1 | profilin 1 | TTTTTGGGCCATTACCCCATACCCC |
| ASSAY0456 | Hs00750443_s1 | ARL8B | ADP-ribosylation | GTGTGACTCTGTGGGGACTGCATAG |
| | | | factor-like 8B | |
| ASSAY0464 | Hs00793391_m1 | CSNK1A1 | casein kinase 1, | AGTTTTATGTAAGGGGTTTCCTGCA |
| | | | alpha 1 | |
| ASSAY0467 | Hs00798979_s1 | CCT6A | chaperonin containing | TTTGGGATGTCAGCAGTGGCCTGAA |
| | | | TCP1, subunit 6A | |
| | | | (zeta 1) | |
| ASSAY0476 | Hs00236976_m1 | ITGB1 | integrin, beta 1 | TGTGGCGCGTGCAGGTGCAATGAAG |
| | | | (fibronectin receptor, | |
| | | | beta polypeptide, | |
| | | | antigen CD29 includes | |
| | | | MDF2, MSK12) | |
| ASSAY0477 | Hs00237035_m1 | TRAF3 | TNF receptor- | TCGCGCTGCAGAAACACGAAGACAC |
| | | | associated factor 3 | |
| ASSAY0478 | Hs00237047_m1 | YWHAZ | tyrosine 3-monooxy- | GATAAAAAGAACATCCAGTCATGGA |
| | | | genase/tryptophan 5- | |
| | | | monooxygenase | |
| | | | activation protein, | |
| | | | zeta polypeptide | |
| ASSAY0480 | Hs002442160_m1 | HHEX | hematopoietically | ACCCCCTGGGCAAACCTCTACTCTG |
| | | | expressed homeobox | |
| ASSAY0482 | Hs00242770_m1 | MBD1 | methyl-CpG binding | ATTACCAGAGCCCCACAGGAGACAG |
| | | | domain protein 1 | |
| ASSAY0484 | Hs00244740_m1 | CDC25B | cell division cycle | GGCGGAGCAGACGTTTGAACAGGCC |
| | | | 25 homolog B | |
| | | | (S. pombe) | |
| ASSAY0487 | Hs00248078_m1 | GPR162 | G protein-coupled | AGGATGGAGATGACGATGGGGGCTG |
| | | | receptor 162 | |
| ASSAY0488 | Hs00248163_m1 | GLS | glutaminase | ACTTCTACTTCCAGCTGTGCTCCAT |
| ASSAY0491 | Hs00250236_s1 | KIF21B | kinesin family member | CCCAACATCCATGAGACACCCCGAG |
| | | | 21B | |
| ASSAY0500 | Hs00256558_m1 | WHSC1L1 | Wolf-Hirschhorn | TTACAGAAAGGTGCCAGCGAGATTT |
| | | | syndrome candidate | |
| | | | 1-like 1 | |
| ASSAY0504 | Hs00257861_m1 | COQ10B | coenzyme Q10 homolog | CGCCCGTGCGGAATGGCAGATATTT |
| | | | B (S. cerevisiae) | |
| ASSAY0512 | Hs00260786_m1 | ARFGAP2 | ADP-ribosylation | GTATCCCGAAGCTCTGTCTCCCACT |
| | | | factor GTPase | |
| | | | activating protein 2 | |
| ASSAY0531 | Hs00267008_m1 | IPO5 | importin 5 | TGCTTGCCAGATGTTGGTTTGCTAT |
| ASSAY0540 | Hs00270536_m1 | SNRNP40 | small nuclear | TGAGCCCATCATTATCTCAGCATCG |
| | | | ribonucleoprotein | |
| | | | 40 kDa (U5) | |
| ASSAY0541 | Hs00270620_s1 | IER2 | immediate early | CCCCGCCAAAGTCAGCCGCAAACGA |
| | | | response 2 | |
| ASSAY0543 | Hs00272235_m1 | EIF3M | eukaryotic translation | AGAAGAGTGATGCTGCTTCAAAAGT |
| | | | initiation factor 3, | |
| | | | subunit M | |
| ASSAY0547 | Hs00272902_s1 | RNF113A | ring finger protein | GGGGCCAAGTGCAACCCAGGCAGCC |
| | | | 113A | |
| ASSAY0576 | Hs00326979_m1 | SYNE1 | spectrin repeat | CAAGCTCGAGGCTCTATTATCAGTC |
| | | | containing, nuclear | |
| | | | envelope 1 | |
| ASSAY0579 | Hs00330066_m1 | CCNY | cyclin Y | CCGTCGTCACCCTGGTGTACCTTGA |
| ASSAY0582 | Hs00354853_m1 | CSE1L | CSE1 chromosome | AGGAACTGGAGAATTGTTGAAGATG |
| | | | segregation 1-like | |
| | | | (yeast) | |
| ASSAY0588 | Hs00360923_g1 | CRELD2 | cysteine-rich with | TCCAAGTACGAGTCCAGCGAGATTC |
| | | | EGF-like domains 2 | |
| ASSAY0604 | Hs00369090_m1 | SFRS18 | splicing factor, | ACCAACAGGATCCAAGCCAGATTGA |
| | | | arginine/serine- | |
| | | | rich 18 | |
| ASSAY0619 | Hs00375556_m1 | PIP4K2C | phosphatidylinositol- | CCTTTTCCACAGGGAAAATCTGCCC |
| | | | 5-phosphate 4-kinase, | |
| | | | type II, gamma | |
| ASSAY0632 | Hs00379295_m1 | C1orf144 | chromosome 1 open | AACCCATCCTCGACAGGCCAACCAG |
| | | | reading frame 144 | |
| ASSAY0637 | Hs00383718_m1 | C5AR1 | complement component | AGACCAGAACATGAACTCCTTCAAT |
| | | | 5a receptor 1 | |
| ASSAY0641 | Hs00385203_g1 | FBXW5 | F-box and WD repeat | CCTGTCGCCCGACAACAGGTACCTG |
| | | | domain containing 5 | |
| ASSAY0645 | Hs00387426_m1 | MAP2K4 | mitogen-activated | CAAATAATGGCAGTTAAAAGAATTC |
| | | | protein kinase | |
| | | | kinase 4 | |
| ASSAY0656 | Hs00395045_m1 | STMN3 | stathmin-like 3 | CCAGTACGGGGACATGGAGGTGAAG |
| ASSAY0659 | Hs00400565_m1 | ATG16L2 | ATG16 autophagy | GCTGGTGCCGGCCTATAACCATCTC |
| | | | related 16-like 2 | |
| | | | (S. cerevisiae) | |
| ASSAY0660 | Hs00402617_m1 | MPZL3 | myelin protein zero- | GTGCCTGGATTCAGACTATGAAGAG |
| | | | like 3 | |
| ASSAY0665 | Hs00406064_m1 | DNAJC2 | DnaJ (Hsp40) homolog, | TCAAAGCAGCTCATAAAGCAATGGT |
| | | | subfamily C, member 2 | |
| ASSAY0667 | Hs00409956_g1 | GPS2 | G protein pathway | CTCCGACTCATCCTCTCTGCGCCCC |
| | | | supressor 2 | |
| ASSAY0672 | Hs00412706_m1 | MIA3 | melanoma inhibitory | AGTGAATTTGGATCAGTGGACGGGC |
| | | | activity family, | |
| | | | member 3 | |
| ASSAY0676 | Hs00414732_g1 | LSMD1 | LSM domain | AGCCGTCGGATTCCTTCTCTGCCGG |
| | | | containing 1 | |
| ASSAY0677 | Hs00414889_m1 | ANKRD36B | ankyrin repeat | GAAGGAAAGGACTGCCCTACATTTG |
| | | | domain 36B | |
| ASSAY0678 | Hs00415203_m1 | MARCH3 | membrane-associated | GCCACCCAGAGCCCCTTCAATGACC |
| | | | ring finger (C3HC4) 3 | |
| ASSAY0684 | Hs00417273_m1 | LRRK2 | leucine-rich repeat | TTTGGCCCTCCTCACTGAGACTATT |
| | | | kinase 2 | |
| ASSAY0686 | Hs00418955_m1 | SMCHD1 | structural mainten- | AAGGATTTTAAATGGACAGGAACAG |
| | | | ance of chromosomes | |
| | | | flexible hinge domain | |
| | | | containing 1 | |
| ASSAY0696 | Hs00428204_m1 | NDUFB8; S | NADH dehydrogenase | CGGATGATGGCATGGGGTATGGCGA |
| | | EC31B | (ubiquinone) 1 beta | |
| | | | subcomplex, 8, 19 kDa; | |
| | | | SEC31 homolog B | |
| | | | (S. cerevisiae) | |
| ASSAY0704 | Hs00430663_g1 | UBL5 | ubiquitin-like 5 | CTGGGGGACTATGAAATCCACGATG |
| ASSAY0709 | Hs00536594_m1 | MTG1 | mitochondiral GTPase | CAGCGCTTTGGGTACGTGCAGCACT |
| | | | 1 homolog | |
| | | | (S. cerevisiae) | |
| ASSAY0710 | Hs00536891_m1 | ITSN2 | intersectin 2 | GCTATGAATGGAGGGCCAAACATGT |
| ASSAY0712 | Hs00537038_m1 | TNFAIP8L1 | tumor necrosis factor, | TGCTTCGAGAGTAGGCCATGGACAC |
| | | | alpha-induced protein | |
| | | | 8-like 1 | |
| ASSAY0713 | Hs00538077_m1 | C5orf41 | chromosome 5 open | ACACCCACAGACAGCATCGCACAGA |
| | | | reading frame 41 | |
| ASSAY0714 | Hs00538879_s1 | LUC7L3 | LUC7-like 3 | GTTACACTCAATGCAATTCTCAAGT |
| | | | (S. cerevisiae) | |
| ASSAY0715 | Hs00539341_m1 | C10orf137 | chromosome 10 open | AGACTAGTGAGCAAATCTGTGTCTG |
| | | | reading frame 137 | |
| ASSAY0724 | Hs00542592_g1 | AGER | advanced glycosylation | CGCCGAGGAGAGGAGAGGAAGGCCC |
| | | | end product-specific | |
| | | | receptor | |
| ASSAY0726 | Hs00543883_s1 | HIST1H4C | histone cluster 1, H4c | TATGGCTTCGGCGGCTGAATCTAAG |
| ASSAY0736 | Hs00603727_g1 | EIF1 | eukaryotic translation | TTAAGAAAAAGTTTGCCTGCAATGG |
| | | | initiation factor 1 | |
| ASSAY0741 | Hs00606874_g1 | TNFRSF13C | tumor necrosis factor | CGGAGACAAGGACGCCCCAGAGCCC |
| | | | receptor superfamily, | |
| | | | member 13C | |
| ASSAY0743 | Hs00818252_g1 | KPNA2 | karyopherin alpha 2 | TCATCTTTAGCATGTGGCTACTTAC |
| | | | (RAG cohort 1, | |
| | | | importin alpha 1) | |
| ASSAY0748 | Hs00830558_g1 | FOXN3 | forkhead box N3 | TCTAGGGACTTGGTGTTGCTTGGAA |
| ASSAY0749 | Hs00833126_g1 | MAPK6 | mitogen-activated | CTGAGCCTTGTTGGCAATACTCAGA |
| | | | protein kinase 6 | |
| ASSAY0753 | Hs00855332_g1 | LDHA | lactate dehydrogenase | TCTGACGCACCACTGCCAATGCTGT |
| | | | A | |
| ASSAY0780 | Hs00942554_m1 | RPL6 | ribosomal protein L6 | TCTTGCAAGATGGCGGGTGAAAAAG |
| ASSAY0797 | Hs00975865_m1 | BTK | Bruton | TTATCCCTTCCAGGTTGTATATGAT |
| | | | agammaglobulinemia | |
| | | | tyrosine kinase | |
| ASSAY0802 | Hs00989184_m1 | GZMA | granzyme A (granzyme | ACTCGTGCAATGGAGATTCTGGAAG |
| | | | 1, cytotoxic T- | |
| | | | lymphocyte-associated | |
| | | | serine esterase 3) | |
| ASSAY0807 | Hs00998133_m1 | TGFB1 | transforming growth | ACAGCAAGGTCCTGGCCCTGTACAA |
| | | | factor, beta 1 | |
| ASSAY0810 | Hs01007839_m1 | TNPO1 | transportin 1 | GAAGCTGCCTGCAGTGCCTTTGCTA |
| ASSAY0814 | Hs01013056_g1 | GLUL | glutamate-ammonia | TCTGAAGTACATCGAGGAGGCCATT |
| | | | ligase (glutamine | |
| | | | synthetase) | |
| ASSAY0818 | Hs01018736_g1 | UBL3 | ubiquitin-like 3 | GCCAAACTCTCAAGGTCAGAGGAAT |
| ASSAY0819 | Hs01030693_m1 | ARHGAP17 | Rho GTPase activating | CCAAGATAGTAACAGACTCCAATTC |
| | | | protein 17 | |
| ASSAY0820 | Hs01031740_m1 | ARPC2 | actin releated protein | TGAAAACAATCACGGGGAAGACGTT |
| | | | ⅔ complex, subunit | |
| | | | 2, 34 kDa | |
| ASSAY0827 | Hs01037385_s1 | HMGB1 | high-mobility group | AAAGCAAAGGGAGGATAAAACAGTA |
| | | | box 1 | |
| ASSAY0834 | Hs01053201_s1 | ZBTB38 | zinc finger and BTB | GTAATAAGCTGTGTGACGGTCTTTA |
| | | | domain containing 38 | |
| ASSAY0836 | Hs01053867_s1 | NCRNA00203 | non-protein coding | AGCGCCAGTGCTGGCATGGGCTTTC |
| | | | RNA 203 | |
| ASSAY0844 | Hs01064792_m1 | TRANK1 | tetratricopeptide | TAAAGAAGGAAGGTATTGTTCAGGA |
| | | | repeat and ankyrin | |
| | | | repeat containing 1 | |
| ASSAY0854 | Hs01082775_m1 | TFAM | transcription factor | GGTGATTCACCGCAGGAAAAGCTGA |
| | | | A, mitochondrial | |
| ASSAY0856 | Hs01085351_m1 | STK39 | serine threonine | TAAGTTGGCTTCTGGCTGTGATGGG |
| | | | kinase 39 (STE20/SPS1 | |
| | | | homolog, yeast) | |
| ASSAY0858 | Hs01087966_m1 | MEG3 | maternally expressed 3 | GGATCCCTCACCCGGGTCTCTCCTC |
| | | | (non-protein coding) | |
| ASSAY0871 | Hs01114250_m1 | TGFBR3 | transforming growth | TCTATTCTCACACAGGGGAGACAGC |
| | | | factor, beta receptor | |
| | | | III | |
| ASSAY0888 | Hs01577197_m1 | PSEN2 | presenilin 2 | CCTCATTGGCTTGTGTCTGACCCTC |
| | | | (Alzheimer disease 4) | |
| ASSAY0900 | Hs01636043_s1 | SRP9 | signal recognition | TGCTGTTGTGACCAATAAATATAAA |
| | | | particle 9 kDa | |
| ASSAY0916 | Hs02339727_m1 | ZNF708 | zinc finger protein | CAAACCCCCAGCTATGTGTTCTCAT |
| | | | 708 | |
| ASSAY0923 | Hs02621508_s1 | TNFAIP8 | tumor necrosis factor, | AAATACAGATGTCTCCAGACCTGAG |
| | | | alpha-induced protein | |
| | | | 8 | |
| ASSAY0959 | Hs00185574_m1 | EZR | ezrin | AAAATGCCGAAACCAATCAATGTCC |
| ASSAY0962 | Hs00211306_m1 | DHRS7 | dehydrogenase/reduct- | CTTTAAGAGTGGTGTGGATGCAGAC |
| | | | ase (SDR family) | |
| | | | member 7 | |
| ASSAY0966 | Hs00323799_m1 | RNF160 | ring finger protein | TGAAAAGGCATGTCCTAGTTCAGAT |
| | | | 160 | |
| ASSAY0988 | Hs00200446_m1 | SUPT16H | supressor of Ty 16 | AGGAAATTACATACCGAGCATCAAA |
| | | | homolog | |
| | | | (S. cerevisiae) | |
| ASSAY0996 | Hs00369838_s1 | GPR82 | G protein-coupled | ATGGGAATATCAATCTGCTCAATGC |
| | | | receptor 82 | |
| ASSAY1000 | Hs00403541_m1 | FAM129C | family with sequence | CTGCCCTGAATCCTTGGGAGACCAT |
| | | | similarity 129, | |
| | | | member C | |
| ASSAY1066 | Hs00544818_m1 | MS4A1 | membrane-spanning | TCTCTGTTCTTGGGCATTTTGTCAG |
| | | | 4-domains, subfamily | |
| | | | A, member 1 | |
| ASSAY1071 | Hs00358603_g1 | APOL1 | apolipoprotein L, 1 | AGGAAGCTGGAGCGAGGGTGCAACA |
| ASSAY1087 | Hs00360928_m1 | CRELD2 | cysteine-rich with | GTGCGAAGATGTGGACGAGTGCTCA |
| | | | EFD-like domains 2 | |
| ASSAY1095 | Hs00559595_m1 | ITGB1 | integrin, beta 1 | TTGCTCAAACAGATGAAAATAGATG |
| | | | (fibronectin receptor, | |
| | | | beta polypeptide, | |
| | | | antigen CD29 includes | |
| | | | MDF2, MSK12) | |

TABLE 8
Informative probes for Very Mild versus Mild dementia
(All probes have p-value <0.5)

| Sequence No. | | Gene | | Context Sequence |
|---|---|---|---|---|
| (DiaGenic Assay ID) | Assay ID | Symbol | Gene name | (Oligonucleotide sequence) |
| ASSAY0011 | Hs99999905_m1 | GAPDH | glyceraldehyde-3- | GGGCGCCTGGTCACCAGGGCTGCTT |
| | | | phosphate dehydrogenase | |
| ASSAY0022 | Hs00190463_m1 | C21orf33 | chromosome 21 open | GGGAAGCCCATCGGCTTGTGCTGCA |
| | | | reading frame 33 | |
| ASSAY0047 | Hs00220301_m1 | PPAN; | peter pan homolog | ATCAACGTGCACAAGGTGAACCTGA |
| | | PPAN- | (Drosophila); PPAN- | |
| | | P2RY11 | P2RY11 readthrough | |
| ASSAY0051 | Hs00220527_m1 | C1orf128 | chromosome 1 open | CCCTCTGAGATGAGACTGTACAAGA |
| | | | reading frame 128 | |
| ASSAY0052 | Hs00220814_m1 | SLC44A2 | solute carrier family | AAACGAGAACAAACCCTATCTGTTT |
| | | | 44, member 2 | |
| ASSAY0057 | Hs00221859_m1 | SQRDL | sulfide quinone | GTTGAGCCCAGTGAGAGACATTTCT |
| | | | reductase-like (yeast) | |
| ASSAY0062 | Hs00223727_m1 | PAPD5 | PAP associated | TTTACAACCAGGTAACGATGTTGGA |
| | | | domain containing 5 | |
| ASSAY0082 | Hs00228787_m1 | COASY | Coenzyme A synthase | AAAGATCTGTTGAAGAGCAAGTTGC |
| ASSAY0113 | Hs00157831_m1 | GTF2E2 | general transcription | GCCCTTCTCACTCAGCATTATGGAT |
| | | | factor IIE, polypeptide | |
| | | | 2, beta 34 kDa | |
| ASSAY0137 | Hs99999908_m1 | GUSB | glucuronidase, beta | TGAACAGTCACCGACGAGAGTGCTG |
| ASSAY0150 | Hs00174705_m1 | CD163 | CD163 molecule | ACCTGCTCAGCCCACAGGGAACCCA |
| ASSAY0172 | Hs00182671_m1 | NAE1 | NEDD8 activating | GACCGGCAGCTGAGGTTGTGGGGTG |
| | | | enzyme E1 subunit 1 | |
| ASSAY0185 | Hs00189530_m1 | FRG1; | FSHD region gene 1; | TTCAAAATGGGAAAATGGCTTTGTT |
| | | FRG1B | FSHD region gene 1 | |
| | | | family, member B | |
| ASSAY0187 | Hs00189576_m1 | HSD17B10 | hydroxysteroid (17- | CGCCCCAGCCGACGTGACCTCTGAG |
| | | | beta) dehydrogenase 10 | |
| ASSAY0205 | Hs00188277_m1 | KDM5C | lysine (K)-specific | CCACCCGCGGACTGGCAGCCACCCT |
| | | | demethylase 5C | |
| ASSAY0209 | Hs00200082_m1 | UBL3 | ubiquitin-like 3 | CAATTGGCCAATGGACTGGGAAGAA |
| ASSAY0212 | Hs00204260_m1 | C11orf21 | chromosome 11 open | GAGGAGGAGCGCTGTGCCCAGGTGG |
| | | | reading frame 21 | |
| ASSAY0224 | Hs00218060_m1 | TMEM106B | transmembrane | GCGCCCCGCGTGCCGACATGGGAAA |
| | | | protein 106B | |
| ASSAY0261 | Hs00429212_m1 | C16orf35 | chromosome 16 open | GCTGTGCAGGAGACCCAGCTCATCC |
| | | | reading frame 35 | |
| ASSAY0279 | Hs01585413_g1 | N/A | N/A | TTTACCAAATTCAAGGTGGATGAAT |
| ASSAY0285 | Hs00194072_m1 | APBA2 | amyloid beta (A4) | AACATTCCAGAGACAAAGAAGGTGG |
| | | | precursor protein- | |
| | | | binding, family A, | |
| | | | member 2 | |
| ASSAY0289 | Hs00194815_m1 | ARPC1B | actin releated protein | CGCGGGAGGAGCCAAGCCGCCATGG |
| | | | ⅔ complex, subunit | |
| | | | 1B, 41 kDa | |
| ASSAY0304 | Hs00199030_m1 | EHD1 | EH-domain containing 1 | GGCTGGCCAAGGTTCACGCCTACAT |
| ASSAY0306 | Hs00199344_m1 | ZFHX3 | zinc finger homeobox 3 | AGGGCGGAGCATCGTCCAGCCAAGC |
| ASSAY0307 | Hs00199894_m1 | CD160 | CD160 molecule | GGCCCTTCAAGCTTTGTAAGCCTTG |
| ASSAY0327 | Hs00203782_m1 | BAZ2A | bromodomain adjacent | AGAAACTGGAGGCCCAAGAAACATT |
| | | | to zinc finger domain, | |
| | | | 2A | |
| ASSAY0346 | Hs00211420_m1 | FIS1 | fission 1 (mitochon- | CTGCTCGAGGAGCTGCTGCCCAAAG |
| | | | drial outer membrane) | |
| | | | homolog (S. cerevisiae) | |
| ASSAY0372 | Hs00218079_m1 | FBXL8 | F-box and leucine-rich | CACAAAAATCAGTTGCGAATGTGAG |
| | | | repeat protein 8 | |
| ASSAY0399 | Hs00377979_m1 | TRIP6 | thyroid hormone | GGACTTTCACAGGAAGTTTGCCCCA |
| | | | receptor interactor 6 | |
| ASSAY0422 | Hs00610210_g1 | RHBDL1 | rhomboid, veinlet-like | TCTTGCCCAGATCATCGTGTTCCTG |
| | | | 1 (Drosophila) | |
| ASSAY0428 | Hs00610917_g1 | AURKAIP1 | aurora kinase A | CTGAGACGCAAGCAGATCAAGTTCG |
| | | | interacting protein 1 | |
| ASSAY0456 | Hs00750443_s1 | ARL8B | ADP-ribosylation | GTGTGACTCTGTGGGGACTGCATAG |
| | | | factor-like 8B | |
| ASSAY0458 | Hs00751057_s1 | GOT2 | glutamic-oxaloacetic | GCTGATGCCGTACCCTCACCCTTTT |
| | | | transaminase 2, mito- | |
| | | | chondrial (aspartate | |
| | | | aminotransferase 2) | |
| ASSAY0463 | Hs00762481_s1 | RLP36 | ribosomal protein L36 | CCTTCTCCCCGTCGCTGTCCGCAGC |
| ASSAY0467 | Hs00798979_s1 | CCT6A | chaperonin containing | TTTGGGATGTCAGCAGTGGCCTGAA |
| | | | TCP1, subunit 6A | |
| | | | (zeta 1) | |
| ASSAY0481 | Hs00242737_m1 | LTB | lymphotoxin beta (TNF | ATCAGGGAGGACTGGTAACGGAGAC |
| | | | superfamily, member 3) | |
| ASSAY0489 | Hs00248408_m1 | Sep6 | septin 6 | AGAAAGAGCTGCACGAGAAGTTTGA |
| ASSAY0502 | Hs00257171_s1 | GALNT10 | UDP-N-acetyl-alpha-D- | AGATTCTGCACAAGTCAGCAGTGCA |
| | | | galactosamine-polypep- | |
| | | | tide N-acetylgalacto- | |
| | | | saminyltransferase 10 | |
| | | | (GalNAc-T10) | |
| ASSAY0507 | Hs00258828_m1 | FERMT3 | fermitin family homolog | GGATCCCAAGACAGACCCCGTGCGG |
| | | | 3 (Drosophila) | |
| ASSAY0511 | Hs00260613_m1 | VPS25 | vacuolar protein | GAGGATGAGGAGTTCCACGGGCTGG |
| | | | sorting 25 homolog | |
| | | | (S. cerevisiae) | |
| ASSAY0532 | Hs00267168_s1 | MC1R | melanocortin 1 | GCAGGACGCTCAAGGAGGTGCTGAC |
| | | | receptor (alpha | |
| | | | melanocyte stimulating | |
| | | | hormone receptor) | |
| ASSAY0537 | Hs00269247_s1 | GPR65 | G protein-coupled | TTCTCTCCTGCCTTGTGCAAAGGGA |
| | | | receptor 65 | |
| ASSAY0542 | Hs00271244_s1 | HSPA1B; | heat shock 70 kDa | AGGACTTTGCTGCTGTTTTCCTATG |
| | | HSPA1A | protein 1; heat shock | |
| | | | 70 kDa protein 1A | |
| ASSAY0547 | Hs00272902_s1 | RFN113A | ring finger protein | GGGGCCAAGTGCAACCCAGGCAGCC |
| | | | 113A | |
| ASSAY0553 | Hs00275656_m1 | GSK3B | glycogen synthase | AGAAATAATCAAGGTCCTGGGAACT |
| | | | kinase 3 beta | |
| ASSAY0570 | Hs00299189_m1 | RLP32P3 | ribosomal protein L32 | AAGGAAGAGGACCAGGCTTCCTGTC |
| | | | pseudogene 3 | |
| ASSAY0584 | Hs00356601_m1 | CCR2 | chemokine (C-C motif) | GCCACAAGCTGAACAGAGAAAGTGG |
| | | | receptor 2 | |
| ASSAY0615 | Hs00375047_m1 | TMED9 | transmembrane emp24 | CCCAGAGGACAAGGTCATCCTGGCC |
| | | | protein transport | |
| | | | domain containing 9 | |
| ASSAY0619 | Hs00375556_m1 | PIP4K2C | phosphatidylinositol-5- | CCTTTTCCACAGGGAAAATCTGCCC |
| | | | phosphate 4-kinase, | |
| | | | type II, gamma | |
| ASSAY0621 | Hs00375641_m1 | TOMM40L | translocase of outer | GCTCAGTCCCACTGAGGTGTTCCCC |
| | | | mitochondrial membrane | |
| | | | 40 homolog (yeast)- | |
| | | | like | |
| ASSAY0634 | Hs00379889_m1 | PQLC3 | PQ loop repeat | GACCTGGCCATGAATCTATGTACTT |
| | | | containing 3 | |
| ASSAY0641 | Hs00385203_g1 | FBXW5 | F-box and WD repeat | CCTGTCGCCCGACAACAGGTACCTG |
| | | | domain containing 5 | |
| ASSAY0667 | Hs00409956_g1 | GPS2 | G protein pathway | CTCCGACTCATCCTCTCTGCGCCCC |
| | | | suppressor 2 | |
| ASSAY0676 | Hs00414732_g1 | LSMD1 | LSM domain containing 1 | AGCCGTCGGATTCCTTCTCTGCCGG |
| ASSAY0678 | Hs00415203_m1 | MARCH3 | membrane-associated | GCCACCCAGAGCCCCTTCAATGACC |
| | | | ring finger (C3HC4) 3 | |
| ASSAY0682 | Hs00416940_m1 | INSC | inscuteable homolog | TGGCCTGCCTGGCTGCTCTGCGTAG |
| | | | (Drosophila) | |
| ASSAY0683 | Hs00417251_m1 | SNHG6 | small nucleolar RNA | TAGCTGGGCTCTGCGAGGTGCAAGA |
| | | | host gene 6 (non- | |
| | | | protein coding) | |
| ASSAY0729 | Hs00559804_m1 | CAPN1 | calpain 1, (mu/l) large | AAACTACCCAGCCACCTTCTGGGTG |
| | | | subunit | |
| ASSAY0741 | Hs00606874_g1 | TNFRSF13C | tumor necrosis factor | CGGAGACAAGGACGCCCCAGAGCCC |
| | | | receptor superfamily, | |
| | | | member 13C | |
| ASSAY0743 | Hs00818252_g1 | KPNA2 | karyopherin alpha 2 | TCATCTTTAGCATGTGGCTACTTAC |
| | | | (RAG cohort 1, | |
| | | | importin alpha 1) | |
| ASSAY0751 | Hs00852410_g1 | PRKRIR | protein-kinase, | TACTCTGCAGTGCAGTGTCAGATTT |
| | | | interferon-inducible | |
| | | | double stranded RNA | |
| | | | dependent inhibitor, | |
| | | | repressor of (P58 | |
| | | | repressor) | |
| ASSAY0753 | Hs00855332_g1 | LDHA | lactate dehydrogenase | TCTGACGCACCACTGCCAATGCTGT |
| | | | A | |
| ASSAY0797 | Hs00975865_m1 | BTK | Bruton | TTATCCCTTCCAGGTTGTATATGAT |
| | | | agammaglobulinemia | |
| | | | tyrosine kinase | |
| ASSAY0804 | Hs00989762_g1 | CIRBP | cold inducible RNA | CTATAGCAGCCGGAGTCAGAGTGGT |
| | | | binding protein | |
| ASSAY0814 | Hs01013056_g1 | GLUL | glutamate-ammonia | TCTGAAGTACATCGAGGAGGCCATT |
| | | | ligase (glutamine | |
| | | | synthetase) | |
| ASSAY0820 | Hs01031740_m1 | ARPC2 | actin related protein | TGAAAACAATCACGGGGAAGACGTT |
| | | | ⅔ complex, subunit 2, | |
| | | | 34 kDa | |
| ASSAY0826 | Hs01036536_m1 | BCR | breakpoint cluster | ATTGCTGTGGTCACCAAGAGAGAGA |
| | | | region | |
| ASSAY0836 | Hs01053867_s1 | NCRNA002 | non-protein coding | AGCGCCAGTGCTGGCATGGGCTTTC |
| | | 03 | RNA 203 | |
| ASSAY0844 | Hs01064792_m1 | TRANK1 | tetratricopeptide | TAAAGAAGGAAGGTATTGTTCAGGA |
| | | | repeat and ankyrin | |
| | | | repeat containing 1 | |
| ASSAY0856 | Hs01085351_m1 | STK39 | serine threonine | TAAGTTGGCTTCTGGCTGTGATGGG |
| | | | kinase 39 (STE20/SPS1 | |
| | | | homolog, yeast) | |
| ASSAY0871 | Hs01114250_m1 | TGFBR3 | transforming growth | TCTATTCTCACACAGGGGAGACAGC |
| | | | factor, beta receptor | |
| | | | III | |
| ASSAY0888 | Hs01577197_m1 | PSEN2 | presenilin 2 | CCTCATTGGCTTGTGTCTGACCCTC |
| | | | (Alzheimer disease 4) | |
| ASSAY0914 | Hs02339116_s1 | OR52K1 | olfactory receptor, | GGCAGTTCTCCAGCTTGCCTCTCAG |
| | | | family 52, subfamily K, | |
| | | | member 1 | |
| ASSAY0916 | Hs02339727_m1 | ZNF708 | zinc finger protein 708 | CAAACCCCCAGCTATGTGTTCTCAT |
| ASSAY0925 | Hs02863396_m1 | GNA12 | guanine nucleotide | AGCGAGTTTCAGCTGGGGGAGTCGG |
| | | | binding protein (G | |
| | | | protein) alpha 12 | |
| ASSAY0941 | Hs00328784_s1 | MTMR3 | myotubularin related | CCCTCGGGAAGGTTGGTATTGAGGG |
| | | | protein 3 | |
| ASSAY0947 | Hs00254569_s1 | HRH2 | histamine receptor H2 | GGTCACCCCAGTTCGGGTCGCCATC |
| ASSAY0976 | Hs00376366_m1 | CCDC12 | coiled-coil domain | CAAACCGGTTGCAGTGGAGGAGAAG |
| | | | containing 12 | |
| ASSAY1014 | Hs00204129_m1 | C13orf15 | chromosome 13 open | TCGGAGAGTGCAGATTCACTTTATA |
| | | | reading frame 15 | |
| ASSAY1023 | Hs01573555_m1 | ITPR3 | inositol 1,4,5- | GCTTCATCTGTGGTCTGGAGAGGGA |
| | | | triphosphate receptor | |
| | | | type 3 | |
| ASSAY1026 | Hs00162271_m1 | SPTBN1 | spectrin, beta, non- | GCTCTGGGCACACAGGTGAGGCAGC |
| | | | erythrocytic 1 | |
| ASSAY1035 | Hs00202392_m1 | SLC39A6 | solute carrier family | CGGAGACGAAGGCGCAATGGCGAGG |
| | | | 39 (zinc transporter), | |
| | | | member 6 | |

TABLE 9
Informative probes for Prospective modelling
(non-clear versus clear progression of AD)

| Sequence No. | | Gene | | Context Sequence |
|---|---|---|---|---|
| (DiaGenic Assay ID) | Assay ID | Symbol | Gene name | (Oligonucleotide sequence) |
| ASSAY0001 | Hs00152932_m1 | TLR2 | toll-like receptor 2 | TCAACTGGTAGTTGTGGGTTGAAGC |
| ASSAY0002* | Hs00153510_m1 | MME | membrane metallo- | TGAAGAAAAGGCCTTAGCAATTAAA |
| | | | endopeptidase | |
| ASSAY0003* | Hs00190079_m1 | PFKFB3 | 6-phosphofructo-2- | TGCCCAGATCCTGTGGGCCAAAGCT |
| | | | kinase/fructose-2,6- | |
| | | | biphosphatase 3 | |
| ASSAY0006* | Hs00220373_m1 | SLC12A9 | solute carrier family | CTCCGGCCTCGGTGGCATGAAGCCC |
| | | | 12 (potassium/chloride | |
| | | | transporters), member 9 | |
| ASSAY0013* | Hs00163311_m1 | UBE2B | ubiquitin-conjugating | CACCTTTTGAAGATGGTACTTTTAA |
| | | | enzyme E2B (RAD6 | |
| | | | homolog) | |
| ASSAY0017* | Hs00179345_m1 | MAP4K1 | mitogen-activated | CTCTCTCAGGAAAGACCCCCCACCT |
| | | | protein kinase kinase | |
| | | | kinase kinase 1 | |
| ASSAY0018 | Hs00185876_m1 | ACOX3 | acyl-Coenzyme A | ATCTGGCCATGAACCGGTTGGGTGT |
| | | | oxidase 3, pristanoyl | |
| ASSAY0022* | Hs00190463_m1 | C21orf33 | chromosome 21 open | GGGAAGCCCATCGGCTTGTGCTGCA |
| | | | reading frame 33 | |
| ASSAY0024 | Hs00191108_m1 | SFRS11 | splicing factor, | CCGCCGGATGATTCGCCTTTGCCAG |
| | | | arginine/serine-rich 11 | |
| ASSAY0027* | Hs00191312_m1 | NMT2 | N-myristoyltransferase | TTCGGATTTATGACAGTGTGAAGAA |
| | | | 2 | |
| ASSAY0031 | Hs00198312_m1 | AHCYL1 | adenosylhomocysteinase- | AGCTACAGTTCAGCTGCATCCTACA |
| | | | like 1 | |
| ASSAY0036 | Hs00217597_m1 | PSPC1 | paraspeckle component 1 | ACATGGAAAATGGTGATAAAAGAAA |
| ASSAY0040* | Hs00219196_m1 | YIPF1 | Yip1 domain family, | TGGGCTGCTTGGCATACTTTTTTGA |
| | | | member 1 | |
| ASSAY0041* | Hs00219523_m1 | C1orf183 | chromosome 1 open | TCAAACAGGAGCTGATGTCCATGAA |
| | | | reading frame 183 | |
| ASSAY0047* | Hs00220301_m1 | PPAN; PPA | peter pan homolog | ATCAACGTGCACAAGGTGAACCTGA |
| | | N-P2TY11 | (Drosophila); PPAN- | |
| | | | P2RY11 readthrough | |
| ASSAY0049* | Hs00220491_m1 | ENTPD7 | ectonucleoside | CAAGGCTGCTCAGGATTACTGTGGC |
| | | | triphosphate | |
| | | | diphosphohydrolase 7 | |
| ASSAY0050 | Hs00220503_m1 | CASS4 | Cas scaffolding protein | TGCGCCCAAGGCACTCCTGGCCAGG |
| | | | family member 4 | |
| ASSAY0053* | Hs00221104_m1 | ABHD6 | abhydrolase domain | CGTGTGTCCTGCTGGCCTGCAGTAC |
| | | | containing 6 | |
| ASSAY0054 | Hs00221227_m1 | PLEKHA4 | pleckstrin homology | TCTCCCCAGGACAGAGTGTCTGCTC |
| | | | domain containing, | |
| | | | family A (phosphoino- | |
| | | | sitide binding | |
| | | | specific) member 4 | |
| ASSAY0055* | Hs00221499_m1 | KAT2A | K(lysine) | TCACTTCCCCAAATTCCTGTCCATG |
| | | | acetyltransferase 2A | |
| ASSAY0057* | Hs00221859_m1 | SQRDL | sulfide quinone | GTTGAGCCCAGTGAGAGACATTTCT |
| | | | reductase-like (yeast) | |
| ASSAY0061 | Hs00223525_m1 | ERAP2 | endoplasmic reticulum | AGCTAGTTGGTGCAGGGAGACTGAC |
| | | | aminopeptidase 2 | |
| ASSAY0065 | Hs00224328_m1 | CRTC3 | CREB regulated trans- | TACCTCCCAGATGGTGTCCTCAGAC |
| | | | cription coactivator 3 | |
| ASSAY0070 | Hs00225747_m1 | NOTCH2 | Nothc homolog 2 | GTGCCTTTACTGGCCGGCACTGTGA |
| | | | (Drosophila) | |
| ASSAY0080 | Hs00228549_m1 | SIK3 | SIK family kinase 3 | CCCAGCAGAGAGCCTGTCATAGGGA |
| ASSAY0085 | Hs00229911_m1 | APH1B | anterior pharynx | TCATCGCCGGAGCTTTCTTCTGGTT |
| | | | defective 1 homolog B | |
| | | | (C. elegans) | |
| ASSAY0089* | Hs00231324_m1 | SMARCA4 | SWI/SNF related, matrix | GAATCCTCACCAGGACCTGCAAGCG |
| | | | associated, actin | |
| | | | dependent regulator of | |
| | | | chromatin, subfamily a, | |
| | | | member 4 | |
| ASSAY0093 | Hs00233856_m1 | LRP1 | low density lipoprotein | CCCCTGAGATTTGTCCACAGAGTAA |
| | | | receptor-related | |
| | | | protein 1 | |
| ASSAY0096* | Hs00234224_m1 | ADAM17 | ADAM metallopeptidase | GGTGTCCAGTGCAGTGACAGGAACA |
| | | | domain 17 | |
| ASSAY0097* | Hs00234280_m1 | UBE2D1 | ubiquitin-conjugating | GAGGATTCAGAAAGAATTGAGTGAT |
| | | | enzyme E2D 1 (UBC4/5 | |
| | | | homolog, yeast) | |
| ASSAY0098* | Hs00153519_m1 | MME | membrane metallo- | TCCAGGCAATTTCAGGATTATTGGG |
| | | | endopeptidase | |
| ASSAY0108 | Hs00156251_m1 | CAPN2 | calpain 2, (m/ll) | GAAGCGCCCCACGGAGATCTGCGCT |
| | | | large subunit | |
| ASSAY0112 | Hs00157403_m1 | EPHX2 | epoxide hydrolase 2, | ACGTGACAGTAAAGCCCAGGGTCCG |
| | | | cytoplasmic | |
| ASSAY0115* | Hs00158057_m1 | IL1RAP | interleukin 1 receptor | AACCATTTTAGATGGAAAAGAGTAT |
| | | | accessory protein | |
| ASSAY0119* | Hs00159537_m1 | NBN | nibrin | CCCGGCAGGAGGAGAACCATACAGA |
| ASSAY0120* | Hs00159668_m1 | NRD1 | nardilysin (N-arginine | TGTCACAAGCACAGAATCTATGGAT |
| | | | dibasic convertase) | |
| ASSAY0127* | Hs00162394_m1 | STIM1 | stromal interaction | TTGTCCATGCAGTCCCCTAGCCTGC |
| | | | molecule 1 | |
| ASSAY0132* | Hs00166580_m1 | UBE3A | ubiquitin protein | CTAGCCGAATGAAGCGAGCAGCTGC |
| | | | ligase E3A | |
| ASSAY0133* | Hs00167309_m1 | SOD2 | superoxide dismutase | GGAACAACAGGCCTTATTCCACTGC |
| | | | 2, mitochondrial | |
| ASSAY0136* | Hs00170600_m1 | DNAJA3 | DnaJ (Hsp40) homolog, | TCAACGTGACGATCCCCCCTGGGAC |
| | | | subfamily A, member 3 | |
| ASSAY0137* | Hs99999908_m1 | GUSB | glucuronidase, beta | TGAACAGTCACCGACGAGAGTGCTG |
| ASSAY0145 | Hs00174164_m1 | CSF1 | colony stimulating | AGAGCATGACAAGGCCTGCGTCCGA |
| | | | factor 1 (macrophage) | |
| ASSAY0150 | Hs00174705_m1 | CD163 | CD163 molecule | ACCTGCTCAGCCCACAGGGAACCCA |
| ASSAY0154* | Hs00175407_m1 | CTSS | cathespin S | TGTGAAAAACAGCTGGGGCCACAAC |
| ASSAY0156* | Hs00175573_m1 | AQP9 | aquaporin 9 | CATCTTGATTGTCCTTGGATGTGGC |
| ASSAY0157* | Hs00175591_m1 | PRNP | prion protein | CACGACCGAGGCAGAGCAGTCATTA |
| ASSAY0158* | Hs00176666_m1 | ITPKB | inositol 1,4,5- | GCAAGATGGGAATCAGGACCTACCT |
| | | | triphosphate 3-kinase B | |
| ASSAY0162* | Hs00177028_m1 | PKN1 | protein kinase N1 | TGGCAGCACCAAGGACCGGAAGCTG |
| ASSAY0163* | Hs00177066_m1 | MAPK1 | mitogen-activated | CGGCATGGTGTGCTCTGCTTATGAT |
| | | | protein kinase 1 | |
| ASSAY0166 | Hs00178787_m1 | CDC42BPB | CDC42 binding protein | CTGTCGCCTGTAGTTGCAGCCCCAC |
| | | | kinase beta (DMPK-like) | |
| ASSAY0169* | Hs00179997_m1 | KDSR | 3-ketodihydrosphingo- | GCTCCAGCAGGTGGTCACCATGGGC |
| | | | sine reductase | |
| ASSAY0170 | Hs00180965_m1 | ERBB2IP | erbb2 interacting | GCCGAAAGAATGTTGGCTCAATTAA |
| | | | protein | |
| ASSAY0180 | Hs00187845_m1 | BCL2A1 | BCL2-related protein A1 | AAAACGGAGGCTGGGAAAATGGCTT |
| ASSAY0182 | Hs00188433_m1 | FIBP | fibroblast growth | TGACCGGTTGGCCAGGGACTATGCA |
| | | | factor (acidic) intra- | |
| | | | cellular binding | |
| | | | protein | |
| ASSAY0183 | Hs00188713_m1 | BAG3 | BCL2-associated | GGGCCCCAAGGAGACTCCATCCTCT |
| | | | athanogene 3 | |
| ASSAY0190 | Hs00154457_m1 | CIRBP | cold inducible RNA | GCCCGACTCAGTGGCCGCCATGGCA |
| | | | binding protein | |
| ASSAY0191 | Hs00157817_m1 | GRB2 | growth factor receptor- | GGGGGGACATCCTCAAGGTTTTGAA |
| | | | bound protein 2 | |
| ASSAY0194* | Hs00164370_m1 | CYBA | cytochrome b-245, | GGCCTGATCCTCATCACCGGGGGCA |
| | | | alpha polypeptide | |
| ASSAY0197 | Hs00170953_m1 | S100A6 | S100 calcium binding | CCCTACCGCTCCAAGCCCAGCCCTC |
| | | | protein A6 | |
| ASSAY0199 | Hs00175295_m1 | TCF12 | transcription factor 12 | GCGCTTGATCCCTTGCAAGCAAAAA |
| ASSAY0203* | Hs00183479_m1 | PDE4A | phosphodiesterase 4A, | CCTGGCCCAAGAACTGGAGAACCTG |
| | | | cAMP-specific | |
| | | | (phosphodiesterase E2 | |
| | | | dunce homolog, | |
| | | | Drosophila) | |
| ASSAY0204* | Hs00184390_m1 | TCOF1 | Treacher Collins- | GCATCTCCAGCACAGGTGAAAACCT |
| | | | Franceschetti | |
| | | | syndrome 1 | |
| ASSAY0210 | Hs00203291_m1 | CCDC106 | coiled-coil domain | CTCGGATGGAGGCAGAGGACCACTG |
| | | | containing 106 | |
| ASSAY0213* | Hs00204880_m1 | PATZ1 | POZ (BTB) and AT | ACAAGTGTCAGACCTGCAATGCTTC |
| | | | hook containing zinc | |
| | | | finger 1 | |
| ASSAY0214* | Hs00207230_m1 | FAM38A | family with sequence | CGGCCCTGTGCATTGATTATCCCTG |
| | | | similarity 38, | |
| | | | member A | |
| ASSAY0215* | Hs00208212_m1 | RBM19 | RNA binding motif | ACGAGCCACTAAGCCAGCCGTGACA |
| | | | protein 19 | |
| ASSAY0218 | Hs00212288_m1 | BIRC6 | baculoviral IAP repeat- | GCGAATGCATTCAGGAGCAAGAAGA |
| | | | containing 6 (apollon) | |
| ASSAY0223 | Hs00215938_m1 | RNF31 | ring finger protein 31 | TGCCCCACAACCGGATGCAGGCCCT |
| ASSAY0227* | Hs00222984_m1 | HPS4 | Hermansky-Pudlak | CATAGAGGAAGTGTACCACAGCAGC |
| | | | syndrome 4 | |
| ASSAY0228* | Hs00227687_m1 | DENND2D | DENN/MADD domain | TGGAAGAGGTCCTGCTGGTCAATCT |
| | | | containing 2D | |
| ASSAY0232 | Hs00255879_m1 | GFOD1 | glucose-fructose | AAACCCTAGGCATCGGCAAGAACGT |
| | | | oxidereductase domain | |
| | | | containing 1 | |
| ASSAY0242 | Hs00276830_m1 | RUNDC2A | RUN domain | CAGTGAAACAGTGCCAGATCCGCTT |
| | | | containing 2A | |
| ASSAY0246 | Hs00330168_m1 | DNHD1 | dynein heavy chain | GGGCGCTGGAGTCAAGTGACTCTAA |
| | | | domain 1 | |
| ASSAY0249 | Hs00356977_m1 | PLEC | plectin | TGCAGGATGCCCAGGACGAGAAGGA |
| ASSAY0250* | Hs00363005_m1 | SCRIB | scribbled homolog | ACGGAGAACCTGCTGATGGCCCTGC |
| | | | (Drosophila) | |
| ASSAY0251 | Hs00367259_m1 | GOLGA8B; | golgin A8 family, | AGAAGCCGGATGGGTTCTCGAGCCG |
| | | GOLGA8A | member B; golgin A8 | |
| | | | family, member A | |
| ASSAY0254* | Hs00382453_m1 | XPO5 | exportin 5 | TTGCGCTTATAAGAACCCACAATAC |
| ASSAY0267* | Hs00609831_g1 | AARS | alanyl-tRNA synthetase | CGGCGCCTCAGCCAAGGCCCTGAAT |
| ASSAY0270 | Hs00754750_s1 | PTP4A2 | protein tyrosine | CCTTTTCCCCCGATCCAAGTTGTAG |
| | | | phosphatase type IVA, | |
| | | | member 2 | |
| ASSAY0272 | Hs00831506_g1 | PEBP1 | phosphatidylethanol- | TGGCAAATTCAAGGTGGCGTCCTTC |
| | | | amine binding protein 1 | |
| ASSAY0281 | Hs00191727_m1 | WTAP | Wilms tumor 1 | TGGCAAATTCAAGGTGGCGTCCTTC |
| | | | associated protein | |
| ASSAY0285 | Hs00194072_m1 | APBA2 | amyloid beta (A4) | AACATTCCAGAGACAAAGAAGGTGG |
| | | | precursor protein- | |
| | | | binding, family A, | |
| | | | member 2 | |
| ASSAY0286 | Hs00194400_m1 | LPP | LIM domain containing | GAGGACTTCCACAAGAAATTTGCCC |
| | | | preferred translocation | |
| | | | partner in lipoma | |
| ASSAY0291* | Hs00195560_m1 | MTHFR | 5,10-methylenetetra- | GTGGCAGGTTACCCCAAAGGCCACC |
| | | | hydrofolate reductase | |
| | | | (NAPDH) | |
| ASSAY0294* | Hs00196191_m1 | CD7 | CD7 molecule | TGGCGAGGACACAGATAAAGAAACT |
| ASSAY0296* | Hs00196955_m1 | NCOR2 | nuclear receptor co- | GCGCCGAGCTGGCCTCCATGGAGCT |
| | | | repressor 2 | |
| ASSAY0302 | Hs00198676_m1 | TCERG1 | transcription | TACTCCATGGTGTGTCGTTTGGACT |
| | | | elongation regulator 1 | |
| ASSAY0309* | Hs00200073_m1 | NDUFV1 | NADH dehydrogenase | CGGCGACACGACAGCACCCAAGAAA |
| | | | (ubiquinone) flavo- | |
| | | | protein 1, 51 kDa | |
| ASSAY0313* | Hs00201247_m1 | NCBP2 | nuclear cap binding | GACCAGCACTTCCGGGGTGACAATG |
| | | | protein subunit 2, | |
| | | | 20 kDa | |
| ASSAY0319 | Hs00202185_m1 | FTSJ1 | FtsJ homolog 1 | CTTAACCCATTACGCTGGCAAACTG |
| | | | (E. coli) | |
| ASSAY0332* | Hs00205182_m1 | SND1 | staphylococcal | CAGCGAGAGGTGGAGGTGGAGGTGG |
| | | | nuclease and tudor | |
| | | | domain containing 1 | |
| ASSAY0338 | Hs00209768_m1 | C17orf81 | chromosome 17 open | GATATCAACAATCGGCTGGTTTACC |
| | | | reading frame 81 | |
| ASSAY0339* | Hs00209887_m1 | ABHD14A | abhydrolase domain | GCCCTTGACCTTCCAGGTTTTGGGA |
| | | | containing 14A | |
| ASSAY0343* | Hs00211070_m1 | ERGIC3 | ERGIC and golgi 3 | AGCGGCATGAGCTTGGGAAAGTCGA |
| ASSAY0355 | Hs00214019_m1 | SMG6 | Smg-6 homolog, | CCCCTCATCGTGATCAATGAGCTGG |
| | | | nonsense mediated mRNA | |
| | | | decay factor | |
| | | | (C. elegans) | |
| ASSAY0358* | Hs00214624_m1 | TMEM214 | transmembrane | TCCTTCCAGGCCTCCCTTACTGGCC |
| | | | protein 214 | |
| ASSAY0361* | Hs00215064_m1 | BTBD2 | BTB (POZ) domain | TCGCTGCAGGTCCCGCACAGTCGGG |
| | | | containing 2 | |
| ASSAY0364 | Hs00215334_m1 | INTS8 | integrator complex | AAATGAGGCTTCCTGATATTCCTCT |
| | | | subunit 8 | |
| ASSAY0369* | Hs00217022_m1 | ZFP64 | zinc finger protein 64 | AGACAATCACAGTTTCAGCTCCAGA |
| | | | homolog (mouse) | |
| ASSAY0374 | Hs00218284_m1 | TBC1D2 | TBC1 domain family, | CTTCTGACGAAGTGCGCCTACCTCC |
| | | | member 2 | |
| ASSAY0376* | Hs00234404_m1 | FKBP2 | FK506 binding protein | CACTACACGGGGAAGCTGGAAGATG |
| | | | 2, 13 kDa | |
| ASSAY0380* | Hs00609603_m1 | ACVR2B | activin A receptor, | ATTGCCCACAGGGACTTTAAAAGTA |
| | | | type IIB | |
| ASSAY0381* | Hs00612265_m1 | ZCCHC6 | zinc finger, CCHC | GGAAGCAGGAAGTCCTGAAAACAAG |
| | | | domain containing 6 | |
| ASSAY0387 | Hs00260452_m1 | C4orf14 | chromosome 4 open | GTTACTCCAGATTCCAATGGGTGGA |
| | | | reading frame 14 | |
| ASSAY0393 | Hs00295454_s1 | N/A | N/A | AGCTAAGAGGTTTCCAGTGCAATAC |
| ASSAY0394* | Hs00325999_m1 | TET2 | tet oncogene family | GGCAGCACATTGGTATGCACTCTCA |
| | | | member 2 | |
| ASSAY0400 | Hs00379387_m1 | RAD54L2 | RAD54-like 2 | GGCTGCCTCAGGTTCCCAGGGACCT |
| | | | (S. cerevisiae) | |
| ASSAY0401 | Hs00385941_m1 | LSM14A | LSM14A, SCD6 homolog | GCCCTTGCCAAAGTTCGATCCTTTG |
| | | | A (S. cerevisiae) | |
| ASSAY0402* | Hs00390635_m1 | TN1K | TRAF2 and NCK | ACCCATCAGAGCAAGCAACCCTGAT |
| | | | interacting kinase | |
| ASSAY0407 | Hs00540709_s1 | TMEM203 | transmembrane | CGGGAGCTGGTGCAGTGGCTAGGCT |
| | | | protein 203 | |
| ASSAY0415 | Hs00608266_m1 | BYSL | bystin-like | ACCCTCCTGCCAGGCGCACCCTGGC |
| ASSAY0421* | Hs00609836_m1 | AARS | alanyl-tRNA synthetase | CAAAATTTGGGGCTGGATGACACCA |
| ASSAY0423* | Hs00610216_m1 | SH2D2A | SH3 domain protein 2A | GGGCTACACTGCGGCATCTCCCCAG |
| ASSAY0425* | Hs00610478_m1 | PWP2 | PWP2 periodic | GGCTGGCCAAGTACTTCTTCAATAA |
| | | | tryptophan protein | |
| | | | homolog (yeast) | |
| ASSAY0432* | Hs00696974_m1 | BUD31 | BUD31 homolog | GAAAGCCATCAGCAGAGAACTCTAT |
| | | | (S. cerevisiae) | |
| ASSAY0433 | Hs00697331_m1 | YTHDF1 | YTH domain family, | TGGTGCGCAAGGAACGGCAGAGTCG |
| | | | member 1 | |
| ASSAY0434 | Hs00698392_m1 | ZMYND17 | zinc finger, MYND-type | GTGGCGGCATTCCATCCAGGTTTTC |
| | | | containing 17 | |
| ASSAY0437* | Hs00705412_s1 | NFIL3 | nuclear factor, inter- | ACTCTCCACAAAGCTCGCTGTCCGA |
| | | | leukin 3 regulated | |
| ASSAY0450 | Hs00743508_s1 | C18orf32 | chromosome 18 open | AGGTAGAATTTTGGGAGGTAATAAT |
| | | | reading frame 32 | |
| ASSAY0463 | Hs00762481_s1 | RPL36 | ribosomal protein L36 | CCTTCTCCCCGTCGCTGTCCGCAGC |
| ASSAY0465 | Hs00793492_m1 | SARNP | SAP domain containing | ACTGTTGATGTGGCAGCAGAGAAGA |
| | | | ribonucleoprotein | |
| ASSAY0473* | Hs00234720_g1 | BASP1 | brain abundant, | CCCAGAGCCGAACTCCAAGATGGGA |
| | | | membrane attached | |
| | | | signal protein 1 | |
| ASSAY0478* | Hs00237047_m1 | YWHAZ | tyrosine 3-monooxy- | GATAAAAAGAACATCCAGTCATGGA |
| | | | genase/tryptophan 5- | |
| | | | activation protein, | |
| | | | zeta polypeptide | |
| ASSAY0484 | Hs00244740_m1 | CDC25B | cell division cycle 25 | GGCGGAGCAGACGTTTGAACAGGCC |
| | | | homolog B (S. pombe) | |
| ASSAY0485* | Hs00247369_m1 | USP21 | ubiquitin specific | TCTGATGACAAGATGGCTCATCACA |
| | | | peptidase 21 | |
| ASSAY0489 | Hs00248408_m1 | Sep-06 | septin 6 | AGAAAGAGCTGCACGAGAAGTTTGA |
| ASSAY0494* | Hs00252433_m1 | CDC42SE1 | CDC42 small effector 1 | AGAGCAGGGTTCCGAGTCTGAGGAA |
| ASSAY0495 | Hs00253715_m1 | FXYD2 | FXYD domain containing | GTGGTACCTGGGCGGCAGCCCCAAG |
| | | | ion transport | |
| | | | regulator 2 | |
| ASSAY0497 | Hs00254277_m1 | NAA35 | N(alpha)-acetyl- | ACTCACTGTGTTCGGCCATTCTGTA |
| | | | transferase 35, NatC | |
| | | | auxiliary subunit | |
| ASSAY0499 | Hs00254802_s1 | RBM8A; | RNA binding motif | CCCTTCCTTGTCTGGGGCCTGGACA |
| | | GNRHR2 | protein 8A; gonado- | |
| | | | tropin-releasing | |
| | | | hormone (type 2) | |
| | | | receptor 2 | |
| ASSAY0504* | Hs00257861_m1 | COQ10B | coenzyme Q10 homolog | CGCCCGTGCGGAATGGCAGATATTT |
| | | | B (S. cerevisiae) | |
| ASSAY0509* | Hs00260517_s1 | CAPNS2 | calpain, small subunit | GATCGAGGTCTTGGAGAAGCTCTTG |
| | | | 2 | |
| ASSAY0510 | Hs00260545_m1 | GINS4 | GINS complex subunit 4 | TTGGAGCAGGCCTGGATGAATGAAA |
| | | | (Sld5 homolog) | |
| ASSAY0513* | Hs00260900_m1 | C5orf32 | chromosome 5 open | CAGGAGCCTCCTAAAACCACAGTGT |
| | | | reading frame 32 | |
| ASSAY0517* | Hs00261978_m1 | PYROXD2 | pyridine nucleotide- | TGGTGGCTGCAGCGTACCTGCAGAG |
| | | | disulphide oxidere- | |
| | | | ductase domain 2 | |
| ASSAY0518 | Hs00262488_m1 | FIZ1 | FLT3-interacting zinc | TGCACCACCAGGTCGTCCACACTGG |
| | | | finger 1 | |
| ASSAY0521 | Hs00263798_m1 | ALG2 | asparagine-linked | TAGTGTGCGACCAGGTGTCTGCCTG |
| | | | glycosylation 2, alpha- | |
| | | | 1,3-mannosyltrans- | |
| | | | ferase homolog | |
| | | | (S. cerevisiae) | |
| ASSAY0534 | Hs00268265_m1 | SMARCC1 | SWI/SNF related, | CCAAACTCCCTGCAAAGTGTTTCAT |
| | | | matrix associated, | |
| | | | actin dependent | |
| | | | regulator or chromatin, | |
| | | | subfamily c, member 1 | |
| ASSAY0545 | Hs00272390_m1 | PAICS | phosphoribosylamino- | ATGGCGACAGCTGAGGTACTGAACA |
| | | | imidazole carboxylase, | |
| | | | phosphoribosylamino- | |
| | | | imidazole succinocar- | |
| | | | boxamide synthase | |
| ASSAY0548 | Hs00273238_m1 | BACE2 | beta-site APP-cleaving | ACACTTGCCAAGCCATCAAGTTCTC |
| | | | enzyme 2 | |
| ASSAY0549 | Hs00273329_s1 | NAT6 | N-acetyltransferase 6 | CCGCACCTCCCGCCTGCACTCCCTG |
| | | | (GCN5-related) | |
| ASSAY0553* | Hs00275656_m1 | GSK3B | glycogen synthase | AGAAATAATCAAGGTCCTGGGAACT |
| | | | kinase 3 beta | |
| ASSAY0559* | Hs00291515_m1 | IKBIP | IKBKB interacting | TAATTTCAGAAAAGCTTGAGTCTAC |
| | | | protein | |
| ASSAY0561* | Hs00292281_m1 | LOC439949 | hypothetical protein | AAGCTGCAAAGGTTCTGCCCTGATG |
| | | | LOC439949 | |
| ASSAY0566 | Hs00293370_m1 | SPPL3 | signal peptide | TATTTAAAGGGCGACCTCCGGCGGA |
| | | | peptidase 3 | |
| ASSAY0567 | Hs00298028_s1 | BTBD9 | BTB (POZ) domain | CCACCACTGGTCACGGTGCTCCCTG |
| | | | containing 9 | |
| ASSAY0568* | Hs00298999_m1 | SLC38A10 | solute carrier family | TTCGCCTGCCAGTCCCAGGTGCTGC |
| | | | 38, member 10 | |
| ASSAY0572* | Hs00300396_m1 | PEPL1 | proline, glutamate and | TCTCTCAAAGGCAAGCTGGCCTCAT |
| | | | leucine rich protein 1 | |
| ASSAY0573 | Hs00324432_m1 | RAP1GAP2 | RAP1 GTPase activating | TTTCAAAGGTTTCCGAGGAGGCCTG |
| | | | protein 2 | |
| ASSAY0574* | Hs00325168_m1 | NUFIP2 | nuclear fragile X | AAGAAAACAGGCTATGGTGAACTAA |
| | | | mental retardation | |
| | | | protein interacting | |
| | | | protein 2 | |
| ASSAY0575* | Hs00325918_m1 | ALPK1 | alpha-kinase 1 | TTCTGGGGAGGTATGTTGGGAAAGA |
| ASSAY0577* | Hs00328354_m1 | HUWE1 | HECT, UBA and WWE | GAAAAAGATCAGATGGGGAACAGGA |
| | | | domain containing 1 | |
| ASSAY0578 | Hs00329245_s1 | C20orf117 | chromosome 20 open | GAGGACATGATGCTGGGCCCAAGTC |
| | | | reading frame 117 | |
| ASSAY0583 | Hs00356436_m1 | PCK2 | phosphoenolpyruvate | CCCTGGCCTGCGGCTTAACTGGCAT |
| | | | carboxykinase 2 | |
| | | | (mitochondrial) | |
| ASSAY0591 | Hs00361490_m1 | CNR2 | cannabinoid receptor 2 | ACAACACAACCCAAAGCCTTCTAGA |
| | | | (macrophage) | |
| ASSAY0593 | Hs00362511_g1 | SUGT1 | SGT1, suppressor of | CTGCAACATCCCAGAGGTTTTTCCA |
| | | | G2 allele of SKP1 | |
| | | | (S. cerevisiae) | |
| ASSAY0596 | Hs00364293_m1 | CDK1 | cyclin-dependent | TTGGATTTGCTCTCGAAAATGTTAA |
| | | | kinase 1 | |
| ASSAY0599 | Hs00365678_g1 | RAB24 | RAB24, member RAS | GTATTTGGGACACAGCAGGCTCTGA |
| | | | oncogene family | |
| ASSAY0601 | Hs00366434_m1 | SERPINB6 | serpin peptidase | AGATGGCCCAGATACTTTCTTTCAA |
| | | | inhibitor clade B | |
| | | | (ovalbumin), member 6 | |
| ASSAY0613 | Hs00372436_s1 | XKR8 | XK, Kell blood group | AGCTCCGAGTGGCTGTACCGGGTGA |
| | | | complex subunit- | |
| | | | related family, member | |
| | | | 8 | |
| ASSAY0614* | Hs00373045_m1 | GAB2 | GRB2-associated | GAGAGCACAGACTCCCTGAGAAATG |
| | | | binding protein 2 | |
| ASSAY0616 | Hs00375126_m1 | BCAS3 | breast carcinoma | GTCACCCTTGCATGGGAAACTGAAC |
| | | | amplified sequence 3 | |
| ASSAY0624 | Hs00377427_m1 | APBB1 | amyloid beta (A4) | TCCCCAGAGGACACAGATTCCTTCT |
| | | | precursor protein- | |
| | | | binding, family B, | |
| | | | member 1 (Fe65) | |
| ASSAY0625 | Hs00378208_m1 | UBR4 | ubiquitin protein | CACTTGCTTGGCAAGACACAACACT |
| | | | ligase E3 component | |
| | | | n-recognin 4 | |
| ASSAY0626 | Hs00378210_m1 | UBR4 | ubiquitin protein | TGGAGCCACCAGGCTGACAGATAAG |
| | | | ligase E3 component | |
| | | | n-recognin 4 | |
| ASSAY0629 | Hs00378902_m1 | ZNF337 | zinc finger protein 337 | CAGGCCCCTGTGCAGGAATATATGC |
| ASSAY0633 | Hs00379355_m1 | GRPEL1 | GrpE-like 1, | CGTTGTCTCTCAGGCCATCTCCCCG |
| | | | mitochondrial (E. coli) | |
| ASSAY0637 | Hs00383718_m1 | C5AR1 | complement component | AGACCAGAACATGAACTCCTTCAAT |
| | | | 5a receptor 1 | |
| ASSAY0638 | Hs00384448_m1 | PARS2 | prolyl-tRNA synthetase | GGCTGGGATTGCGGTGCCTGTGCTT |
| | | | 2, mitochondrial | |
| | | | (putative) | |
| ASSAY0640 | Hs00385075_m1 | MAPK3 | mitogen-activated | AGATGTCTACATTGTGCAGGACCTG |
| | | | protein kinase 3 | |
| ASSAY0644* | Hs00386171_m1 | C4orf3 | chromosome 4 open | TATTTTTTGCCATGACTTGTTCGCT |
| | | | reading frame 3 | |
| ASSAY0645* | Hs00387426_m1 | MAP2K4 | mitogen-activated | CAAATAATGGCAGTTAAAAGAATTC |
| | | | protein kinase kinase 4 | |
| ASSAY0648* | Hs00389570_m1 | SEC16A | SEC16 homolog A | AACCTAAGAAGGGTGAATCCTGGTT |
| | | | (S. cerevisiae) | |
| ASSAY0649 | Hs00390028_m1 | TCF20 | transcription factor | GGAAATAGCCAGAGAGATGAAATGT |
| | | | 20 (AR1) | |
| ASSAY0650 | Hs00390576_m1 | ZNF862 | zinc finger protein 862 | GCTGTTGGCATCCTTGGGACCTGCT |
| ASSAY0651 | Hs00391737_m1 | SMG6 | Smg-6 homolog, nonsense | ACGCAAGACAGTAAAATATGCCTTG |
| | | | mediated mRNA decay | |
| | | | factor (C. elegans) | |
| ASSAY0655* | Hs00394683_m1 | LST1 | leukocyte specific | AGGCCACAAGCTCTGGATGAGGAAC |
| | | | transcript 1 | |
| ASSAY0656 | Hs00395045_m1 | STMN3 | stathmin-like 3 | CCAGTACGGGGACATGGAGGTGAAG |
| ASSAY0660* | Hs00402617_m1 | MPZL3 | myelin protein zero- | GTGCCTGGATTCAGACTATGAAGAG |
| | | | like 3 | |
| ASSAY0661* | Hs00405469_m1 | JMJD1C | jumonji domain | TCAAAAGCAGGAATTCTCAAGAAAT |
| | | | containing 1C | |
| ASSAY0668* | Hs00411197_m1 | LRRK2 | leucine-rich repeat | GACAAGAACAAGCCAACTGTTTTCT |
| | | | kinase 2 | |
| ASSAY0684* | Hs00417273_m1 | LRRK2 | leucine-rich repeat | TTTGGCCCTCCTCACTGAGACTATT |
| | | | kinase 2 | |
| ASSAY0686* | Hs00418955_m1 | SMCHD1 | structural maintenance | AAGGATTTTAAATGGACAGGAACAG |
| | | | of chromosomes | |
| | | | flexible hinge domain | |
| | | | containing 1 | |
| ASSAY0687 | Hs00419531_m1 | NSF | N-ethylmaleimide- | TTTCCAGTCTGGCCAGCATGTGATT |
| | | | sensitive factor | |
| ASSAY0695* | Hs00427795_g1 | TNFRSF10C | tumor necrosis factor | CGGAAGTGTAGCAGGTGCCCTAGTG |
| | | | receptor superfamily, | |
| | | | member 10c, decoy | |
| | | | without an intra- | |
| | | | cellular domain | |
| ASSAY0702 | Hs00429977_m1 | SHISA5 | shisa homolog 5 | CCGGGTGCACGTGGTGAGGTGTGTA |
| | | | (Xenopus laevis) | |
| ASSAY0712* | Hs00537038_m1 | TNFAIP8L1 | tumor necrosis factor, | TGCTTCGAGAGTAGGCCATGGACAC |
| | | | alpha-induced protein | |
| | | | 8-like 1 | |
| ASSAY0713 | Hs00538077_m1 | C5orf41 | chromosome 5 open | ACACCCACAGACAGCATCGCACAGA |
| | | | reading frame 41 | |
| ASSAY0722 | Hs00541991_m1 | C19orf46 | chromosome 19 open | CTCCGGAAGCCTCAGGACAAGAAGA |
| | | | reading frame 46 | |
| ASSAY0725* | Hs00543135_m1 | C22orf30 | chromosome 22 open | CACAAGCAGCCACACCATGTTACCA |
| | | | reading frame 30 | |
| ASSAY0727 | Hs00544314_s1 | LCMT2 | leucine carboxyl | CGGAGCCGTGAGCGTCGGGCAGGCG |
| | | | methyltransferase 2 | |
| ASSAY0734* | Hs00602957_m1 | HN1 | hematological and | CCAAGTCAGCAGGTGCCAAGTCTAG |
| | | | neurological expressed | |
| | | | 1 | |
| ASSAY0744 | Hs00819308_m1 | SEC11A | SEC11 homolog A | CTATCCTAAATTTAAGTATGCAGTT |
| | | | (S. cerevisiae) | |
| ASSAY0745 | Hs00826823_m1 | SFI1 | Sfi1 homolog, spindle | GCAGAACCTCTGGTCCTGTCGGCGG |
| | | | assembly associated | |
| | | | (yeast) | |
| ASSAY0748 | Hs00830558_g1 | FOXN3 | forkhead box N3 | TCTAGGGACTTGGTGTTGCTTGGAA |
| ASSAY0754* | Hs00867656_s1 | DLEU2 | deleted in lymphocytic | AAAAATTTATTTTACACATGTCAAG |
| | | | leukemia 2 (non- | |
| | | | protein coding) | |
| ASSAY0763* | Hs00907493_m1 | TRA2B | transformer 2 beta | ATCAGATTTATAGAAGGCGGTCACC |
| | | | homolog (Drosophila) | |
| ASSAY0778 | Hs00939205_m1 | RNF24 | ring finger protein 24 | GCCTTCCACAGAAAGTGCCTTATTA |
| ASSAY0781* | Hs00943178_g1 | PGK1 | phosphoglycerate | AGCCCACAGCTCCATGGTAGGAGTC |
| | | | kinase 1 | |
| ASSAY0784 | Hs00949382_m1 | ST6GAL1 | ST6 beta-galactosamide | CCAAAGTGGTACCAGAATCCGGATT |
| | | | alpha-2,6-sialyltrans- | |
| | | | ferase 1 | |
| ASSAY0795* | Hs00971411_m1 | ANXA3 | annexin A3 | TTACTGTTGGCCATAGTTAATTGTG |
| ASSAY0797 | Hs00975865_m1 | BTK | Bruton | TTATCCCTTCCAGGTTGTATATGAT |
| | | | agammaglobulinemia | |
| | | | tyrosine kinase | |
| ASSAY0806 | Hs00997789_m1 | PSEN1 | presenilin 1 | TTCATTTACTTGGGGGAAGTGTTTA |
| ASSAY0818 | Hs01018736_g1 | UBL3 | ubiquitin-like 3 | GCCAAACTCTCAAGGTCAGAGGAAT |
| ASSAY0820 | Hs01031740_m1 | ARPC2 | actin related protein | TGAAAACAATCACGGGGAAGACGTT |
| | | | ⅔ complex, subunit 2, | |
| | | | 34 kDa | |
| ASSAY0821* | Hs01032565_m1 | ST6GALNAC2 | ST6 (alpha-N-acetyl- | CCTGTGACCAGGTCAGTGCCTATGG |
| | | | neuraminyl-2,3-beta- | |
| | | | galactosyl-1,3)-N- | |
| | | | acetylgalactosaminide | |
| | | | alpha-2,6-sialyltrans- | |
| | | | ferase 2 | |
| ASSAY0822 | Hs01032700_m1 | LBR | lamin B receptor | TTATTGTTCTGAAACTTTGTGGTTA |
| ASSAY0842 | Hs01062739_m1 | TMX4 | thioredoxin-related | TCTGAGCGTTCTGAGCAGAATCGGA |
| | | | transmembrane protein 4 | |
| ASSAY0843* | Hs01064052_g1 | SEPX1 | selenoprotein X, 1 | TTGTCCCTAAAGGCAAAGAAACTTC |
| ASSAY0844 | Hs01064792_m1 | TRANK1 | tetraatricopeptide | TAAAGAAGGAAGGTATTGTTCAGGA |
| | | | repeat and ankyrin | |
| | | | repeat containing 1 | |
| ASSAY0862* | Hs01095303_m1 | RALB | v-ral simian leukemia | AACGTGGACAAGGTGTTCTTTGACC |
| | | | viral oncogene homolog | |
| | | | B (ras related; GTP | |
| | | | binding protein) | |
| ASSAY0866* | Hs01108442_s1 | N/A | N/A | CCCTAACATTTCAAGAAGAAGCAGA |
| ASSAY0874* | Hs01123242_m1 | BACE1 | beta-site APP cleaving | GAGATTGCCAGGCCTGACGACTCCC |
| | | | enzyme 1 | |
| ASSAY0876 | Hs01372307_m1 | ZDHHC18 | zinc finger, DHHC-type | ACCTCCCAGCCTAATTGACCGGAGG |
| | | | containing 18 | |
| ASSAY0882* | Hs01550808_m1 | MX2 | myxovirus (influenza | GAATGCCTACTTCTTGGAAACCAGC |
| | | | virus) resistance 2 | |
| | | | (mouse) | |
| ASSAY0885 | Hs01555410_m1 | IL1B | interleukin 1, beta | CAGATGAAGTGCTCCTTCCAGGACC |
| ASSAY0886* | Hs01564142_m1 | GLIPR1 | GLI pathogenesis- | CTATACATGACTTGGGACCCAGCAC |
| | | | related 1 | |
| ASSAY0887* | Hs01573482_m1 | IVNS1ABP | influenza virus NS1A | GAGTGGCTGTTCTTAATGGAAAACT |
| | | | binding protein | |
| ASSAY0895 | Hs01593434_s1 | N/A | N/A | GCTCCAGAGCTTACTGACATGGGCC |
| ASSAY0899* | Hs01632947_g1 | CCDC72 | coiled-coil domain | GGAATTAAGTGTTGTCTTGGAGCTG |
| | | | containing 72 | |
| ASSAY0912* | Hs01932078_s1 | COMMD6 | COMM domain | AGATTAAGATTGACCATTGCTCCTT |
| | | | containing 6 | |
| ASSAY0919 | Hs02510591_s1 | DPYD | dihydropyrimidine | GATGGGTGTACAAACTCATCCTCTT |
| | | | dehydrogenase | |
| ASSAY0921 | Hs02596877_g1 | MT-ND4L; | mitochondrially | CCCTCAACACCCACTCCCTCTTAGC |
| | | CCDC104 | encoded NADH 4L; | |
| | | | coiled-coil domain | |
| | | | containing 104 | |
| ASSAY0922 | Hs02597217_g1 | GNG10; | guanine nucleotide | GAGAGGATCAAGGTCTCTCAGGCAG |
| | | LOC653503 | binding protein (G | |
| | | | protein), gamma 10; | |
| | | | GNG10 pseudogene | |
| ASSAY0927 | Hs03037952_m1 | NAIP | NLR family, apoptosis | GCGTGGTGGAAATTGCCAAAGTAGC |
| | | | inhibitory protein | |
| ASSAY0935* | Hs00991010_m1 | IL1R1 | interleukin 1 receptor, | TATTACAGTGTGGAAAATCCTGCAA |
| | | | type I | |
| ASSAY0941* | Hs00328784_s1 | MTMR3 | myotubularin related | CCCTCGGGAAGGTTGGTATTGAGGG |
| | | | protein 3 | |
| ASSAY0947* | Hs00254569_s1 | HRH2 | histamine receptor H2 | GGTCACCCCAGTTCGGGTCGCCATC |
| ASSAY0957 | Hs00536435_m1 | NLRP12 | NLR family, pyrin | ACTACGGACTTTGTGGCTGAAGATC |
| | | | domain containing 12 | |
| ASSAY0960* | Hs00984297_m1 | C1orf175 | chromosome 1 open | AATGAAGTGAAAGCTGCTCTGGATA |
| | | | reading frame 175 | |
| ASSAY0962* | Hs00211306_m1 | DHRS7 | dehydrogenase/reductase | CTTTAAGAGTGGTGTGGATGCAGAC |
| | | | (SDR family) member 7 | |
| ASSAY0969* | Hs00948075_m1 | HUWE1 | HECT, UBA and WWE | TCAATTGGCCAAGGTATTTCCCAGC |
| | | | domain containing 1 | |
| ASSAY0971* | Hs00391048_m1 | MEGF9 | multiple EGF-like- | GTGCAACAGTTCTGGGAAATGCCAG |
| | | | domains 9 | |
| ASSAY0986 | Hs00990751_m1 | TCIRG1 | T-cell, immune | ACCCCGCTCCCTACACCATCATCAC |
| | | | regulator 1, ATPase, | |
| | | | H+ transporting, | |
| | | | lysosomal V0 subunit A3 | |
| ASSAY0987 | Hs00179553_m1 | MINK1 | misshapen-like kinase | ACAGGTGTACAAGGGTCGGCATGTC |
| | | | 1 (zebrafish) | |
| ASSAY0997 | Hs00699585_m1 | PDDC1 | Parkinson disease 7 | TCCACTCTGAGAGCAAACCCATCTG |
| | | | domain containing 1 | |
| ASSAY1002 | Hs00219444_m1 | ING3 | inhibitor of growth | GGTGCAGAATGCAATGGATCAACTA |
| | | | family, member 3 | |
| ASSAY1004 | Hs00182998_m1 | LRP8 | low density lipoprotein | GGACGACTGCCCCAAGAAGACCTGT |
| | | | receptor-related | |
| | | | protein 8, apolipo- | |
| | | | protein receptor | |
| ASSAY1007* | Hs00226343_m1 | PARP8 | poly (ADP-ribose) | CAACTGGAGCTCAGGTGGTAGATCT |
| | | | polymerase family, | |
| | | | member 8 | |
| ASSAY1019* | Hs00271722_m1 | ARPC5 | actin related protein | GTCAGGCAGTGAAGGACCGGGCAGG |
| | | | 2/3 complex, subunit 5, | |
| | | | 16 kDa | |
| ASSAY1026 | Hs00162271_m1 | SPTBN1 | spectrin, beta, non- | GCTCTGGGCACACAGGTGAGGCAGC |
| | | | erythrocytic 1 | |
| ASSAY1037 | Hs00300550_m1 | LAMA1 | laminin, alpha 1 | GGCAGAGAGGCCTGTTTCCTGCCAT |
| ASSAY1039* | Hs00425763_m1 | TAF6 | TAF6 RNA polymerase II, | GAGCCTCCTGCTGAAACACTGTGCT |
| | | | TATA box binding | |
| | | | protein (TBP)- | |
| | | | associated factor | |
| | | | 80 kDa | |
| ASSAY1042 | Hs00202482_m1 | ACOT9 | acyl-CoA thioesterase 9 | CTGAAAATAAAGGGCCGGCATTTGT |
| ASSAY1051 | Hs03045171_m1 | HLA-E | major histocompati- | CTGCTTCACCTGGAGCCCCCAAAGA |
| | | | bility complex, | |
| | | | class I, E | |
| ASSAY1058* | Hs00369593_m1 | RBM33 | RNA binding motif | GAAAATTTCAGTTCTCAGGGTGTTA |
| | | | protein 33 | |
| ASSAY1059* | Hs00195059_m1 | SORBS3 | sorbin and SH3 domain | ATGGCTGGTTTGTGGGTGTCTCCCG |
| | | | containing 3 | |
| ASSAY1061* | Hs00330542_m1 | TPCN1 | two pore segment | TACCTCCAGGAAGGCGAGAACAACG |
| | | | channel 1 | |
| ASSAY1064 | Hs00559914_m1 | YKT6 | YKT6 v-SNARE homolog | TATAAAACTGCCCGGAAACAAAACT |
| | | | (S. cerevisiae) | |
| ASSAY1078* | Hs00229975_m1 | HUWE1 | HECT, UBA and WWE | TGAGAATGACAGGAGCCATCCGCAA |
| | | | domain containing 1 | |
| ASSAY1084 | Hs00390223_m1 | UBR4 | ubiquitin protein | ACATGACCACAGGTACAGAATCAGA |
| | | | ligase E3 component n- | |
| | | | recognin 4 | |
| ASSAY1093* | Hs00226352_m1 | ZCCHC6 | zinc finger, CCHC | AAAGGCTCTTCAGGTAGCCTTTCCA |
| | | | domain containing 6 | |
| ASSAY0197 | Hs00704884_s1 | C5AR1 | complement component | TATTTATTTTATGGCAAGTTGGAAA |
| | | | 5a receptor 1 | |
| ASSAY1103 | Hs00300475_s1 | SORL1 | sortilin-related | CAGAAGACACACAGCTGCCTGTTCT |
| | | | receptor, L(DLR class) | |
| | | | A repeats-containing | |

Assays with p values <0.5 are marked with an asterisk.

TABLE 10
Informative probes for Retrospective Intraperson Progression or
Non-Progression (AD) (All probes have p-value <0.5)

| Sequence No. | | Gene | | Context Sequence |
|---|---|---|---|---|
| (DiaGenic Probe ID) | Assay ID | Symbol | Gene name | (Oligonucleotide sequence) |
| ASSAY0002 | Hs00153510_m1 | MME | membrane metallo- | TGAAGAAAAGGCCTTAGCAATTAAA |
| | | | endopeptidase | |
| ASSAY0006 | Hs00220373_m1 | SLC12A9 | solute carrier/family | CTCCGGCCTCGGTGGCATGAAGCCC |
| | | | 12 (potassium/chloride | |
| | | | transporters), member | |
| | | | 9 | |
| ASSAY0007 | Hs00221912_m1 | ARHGAP22 | Rho GTPase activating | AGTGTGAAAAGAATCGAAGAAGGGA |
| | | | protein 22 | |
| ASSAY0013 | Hs00163311_m1 | UBE2B | ubiquitin-conjugating | CACCTTTTGAAGATGGTACTTTTAA |
| | | | enzyme E2B (RAD6 | |
| | | | homolog) | |
| ASSAY0015 | Hs00174469_m1 | KLRB1 | killer cell lectin- | TTCCTCGGGATGTCTGTCAGGGTTC |
| | | | like receptor sub- | |
| | | | family B, member 1 | |
| ASSAY0053 | Hs00221104_m1 | ABHD6 | abhydrolase domain | CGTGTGTCCTGCTGGCCTGCAGTAC |
| | | | containing 6 | |
| ASSAY0077 | Hs00227357_m1 | LPCAT1 | lysophosphatidyl- | GAAGATCACATTCGCTGACTTCCAC |
| | | | choline acyltrans- | |
| | | | ferase 1 | |
| ASSAY0081 | Hs00228559_m1 | ELL3 | elongation factor RNA | CAGAATACAAGGTCCTGGAAGACAA |
| | | | polymerase II-like 3 | |
| ASSAY0098 | Hs00153519_m1 | MME | membrane metallo- | TCCAGGCAATTTCAGGATTATTGGG |
| | | | endopeptidase | |
| ASSAY0118 | Hs00158875_m1 | LRPAP1 | low density lipo- | AAGGCCCAGCGACTGCATCTTCCTC |
| | | | protein receptor- | |
| | | | related protein | |
| | | | associated protein 1 | |
| ASSAY0119 | Hs00159537_m1 | NBN | nibrin | CCCGGCAGGAGGAGAACCATACAGA |
| ASSAY0133 | Hs00167309_m1 | SOD2 | superoxide dismutase | GGAACAACAGGCCTTATTCCACTGC |
| | | | 2, mitochondrial | |
| ASSAY0162 | Hs00177028_m1 | PKN1 | protein kinase N1 | TGGCAGCACCAAGGACCGGAAGCTG |
| ASSAY0172 | Hs00182671_m1 | NAE1 | NEDD8 activating | GACCGGCAGCTGAGGTTGTGGGGTG |
| | | | enzyme E1 subunit 1 | |
| ASSAY0186 | Hs00189566_m1 | GOLGB1 | golgin B1 | CAGCAACTGAACAGCAACTTCTCTC |
| ASSAY0223 | Hs00215938_m1 | RNF31 | ring finger protein 31 | TGCCCCACAACCGGATGCAGGCCCT |
| ASSAY0225 | Hs00218331_m1 | KDM3A | lysine (K)-specific | TTCTTAAAAAGGTATCAGAAGAGCA |
| | | | demethylase 3A | |
| ASSAY0242 | Hs00276830_m1 | RUNDC2A | RUN domain | CAGTGAAACAGTGCCAGATCCGCTT |
| | | | containing 2A | |
| ASSAY0245 | Hs00326671_m1 | TTC14 | tetratricopeptide | AGAGAGAGGAGGACAGTTAGAAGAA |
| | | | repeat domain 14 | |
| ASSAY0254 | Hs00382453_m1 | XPO5 | exportin 5 | TTGCGCTTATAAGAACCCACAATAC |
| ASSAY0292 | Hs00195718_m1 | TAX1BP1 | Tax1 (human T-cell | AAACAACTCTTGCAGGATGAGAAAG |
| | | | leukemia virus type I) | |
| | | | binding protein 1 | |
| ASSAY0299 | Hs00197744_m1 | POLR3C | polymerase (RNA) III | CAGATAACAAGGAGCCCATTCCAGA |
| | | | (DNA directed) | |
| | | | polypeptide C (62 kDa) | |
| ASSAY0334 | Hs00206922_m1 | CP110 | CP110 protein | TCTCCACTGCTTAACATTGAGAAAA |
| ASSAY0337 | Hs00208459_m1 | N4BP2L2 | NEDD4 binding protein | ATTGTCTCGAATTCTGCTTGGTCAG |
| | | | 2-like 2 | |
| ASSAY0344 | Hs00211234_m1 | FAM164A | family with sequence | ACATAGCCAGGCCAGATGGGGACTG |
| | | | similarity 164, | |
| | | | member A | |
| ASSAY0359 | Hs00214745_m1 | DPP8 | dipeptidyl-peptidase 8 | CTGCCTGCTCCAAGTGATTTCAAGT |
| ASSAY0361 | Hs00215064_m1 | BTBD2 | BTB (POZ) domain | TCGCTGCAGGTCCCGCACAGTCGGG |
| | | | containing 2 | |
| ASSAY0366 | Hs00215835_m1 | C19orf60 | chromosome 19 open | CAGCAGCTGAAAATGAAGGTAATTA |
| | | | reading frame 60 | |
| ASSAY0369 | Hs00217022_m1 | ZFP64 | zinc finger protein 64 | AGACAATCACAGTTTCAGCTCCAGA |
| | | | homolog (mouse) | |
| ASSAY0376 | Hs00234404_m1 | FKBP2 | FK506 binding protein | CACTACACGGGGAAGCTGGAAGATG |
| | | | 2, 13 kDa | |
| ASSAY0381 | Hs00612265_m1 | ZCCHC6 | zinc finger, CCHC | GGAAGCAGGAAGTCCTGAAAACAAG |
| | | | domain containing 6 | |
| ASSAY0401 | Hs00385941_m1 | LSM14A | LSM14A, SCD6 homolog | GCCCTTGCCAAAGTTCGATCCTTTG |
| | | | A (S. cerevisiae) | |
| ASSAY0421 | Hs00609836_m1 | AARS | alanyl-tRNA | CAAAATTTGGGGCTGGATGACACCA |
| | | | synthetase | |
| ASSAY0423 | Hs00610216_m1 | SH2D2A | SH2 domain protein 2A | GGGCTACACTGCGGCATCTCCCCAG |
| ASSAY0425 | Hs00610478_m1 | PWP2 | PWP2 periodic | GGCTGGCCAAGTACTTCTTCAATAA |
| | | | tryptophan protein | |
| | | | homolog (yeast) | |
| ASSAY0429 | Hs00611133_m1 | MRPL10 | mitochondrial | CGCTGCTAGGTGGCTGCATTGATGA |
| | | | ribosomal protein L10 | |
| ASSAY0437 | Hs00705412_s1 | NFIL3 | nuclear factor, | ACTCTCCACAAAGCTCGCTGTCCGA |
| | | | interleukin 3 | |
| | | | regulated | |
| ASSAY0452 | Hs00747351_mH | CLTA | clathrin, light chain | GGGGTCCGGATGCTGTTGATGGAGT |
| | | | (Lca) | |
| ASSAY0463 | Hs00762481_s1 | RLP36 | ribosomal protein L36 | CCTTCTCCCCGTCGCTGTCCGCAGC |
| ASSAY0465 | Hs00793492_m1 | SARNP | SAP domain containing | ACTGTTGATGTGGCAGCAGAGAAGA |
| | | | ribonucleoprotein | |
| ASSAY0524 | Hs00264721_m1 | MSH6 | mutS homolog 6 | TGCCCCCACCAGTTGTGACTTCTCA |
| | | | (E. coli) | |
| ASSAY0532 | Hs00267168_s1 | MC1R | melanocortin 1 | GCAGGACGCTCAAGGAGGTGCTGAC |
| | | | receptor (alpha | |
| | | | melanocyte stimulating | |
| | | | hormone receptor) | |
| ASSAY0534 | Hs00268265_m1 | SMARCC1 | SWI/SNF related, | CCAAACTCCCTGCAAAGTGTTTCAT |
| | | | matrix associated, | |
| | | | actin dependent | |
| | | | regulator of | |
| | | | chromatin, subfamily | |
| | | | c, member 1 | |
| ASSAY0546 | Hs00272828_m1 | ZFP36L2 | zinc finger protein | GTCGACTTCTTGTGCAAGACAGAGA |
| | | | 36, C3H type-like 2 | |
| ASSAY0593 | Hs00362511_g1 | SUGT1 | SGT1, suppressor of | CTGCAACATCCCAGAGGTTTTTCCA |
| | | | G2 allele of SKP1 | |
| | | | (S. cerevisiae) | |
| ASSAY0625 | Hs00378208_m1 | UBR4 | ubiquitin protein | CACTTGCTTGGCAAGACACAACACT |
| | | | ligase E3 component | |
| | | | n-recognin 4 | |
| ASSAY0632 | Hs00379295_m1 | C1orf144 | chromosome 1 open | AACCCATCCTCGACAGGCCAACCAG |
| | | | reading frame 144 | |
| ASSAY0661 | Hs00405469_m1 | JMJD1C | jumonji domain | TCAAAAGCAGGAATTCTCAAGAAAT |
| | | | containing 1C | |
| ASSAY0666 | Hs00406365_m1 | MAPKBP1 | mitogen-activated | AGAGGACCTCAGCTCCAAGGTGACC |
| | | | protein kinase binding | |
| | | | protein 1 | |
| ASSAY0674 | Hs00414236_m1 | GLTSCR2 | glioma tumor | CGCACGAGCGGTGGCTTGTTGTCAG |
| | | | suppressor candidate | |
| | | | region gene 2 | |
| ASSAY0679 | Hs00415699_m1 | LOC149837 | hypothetical | TCACCACCTGCCGGCAATCAGCCAT |
| | | | LOC149837 | |
| ASSAY0683 | Hs00417251_m1 | SNHG6 | small nucleolar RNA | TAGCTGGGCTCTGCGAGGTGCAAGA |
| | | | host gene 6 (non- | |
| | | | protein coding) | |
| ASSAY0684 | Hs00417273_m1 | LRRK2 | leucine-rich repeat | TTTGGCCCTCCTCACTGAGACTATT |
| | | | kinase 2 | |
| ASSAY0686 | Hs00418955_m1 | SMCHD1 | structural maintenance | AAGGATTTTAAATGGACAGGAACAG |
| | | | of chromosomes | |
| | | | flexible hinge domain | |
| | | | containing 1 | |
| ASSAY0689 | Hs00419820_g1 | LOC728975 | hypothetical protein | CTGCGTGACCTTGGGCTCTCAGCCC |
| | | | LOC728975 | |
| ASSAY0718 | Hs00539707_m1 | DTX2 | deltex homolog 2 | GGCCGCAAGGTCCTAGAGCTCCTGA |
| | | | (Drosophila) | |
| ASSAY0719 | Hs00540753_m1 | DYNLL2 | dynein, light chain | GCCTCCGTGAAGTGTCACACCATGT |
| | | | LC8-type 2 | |
| ASSAY0726 | Hs00543883_s1 | HIST1H4C | histone cluster 1, | TATGGCTTCGGCGGCTGAATCTAAG |
| | | | H4c | |
| ASSAY0740 | Hs00606809_g1 | MRPL41 | mitochondrial | TCCGGTCCAGGGCGCGGCATGGGCG |
| | | | ribosomal protein L41 | |
| ASSAY0741 | Hs00606874_g1 | TNFRSF13C | tumor necrosis factor | CGGAGACAAGGACGCCCCAGAGCCC |
| | | | receptor superfamily, | |
| | | | member 13C | |
| ASSAY0754 | Hs00867656_s1 | DLEU2 | deleted in lymphocytic | AAAAATTTATTTTACACATGTCAAG |
| | | | leukemia 2 (non- | |
| | | | protein coding) | |
| ASSAY0756 | Hs00894392_m1 | TBX21 | T-box 21 | ACAATGTGACCCAGATGATTGTGCT |
| ASSAY0786 | Hs00953178_m1 | EPHA4 | EPH receptor A4 | CGACCCCAGATCTGCAAGGGAGTAG |
| ASSAY0795 | Hs00971411_m1 | ANXA3 | annexin A3 | TTACTGTTGGCCATAGTTAATTGTG |
| ASSAY0799 | Hs00982887_g1 | BCL2L12 | BCL2-like 12 (proline | CCGCCCAGCCCAGAATTACAGGGTC |
| | | | rich) | |
| ASSAY0874 | Hs00123242_m1 | BACE1 | beta-site APP- | GAGATTGCCAGGCCTGACGACTCCC |
| | | | cleaving enzyme 1 | |
| ASSAY0912 | Hs01932078_s1 | COMMD6 | COMM domain | AGATTAAGATTGACCATTGCTCCTT |
| | | | containing 6 | |
| ASSAY0935 | Hs00991010_m1 | IL1R1 | interleukin 1 | TATTACAGTGTGGAAAATCCTGCAA |
| | | | receptor, type I | |
| ASSAY0960 | Hs00984297_m1 | C1orf175 | chromosome 1 open | AATGAAGTGAAAGCTGCTCTGGATA |
| | | | reading frame 175 | |
| ASSAY0962 | Hs00211306_m1 | DHRS7 | dehydrogenase/reduct- | CTTTAAGAGTGGTGTGGATGCAGAC |
| | | | ase (SDR family) | |
| | | | member 7 | |
| ASSAY0992 | Hs00293951_m1 | LOC375295 | hypothetical protein | CCCCGCTCAGTTCAATATTTCAAGT |
| | | | LOC375295 | |
| ASSAY1000 | Hs00403541_m1 | FAM129C | family with sequence | CTGCCCTGAATCCTTGGGAGACCAT |
| | | | similarity 129, | |
| | | | member C | |
| ASSAY1039 | Hs00425763_m1 | TAF6 | TAF6 RNA polymerase | GAGCCTCCTGCTGAAACACTGTGCT |
| | | | II, TATA box binding | |
| | | | protein (TBP)- | |
| | | | associated factor, | |
| | | | 80 kDa | |
| ASSAY1047 | Hs00398895_m1 | SLMO1 | slowmo homolog 1 | CAATGCAAAGAAGGGGTGGGCTGCT |
| | | | (Drosophila) | |
| ASSAY1077 | Hs01547450_m1 | FIL1L1 | FIP1 like 1 | TAGAAAGTGGACATTCCTCTGGTTA |
| | | | (S. cerevisiae) | |
| ASSAY1081 | Hs00365632_m1 | DGUOK | deoxyguanosine | AGGCTTCTCCCCAGGTTTGTTTGAA |
| | | | kinase | |
| ASSAY1093 | Hs00226352_m1 | ZCCHC6 | zinc finger, CCHC | AAAGGCTCTTCAGGTAGCCTTTCCA |
| | | | domain containing 6 | |

TABLE 11
Informative probes for Retrospective modelling Interperson
L1 versus L2 (AD) (All probes have p-value <0.5)

| Sequence No. | | Gene | | Context Sequence |
|---|---|---|---|---|
| (DiaGenic Probe ID) | Assay ID | Symbol | Gene name | (Oligonucleotide sequence) |
| ASSAY0024 | Hs00191108_m1 | SFRS11 | splicing factor, | CCGCCGGATGATTCGCCTTTGCCAG |
| | | | arginine/serine-rich 11 | |
| ASSAY0037 | Hs00218384_m1 | CAND1 | cullin-associated and | GTACAACTAAGGTAAAGGCAAACTC |
| | | | neddylation- | |
| | | | dissociated 1 | |
| ASSAY0038 | Hs00218782_m1 | RNF114 | ring finger protein 114 | TGCCCTGCGGACACGTCTTTTGCTC |
| ASSAY0039 | Hs00218814_m1 | CMAS | cytidine monophosphate | TCAGAAAGGAGTTCGTGAAGTGACC |
| | | | N-acetylneuraminic acid | |
| | | | synthetase | |
| ASSAY0052 | Hs00220814_m1 | SLC44A2 | solute carrier family | AAACGAGAACAAACCCTATCTGTTT |
| | | | 44, member 2 | |
| ASSAY0066 | Hs00224697_m1 | CASD1 | CAS1 domain | TTTGGCATATTCTCAGGGTGCATTT |
| | | | containing 1 | |
| ASSAY0070 | Hs00225747_m1 | NOTCH2 | Notch homolog 2 | GTGCCTTTACTGGCCGGCACTGTGA |
| | | | (Drosophila) | |
| ASSAY0077 | Hs00227357_m1 | LPCAT1 | lysophosphatidylcholine | GAAGATCACATTCGCTGACTTCCAC |
| | | | acyltranferase 1 | |
| ASSAY0098 | Hs00153519_m1 | MME | membrane metallo- | TCCAGGCAATTTCAGGATTATTGGG |
| | | | endopeptidase | |
| ASSAY0099 | Hs00153853_m1 | ADAM10 | ADAM metallopeptidase | AAACAGTGCAGTCCAAGTCAAGGTC |
| | | | domain 10 | |
| ASSAY0104 | Hs00154683_m1 | DARS | aspartyl-tRNA | GTGGAGGCATTGGATTGGAACGAGT |
| | | | synthetase | |
| ASSAY0126 | Hs00162077_m1 | SOAT1 | sterol O- | CCATCTTGCCAGGTGTGCTGATTCT |
| | | | acyltransferase 1 | |
| ASSAY0140 | Hs00173196_m1 | ZNF146 | zinc finger protein 146 | AGGATCTGCGCGGAAGAAGCCTGAG |
| ASSAY0159 | Hs00176944_m1 | PRKACB | protein kinase, cAMP- | GAGAATCCAACTCAGAATAATGCCG |
| | | | dependent, catalytic, | |
| | | | beta | |
| ASSAY0162 | Hs00177028_m1 | PKN1 | protein kinase N1 | TGGCAGCACCAAGGACCGGAAGCTG |
| ASSAY0164 | Hs00177638_m1 | ADAM9 | ADAM metallopeptidase | TGCCACTGGGAATGCTTTGTGTGGA |
| | | | domain 9 (meltrin | |
| | | | gamma) | |
| ASSAY0165 | Hs00177790_m1 | STK17B | serine/threonine | TGATATTGGAATATGCTGCAGGTGG |
| | | | kinase 17b | |
| ASSAY0174 | Hs00184625_m1 | SMAD2 | SMAD family member 2 | TGGACACAGGCTCTCCAGCAGAACT |
| ASSAY0176 | Hs00184625_m1 | ATP6V1C1 | ATPase, H+ transport- | ACCTTCCTGGAATCTCTCTTGATTT |
| | | | ing, lysosomal 42 kDa, | |
| | | | V1 subunit C1 | |
| ASSAY0210 | Hs00203291_m1 | CCDC106 | coiled-coil domain | CTCGGATGGAGGCAGAGGACCACTG |
| | | | containing 106 | |
| ASSAY0225 | Hs00218331_m1 | KDM3A | lysine (K)-specific | TTCTTAAAAAGGTATCAGAAGAGCA |
| | | | demethylase 3A | |
| ASSAY0230 | Hs00228829_m1 | TNKS2 | tankyrase, TRF1- | TGAAACAGCATTGCATTGTGCTGCT |
| | | | interacting ankyrin- | |
| | | | related ADP-ribose | |
| | | | polymerase 2 | |
| ASSAY0242 | Hs00276830_m1 | RUNDC2A | RUN domain containing | CAGTGAAACAGTGCCAGATCCGCTT |
| | | | 2A | |
| ASSAY0245 | Hs00326671_m1 | TTC14 | tetratricopeptide | AGAGAGAGGAGGACAGTTAGAAGAA |
| | | | repeat domain 14 | |
| ASSAY0256 | Hs00385050_m1 | RNF166 | ring finger protein 166 | GCGGCCACACGTTCTGCGGGGAGTG |
| ASSAY0257 | Hs00397335_m1 | DNAJC13 | DnaJ (Hsp40) homolog, | GGTCCAAAGGTTCGAATTACGTTAA |
| | | | subfamily C, member 13 | |
| ASSAY0258 | Hs00406040_m1 | LYSMD3 | LysM, putative | TTGTACGGTAGCAGATATCAAGAGA |
| | | | peptidoglycan-binding, | |
| | | | domain containing 3 | |
| ASSAY0263 | Hs00606262_g1 | HDAC1 | histone deacetylase 1 | AGGAGAAGAAAGAAGTCACCGAAGA |
| ASSAY0268 | Hs00705337_s1 | RBM39 | RNA binding motif | AACAGCAGCATATGTACCTCTTCCA |
| | | | protein 39 | |
| ASSAY0269 | Hs00743451_s1 | SUB1 | SUB1 homolog | AACTTAATCTCTTCATGTTCAGTTT |
| | | | (S. cerevisiae) | |
| ASSAY0274 | Hs00963664_g1 | UBE3A | ubiquitin protein | TGGGAGACTCTCACCCAGTTCTATA |
| | | | ligase E3A | |
| ASSAY0292 | Hs00195718_m1 | TAX1BP1 | Tax1 (human T-cell | AAACAACTCTTGCAGGATGAGAAAG |
| | | | leukemia virus type I) | |
| | | | binding protein 1 | |
| ASSAY0293 | Hs00196061_m1 | CEPT1 | choline/ethanolamine | ACAGAGCAGGCACCTCTGTGGGCAT |
| | | | phosphotransferase 1 | |
| ASSAY0299 | Hs00197744_m1 | POLR3C | polymerase (RNA) II | CAGATAACAAGGAGCCCATTCCAGA |
| | | | (DNA directed) | |
| | | | polypeptide C (62 kD) | |
| ASSAY0337 | Hs00208459_m1 | N4BP2L2 | NEDD4 binding protein | ATTGTCTCGAATTCTGCTTGGTCAG |
| | | | 2-like 2 | |
| ASSAY0340 | Hs00210194_m1 | SIPA1L1 | signal-induced | ACTAGAGAGGCGGCTGTCTCCTGGT |
| | | | proliferation- | |
| | | | associated 1 like 1 | |
| ASSAY0344 | Hs00211234_m1 | FAM164A | family with sequence | ACATAGCCAGGCCAGATGGGGACTG |
| | | | similarity 164, | |
| | | | member A | |
| ASSAY0352 | Hs00213029_m1 | SIRT7 | sirtuin (silent mating | AATCAGCACGGCAGCGTCTATCCCA |
| | | | type information | |
| | | | regulation 2 homolog) | |
| | | | 7 (S. cerevisiae) | |
| ASSAY0359 | Hs00214745_m1 | DPP8 | dipeptidyl-peptidase 8 | CTGCCTGCTCCAAGTGATTTCAAGT |
| ASSAY0367 | Hs00215976_m1 | ARGLU1 | arginine and glutamate | AGCCAAACTGGCCGAAGAACAGTTG |
| | | | rich 1 | |
| ASSAY0369 | Hs00217022_m1 | ZFP64 | zinc finger protein 64 | AGACAATCACAGTTTCAGCTCCAGA |
| | | | homolog (mouse) | |
| ASSAY0370 | Hs00217272_m1 | NUP133 | nucleoporin 133 kDa | AACTTTTAAAAGATGGCATTCAGCT |
| ASSAY0371 | Hs00217966_m1 | C5orf22 | chromosome 5 open | CTTCAAACCCTGGAATGGAATCACT |
| | | | reading frame 22 | |
| ASSAY0372 | Hs00218079_m1 | FBXL8 | F-box and leucine-rich | CACAAAAATCAGTTGCGAATGTGAG |
| | | | repeat protein 8 | |
| ASSAY0376 | Hs00234404_m1 | FKBP2 | FK506 binding protein | CACTACACGGGGAAGCTGGAAGATG |
| | | | 2, 13 kDa | |
| ASSAY0388 | Hs00262263_m1 | ZDHHC12 | zinc finger, DHHC-type | TGCACGATACCGAGCTGCGGCAATG |
| | | | containing 12 | |
| ASSAY0401 | Hs00385941_m1 | LSM14A | LSM14A, SCD6 homolog A | GCCCTTGCCAAAGTTCGATCCTTTG |
| | | | (S. cerevisiae) | |
| ASSAY0403 | Hs00401096_m1 | SLC35E2 | similar to solute | TGACTTTCAGCGTCGCCAGCACCGT |
| | | | carrier family 35, | |
| | | | member E2 | |
| ASSAY0407 | Hs00540709_s1 | TMEM203 | transmembrane | CGGGAGCTGGTGCAGTGGCTAGGCT |
| | | | protein 203 | |
| ASSAY0421 | Hs00609836_m1 | AARS | alanyl-tRNA synthetase | CAAAATTTGGGGCTGGATGACACCA |
| ASSAY0425 | Hs00610478_m1 | PWP2 | PWP2 periodic | GGCTGGCCAAGTACTTCTTCAATAA |
| | | | tryptophan protein | |
| | | | homolog (yeast) | |
| ASSAY0429 | Hs00611133_m1 | MRPL10 | mitochondrial | CGCTGCTAGGTGGCTGCATTGATGA |
| | | | ribosomal protein L10 | |
| ASSAY0434 | Hs00698392_m1 | ZMYND17 | zinc finger, MYND-type | GTGGCGGCATTCCATCCAGGTTTTC |
| | | | containing 17 | |
| ASSAY0451 | Hs00745818_s1 | ZNF595 | zinc finger protein 595 | CAAAGCTTTTAATCGGCCCTCAACC |
| ASSAY0452 | Hs00747351_mH | CLTA | clathrin, light chain | GGGGTCCGGATGCTGTTGATGGAGT |
| | | | (Lca) | |
| ASSAY0456 | Hs00750443_s1 | ARL8B | ADP-ribosylation | GTGTGACTCTGTGGGGACTGCATAG |
| | | | factor-like 8B | |
| ASSAY0457 | Hs00750732_s1 | ARHGAP5 | Rho GTPase activating | TCTACCAATTCTCAGGCACCAAGGG |
| | | | protein 5 | |
| ASSAY0463 | Hs00762481_s1 | RPL36 | ribosomal protein L36 | CCTTCTCCCCGTCGCTGTCCGCAGC |
| ASSAY0464 | Hs00793391_m1 | CSNK1A1 | casein kinase 1, | AGTTTTATGTAAGGGGTTTCCTGCA |
| | | | alpha 1 | |
| ASSAY0482 | Hs00242770_m1 | MBD1 | methyl-CpG binding | ATTACCAGAGCCCCACAGGAGACAG |
| | | | domain protein 1 | |
| ASSAY0486 | Hs00247895_s1 | LSM14B | LSM14B, SCD6 homolog B | GAGCCTGGGATGAGCCCCGGCAGCG |
| | | | (S. cerevisiae) | |
| ASSAY0494 | Hs00252433_m1 | CDC42SE1 | CDC42 small effector 1 | AGAGCAGGGTTCCGAGTCTGAGGAA |
| ASSAY0499 | Hs00254802_s1 | RBM8A; | RNA binding motif | CCCTTCCTTGTCTGGGGCCTGGACA |
| | | GNRHR2 | protein 8A; gonadot- | |
| | | | ropin-releaseing | |
| | | | hormone (type 2) | |
| | | | receptor 2 | |
| ASSAY0512 | Hs00260786_m1 | ARFGAP2 | ADP-ribosylation factor | GTATCCCGAAGCTCTGTCTCCCACT |
| | | | GTPase activating | |
| | | | protein 2 | |
| ASSAY0521 | Hs00263798_m1 | ALG2 | asparagine-linked | TAGTGTGCGACCAGGTGTCTGCCTG |
| | | | glycosylation 2, alpha- | |
| | | | 1,3-mannosyltransferase | |
| | | | homolog (S. cerevisiae) | |
| ASSAY0533 | Hs00268117_m1 | SDHB | succinate dehydrogenase | TCATGCAGAGAAGGCATCTGTGGCT |
| | | | complex, subunit B, | |
| | | | iron sulful (Ip) | |
| ASSAY0534 | Hs00268265_m1 | SMARCC1 | SWI/SNF related, matrix | CCAAACTCCCTGCAAAGTGTTTCAT |
| | | | associated, actin | |
| | | | dependent regulator of | |
| | | | chromatin, subfamily c, | |
| | | | member 1 | |
| ASSAY0535 | Hs00268342_m1 | SORL1 | sortilin-related | CAACAAGCGGTACATCTTTGCAGAC |
| | | | receptor, L(DLR class) | |
| | | | A repeats-containing | |
| ASSAY0541 | Hs00270620_s1 | IER2 | immediate early | CCCCGCCAAAGTCAGCCGCAAACGA |
| | | | response 2 | |
| ASSAY0558 | Hs00287906_s1 | H3F3B | H3 histone, family 3B | GCTGTATTTGCAGTGTGGGCTAAGA |
| | | | (H3.3B) | |
| ASSAY0562 | Hs00292593_m1 | COMMD7 | COMM domain containing | GGGCGCGCAGCAGTTCTCAGCCCTG |
| | | | 7 | |
| ASSAY0566 | Hs00293370_m1 | SPPL3 | signal peptide | TATTTAAAGGGCGACCTCCGGCGGA |
| | | | peptidase 3 | |
| ASSAY0568 | Hs00298999_m1 | SLC38A10 | solute carrier family | TTCGCCTGCCAGTCCCAGGTGCTGC |
| | | | 38, member 10 | |
| ASSAY0593 | Hs00362511_g1 | SUGT1 | SGT1, suppressor of | CTGCAACATCCCAGAGGTTTTTCCA |
| | | | G2 allele of SKP1 | |
| | | | (S. cerevisiae) | |
| ASSAY0603 | Hs00368207_m1 | PREX1 | phosphatidylinositol- | CTTCTTGCAGTCGGCATTCCTGCAT |
| | | | 3,4,5-triphosphate- | |
| | | | dependent Rac | |
| | | | exchange factor 1 | |
| ASSAY0611 | Hs00371424_s1 | HIST1H4D | histone cluster 1, H4d | TTCGGCGGCTGAGCTTACCTCTACA |
| ASSAY0614 | Hs00373045_m1 | GAB2 | GRB2-associated | GAGAGCACAGACTCCCTGAGAAATG |
| | | | binding protein 2 | |
| ASSAY0621 | Hs00375641_m1 | TOMM40L | translocase of outer | GCTCAGTCCCACTGAGGTGTTCCCC |
| | | | mitochondrial membrane | |
| | | | 40 homolog (yeast)- | |
| | | | like | |
| ASSAY0625 | Hs00378208_m1 | UBR4 | ubiquitin protein | CACTTGCTTGGCAAGACACAACACT |
| | | | ligase E3 component n- | |
| | | | recognin 4 | |
| ASSAY0632 | Hs00379295_m1 | C1orf144 | chromosome 1 open | AACCCATCCTCGACAGGCCAACCAG |
| | | | reading frame 144 | |
| ASSAY0638 | Hs00384448_m1 | PARS2 | prolyl-tRNA synthetase | GGCTGGGATTGCGGTGCCTGTGCTT |
| | | | 2, mitochondrial | |
| | | | (putative) | |
| ASSAY0648 | Hs00389570_m1 | SEC16A | SEC16 homolog A | AACCTAAGAAGGGTGAATCCTGGTT |
| | | | (S. cerevisiae) | |
| ASSAY0654 | Hs00393592_m1 | FZR1 | fizzy/cell division | ACGATGCCACGCGTCACAGAGATGC |
| | | | cycle 20 related 1 | |
| | | | (Drosophila) | |
| ASSAY0661 | Hs00405469_m1 | JMJD1C | jumonji domain | TCAAAAGCAGGAATTCTCAAGAAAT |
| | | | containing 1C | |
| ASSAY0684 | Hs00417273_m1 | LRRK2 | leucine-rich repeat | TTTGGCCCTCCTCACTGAGACTATT |
| | | | kinase 2 | |
| ASSAY0686 | Hs00418955_m1 | SHCHD1 | structural maintenance | AAGGATTTTAAATGGACAGGAACAG |
| | | | of chromosomes | |
| | | | flexible hinge domain | |
| | | | containing 1 | |
| ASSAY0689 | Hs00419820_g1 | LOC728975 | hypothetical protein | CTGCGTGACCTTGGGCTCTCAGCCC |
| | | | LOC728975 | |
| ASSAY0703 | Hs00430402_m1 | PBXIP1 | pre-B-cell leukemia | ACCCCCAAAGCAGCTTGGATCAGGG |
| | | | homeobox interacting | |
| | | | protein 1 | |
| ASSAY0709 | Hs00536594_m1 | MTG1 | mitochondrial GTPase | CAGCGCTTTGGGTACGTGCAGCACT |
| | | | 1 homolog | |
| | | | (S. cerevisiae) | |
| ASSAY0710 | Hs00536891_m1 | ITSN2 | intersectin 2 | GCTATGAATGGAGGGCCAAACATGT |
| ASSAY0714 | Hs00538879_s1 | LUC7L3 | LUC7-like 3 | GTTACACTCAATGCAATTCTCAAGT |
| | | | (S. cerevisiae) | |
| ASSAY0718 | Hs00539707_m1 | DTX2 | deltex homolog 2 | GGCCGCAAGGTCCTAGAGCTCCTGA |
| | | | (Drosophila) | |
| ASSAY0719 | Hs00540753_m1 | DYNLL2 | dynein, light chain, | GCCTCCGTGAAGTGTCACACCATGT |
| | | | LC8-type 2 | |
| ASSAY0720 | Hs00540812_m1 | CCDC101 | coiled-coil domain | AGAGGCTGAGTGCAACATCCTTCGG |
| | | | containing 101 | |
| ASSAY0726 | Hs00543883_s1 | HIST1H4C | histone cluster 1, H4c | TATGGCTTCGGCGGCTGAATCTAAG |
| ASSAY0740 | Hs00606809_g1 | MRPL41 | mitochondrial | TCCGGTCCAGGGCGCGGCATGGGCG |
| | | | ribosomal protein L41 | |
| ASSAY0748 | Hs00830558_g1 | FOXN3 | forkhead box N3 | TCTAGGGACTTGGTGTTGCTTGGAA |
| ASSAY0753 | Hs00855332_g1 | LDHA | lactate dehydrogenase A | TCTGACGCACCACTGCCAATGCTGT |
| ASSAY0754 | Hs00867656_s1 | DLEU2 | deleted in lymphocytic | AAAAATTTATTTTACACATGTCAAG |
| | | | leukemia 2 (non- | |
| | | | protein coding) | |
| ASSAY0758 | Hs00898410_g1 | RPL32P3 | ribosomal protein L32 | GCTGGCAGGCACCATGTCGTCCTGT |
| | | | pseudogene 3 | |
| ASSAY0782 | Hs00945401_m1 | ANXA1 | annexin A1 | TGCCAAGCCATCCTGGATGAAACCA |
| ASSAY0820 | Hs01031740_m1 | ARPC2 | actin related protein | TGAAAACAATCACGGGGAAGACGTT |
| | | | ⅔ complex, subunit 2, | |
| | | | 34 kDa | |
| ASSAY0827 | Hs01037385_s1 | HMGB1 | high-mobility group | AAAGCAAAGGGAGGATAAAACAGTA |
| | | | box 1 | |
| ASSAY0835 | Hs01053640_m1 | TXK | TXK tyrosine kinase | GCTGGCATGAGAAACCTGAAGGCCG |
| ASSAY0836 | Hs01053867_s1 | NCRNA00203 | non-protein coding | AGCGCCAGTGCTGGCATGGGCTTTC |
| | | | RNA 203 | |
| ASSAY0856 | Hs01085351_m1 | STK39 | serine threonine | TAAGTTGGCTTCTGGCTGTGATGGG |
| | | | kinase 39 (STE20/SPS1 | |
| | | | homolog, yeast) | |
| ASSAY0869 | Hs01111764_m1 | UHMK1 | U2AF homology motif | ATCCTGGCAGAGGACAAGTCTTTGT |
| | | | (UHM) kinase 1 | |
| ASSAY0886 | Hs01564142_m1 | GLIPR1 | GLI pathogenesis- | CTATACATGACTTGGGACCCAGCAC |
| | | | related 1 | |
| ASSAY0899 | Hs01632947_g1 | CCDC72 | coiled-coil domain | GGAATTAAGTGTTGTCTTGGAGCTG |
| | | | containing 72 | |
| ASSAY0900 | Hs01636043_s1 | SRP9 | signal recognition | TGCTGTTGTGACCAATAAATATAAA |
| | | | particle 9 kDa | |
| ASSAY0904 | Hs01885851_s1 | LTB4R2 | leukotriene B4 | CTACGGCCTTGGCCTTCTTCAGTTC |
| | | | receptor 2 | |
| ASSAY0912 | Hs01932078_s1 | COMMD6 | COMM domain containing | AGATTAAGATTGACCATTGCTCCTT |
| | | | 6 | |
| ASSAY0919 | Hs02510591_s1 | DPYD | dihydropyrimidine | GATGGGTGTACAAACTCATCCTCTT |
| | | | dehydrogenase | |
| ASSAY0923 | Hs02621508_s1 | TNFAIP8 | tumor necrosis factor, | AAATACAGATGTCTCCAGACCTGAG |
| | | | alpha-induced protein 8 | |
| ASSAY0962 | Hs00211306_m1 | DHRS7 | dehydrogenase/reductase | CTTTAAGAGTGGTGTGGATGCAGAC |
| | | | (SDR family) member 7 | |
| ASSAY0966 | Hs00323799_m1 | RNF160 | ring finger protein 160 | TGAAAAGGCATGTCCTAGTTCAGAT |
| ASSAY1024 | Hs00918650_m1 | CSDE1 | cold shock domain | TAAAAGTAGGAGATGATGTTGAATT |
| | | | containing E1, RNA- | |
| | | | binding | |
| ASSAY1035 | Hs00202392_m1 | SLC39A6 | solute carrier family | CGGAGACGAAGGCGCAATGGCGAGG |
| | | | 39 (zinc transporter), | |
| | | | member 6 | |
| ASSAY1039 | Hs00425763_m1 | TAF6 | TAF6 RNA polymerase | GAGCCTCCTGCTGAAACACTGTGCT |
| | | | II, TATA box binding | |
| | | | protein (TBP)- | |
| | | | associated factor, | |
| | | | 80 kDa | |
| ASSAY1055 | Hs00154952_m1 | EIF4G2 | eukaryotic translation | TGCTGGCAACAGCGAGTTCCTGGGG |
| | | | initiation factor 4 | |
| | | | gamma, 2 | |
| ASSAY1079 | Hs00162564_m1 | TARS | threonyl-tRNA | CGAGGAGAAGCCGATTGGTGCTGGT |
| | | | synthetase | |
| ASSAY1084 | Hs00390223_m1 | UBR4 | ubiquitin protein | ACATGACCACAGGTACAGAATCAGA |
| | | | ligase E3 component n- | |
| | | | recognin 4 | |
| ASSAY1099 | Hs00428461_m1 | CTDSP2 | CTD (carboxy-terminal | CTCACCAAGCAAGGCCTGGTCTCCA |
| | | | domain, RNA polymerase | |
| | | | II, polypeptide A) | |
| | | | small phosphatase 2 | |
| ASSAY1104 | Hs00261330_s1 | NT5DC1 | 5-nucleotidase domain | CTCACCAAGCAAGGCCTGGTCTCCA |
| | | | containing 1 | |

Sequences corresponding to Assay Nos (sequence numbers) are provided in the Sequence Listing. The following table provides the SEQ ID NO: of each of the sequences that correspond to the Assay No.s.

| ASSAY NO | SEQ ID NO. |
|---|---|
| ASSAY0001 | 1 |
| ASSAY0002 | 2 |
| ASSAY0003 | 3 |
| ASSAY0006 | 4 |
| ASSAY0007 | 5 |
| ASSAY0010 | 6 |
| ASSAY0011 | 7 |
| ASSAY0012 | 8 |
| ASSAY0013 | 9 |
| ASSAY0014 | 10 |
| ASSAY0015 | 11 |
| ASSAY0017 | 12 |
| ASSAY0018 | 13 |
| ASSAY0020 | 14 |
| ASSAY0022 | 15 |
| ASSAY0024 | 16 |
| ASSAY0027 | 17 |
| ASSAY0031 | 18 |
| ASSAY0032 | 19 |
| ASSAY0036 | 20 |
| ASSAY0037 | 21 |
| ASSAY0038 | 22 |
| ASSAY0039 | 23 |
| ASSAY0040 | 24 |
| ASSAY0041 | 25 |
| ASSAY0044 | 26 |
| ASSAY0045 | 27 |
| ASSAY0046 | 28 |
| ASSAY0047 | 29 |
| ASSAY0048 | 30 |
| ASSAY0049 | 31 |
| ASSAY0050 | 32 |
| ASSAY0051 | 33 |
| ASSAY0052 | 34 |
| ASSAY0053 | 35 |
| ASSAY0054 | 36 |
| ASSAY0055 | 37 |
| ASSAY0056 | 38 |
| ASSAY0057 | 39 |
| ASSAY0060 | 40 |
| ASSAY0061 | 41 |
| ASSAY0062 | 42 |
| ASSAY0063 | 43 |
| ASSAY0065 | 44 |
| ASSAY0066 | 45 |
| ASSAY0067 | 46 |
| ASSAY0069 | 47 |
| ASSAY0070 | 48 |
| ASSAY0072 | 49 |
| ASSAY0074 | 50 |
| ASSAY0077 | 51 |
| ASSAY0080 | 52 |
| ASSAY0081 | 53 |
| ASSAY0082 | 54 |
| ASSAY0084 | 55 |
| ASSAY0085 | 56 |
| ASSAY0086 | 57 |
| ASSAY0087 | 58 |
| ASSAY0088 | 59 |
| ASSAY0089 | 60 |
| ASSAY0092 | 61 |
| ASSAY0093 | 62 |
| ASSAY0096 | 63 |
| ASSAY0097 | 64 |
| ASSAY0098 | 65 |
| ASSAY0099 | 66 |
| ASSAY0103 | 67 |
| ASSAY0104 | 68 |
| ASSAY0107 | 69 |
| ASSAY0108 | 70 |
| ASSAY0110 | 71 |
| ASSAY0112 | 72 |
| ASSAY0113 | 73 |
| ASSAY0114 | 74 |
| ASSAY0115 | 75 |
| ASSAY0116 | 76 |
| ASSAY0117 | 77 |
| ASSAY0118 | 78 |
| ASSAY0119 | 79 |
| ASSAY0120 | 80 |
| ASSAY0122 | 81 |
| ASSAY0123 | 82 |
| ASSAY0124 | 83 |
| ASSAY0126 | 84 |
| ASSAY0127 | 85 |
| ASSAY0128 | 86 |
| ASSAY0129 | 87 |
| ASSAY0132 | 88 |
| ASSAY0133 | 89 |
| ASSAY0135 | 90 |
| ASSAY0136 | 91 |
| ASSAY0137 | 92 |
| ASSAY0138 | 93 |
| ASSAY0139 | 94 |
| ASSAY0140 | 95 |
| ASSAY0141 | 96 |
| ASSAY0142 | 97 |
| ASSAY0144 | 98 |
| ASSAY0145 | 99 |
| ASSAY0147 | 100 |
| ASSAY0148 | 101 |
| ASSAY0149 | 102 |
| ASSAY0150 | 103 |
| ASSAY0151 | 104 |
| ASSAY0152 | 105 |
| ASSAY0153 | 106 |
| ASSAY0154 | 107 |
| ASSAY0155 | 108 |
| ASSAY0156 | 109 |
| ASSAY0157 | 110 |
| ASSAY0158 | 111 |
| ASSAY0159 | 112 |
| ASSAY0160 | 113 |
| ASSAY0161 | 114 |
| ASSAY0162 | 115 |
| ASSAY0163 | 116 |
| ASSAY0164 | 117 |
| ASSAY0165 | 118 |
| ASSAY0166 | 119 |
| ASSAY0168 | 120 |
| ASSAY0169 | 121 |
| ASSAY0170 | 122 |
| ASSAY0171 | 123 |
| ASSAY0172 | 124 |
| ASSAY0174 | 125 |
| ASSAY0176 | 126 |
| ASSAY0178 | 127 |
| ASSAY0179 | 128 |
| ASSAY0180 | 129 |
| ASSAY0181 | 130 |
| ASSAY0182 | 131 |
| ASSAY0183 | 132 |
| ASSAY0184 | 133 |
| ASSAY0185 | 134 |
| ASSAY0186 | 135 |
| ASSAY0187 | 136 |
| ASSAY0189 | 137 |
| ASSAY0190 | 138 |
| ASSAY0191 | 139 |
| ASSAY0193 | 140 |
| ASSAY0194 | 141 |
| ASSAY0195 | 142 |
| ASSAY0196 | 143 |
| ASSAY0197 | 144 |
| ASSAY0198 | 145 |
| ASSAY0199 | 146 |
| ASSAY0200 | 147 |
| ASSAY0202 | 148 |
| ASSAY0203 | 149 |
| ASSAY0204 | 150 |
| ASSAY0205 | 151 |
| ASSAY0206 | 152 |
| ASSAY0207 | 153 |
| ASSAY0209 | 154 |
| ASSAY0210 | 155 |
| ASSAY0211 | 156 |
| ASSAY0212 | 157 |
| ASSAY0213 | 158 |
| ASSAY0214 | 159 |
| ASSAY0215 | 160 |
| ASSAY0216 | 161 |
| ASSAY0217 | 162 |
| ASSAY0218 | 163 |
| ASSAY0221 | 164 |
| ASSAY0222 | 165 |
| ASSAY0223 | 166 |
| ASSAY0224 | 167 |
| ASSAY0225 | 168 |
| ASSAY0226 | 169 |
| ASSAY0227 | 170 |
| ASSAY0228 | 171 |
| ASSAY0230 | 172 |
| ASSAY0232 | 173 |
| ASSAY0234 | 174 |
| ASSAY0236 | 175 |
| ASSAY0242 | 176 |
| ASSAY0243 | 177 |
| ASSAY0244 | 178 |
| ASSAY0245 | 179 |
| ASSAY0246 | 180 |
| ASSAY0247 | 181 |
| ASSAY0249 | 182 |
| ASSAY0250 | 183 |
| ASSAY0251 | 184 |
| ASSAY0252 | 185 |
| ASSAY0253 | 186 |
| ASSAY0254 | 187 |
| ASSAY0255 | 188 |
| ASSAY0256 | 189 |
| ASSAY0257 | 190 |
| ASSAY0258 | 191 |
| ASSAY0259 | 192 |
| ASSAY0261 | 193 |
| ASSAY0262 | 194 |
| ASSAY0263 | 195 |
| ASSAY0264 | 196 |
| ASSAY0265 | 197 |
| ASSAY0266 | 198 |
| ASSAY0267 | 199 |
| ASSAY0268 | 200 |
| ASSAY0269 | 201 |
| ASSAY0270 | 202 |
| ASSAY0272 | 203 |
| ASSAY0273 | 204 |
| ASSAY0274 | 205 |
| ASSAY0275 | 206 |
| ASSAY0277 | 207 |
| ASSAY0278 | 208 |
| ASSAY0279 | 209 |
| ASSAY0280 | 210 |
| ASSAY0281 | 211 |
| ASSAY0282 | 212 |
| ASSAY0284 | 213 |
| ASSAY0285 | 214 |
| ASSAY0286 | 215 |
| ASSAY0289 | 216 |
| ASSAY0290 | 217 |
| ASSAY0291 | 218 |
| ASSAY0292 | 219 |
| ASSAY0293 | 220 |
| ASSAY0294 | 221 |
| ASSAY0296 | 222 |
| ASSAY0299 | 223 |
| ASSAY0302 | 224 |
| ASSAY0304 | 225 |
| ASSAY0306 | 226 |
| ASSAY0307 | 227 |
| ASSAY0309 | 228 |
| ASSAY0313 | 229 |
| ASSAY0315 | 230 |
| ASSAY0316 | 231 |
| ASSAY0317 | 232 |
| ASSAY0319 | 233 |
| ASSAY0320 | 234 |
| ASSAY0321 | 235 |
| ASSAY0322 | 236 |
| ASSAY0324 | 237 |
| ASSAY0327 | 238 |
| ASSAY0329 | 239 |
| ASSAY0331 | 240 |
| ASSAY0332 | 241 |
| ASSAY0334 | 242 |
| ASSAY0335 | 243 |
| ASSAY0336 | 244 |
| ASSAY0337 | 245 |
| ASSAY0338 | 246 |
| ASSAY0339 | 247 |
| ASSAY0340 | 248 |
| ASSAY0341 | 249 |
| ASSAY0342 | 250 |
| ASSAY0343 | 251 |
| ASSAY0344 | 252 |
| ASSAY0345 | 253 |
| ASSAY0346 | 254 |
| ASSAY0347 | 255 |
| ASSAY0348 | 256 |
| ASSAY0351 | 257 |
| ASSAY0352 | 258 |
| ASSAY0354 | 259 |
| ASSAY0355 | 260 |
| ASSAY0356 | 261 |
| ASSAY0357 | 262 |
| ASSAY0358 | 263 |
| ASSAY0359 | 264 |
| ASSAY0361 | 265 |
| ASSAY0362 | 266 |
| ASSAY0364 | 267 |
| ASSAY0366 | 268 |
| ASSAY0367 | 269 |
| ASSAY0368 | 270 |
| ASSAY0369 | 271 |
| ASSAY0370 | 272 |
| ASSAY0371 | 273 |
| ASSAY0372 | 274 |
| ASSAY0373 | 275 |
| ASSAY0374 | 276 |
| ASSAY0376 | 277 |
| ASSAY0378 | 278 |
| ASSAY0379 | 279 |
| ASSAY0380 | 280 |
| ASSAY0381 | 281 |
| ASSAY0382 | 282 |
| ASSAY0386 | 283 |
| ASSAY0387 | 284 |
| ASSAY0388 | 285 |
| ASSAY0391 | 286 |
| ASSAY0392 | 287 |
| ASSAY0393 | 288 |
| ASSAY0394 | 289 |
| ASSAY0397 | none |
| ASSAY0399 | 290 |
| ASSAY0400 | 291 |
| ASSAY0401 | 292 |
| ASSAY0402 | 293 |
| ASSAY0403 | 294 |
| ASSAY0405 | 295 |
| ASSAY0407 | 296 |
| ASSAY0408 | 297 |
| ASSAY0409 | 298 |
| ASSAY0410 | 299 |
| ASSAY0412 | 300 |
| ASSAY0414 | 301 |
| ASSAY0415 | 302 |
| ASSAY0417 | 303 |
| ASSAY0420 | 304 |
| ASSAY0421 | 305 |
| ASSAY0422 | 306 |
| ASSAY0423 | 307 |
| ASSAY0424 | 308 |
| ASSAY0425 | 309 |
| ASSAY0426 | 310 |
| ASSAY0427 | 311 |
| ASSAY0428 | 312 |
| ASSAY0429 | 313 |
| ASSAY0431 | 314 |
| ASSAY0432 | 315 |
| ASSAY0433 | 316 |
| ASSAY0434 | 317 |
| ASSAY0435 | 318 |
| ASSAY0436 | 319 |
| ASSAY0437 | 320 |
| ASSAY0440 | 321 |
| ASSAY0441 | 322 |
| ASSAY0442 | 323 |
| ASSAY0443 | 324 |
| ASSAY0445 | 325 |
| ASSAY0446 | 326 |
| ASSAY0449 | 327 |
| ASSAY0450 | 328 |
| ASSAY0451 | 329 |
| ASSAY0452 | 330 |
| ASSAY0453 | 331 |
| ASSAY0455 | 332 |
| ASSAY0456 | 333 |
| ASSAY0457 | 334 |
| ASSAY0458 | 335 |
| ASSAY0459 | 336 |
| ASSAY0460 | 337 |
| ASSAY0461 | 338 |
| ASSAY0463 | 339 |
| ASSAY0464 | 340 |
| ASSAY0465 | 341 |
| ASSAY0467 | 342 |
| ASSAY0472 | 343 |
| ASSAY0473 | 344 |
| ASSAY0474 | 345 |
| ASSAY0476 | 346 |
| ASSAY0477 | 347 |
| ASSAY0478 | 348 |
| ASSAY0479 | 349 |
| ASSAY0480 | 350 |
| ASSAY0481 | 351 |
| ASSAY0482 | 352 |
| ASSAY0483 | 353 |
| ASSAY0484 | 354 |
| ASSAY0485 | 355 |
| ASSAY0486 | 356 |
| ASSAY0487 | 357 |
| ASSAY0488 | 358 |
| ASSAY0489 | 359 |
| ASSAY0491 | 360 |
| ASSAY0494 | 361 |
| ASSAY0495 | 362 |
| ASSAY0497 | 363 |
| ASSAY0499 | 364 |
| ASSAY0500 | 365 |
| ASSAY0501 | 366 |
| ASSAY0502 | 367 |
| ASSAY0504 | 368 |
| ASSAY0506 | 369 |
| ASSAY0507 | 370 |
| ASSAY0509 | 371 |
| ASSAY0510 | 372 |
| ASSAY0511 | 373 |
| ASSAY0512 | 374 |
| ASSAY0513 | 375 |
| ASSAY0514 | 376 |
| ASSAY0516 | 377 |
| ASSAY0517 | 378 |
| ASSAY0518 | 379 |
| ASSAY0521 | 380 |
| ASSAY0523 | 381 |
| ASSAY0524 | 382 |
| ASSAY0526 | 383 |
| ASSAY0527 | 384 |
| ASSAY0531 | 385 |
| ASSAY0532 | 386 |
| ASSAY0533 | 387 |
| ASSAY0534 | 388 |
| ASSAY0535 | 389 |
| ASSAY0537 | 390 |
| ASSAY0538 | 391 |
| ASSAY0539 | 392 |
| ASSAY0540 | 393 |
| ASSAY0541 | 394 |
| ASSAY0542 | 395 |
| ASSAY0543 | 396 |
| ASSAY0544 | 397 |
| ASSAY0545 | 398 |
| ASSAY0546 | 399 |
| ASSAY0547 | 400 |
| ASSAY0548 | 401 |
| ASSAY0549 | 402 |
| ASSAY0550 | 403 |
| ASSAY0551 | 404 |
| ASSAY0552 | 405 |
| ASSAY0553 | 406 |
| ASSAY0555 | none |
| ASSAY0558 | 407 |
| ASSAY0559 | 408 |
| ASSAY0560 | 409 |
| ASSAY0561 | 410 |
| ASSAY0562 | 411 |
| ASSAY0563 | 412 |
| ASSAY0565 | 413 |
| ASSAY0566 | 414 |
| ASSAY0567 | 415 |
| ASSAY0568 | 416 |
| ASSAY0569 | 417 |
| ASSAY0570 | 418 |
| ASSAY0572 | 419 |
| ASSAY0573 | 420 |
| ASSAY0574 | 421 |
| ASSAY0575 | 422 |
| ASSAY0576 | 423 |
| ASSAY0577 | 424 |
| ASSAY0578 | 425 |
| ASSAY0579 | 426 |
| ASSAY0580 | 427 |
| ASSAY0582 | 428 |
| ASSAY0583 | 429 |
| ASSAY0584 | 430 |
| ASSAY0585 | 431 |
| ASSAY0587 | 432 |
| ASSAY0588 | 433 |
| ASSAY0591 | 434 |
| ASSAY0593 | 435 |
| ASSAY0596 | 436 |
| ASSAY0597 | 437 |
| ASSAY0598 | 438 |
| ASSAY0599 | 439 |
| ASSAY0600 | 440 |
| ASSAY0601 | 441 |
| ASSAY0603 | 442 |
| ASSAY0604 | 443 |
| ASSAY0607 | 444 |
| ASSAY0608 | 445 |
| ASSAY0611 | 446 |
| ASSAY0612 | 447 |
| ASSAY0613 | 448 |
| ASSAY0614 | 449 |
| ASSAY0615 | 450 |
| ASSAY0616 | 451 |
| ASSAY0617 | 452 |
| ASSAY0618 | 453 |
| ASSAY0619 | 454 |
| ASSAY0621 | 455 |
| ASSAY0623 | 456 |
| ASSAY0624 | 457 |
| ASSAY0625 | 458 |
| ASSAY0626 | 459 |
| ASSAY0627 | 460 |
| ASSAY0628 | 461 |
| ASSAY0629 | 462 |
| ASSAY0632 | 463 |
| ASSAY0633 | 434 |
| ASSAY0634 | 465 |
| ASSAY0637 | 466 |
| ASSAY0638 | 467 |
| ASSAY0640 | 468 |
| ASSAY0641 | 469 |
| ASSAY0642 | 470 |
| ASSAY0643 | 471 |
| ASSAY0644 | 472 |
| ASSAY0645 | 473 |
| ASSAY0647 | 474 |
| ASSAY0648 | 475 |
| ASSAY0649 | 476 |
| ASSAY0650 | 477 |
| ASSAY0651 | 478 |
| ASSAY0653 | 479 |
| ASSAY0654 | 480 |
| ASSAY0655 | 481 |
| ASSAY0656 | 482 |
| ASSAY0657 | 483 |
| ASSAY0659 | 484 |
| ASSAY0660 | 485 |
| ASSAY0661 | 486 |
| ASSAY0662 | 487 |
| ASSAY0664 | 488 |
| ASSAY0665 | 489 |
| ASSAY0666 | 490 |
| ASSAY0667 | 491 |
| ASSAY0668 | 492 |
| ASSAY0669 | 493 |
| ASSAY0670 | 494 |
| ASSAY0671 | 495 |
| ASSAY0672 | 496 |
| ASSAY0673 | 497 |
| ASSAY0674 | 498 |
| ASSAY0675 | 499 |
| ASSAY0676 | 500 |
| ASSAY0677 | 501 |
| ASSAY0678 | 502 |
| ASSAY0679 | 503 |
| ASSAY0682 | 504 |
| ASSAY0683 | 505 |
| ASSAY0684 | 506 |
| ASSAY0686 | 507 |
| ASSAY0687 | 508 |
| ASSAY0689 | 509 |
| ASSAY0691 | 510 |
| ASSAY0692 | 511 |
| ASSAY0693 | 512 |
| ASSAY0695 | 513 |
| ASSAY0696 | 514 |
| ASSAY0697 | 515 |
| ASSAY0698 | 516 |
| ASSAY0699 | 517 |
| ASSAY0701 | 518 |
| ASSAY0702 | 519 |
| ASSAY0703 | 520 |
| ASSAY0704 | 521 |
| ASSAY0706 | 522 |
| ASSAY0709 | 523 |
| ASSAY0710 | 524 |
| ASSAY0712 | 525 |
| ASSAY0713 | 526 |
| ASSAY0714 | 527 |
| ASSAY0715 | 528 |
| ASSAY0716 | 529 |
| ASSAY0718 | 530 |
| ASSAY0719 | 531 |
| ASSAY0720 | 532 |
| ASSAY0722 | 533 |
| ASSAY0723 | 534 |
| ASSAY0724 | 535 |
| ASSAY0725 | 536 |
| ASSAY0726 | 537 |
| ASSAY0727 | 538 |
| ASSAY0728 | 539 |
| ASSAY0729 | 540 |
| ASSAY0733 | 541 |
| ASSAY0734 | 542 |
| ASSAY0736 | 543 |
| ASSAY0739 | 544 |
| ASSAY0740 | 545 |
| ASSAY0741 | 546 |
| ASSAY0743 | 547 |
| ASSAY0744 | 548 |
| ASSAY0745 | 549 |
| ASSAY0746 | 550 |
| ASSAY0748 | 551 |
| ASSAY0749 | 552 |
| ASSAY0750 | 553 |
| ASSAY0751 | 554 |
| ASSAY0752 | 555 |
| ASSAY0753 | 556 |
| ASSAY0754 | 557 |
| ASSAY0755 | 558 |
| ASSAY0756 | 559 |
| ASSAY0758 | 560 |
| ASSAY0759 | 561 |
| ASSAY0760 | 562 |
| ASSAY0762 | 563 |
| ASSAY0763 | 564 |
| ASSAY0766 | 565 |
| ASSAY0767 | 566 |
| ASSAY0771 | 567 |
| ASSAY0772 | 568 |
| ASSAY0773 | 569 |
| ASSAY0774 | 570 |
| ASSAY0778 | 571 |
| ASSAY0780 | 572 |
| ASSAY0781 | 573 |
| ASSAY0782 | 574 |
| ASSAY0784 | 575 |
| ASSAY0785 | 576 |
| ASSAY0786 | 577 |
| ASSAY0790 | 578 |
| ASSAY0792 | 579 |
| ASSAY0793 | 580 |
| ASSAY0794 | 581 |
| ASSAY0795 | 582 |
| ASSAY0797 | 583 |
| ASSAY0798 | 584 |
| ASSAY0799 | 585 |
| ASSAY0801 | 586 |
| ASSAY0802 | 587 |
| ASSAY0804 | 588 |
| ASSAY0805 | 589 |
| ASSAY0806 | 590 |
| ASSAY0807 | 591 |
| ASSAY0809 | 592 |
| ASSAY0810 | 593 |
| ASSAY0811 | 594 |
| ASSAY0814 | 595 |
| ASSAY0817 | 596 |
| ASSAY0818 | 597 |
| ASSAY0819 | 598 |
| ASSAY0820 | 599 |
| ASSAY0821 | 600 |
| ASSAY0822 | 601 |
| ASSAY0826 | 602 |
| ASSAY0827 | 603 |
| ASSAY0831 | 604 |
| ASSAY0833 | 605 |
| ASSAY0834 | 606 |
| ASSAY0835 | 607 |
| ASSAY0836 | 608 |
| ASSAY0838 | 609 |
| ASSAY0841 | 610 |
| ASSAY0842 | 611 |
| ASSAY0843 | 612 |
| ASSAY0844 | 613 |
| ASSAY0846 | 614 |
| ASSAY0847 | 615 |
| ASSAY0850 | 616 |
| ASSAY0853 | 617 |
| ASSAY0854 | 618 |
| ASSAY0856 | 619 |
| ASSAY0857 | 620 |
| ASSAY0858 | 621 |
| ASSAY0859 | 622 |
| ASSAY0861 | 623 |
| ASSAY0862 | 624 |
| ASSAY0863 | 625 |
| ASSAY0865 | 626 |
| ASSAY0866 | 627 |
| ASSAY0867 | 628 |
| ASSAY0869 | 629 |
| ASSAY0871 | 630 |
| ASSAY0874 | 631 |
| ASSAY0876 | 632 |
| ASSAY0878 | 633 |
| ASSAY0879 | 634 |
| ASSAY0882 | 635 |
| ASSAY0883 | 636 |
| ASSAY0885 | 637 |
| ASSAY0886 | 638 |
| ASSAY0887 | 639 |
| ASSAY0888 | 640 |
| ASSAY0893 | 641 |
| ASSAY0894 | 642 |
| ASSAY0895 | 643 |
| ASSAY0897 | 644 |
| ASSAY0899 | 645 |
| ASSAY0900 | 646 |
| ASSAY0903 | 647 |
| ASSAY0904 | 648 |
| ASSAY0906 | 649 |
| ASSAY0907 | 650 |
| ASSAY0910 | 651 |
| ASSAY0911 | 652 |
| ASSAY0912 | 653 |
| ASSAY0913 | 654 |
| ASSAY0914 | 655 |
| ASSAY0916 | 656 |
| ASSAY0917 | 657 |
| ASSAY0919 | 658 |
| ASSAY0921 | 659 |
| ASSAY0922 | 660 |
| ASSAY0923 | 661 |
| ASSAY0924 | 662 |
| ASSAY0925 | 663 |
| ASSAY0927 | 664 |
| ASSAY0928 | 665 |
| ASSAY0929 | 666 |
| ASSAY0931 | 667 |
| ASSAY0933 | 668 |
| ASSAY0934 | 669 |
| ASSAY0935 | 670 |
| ASSAY0936 | 671 |
| ASSAY0938 | 672 |
| ASSAY0939 | 673 |
| ASSAY0941 | 674 |
| ASSAY0943 | 675 |
| ASSAY0944 | 676 |
| ASSAY0947 | 677 |
| ASSAY0948 | 678 |
| ASSAY0950 | 679 |
| ASSAY0951 | 680 |
| ASSAY0953 | 681 |
| ASSAY0957 | 682 |
| ASSAY0959 | 683 |
| ASSAY0960 | 684 |
| ASSAY0962 | 685 |
| ASSAY0964 | 686 |
| ASSAY0966 | 687 |
| ASSAY0968 | 688 |
| ASSAY0969 | 689 |
| ASSAY0970 | 690 |
| ASSAY0971 | 691 |
| ASSAY0976 | 692 |
| ASSAY0978 | 693 |
| ASSAY0980 | 694 |
| ASSAY0982 | 695 |
| ASSAY0983 | 696 |
| ASSAY0985 | 697 |
| ASSAY0986 | 698 |
| ASSAY0987 | 699 |
| ASSAY0988 | 700 |
| ASSAY0990 | 701 |
| ASSAY0992 | 702 |
| ASSAY0994 | 703 |
| ASSAY0996 | 704 |
| ASSAY0997 | 705 |
| ASSAY0998 | 706 |
| ASSAY1000 | 707 |
| ASSAY1001 | 708 |
| ASSAY1002 | 709 |
| ASSAY1004 | 710 |
| ASSAY1006 | 711 |
| ASSAY1007 | 712 |
| ASSAY1010 | 713 |
| ASSAY1011 | 714 |
| ASSAY1012 | 715 |
| ASSAY1014 | 716 |
| ASSAY1017 | 717 |
| ASSAY1018 | 718 |
| ASSAY1019 | 719 |
| ASSAY1022 | 720 |
| ASSAY1023 | 721 |
| ASSAY1024 | 722 |
| ASSAY1025 | 723 |
| ASSAY1026 | 724 |
| ASSAY1029 | 725 |
| ASSAY1030 | 726 |
| ASSAY1033 | 727 |
| ASSAY1035 | 728 |
| ASSAY1036 | 729 |
| ASSAY1037 | 730 |
| ASSAY1039 | 731 |
| ASSAY1040 | 732 |
| ASSAY1041 | 733 |
| ASSAY1042 | 734 |
| ASSAY1044 | 735 |
| ASSAY1045 | 736 |
| ASSAY1046 | 737 |
| ASSAY1047 | 738 |
| ASSAY1048 | 739 |
| ASSAY1051 | 740 |
| ASSAY1052 | 741 |
| ASSAY1053 | 742 |
| ASSAY1055 | 743 |
| ASSAY1056 | 744 |
| ASSAY1057 | 745 |
| ASSAY1058 | 746 |
| ASSAY1059 | 747 |
| ASSAY1061 | 748 |
| ASSAY1063 | 749 |
| ASSAY1064 | 750 |
| ASSAY1065 | 751 |
| ASSAY1066 | 752 |
| ASSAY1071 | 753 |
| ASSAY1074 | 754 |
| ASSAY1075 | 755 |
| ASSAY1077 | 756 |
| ASSAY1078 | 757 |
| ASSAY1079 | 758 |
| ASSAY1081 | 759 |
| ASSAY1082 | 760 |
| ASSAY1083 | 761 |
| ASSAY1084 | 762 |
| ASSAY1086 | 763 |
| ASSAY1087 | 764 |
| ASSAY1088 | 765 |
| ASSAY1090 | 766 |
| ASSAY1093 | 767 |
| ASSAY1094 | 768 |
| ASSAY1095 | 769 |
| ASSAY1096 | 770 |
| ASSAY1097 | 771 |
| ASSAY1099 | 772 |
| ASSAY1100 | 773 |
| ASSAY1101 | 774 |
| ASSAY1102 | 775 |
| ASSAY1103 | 776 |
| ASSAY1104 | 777 |

MEGA

1. A set of oligonucleotide probes, wherein said set comprises at least 10 oligonucleotides, wherein each of said 10 oligonucleotides, which are each different, are selected from:
(a) an oligonucleotide which is a part of a sequence as set forth in any one of Tables 1 to 11;
(b) an oligonucleotide derived from a sequence as set forth in any one of Tables 1 to 11;
(c) an oligonucleotide with a sequence complementary to the sequence of the oligonucleotide of a) or b); or
(d) an oligonucleotide which is functionally equivalent to an oligonucleotide as defined in (a), (b) or (c).

2. A set as claimed in claim 1 wherein said set comprises at least 30 oligonucleotides selected from a) to d).

3. A set as claimed in claim 1 wherein said set comprises oligonucleotides from all of the sequences set forth in any one of Tables 1 to 11, or derived, complementary or functionally equivalent oligonucleotides thereof.

4. A set as claimed in claim 1 wherein said oligonucleotide in (a) is all or a part of the oligonucleotide sequence as set forth in any one of Tables 2 to 11.

5. A set of oligonucleotide probes as claimed in claim 1, wherein each probe in said set binds to a different transcript.

6-7. (canceled)

8. A set as claimed in claim 1 wherein said at least 10 oligonucleotides selected from a) to d) comprise oligonucleotides from all of the sequences set forth in Table 3, or derived, complementary or functionally equivalent oligonucleotides thereof and oligonucleotides selected from a) to d) from sequences set forth in Table 2 which exhibit a p-value of <0.5, or derived, complementary or functionally equivalent oligonucleotides thereof.

9. A set as claimed in claim 1 wherein said at least 10 oligonucleotides selected from a) to d) comprise oligonucleotides from sequences which are set forth in both Tables 2 and 3 (or Tables 9 and 10) or derived, complementary or functionally equivalent oligonucleotides thereof.

10. A set as claimed in claim 1 consisting of from 10 to 500 oligonucleotide probes.

11. A set of oligonucleotide probes as claimed in claim 1, wherein each of said oligonucleotide probes is from 15 to 200 bases in length.

12. A set of oligonucleotide probes as claimed in claim 1, wherein said probes are immobilized on one or more solid supports.

13. (canceled)

14. A kit comprising a set of oligonucleotide probes as defined in claim 12 immobilized on one or more solid supports.

15-16. (canceled)

17. A method of using a set of oligonucleotide probes of claim 1 to determine the gene expression pattern of a cell or sample where the pattern reflects the level of gene expression of genes to which said oligonucleotide probes bind, comprising:
a) isolating mRNA from said cell or sample, which may optionally be reverse transcribed to cDNA;
b) hybridizing the mRNA or cDNA of step (a) to the set of oligonucleotide probes; and
c) assessing the amount of mRNA or cDNA hybridizing to each of said probes to produce said pattern,
wherein the oligonucleotides in said set of oligonucleotide probes are primary oligonucleotides and said set may additionally comprise secondary oligonucleotides which are not assessed in step c).

18. A method of preparing a standard gene transcript pattern characteristic of a neurological disease or condition with a specific stage or progression profile in an organism comprising at least the steps of:
a) isolating mRNA from a blood sample (e.g. containing cells) of one or more organisms having said neurological disease or condition with a specific stage or progression profile, which may optionally be reverse transcribed to cDNA;
b) hybridizing the mRNA or cDNA of step (a) to a set of oligonucleotide probes as defined in claim 1 specific for said neurological disease or condition with a specific stage or progression profile in an organism and sample thereof corresponding to the organism and sample thereof under investigation; and
c) assessing the amount of mRNA or cDNA hybridizing to each of said probes to produce a characteristic pattern reflecting the level of gene expression of genes to which said oligonucleotides bind, in the sample with said neurological disease or condition with a specific stage or progression profile.

19. A method of preparing a test gene transcript pattern comprising at least the steps of:
a) isolating mRNA from a blood sample (e.g. containing cells) of said test organism, which may optionally be reverse transcribed to cDNA;
b) hybridizing the mRNA or cDNA of step (a) to a set of oligonucleotide probes as defined in claim 1 specific for a specific stage or progression profile of a neurological disease or condition in an organism and sample thereof corresponding to the organism and sample thereof under investigation; and
c) assessing the amount of mRNA or cDNA hybridizing to each of said probes to produce said pattern reflecting the level of gene expression of genes to which said oligonucleotides bind, in said test sample.

20. A method of diagnosing or identifying or monitoring a specific stage or progression profile of a neurological disease or condition in an organism, comprising the steps of:
a) isolating mRNA from a blood sample (e.g. containing cells) of said organism, which may optionally be reverse transcribed to cDNA;
b) hybridizing the mRNA or cDNA of step (a) to a set of oligonucleotide probes as defined in claim 1 specific for a specific stage or progression profile of a neurological disease or condition in an organism and sample thereof corresponding to the organism and sample thereof under investigation;
c) assessing the amount of mRNA or cDNA hybridizing to each of said probes to produce a characteristic pattern reflecting the level of gene expression of genes to which said oligonucleotides bind, in said sample; and
d) comparing said pattern to a standard diagnostic pattern prepared according to steps e) through g) below using a sample from an organism corresponding to the organism and sample under investigation to determine the degree of correlation indicative of the presence of a specific stage or progression profile of a neurological disease or condition in the organism under investigation, said steps e) through g) comprising at least the steps of:
e) isolating mRNA from a blood sample (e.g. containing cells) of one or more organisms having said neurological disease or condition with a specific stage or progression profile, which may optionally be reverse transcribed to cDNA;
f) hybridizing the mRNA or cDNA of step (a) to a set of oligonucleotide probes as defined in claim 1 specific for said neurological disease or condition with a specific stage or progression profile in an organism and sample thereof corresponding to the organism and sample thereof under investigation; and
g) assessing the amount of mRNA or cDNA hybridizing to each of said probes to produce a characteristic pattern reflecting the level of gene expression of genes to which said oligonucleotides bind, in the sample with said neurological disease or condition with a specific stage or progression profile.

21. A method of diagnosing or identifying a specific progression profile of a neurological disease or condition in an organism, comprising the steps of:
a) isolating mRNA from a blood sample (e.g. containing cells) of said organism, which may optionally be reverse transcribed to cDNA;
b) hybridizing the mRNA or cDNA of step (a) to a set of oligonucleotides or a kit comprising oligonucleotides specific for a specific progression profile of a neurological disease or condition in an organism and sample thereof corresponding to the organism and sample thereof under investigation;
c) assessing the amount of mRNA or cDNA hybridizing to each of said probes to produce a characteristic pattern reflecting the level of gene expression of genes to which said oligonucleotides bind, in said sample; and
d) comparing said pattern to a standard diagnostic pattern prepared according to claim 18 using a sample from an organism corresponding to the organism and sample under investigation and a set of oligonucleotides or a kit as defined in step b) to determine the degree of correlation indicative of the presence of a specific progression profile of a neurological disease or condition in the organism under investigation.

22. A method of determining the efficacy of a treatment of a neurological disease or condition in an organism, comprising performing steps of a) to d) of the method of claim 20, before, during, and/or after treatment of said neurological condition or disease in said organism to determine the efficacy of said treatment.

23. A method of monitoring the progression of a neurological disease or condition in an organism, comprising the steps of:
a) isolating mRNA from a blood sample (e.g. containing cells) of said organism, which may optionally be reverse transcribed to cDNA;
b) hybridizing the mRNA or cDNA of step (a) to a set of oligonucleotide probes as defined in claim 1 specific for a specific stage of a neurological disease or condition in an organism and sample thereof corresponding to the organism and sample thereof under investigation;
c) assessing the amount of mRNA or cDNA hybridizing to each of said probes to produce a characteristic pattern reflecting the level of gene expression of genes to which said oligonucleotides bind, in said sample;
d) comparing said pattern to a standard diagnostic pattern prepared according to steps g) through i) below using a sample from an organism corresponding to the organism and sample under investigation to determine the degree of correlation indicative of the specific stage of a neurological disease or condition in the organism under investigation;
e) after a time interval, repeating steps a) to d);
f) comparing the specific stage of the disease or condition identified before and after the time interval to establish the progression of said disease or condition, said steps g) through i) comprising at least the steps of:
g) isolating mRNA from a blood sample (e.g. containing cells) of one or more organisms having said neurological disease or condition with a specific stage or progression profile, which may optionally be reverse transcribed to cDNA;
h) hybridizing the mRNA or cDNA of step (a) to a set of oligonucleotide probes as defined in claim 1 specific for said neurological disease or condition with a specific stage or progression profile in an organism and sample thereof corresponding to the organism and sample thereof under investigation; and
i) assessing the amount of mRNA or cDNA hybridizing to each of said probes to produce a characteristic pattern reflecting the level of gene expression of genes to which said oligonucleotides bind, in the sample with said neurological disease or condition with a specific stage or progression profile.

24. A method as claimed in claim 17 wherein said probes are primers and in step b) said mRNA or cDNA or a part thereof is amplified using said primers and in step c) the amount of amplified product is assessed to produce said pattern.

25. A method as claimed in claim 17 wherein said probes are labeling probes and pairs of primers and in step b) said labeling probes and primers are hybridized to said mRNA or cDNA and said mRNA or cDNA or a part thereof is amplified using said primers, wherein when said labeling probe binds to the target sequence it is displaced during amplification thereby generating a signal and in step c) the amount of signal generated is assessed to produce said pattern.

26-28. (canceled)

29. A method of identifying a compound suitable for the treatment of a neurodegenerative condition or disease or a specific stage or progression profile thereof in an organism comprising the steps of:
a) identifying the stage or progression profile of said organism by the method of claim 20,
b) administering said compound to said organism,
c) repeating step a) after step b),
d) comparing the stages or progression profiles identified in steps a) and c) to determine if any therapeutic benefit is observed in said organism relative to a comparable organism not treated by said compound.

30-32. (canceled)

33. A method as claimed in claim 17 wherein said organism is a eukaryotic organism, preferably a mammal.

34. A method as claimed in claim 33 wherein said organism is a human.

35. (canceled)

36. A method as claimed in claim 17 wherein said sample is peripheral blood.

37. A method as claimed in claim 20 wherein said neurological disease or condition is Alzheimer's disease.

38. A method as claimed in claim 20 wherein said neurological disease or condition is MCI.

39. A method as claimed in claim 20 wherein said stage of said neurological disease or condition is prodromal Alzheimer's disease.

40. A method as claimed in claim 20 wherein said stage of said neurological disease or condition is stable MCI.

41. A method as claimed in claim 20 wherein said progression profile of said neurological disease or condition is predictive of clear progression of dementia, preferably Alzheimer's disease.

42. A method as claimed in claim 38 wherein said probes are from Tables 2, 3, 4 and/or 6.

43. A method as claimed in claim 41 wherein said probes are from Tables 9, 10 and/or 11.
